(19) United States
(12) Patent Application Publication
(10) Pub. No.: US 2013/0173328 A1
(43) Pub. Date: Jul. 4, 2013

(54) COMPUTERIZED SYSTEM AND METHOD FOR MANAGING INJECTION OF RESOURCES INTO A FLOW OF MULTIPLE RESOURCE UTILIZATION EVENTS

(71) Applicants: Avi GRINER, Tel Aviv (IL); Ronen ISRAELI, Tel Aviv (IL)

(72) Inventors: Avi GRINER, Tel Aviv (IL); Ronen ISRAELI, Tel Aviv (IL)

(21) Appl. No.: 13/342,132

(22) Filed: Jan. 2, 2012

(51) Int. Cl. G06Q 10/06

(52) U.S. Cl. 705/7.24

(57) ABSTRACT

Method for managing injection of resources into flow of multiple resource utilization events, by receiving flow of base resource utilization events including basic dates on which externally managed resource/s are supplied by supplier to utilizer; deriving resource utilization events from base events and storing as unrelated records: the first storing the first event, whereby externally managed resource is supplied by a first supplier by a “first date” parameter (initially the basic date); the second storing the second event, whereby the externally managed resource is supplied to a utilizer by a “second date” parameter (initially the basic date); providing an internal resource management subsystem for authorization injection of internal resources into events without exceeding available amounts of internal resources and changing first and/or second dates to define a temporal gap between individual and basic dates and recording a resource injection authorized by the subsystem to bridge the gap.

### REFERENCE TO CO-PENDING PATENT APPLICATIONS BELONGING TO APPLICANT

None.

### FIELD OF THE INVENTION

The present invention relates generally to computerized systems and more particularly computerized systems for resource management.

### BACKGROUND OF THE INVENTION

Conventional technology pertaining to certain embodiments of the present invention includes:

According to Wikipedia, “Ajax . . . is a group of interrelated web development methods used on the client-side to create asynchronous web applications. With Ajax, web applications can send data to, and retrieve data from, a server asynchronously (in the background) without interfering with the display and behavior of the existing page.”

According to Wikipedia, “Model-view-controller (MVC) is a software architecture . . . [which] isolates “domain logic” (the application logic for the user) from the user interface (input and presentation), permitting independent development, testing and maintenance of each (separation of concerns). Model View Controller (MVC) pattern creates applications that separate the different aspects of the application (input logic, business logic, and UI logic), while providing a loose coupling between these elements . . . . [C]ontrol flow is generally as follows:
1. The user interacts with the user interface in some way (for example, by pressing a mouse button).
2. The controller handles the input event from the user interface, often via a registered handler or callback, and converts the event into an appropriate user action, understandable for the model.
3. The controller notifies the model of the user action, possibly resulting in a change in the model's state. ( . . . )
4. A view queries the model in order to generate an appropriate user interface . . . . The view gets its own data from the model. In some implementations, the controller may issue a general instruction to the view to render itself. In others, the view is automatically notified by the model of changes in state (Observer) that require a screen update.
5. The user interface waits for further user interactions, which restart the control flow cycle.”

According to Wikipedia, “clearing denotes all activities from the time a commitment is made for a transaction until it is settled. Clearing is necessary because the speed of trades is much faster than the cycle time for completing the underlying transaction . . . . In its widest sense clearing involves the management of post-trading, pre-settlement credit exposures, to ensure that trades are settled in accordance with market rules, even if a buyer or seller should become insolvent prior to settlement.

Clearing is typically automated (computerized) and may include any or all of the following processes: reporting/monitoring, risk margining, netting of trades to single positions, tax handling, and failure handling.

According to Wikipedia, “the Automated Clearing House (ACH) is an electronic payment system, developed jointly by the private sector and the Federal Reserve in the early 1970s as a more-efficient alternative to checks. Since then, the ACH has evolved into a nationwide mechanism that processes credit and debit transfers electronically. ACH credit transfers are used to make direct deposit payroll payments and corporate payments to vendors. ACH debit transfers are used by consumers to authorize the payment of insurance premiums, mortgages, loans, and other bills from their account. The ACH is also used by businesses to concentrate funds at a primary bank and to make payments to other businesses.”

Masav, a corporation active since 1984, is owned by Israeli banks e.g. Poalim, Leumi, Discount, Mizrachi and Benleumi, and is an example of an electronic system, typically providing computerized services to banks and corporate customers thereof, that settles inter-bank movements (debit and credit instructions) that are not based on paper documents or cash, such as account debiting authorizations (“standing orders”), salary payments and tax rebates, which are transferred to it by the banks and by other institutions that are authorized to send direct instructions to the Automatic Clearing House Debit and credit instructions are settled on the evening of the transfer date, at same day value. Interbank transfers are recorded on the business day after the transfer date. The participants in the clearance are entitled to return debits and credits a number of days after the time they are presented. Payment instructions that are returned are assigned the value of the business day on which they were presented.

E-wallets such as Paypal, and E-banking systems such as Citi Bank, are known.

The disclosures of all publications and patent documents mentioned in the specification, and of the publications and patent documents cited therein directly or indirectly, are hereby incorporated by reference.

### SUMMARY OF THE INVENTION

There is thus provided, in accordance with at least one aspect of the presently disclosed subject matter, a computerized method for managing injection of resources into a flow of multiple resource utilization events, the method comprising receiving computerized data including a flow of base resource utilization events each including a digital representation of a basic date on which at least one externally managed resource is to be supplied by a resource supplier to a resource utilizer; deriving first and second resource utilization events from each base resource utilization event and storing the first and second resource utilization events as two unrelated computer database records including a first computer database record storing a digital representation of the first resource utilization event, according to which the externally managed resource is to be supplied by a first resource supplier by a first date wherein the first date is a parameter whose initial value is the basic date; and a second computer database record storing a digital representation of the second resource utilization event, according to which the externally managed resource is to be supplied to an individual resource utilizer by a second date wherein the second date is a parameter whose initial value is the basic date; providing a computerized internal resource management subsystem for managing internal resources, including authorization of injection of internal resources into resource utilization events without exceeding available amounts of the internal resources and recording the injections so authorized; and changing at least an individual date from among the first and second dates, in at least one of the computer database records, so as to define a temporal gap between the individual date and the basic date and recording at least one resource injection authorized by the internal resource management subsystem to bridge the temporal gap.

There is thus further provided, in accordance with at least one embodiment of the presently disclosed subject matter, a computerized method wherein the resources comprise equipment resources.

There is thus yet further provided, in accordance with at least one embodiment of the presently disclosed subject matter, a computerized method, wherein the equipment resources comprise printing equipment.

There is thus yet further provided, in accordance with at least one embodiment of the presently disclosed subject matter, a computerized method wherein the resources comprise a fleet of vehicles performing deliveries.

There is thus yet further provided, in accordance with at least one embodiment of the presently disclosed subject matter, a computerized method, wherein the resources comprise computer-managed credit, wherein the basic date comprises a debit date, the resource supplier comprises a payer computerized system and the resource utilizer comprises a beneficiary computerized system.

There is thus yet further provided, in accordance with at least one embodiment of the presently disclosed subject matter, a computerized method, wherein the resources comprise manufacturing facilities.

There is thus yet further provided, in accordance with at least one embodiment of the presently disclosed subject matter, a computerized method, wherein the equipment resources comprise construction equipment.

There is thus yet further provided, in accordance with at least one embodiment of the presently disclosed subject matter, a computerized method, wherein the computer database record for which the individual date is changed includes a first record, and wherein the changing includes selecting as the individual date, a date later than the first date.

There is thus yet further provided, in accordance with at least one embodiment of the presently disclosed subject matter, a computerized method, wherein the computer database record for which the individual date is changed includes a second record, and wherein the changing includes selecting as the individual date, a date earlier than the second date.

There is thus yet further provided, in accordance with at least one embodiment of the presently disclosed subject matter, a computerized method, wherein the internally managed and externally managed resources are interchangeable.

There is thus yet further provided, in accordance with at least one embodiment of the presently disclosed subject matter, a computerized method, wherein the changing occurs responsive to a computerized request entered by the first resource supplier.

There is thus yet further provided, in accordance with at least one embodiment of the presently disclosed subject matter, a computerized method, wherein the changing occurs responsive to a computerized request entered by the individual resource utilizer.

There is thus yet further provided, in accordance with at least one embodiment of the presently disclosed subject matter, a computerized method comprising allowing resource suppliers to view information regarding first resource utilization events in which the resource suppliers supply the externally managed resource but not allowing resource suppliers to view information regarding second resource utilization events in which the resource suppliers supply the externally managed resource.

There is thus yet further provided, in accordance with at least one embodiment of the presently disclosed subject matter, a computerized method comprising allowing resource utilizers to view information regarding second resource utilization events in which the resource utilizers are supplied with the externally managed resource but not allowing resource utilizers to view information regarding first resource utilization events in which the resource utilizers are supplied with the externally managed resource.

There is thus yet further provided, in accordance with at least one embodiment of the presently disclosed subject matter, a computerized method wherein future payments are sent and received via credit cards, using future payment computerized protocol options provided by external clearing companies.

There is thus yet further provided, in accordance with at least one embodiment of the presently disclosed subject matter, a computerized method comprising a bank account computerized interface operative to send and receive a future transaction using a bank account, including interfacing with at least one external computerized electronic financial system using an API (Application program interface) predefined by the external electronic system.

There is thus yet further provided, in accordance with at least one embodiment of the presently disclosed subject matter, a computerized method wherein the external computerized electronic financial system comprises an Automatic Clearing House.

There is thus yet further provided, in accordance with at least one embodiment of the presently disclosed subject matter, a computerized method wherein full PCI compatibility is maintained. by redirecting clients to a processor system with full PCI compliance.

There is thus yet further provided, in accordance with at least one embodiment of the presently disclosed subject matter, a computerized method wherein computerized Delivery Guarantee is provided.

There is thus yet further provided, in accordance with at least one embodiment of the presently disclosed subject matter, a computerized method wherein an AJAX web application is used on a client side, to send data to, and to receive data from, a server, asynchronously and in the background.

There is thus yet further provided, in accordance with at least one embodiment of the presently disclosed subject matter, a computerized method wherein separation of data and interface is achieved by use of model-view-controller (MVC) software architecture.

There is thus yet further provided, in accordance with at least one embodiment of the presently disclosed subject matter, a computerized method comprising generating and utilizing at least one text file representing data stored in at least one database serving the method, to expedite client-server access while retaining flexibility of the data provided by the database.

There is thus yet further provided, in accordance with at least one aspect of the presently disclosed subject matter, a computerized system for managing injection of resources into a flow of multiple resource utilization events, the system comprising a resource utilization events receiver operative for receiving computerized data including a flow of base resource utilization events each including a digital representation of a basic date on which at least one externally managed resource is to be supplied by a resource supplier to a resource utilizer; a resource utilization event splitter deriving first and second resource utilization events from each base resource utilization event and storing the first and second resource utilization events as two unrelated computer database records including a first computer database record storing a digital representation of the first resource utilization event, according to which the externally managed resource is to be supplied by a first resource supplier by a first date wherein the first date is a parameter whose initial value is the basic date; and a second computer database record storing a digital representation of the second resource utilization event, according to which the externally managed resource is to be supplied to an individual resource utilizer by a second date wherein the second date is a parameter whose initial value is the basic date; a computerized internal resource management subsystem for managing internal resources, including authorization of injection of internal resources into resource utilization events without exceeding available amounts of the internal resources and recording the injections so authorized; and a resource injection manager operative for changing at least an individual date from among the first and second dates, in at least one of the computer database records, so to define a temporal gap between the individual date and the basic date and recording at least one resource injection authorized by the internal resource management subsystem to bridge the temporal gap.

There is thus yet further provided, in accordance with at least one aspect of the presently disclosed subject matter, a computer program product, comprising a computer usable medium having a computer readable program code embodied therein, the computer readable program code adapted to be executed to implement a method for managing injection of resources into a flow of multiple resource utilization events, the method comprising receiving computerized data including a flow of base resource utilization events each including a digital representation of a basic date on which at least one externally managed resource is to be supplied by a resource supplier to a resource utilizer; deriving first and second resource utilization events from each base resource utilization event and storing the first and second resource utilization events as two unrelated computer database records including a first computer database record storing a digital representation of the first resource utilization event, according to which the externally managed resource is to be supplied by a first resource supplier by a first date wherein the first date is a parameter whose initial value is the basic date; and a second computer database record storing a digital representation of the second resource utilization event, according to which the externally managed resource is to be supplied to an individual resource utilizer by a second date wherein the second date is a parameter whose initial value is the basic date; providing a computerized internal resource management subsystem for managing internal resources, including authorization of injection of internal resources into resource utilization events without exceeding available amounts of the internal resources and recording the injections so authorized; and changing at least an individual date from among the first and second dates, in at least one of the computer database records, so to define a temporal gap between the individual date and the basic date and recording at least one resource injection authorized by the internal resource management subsystem to bridge the temporal gap.

Certain embodiments of the present invention seek to provide an improved e-payment system.

Certain embodiments of the present invention seek to provide a computerized payment system which has the ability to send and receive future payments via credit cards. The system may use existing protocol options provided by the clearing companies for future payments.

Certain embodiments of the present invention seek to provide a computerized payment system which has the ability to send and receive a future transaction using a bank account: The system may connect to external electronic systems performing clearing services for banks and their corporate customers, such as but not limited to Masav, using their API (Application program interface).

Certain embodiments of the present invention seek to provide a computerized payment system which has the ability to move forward a credit due date: the system provides the ability to request a discount for any selected payment at any time and thus it can credit a receiving computerized entity at any time. The user is the one to decide if and when he elects to claim an early payment e.g. by selection of suitable user input options in the client.

Certain embodiments of the present invention seek to provide a computerized payment system which has the ability to postpone a debit due date. Selectably, a client may choose to postpone payment at any time.

Typically, the system typically creates a computerized record of and manages two separate transactions, one for the payer and one for the beneficiary. Thus, any change in the transaction by a beneficiary or payer, may not affect the second client of the transaction, the payer or the beneficiary respectively. Therefore, postponing a debit transaction affects only the payer and nonetheless, the beneficiary still gets his payment at the planned due date. Also, moving forward, a credit transaction affects only the beneficiary and the payer still pays his payment at an agreed upon due date and no earlier, unless so requested, independently, by the payer.

Typically, the system provides full PCI compatibility e.g. by redirecting clients to a processor system with full PCI compliance.

Typically, computerized Delivery Guarantee is provided; e.g. if the beneficiary must accept or decline any payment he receives. Also, once payment is delivered to the beneficiary he is typically required to confirm and accept delivery.

Certain embodiments of the present invention seek to provide a comprehensive computerized payment system, for B2B and other applications, which has the ability to commit to a future payment just as cheques do, has a convenient and secured environment as credit cards do, and is delivered in a one stop solution which is highly secured and accessible remotely e.g. by web. Typically, the system enables an end user to communicate with other users who use other methods of payment.

Also provided is a computer program comprising computer program code means for performing any of the methods shown and described herein when said program is run on a computer; and a computer program product, comprising a typically non-transitory computer-usable or -readable medium or computer readable storage medium, typically tangible, having a computer readable program code embodied therein, said computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein, such as but not limited to steps of flowcharts, may be performed by a conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 a is a simplified flowchart illustration of a computerized method for managing injection of resources into a flow of multiple resource utilization events, operative in accordance with certain embodiments of the present invention.

FIG. 1b is a simplified functional block diagram of a computerized system for effecting payments constructed and operative in accordance with certain embodiments of the present invention, being an example embodiment of the computerized method of FIG. 1a; the ordinarily skilled man of the art will appreciate that most aspects of the implementation illustrated are merely exemplary and may readily be modified to suit a particular application or use case or environment; to give one example, “J5”, “J0”, and “J4” are merely examples of conventional computerized transactions used in credit applications and are not intended to be limiting; the applicability of certain embodiments of the invention is certainly not limited to these specific transactions and more generally may of course include any suitable computerized transactions used in credit applications as well as any suitable computerized transactions used in a wide variety of computerized applications in which resources are injected into e.g. allocated to one or more transactions from among a managed population of transactions.

FIGS. 2-13 are tables useful in understanding an example implementation for a computerized “wizard” performing login to the system, including an interface facilitating parameter definition, all in accordance with certain embodiments of the present invention.

FIGS. 14a-14b are tables useful in understanding an example implementation for computerized “dashboard” constructed and operative in accordance with certain embodiments of the present invention.

FIGS. 15-37 are tables useful in understanding computerized transactions which may be performed by a transactions processing unit in the system of FIG. 1b, all in accordance with certain embodiments of the present invention.

FIGS. 38-49 are tables useful in understanding computerized tools which may be provided in the system of FIG. 1b, all in accordance with certain embodiments of the present invention.

FIGS. 50a-50b are tables useful in understanding a system of computerized alerts some or all of which may be sent to various users in respect of different transactions in the system, all in accordance with certain embodiments of the present invention.

FIGS. 51, 52a-52c are flow diagrams useful in understanding “future transaction” functionality provided in accordance with certain embodiments of the present invention.

FIGS. 53a-54e are flow diagrams useful in understanding “separate transaction” functionality provided in accordance with certain embodiments of the present invention.

FIGS. 55a-68b are tables which, when stored in computer memory, are useful in accordance with certain embodiments of the present invention; some or all of the tables may, in part or in their entirety, be stored in the computerized database/s 70 of FIG. 1b.

Computational components described and illustrated herein can be implemented in various forms, for example, as hardware circuits such as but not limited to custom VLSI circuits or gate arrays or programmable hardware devices such as but not limited to FPGAs, or as software program code stored on at least one intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

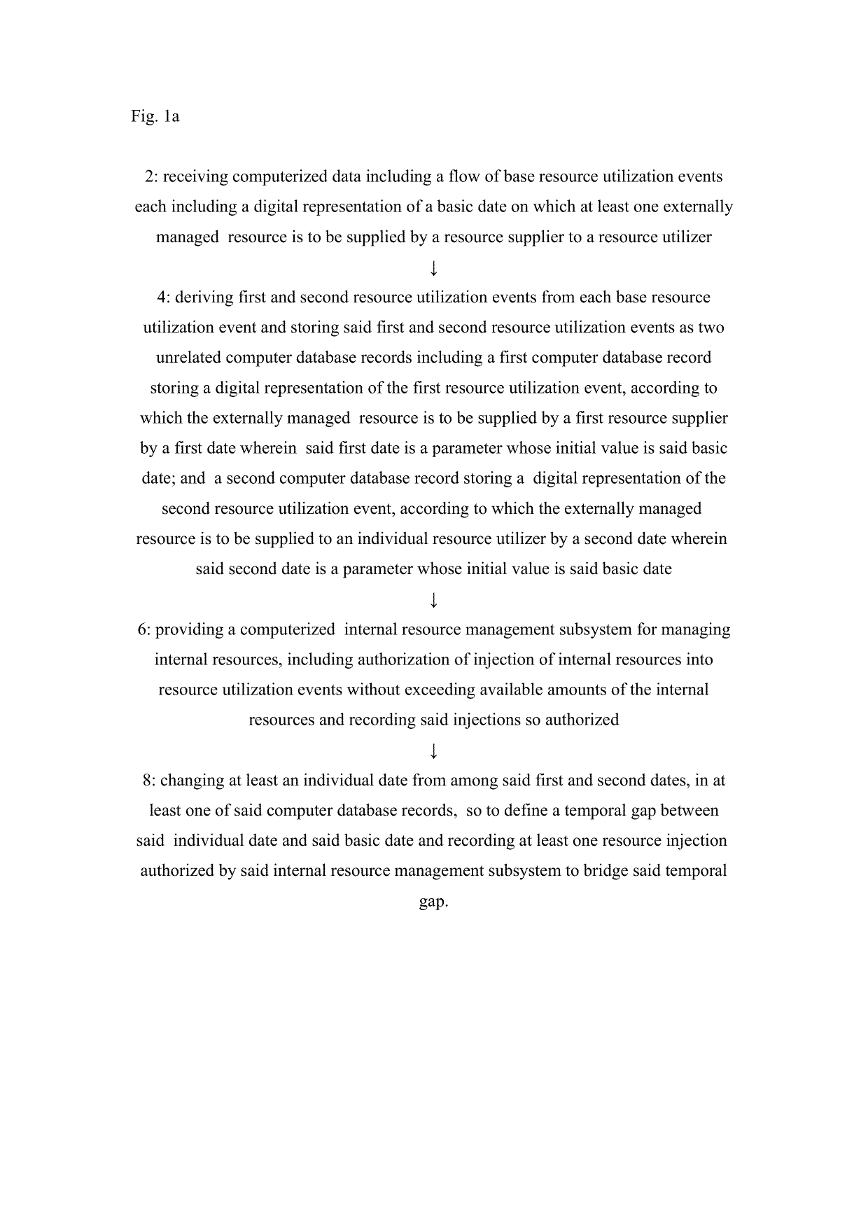

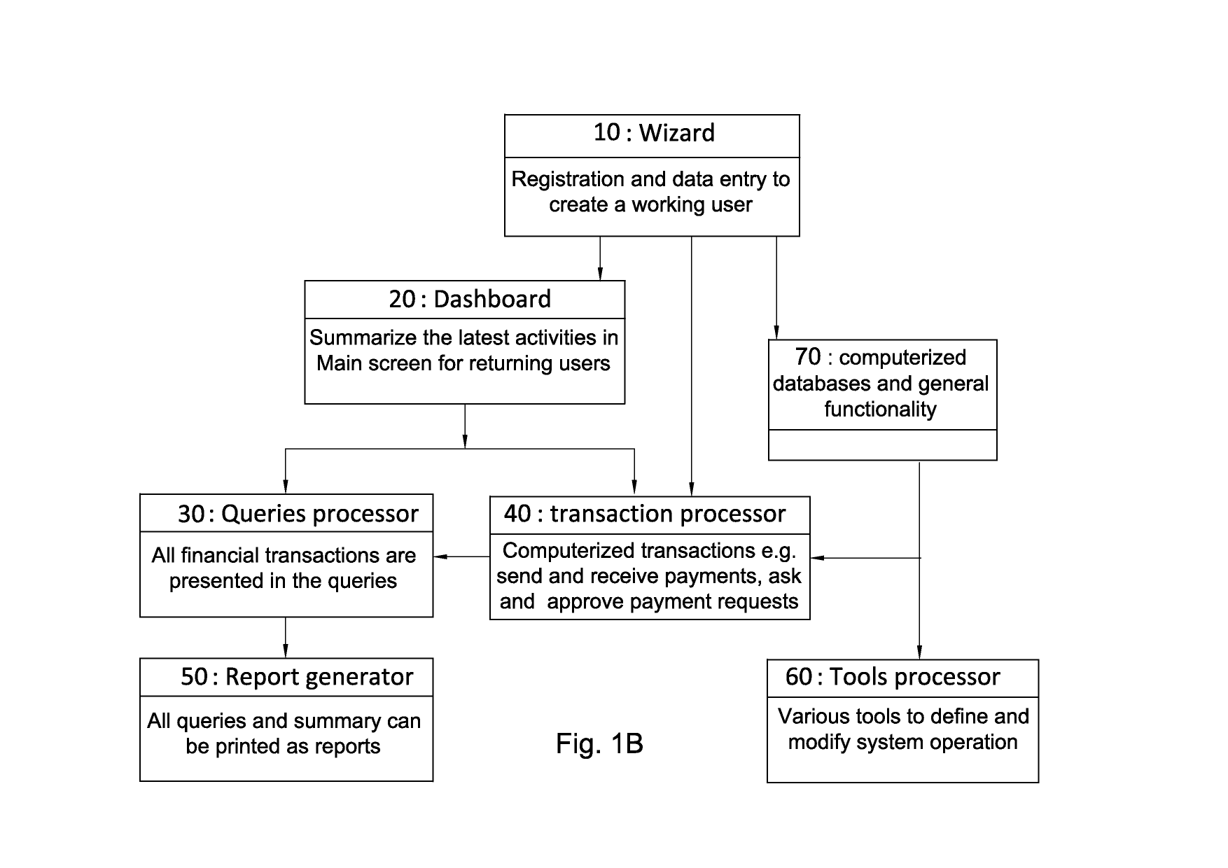

FIG. 1a is a simplified flowchart illustration of a computerized method for managing injection of resources into a flow of multiple resource utilization events, operative in accordance with certain embodiments of the present invention. The method of FIG. 1a typically includes some or all of the following steps, suitably ordered e.g. as shown:

Step 2: receiving computerized data including a flow of base resource utilization events each including a digital representation of a basic date on which at least one externally managed resource is to be supplied by a resource supplier to a resource utilizer.

Step 4: deriving first and second resource utilization events from each base resource utilization event and storing said first and second resource utilization events as two unrelated computer database records including a first computer database record storing a digital representation of the first resource utilization event, according to which the externally managed resource is to be supplied by a first resource supplier by a first date wherein said first date is a parameter whose initial value is said basic date; and a second computer database record storing a digital representation of the second resource utilization event, according to which the externally managed resource is to be supplied to an individual resource utilizer by a second date wherein said second date is a parameter whose initial value is said basic date.

Step 6: providing a computerized internal resource management subsystem for managing internal resources, including authorization of injection of internal resources into resource utilization events without exceeding available amounts of the internal resources and recording said injections so authorized.

Step 8: changing at least an individual date from among said first and second dates, in at least one of said computer database records, so as to define a temporal gap between said individual date and said basic date and recording at least one resource injection authorized by said internal resource management subsystem to bridge said temporal gap.

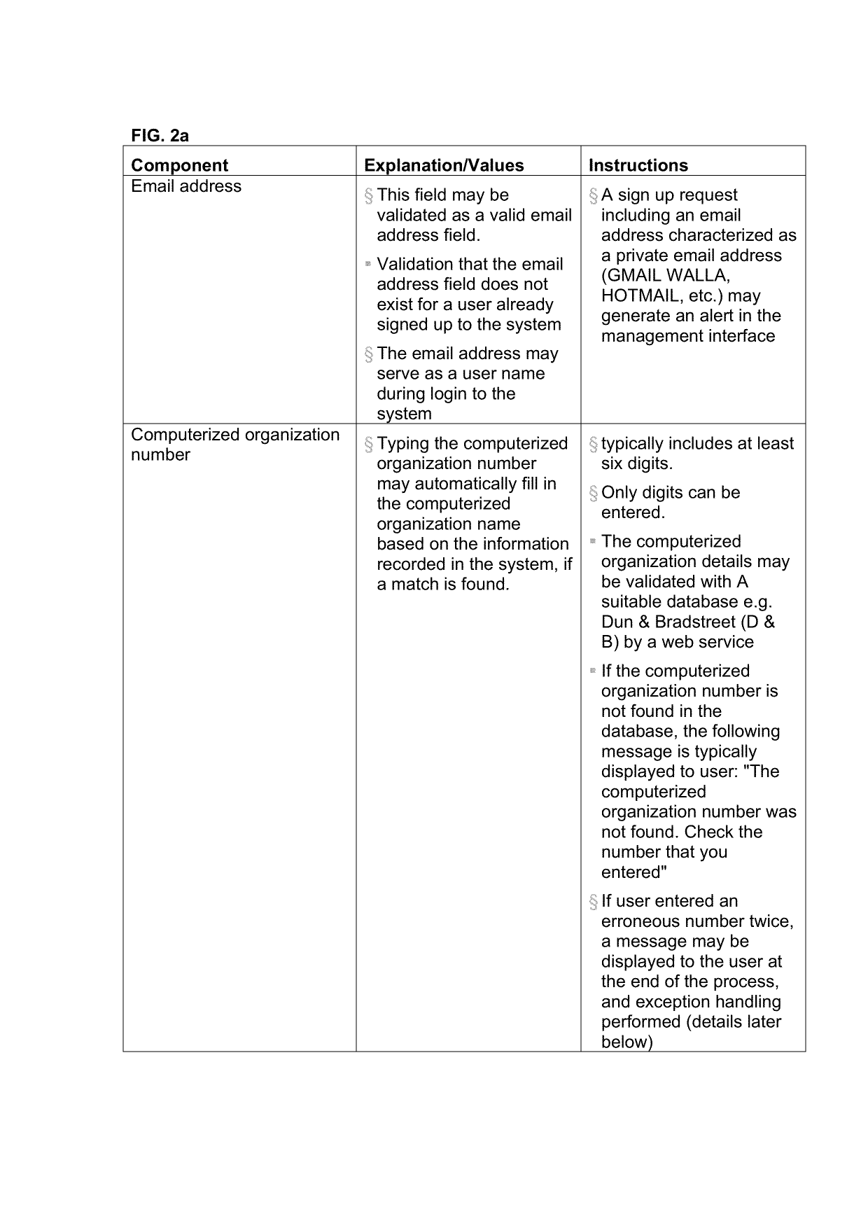

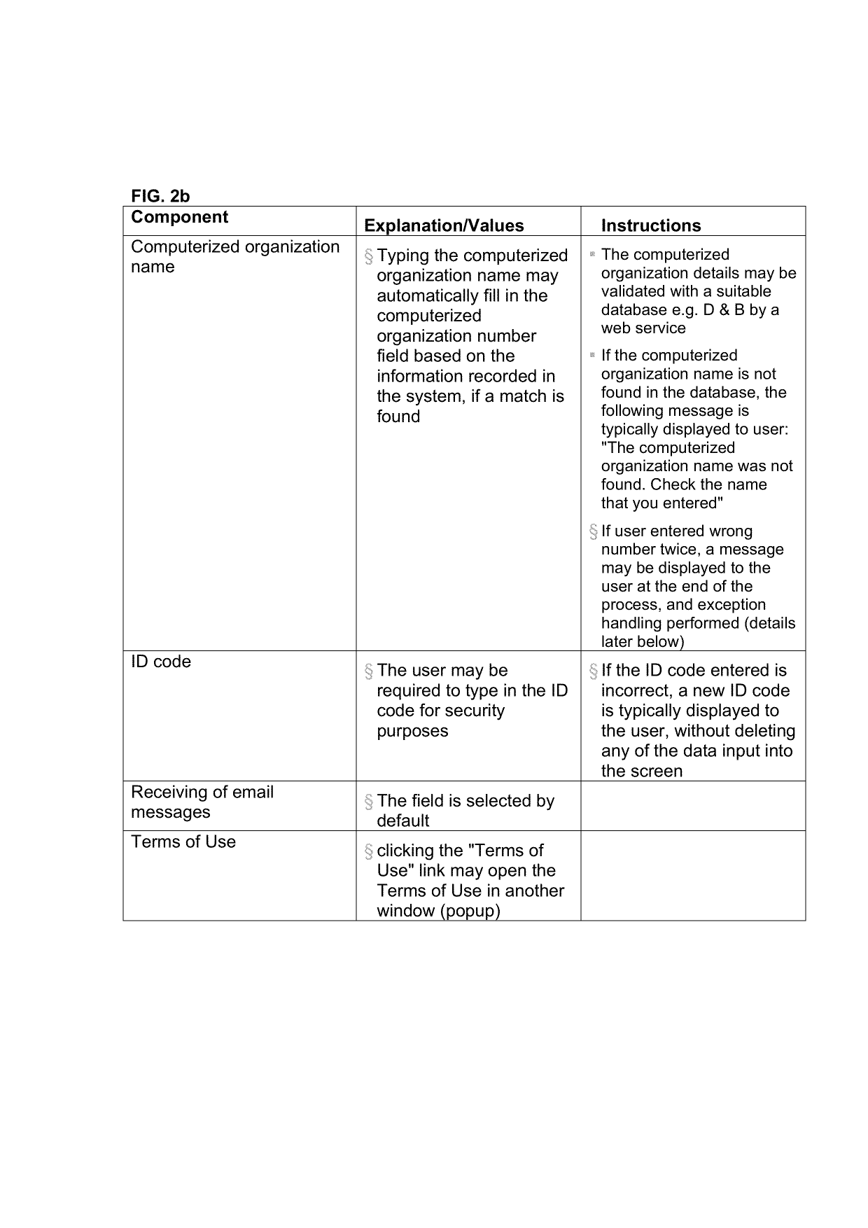

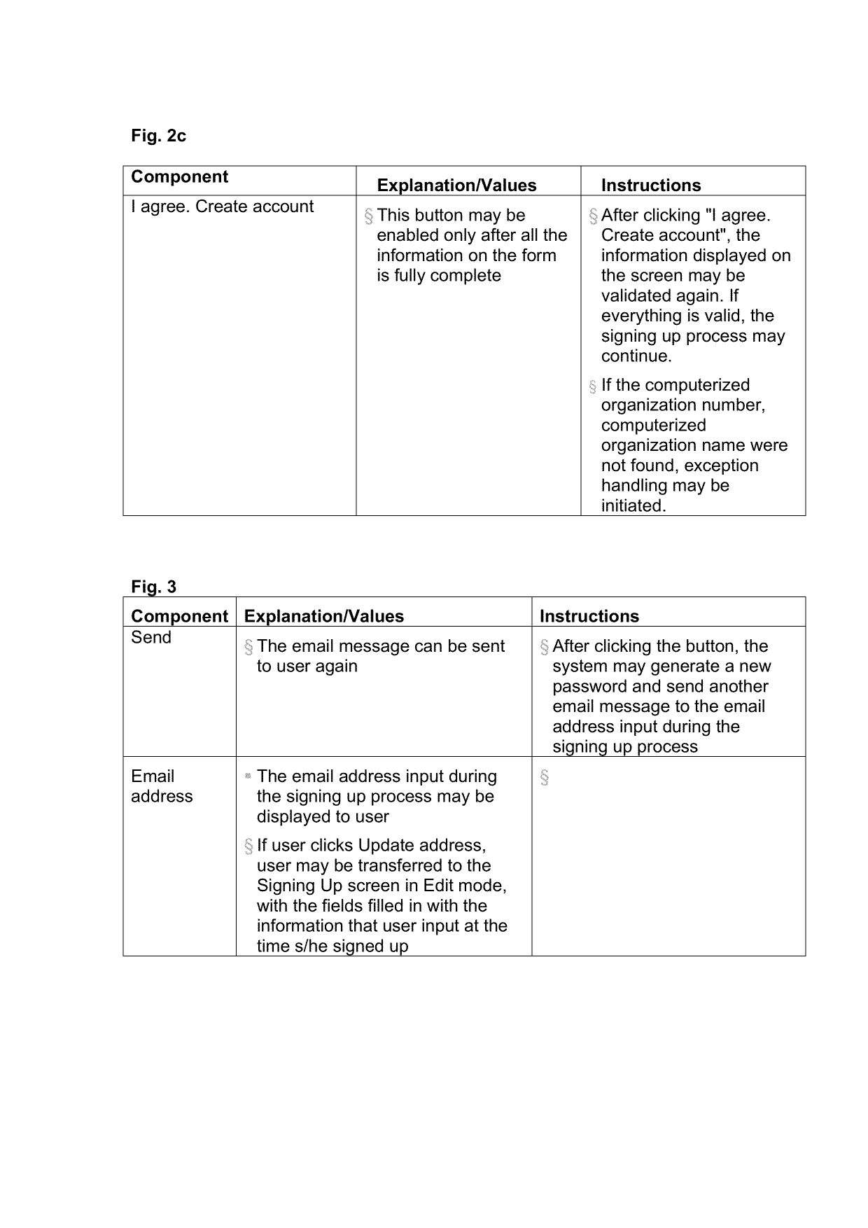

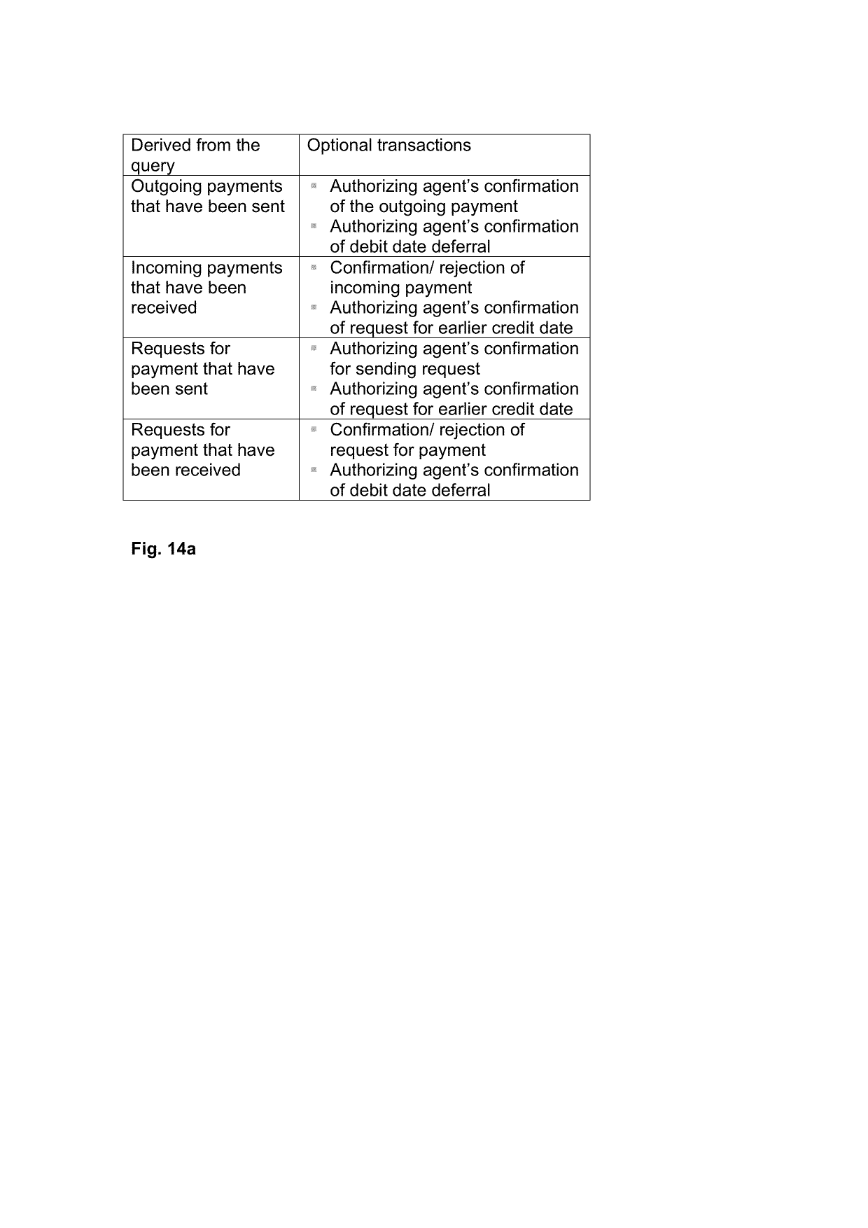

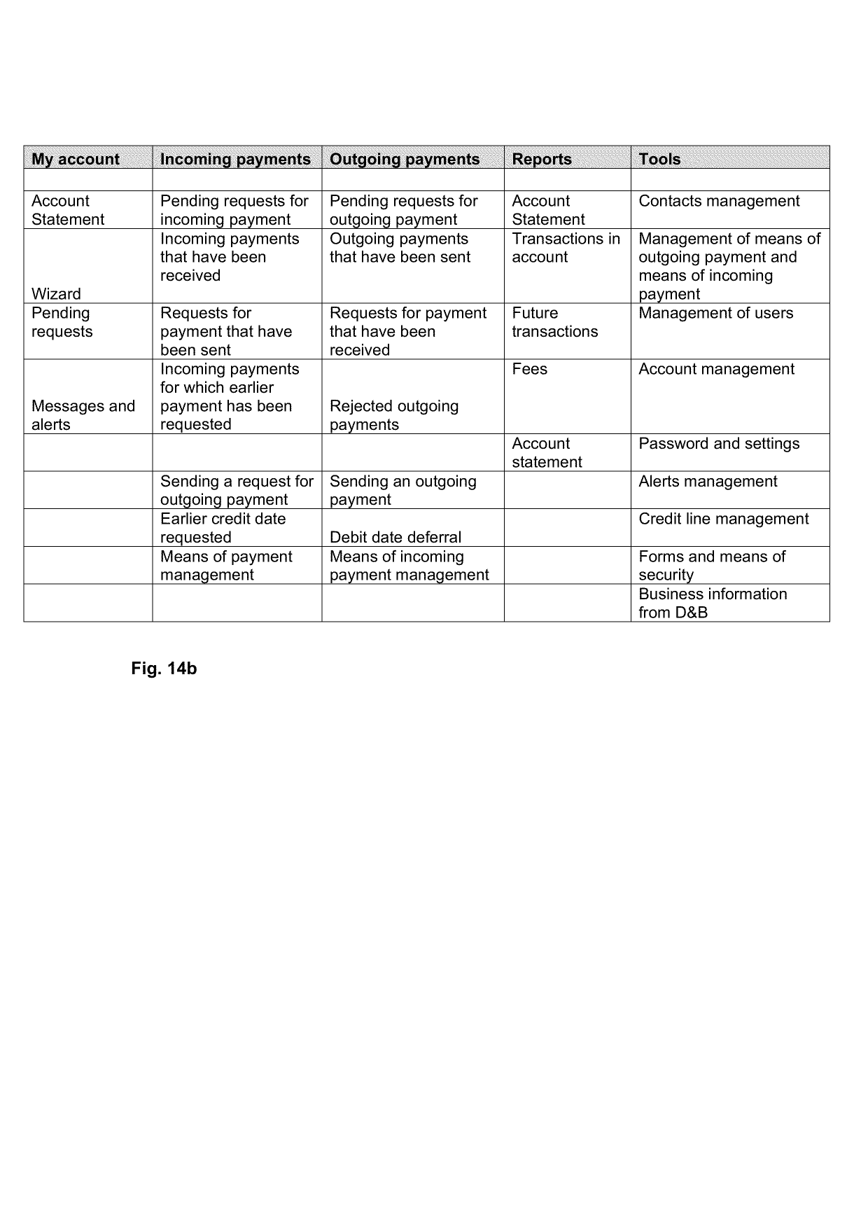

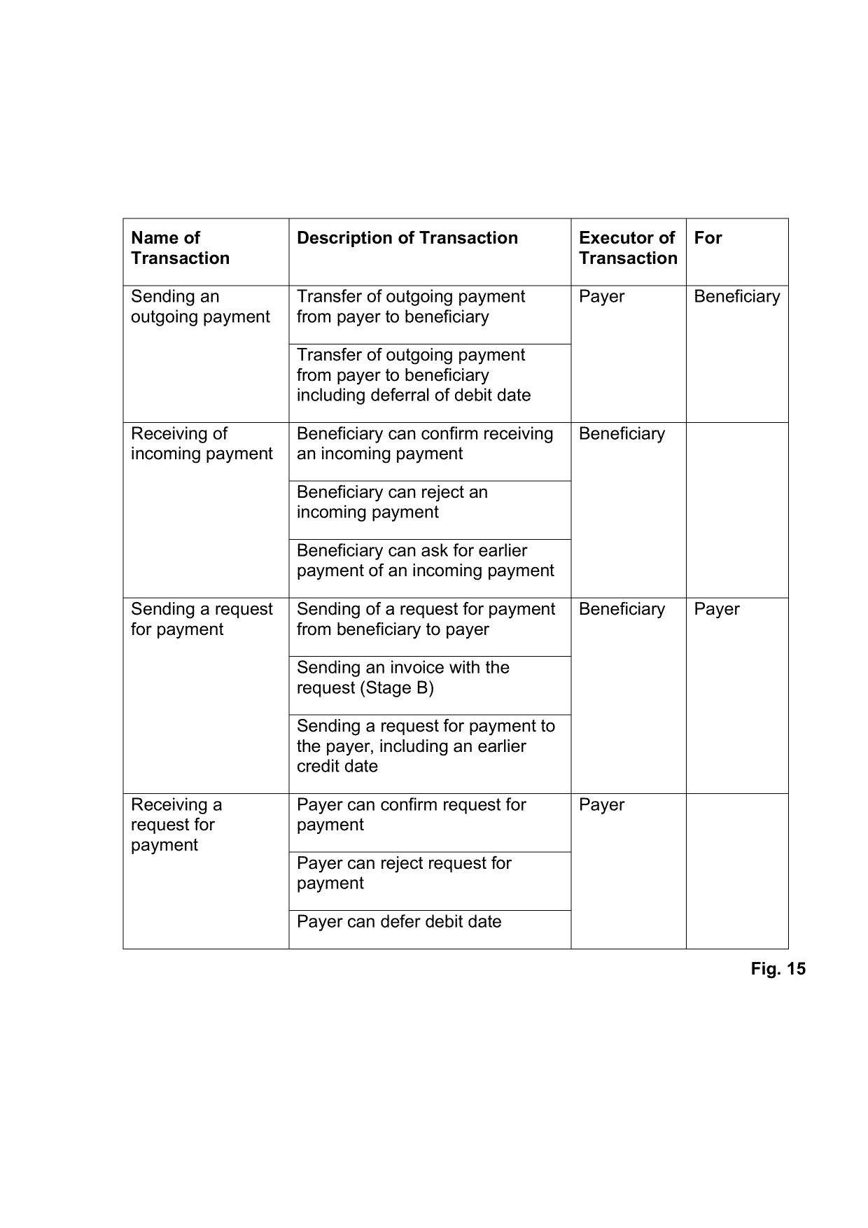

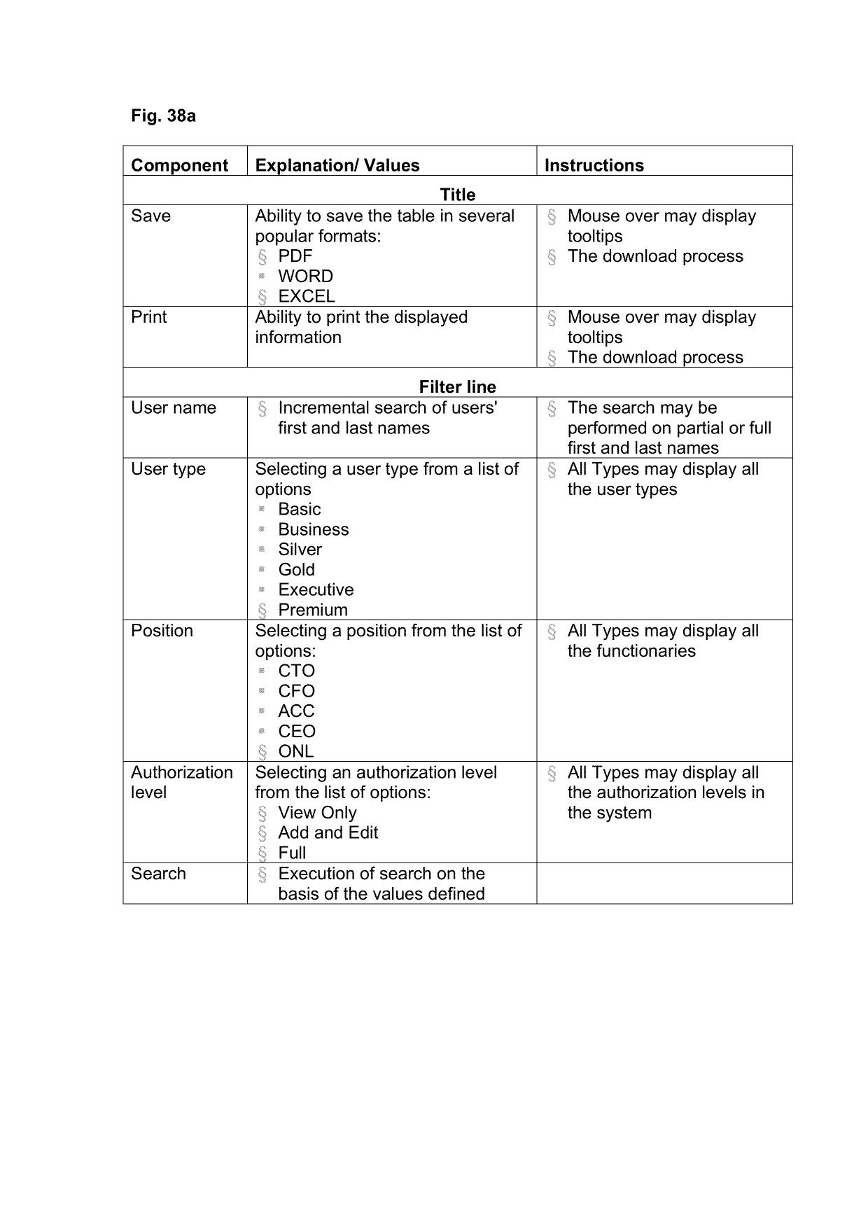

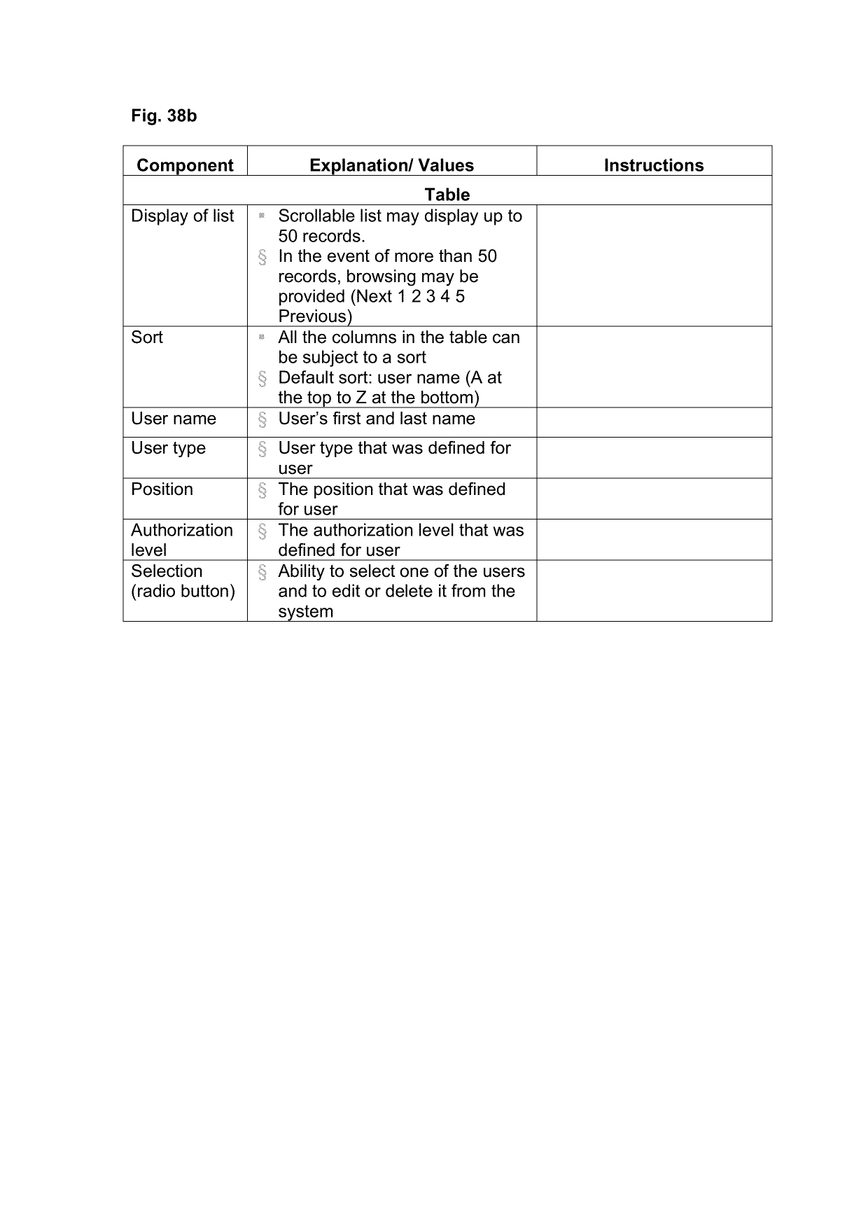

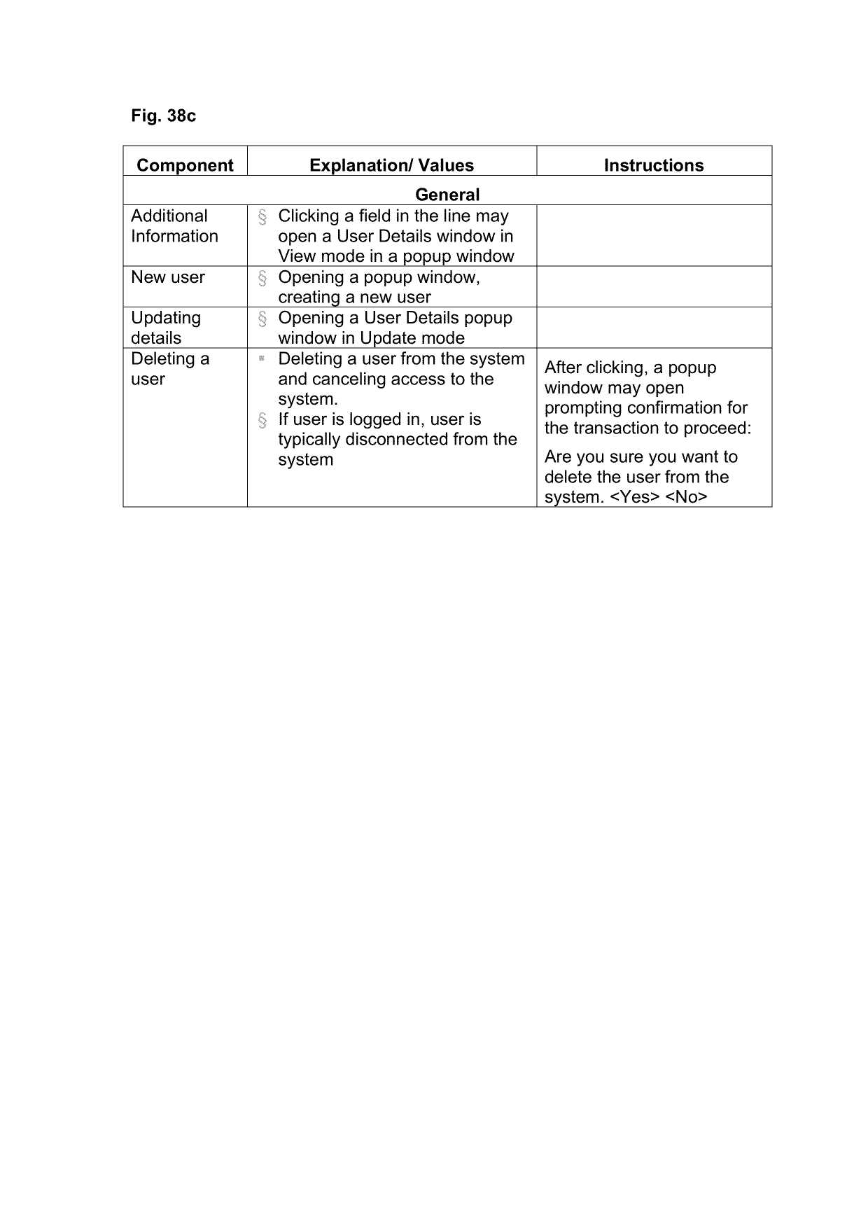

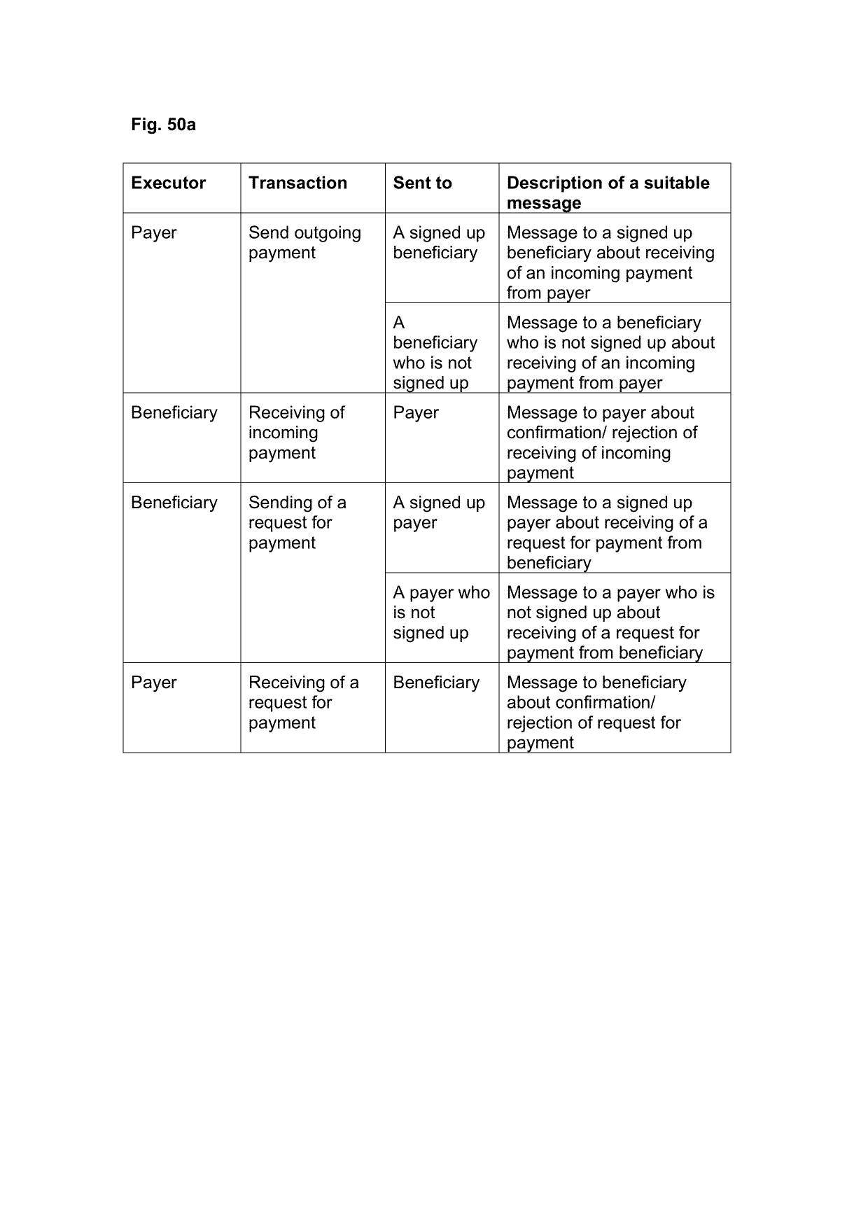

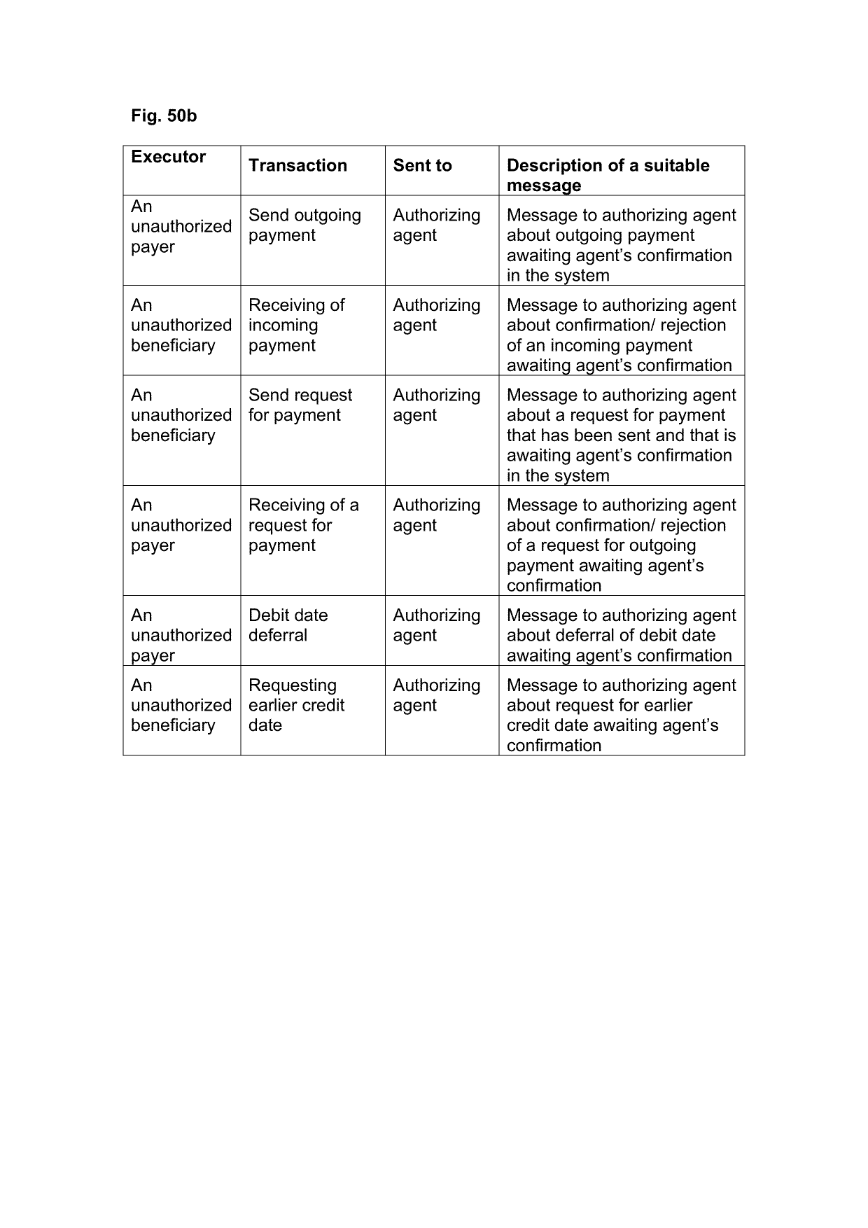

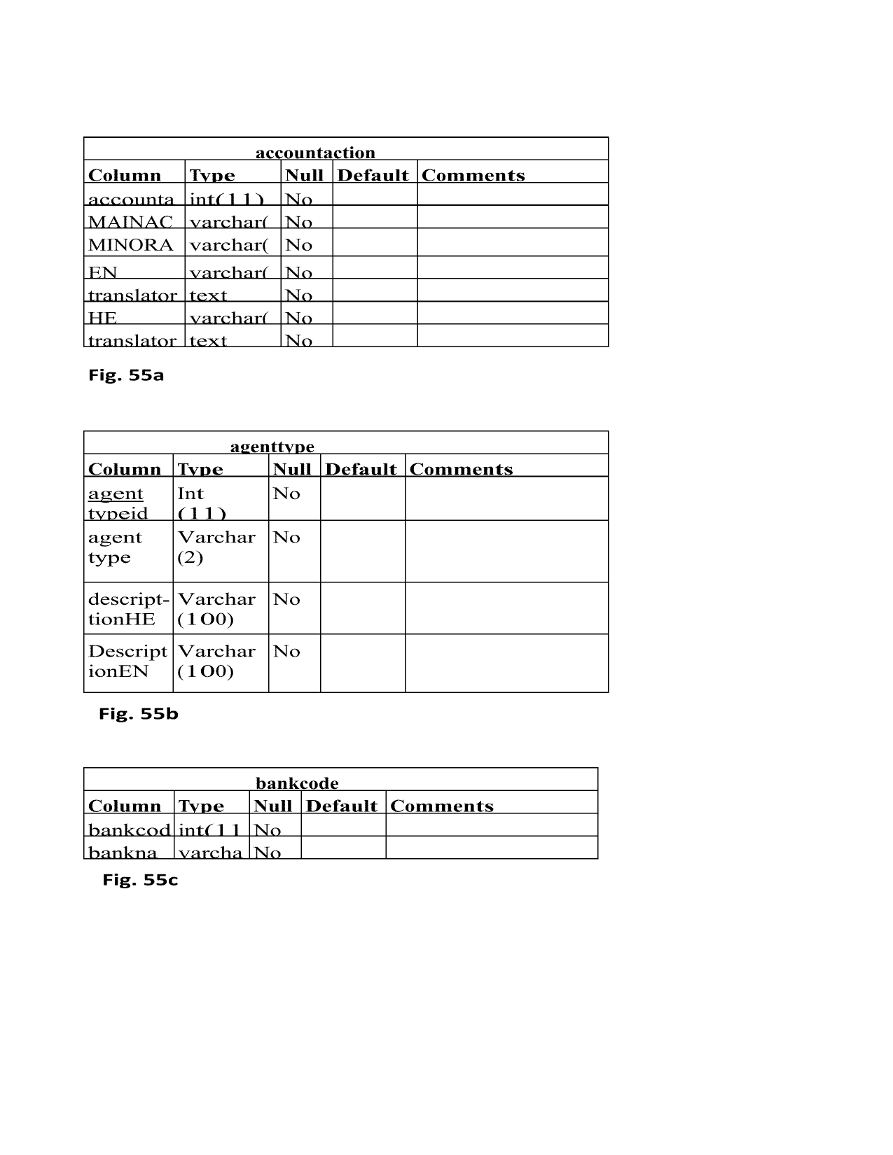

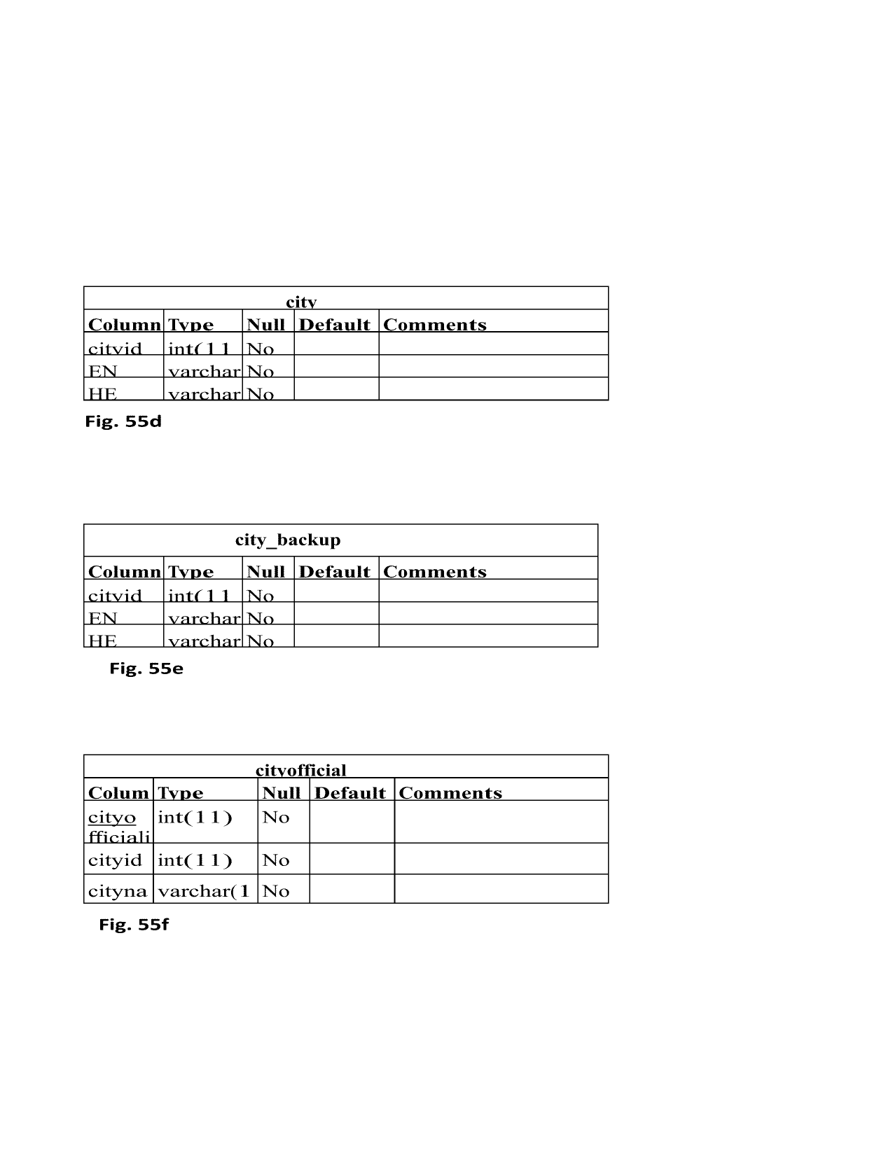

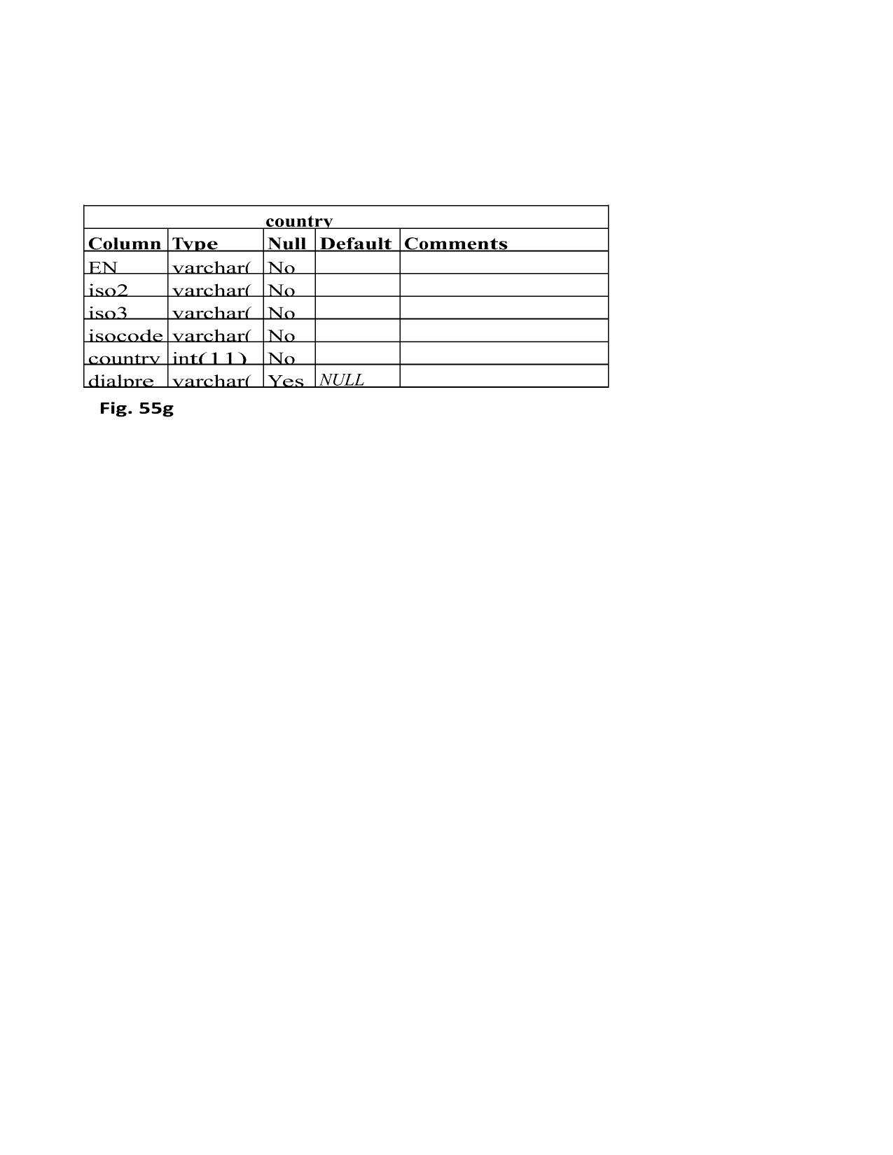

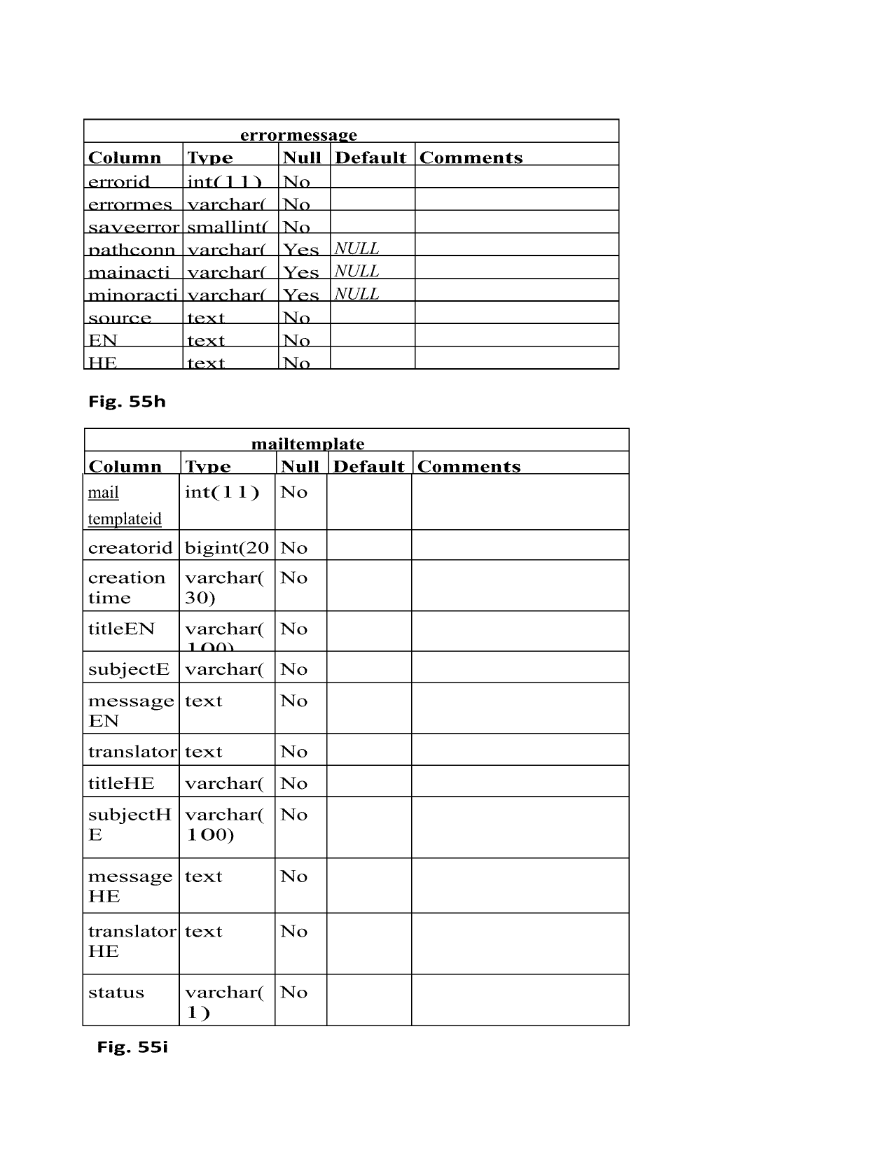

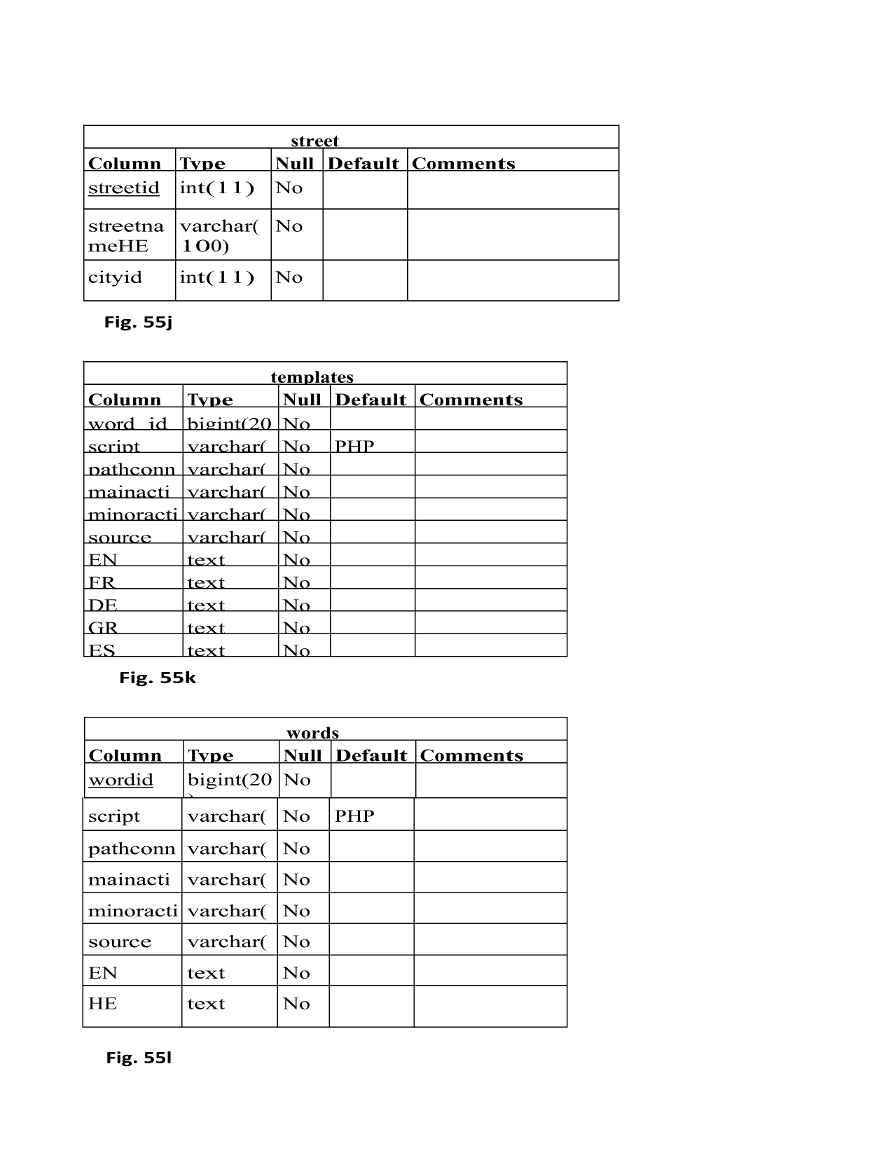

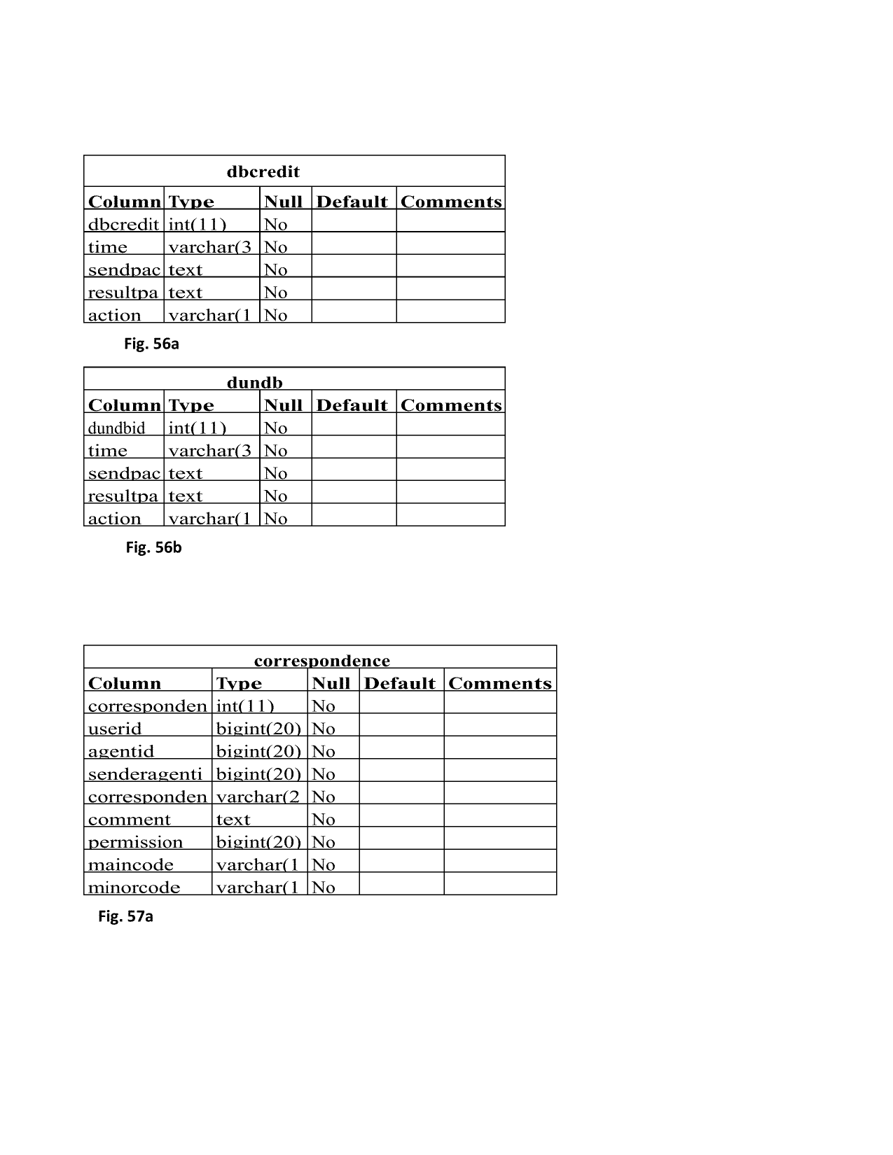

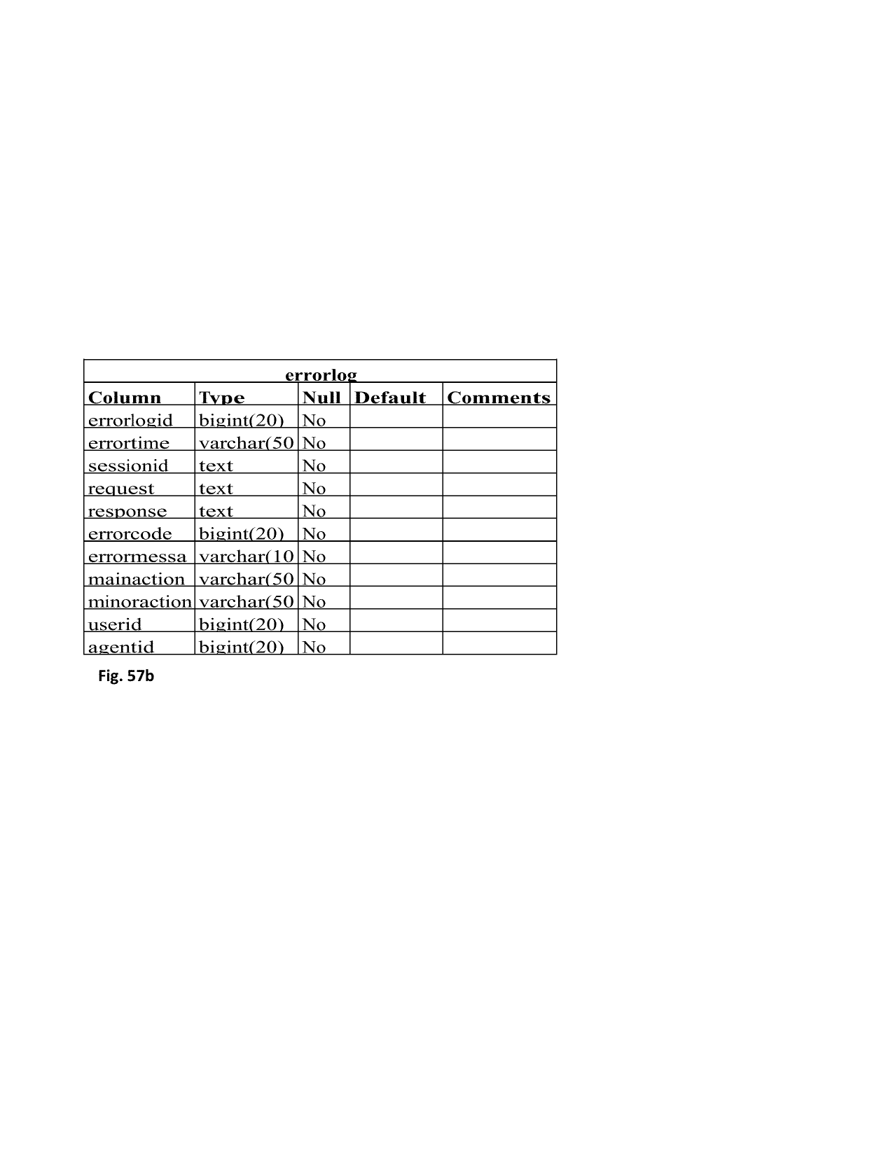

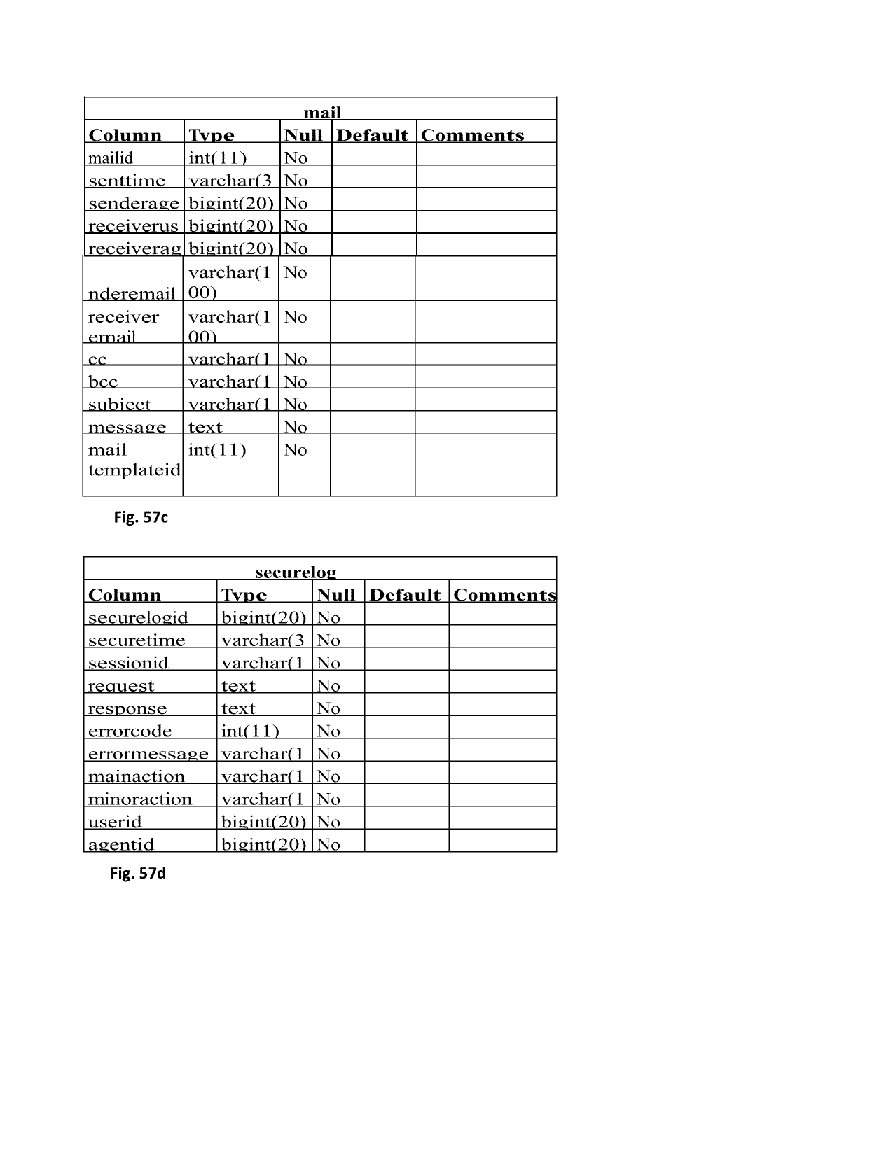

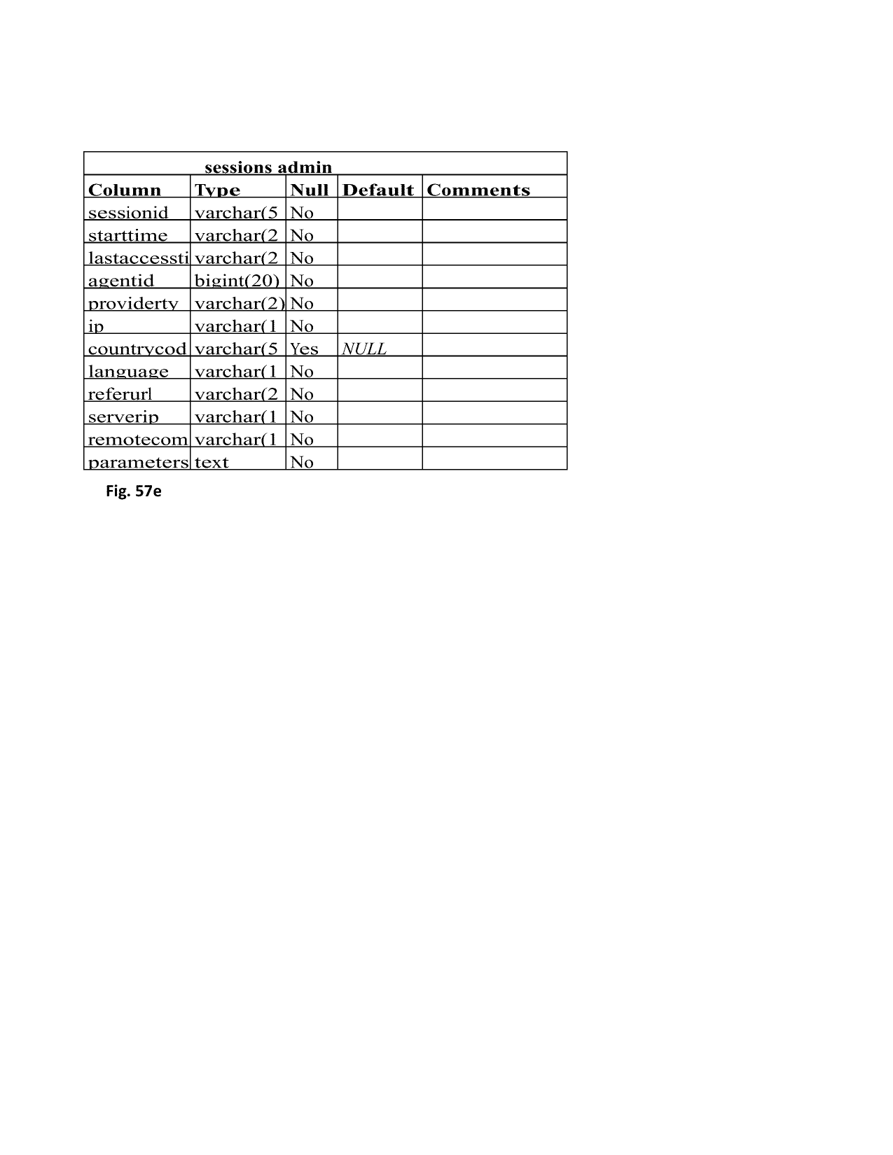

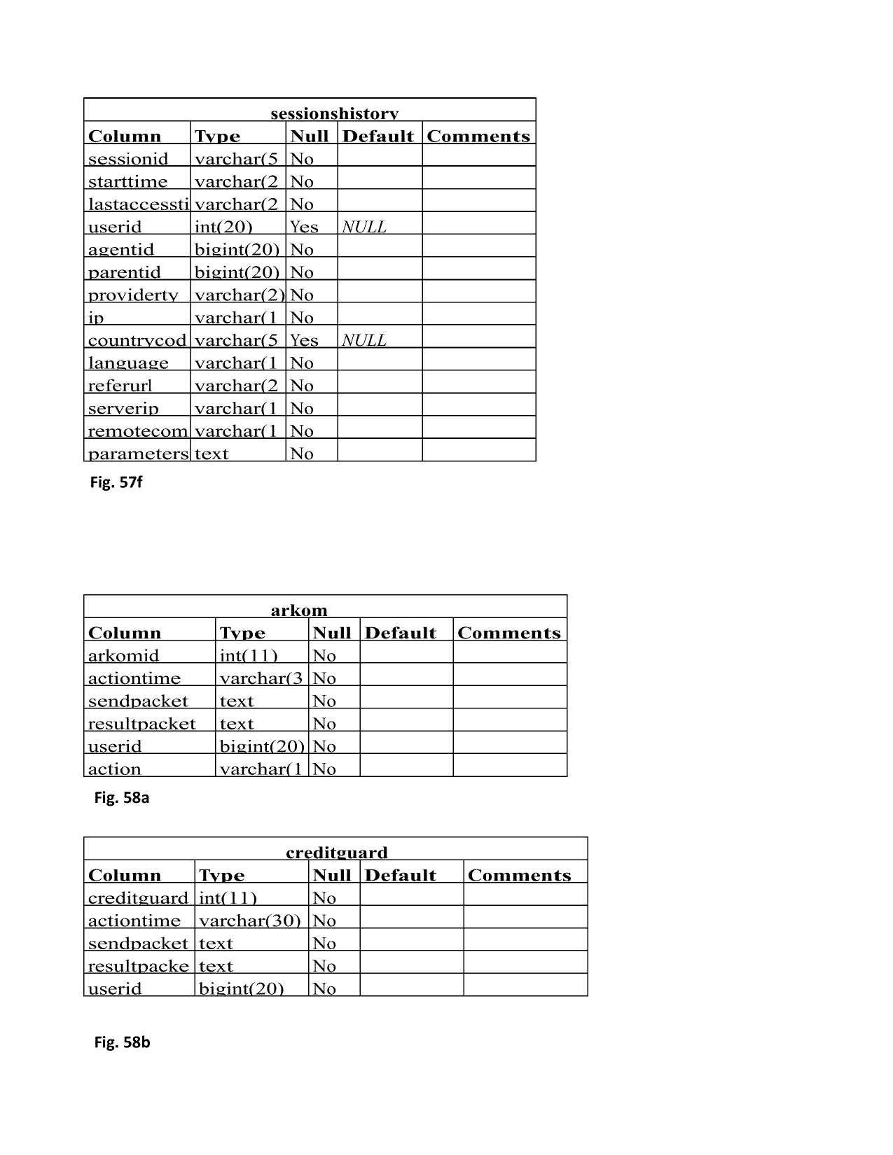

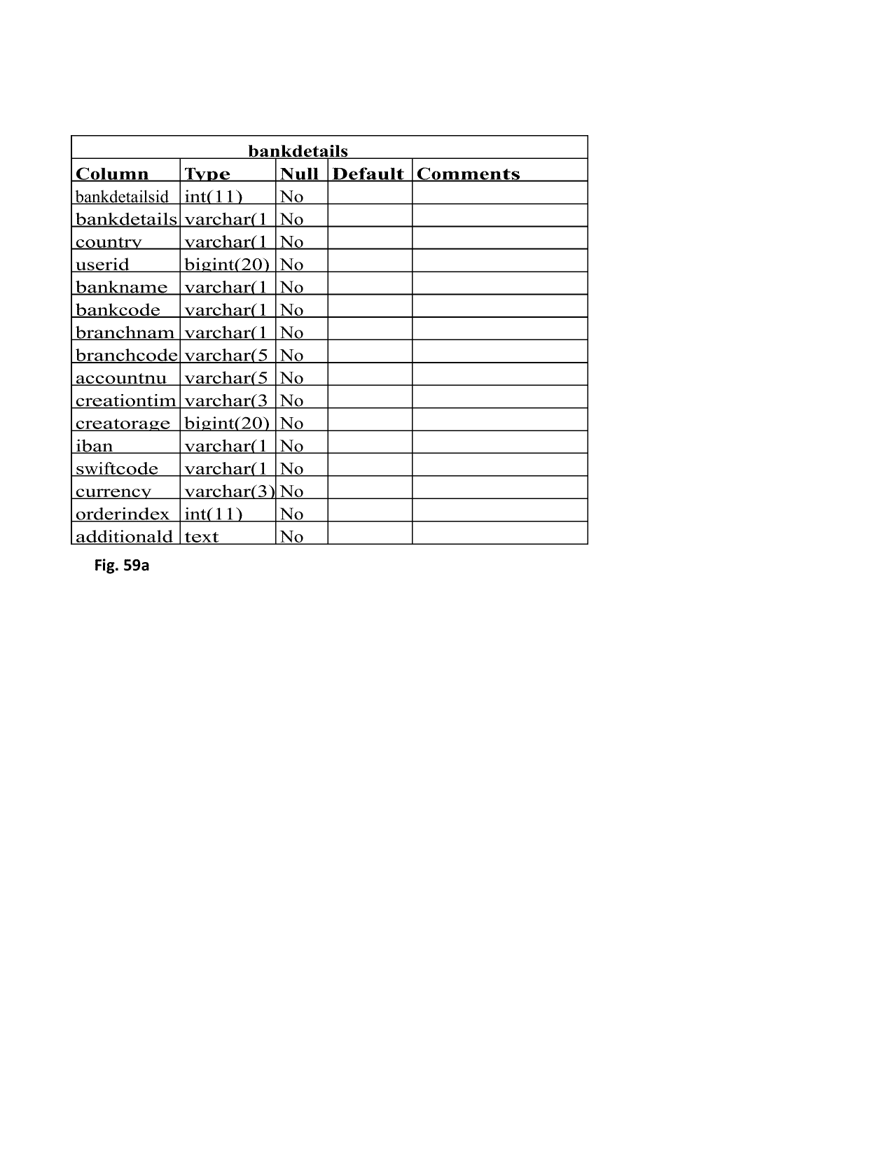

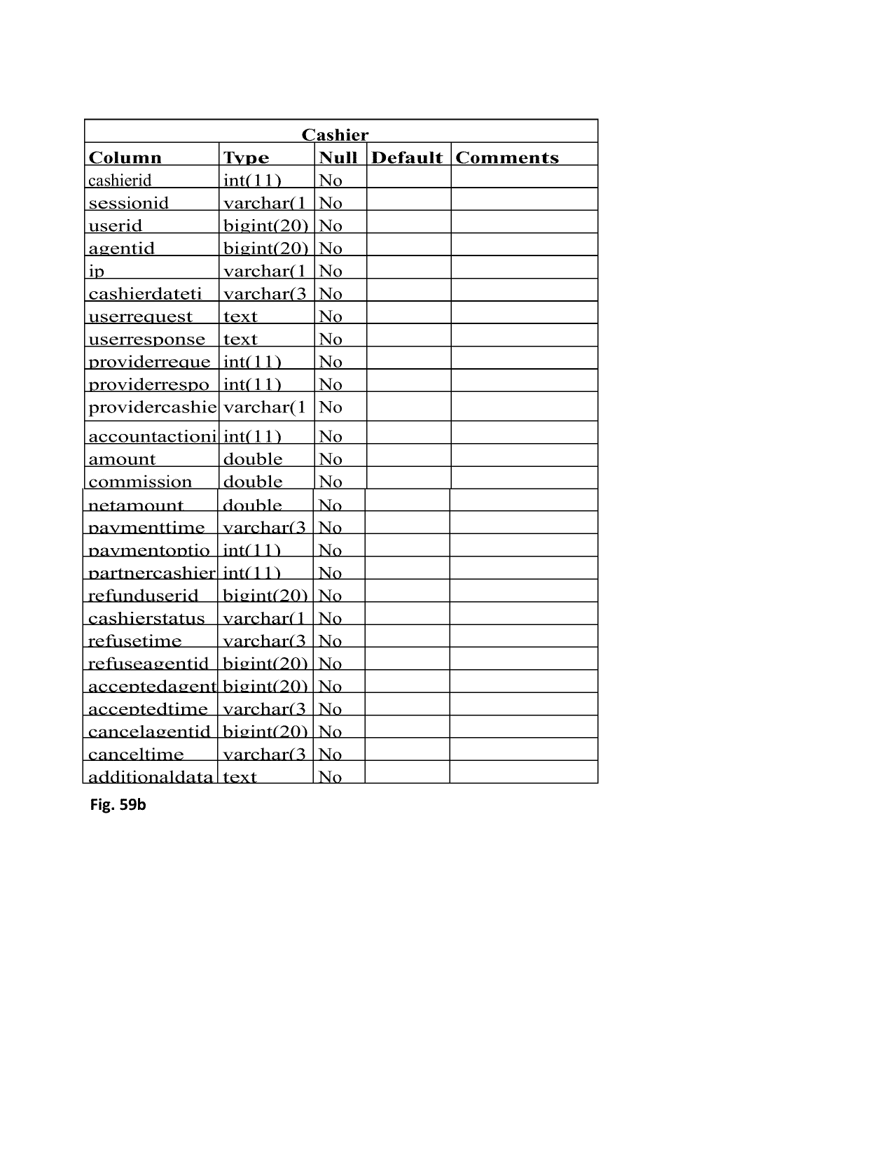

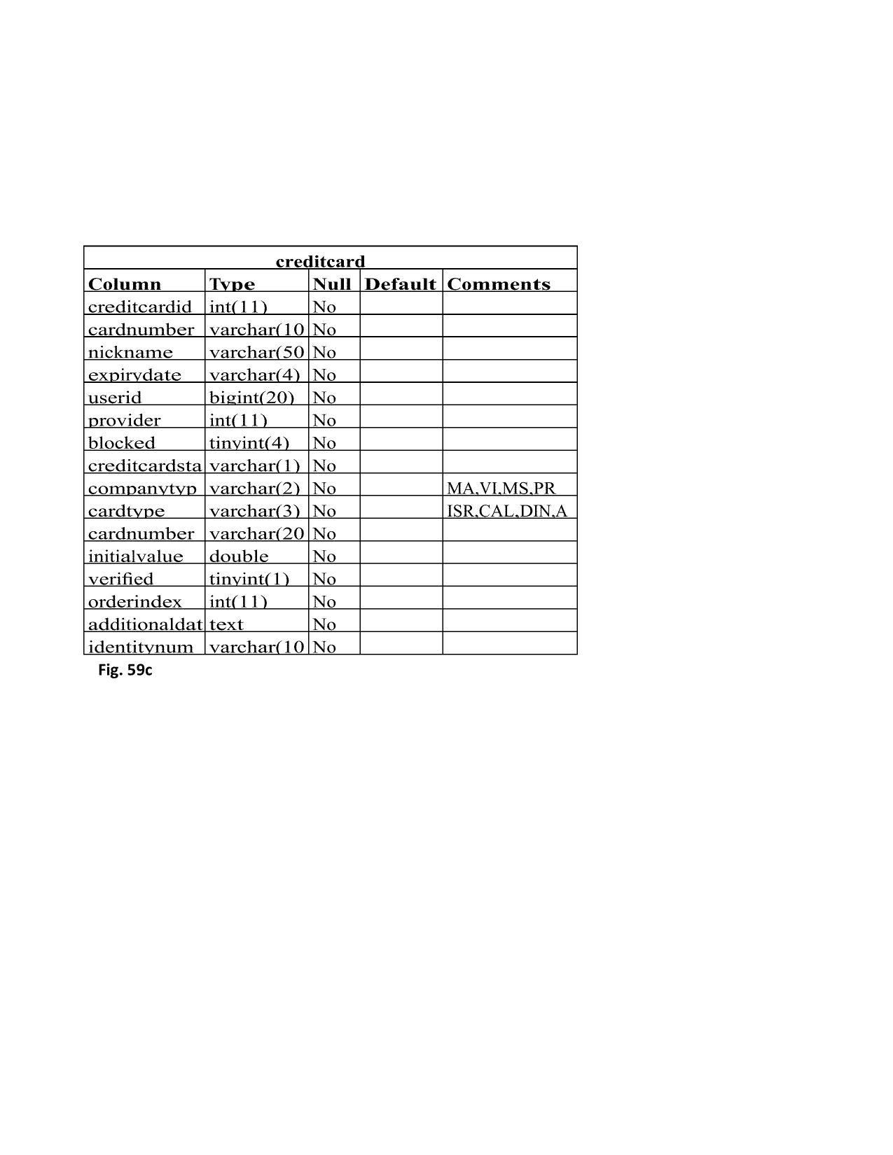

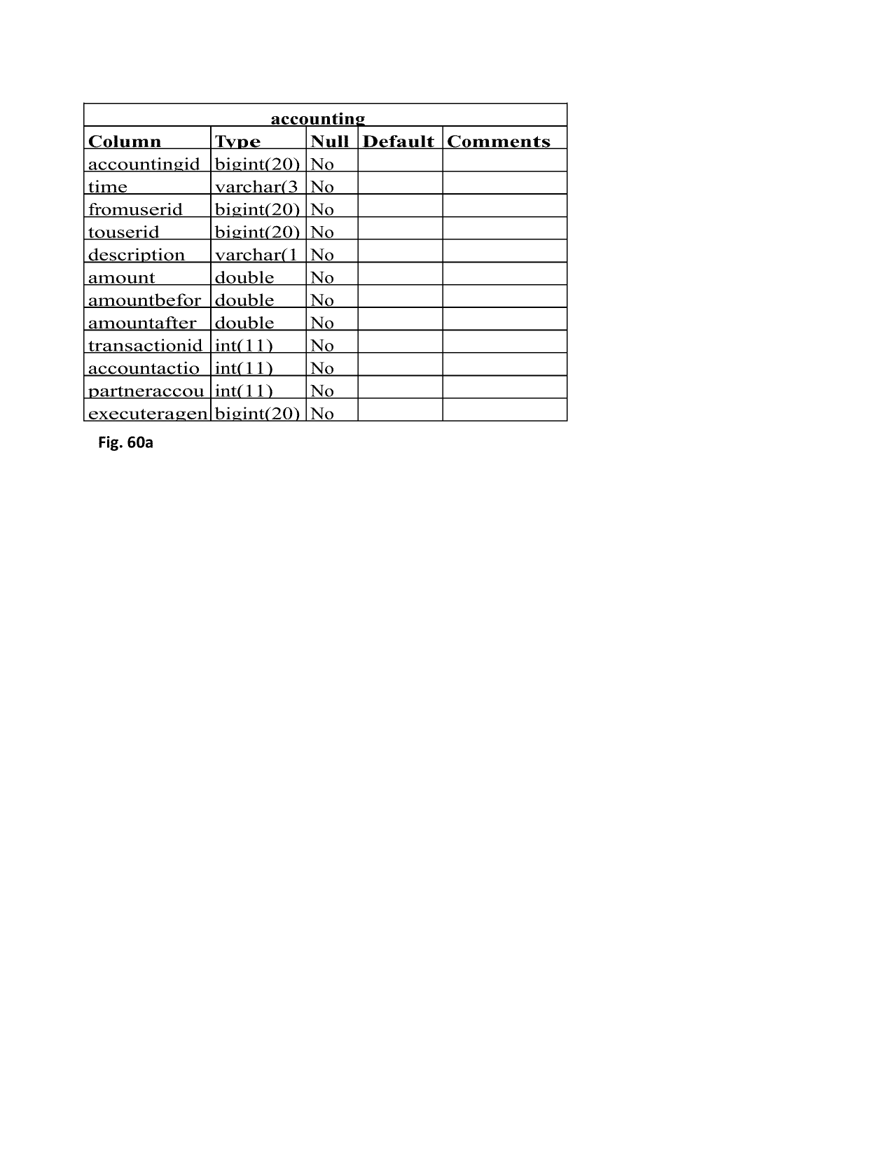

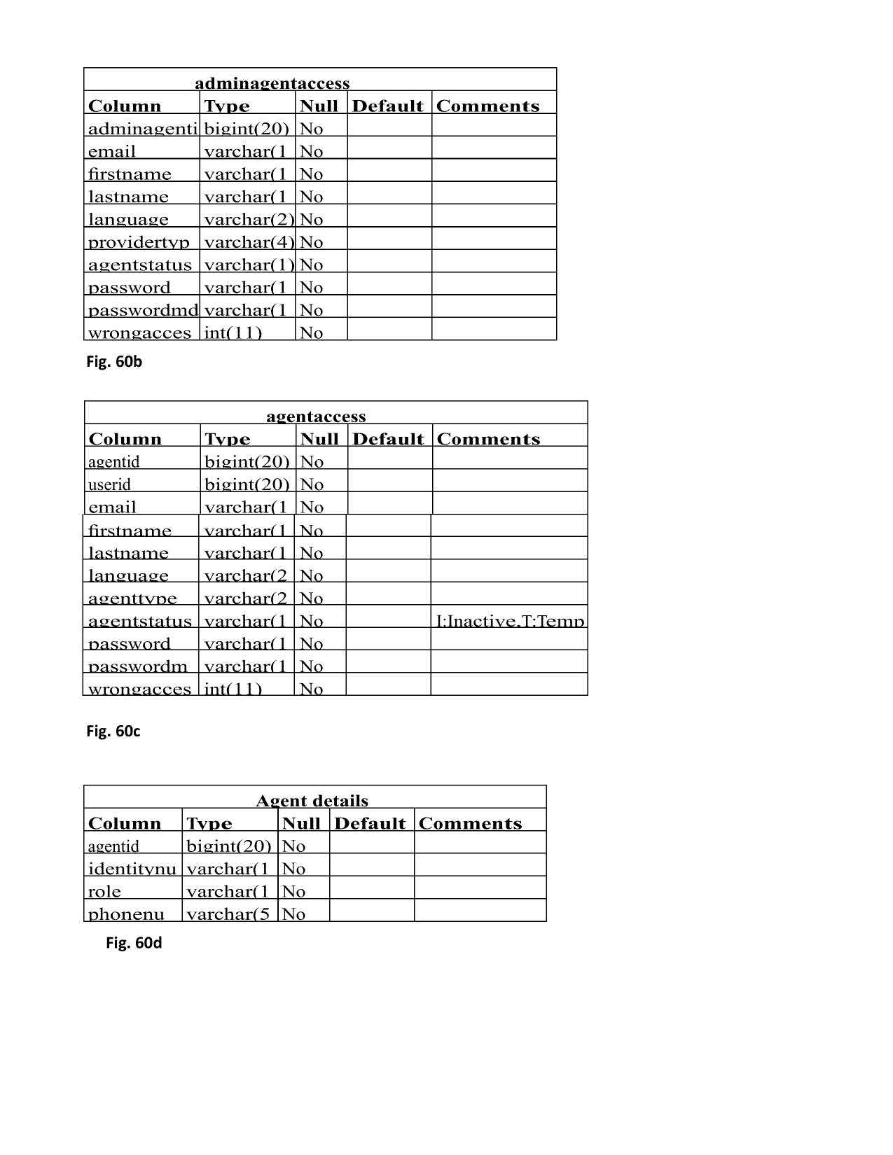

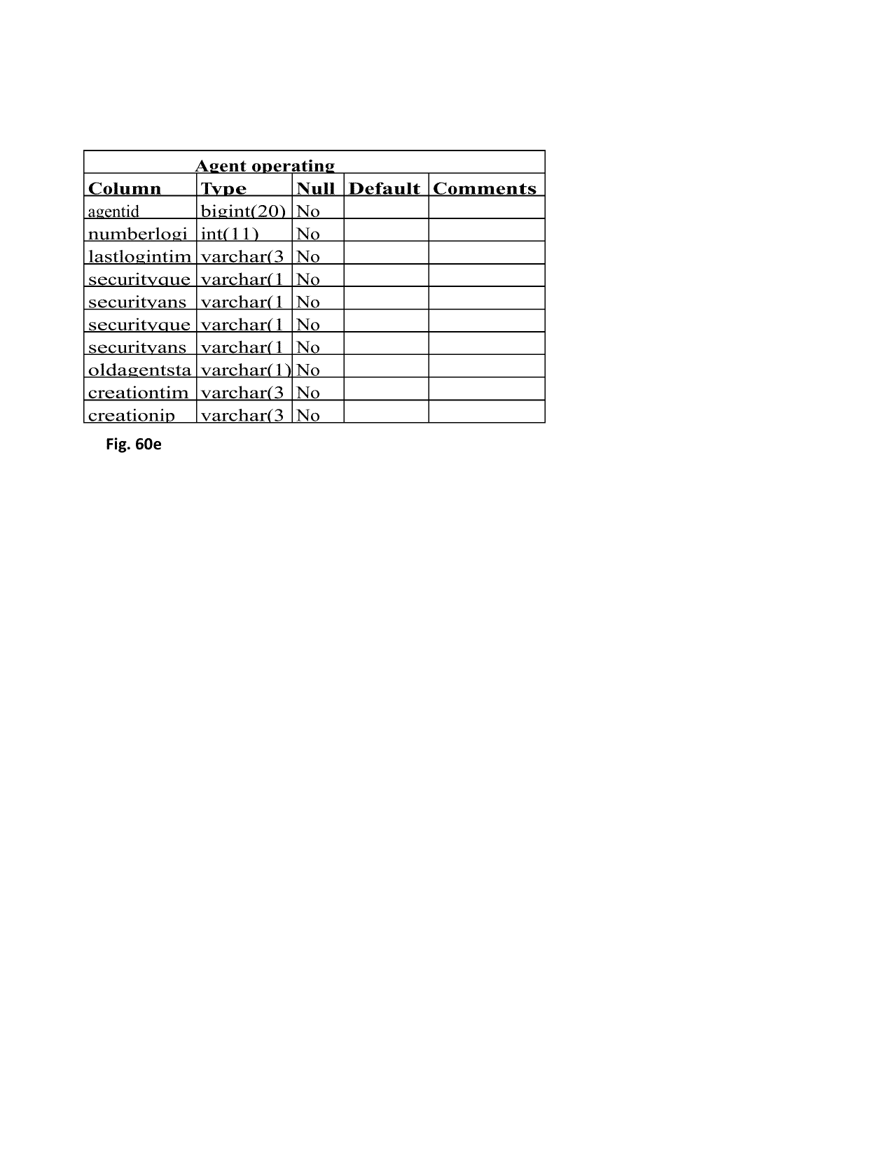

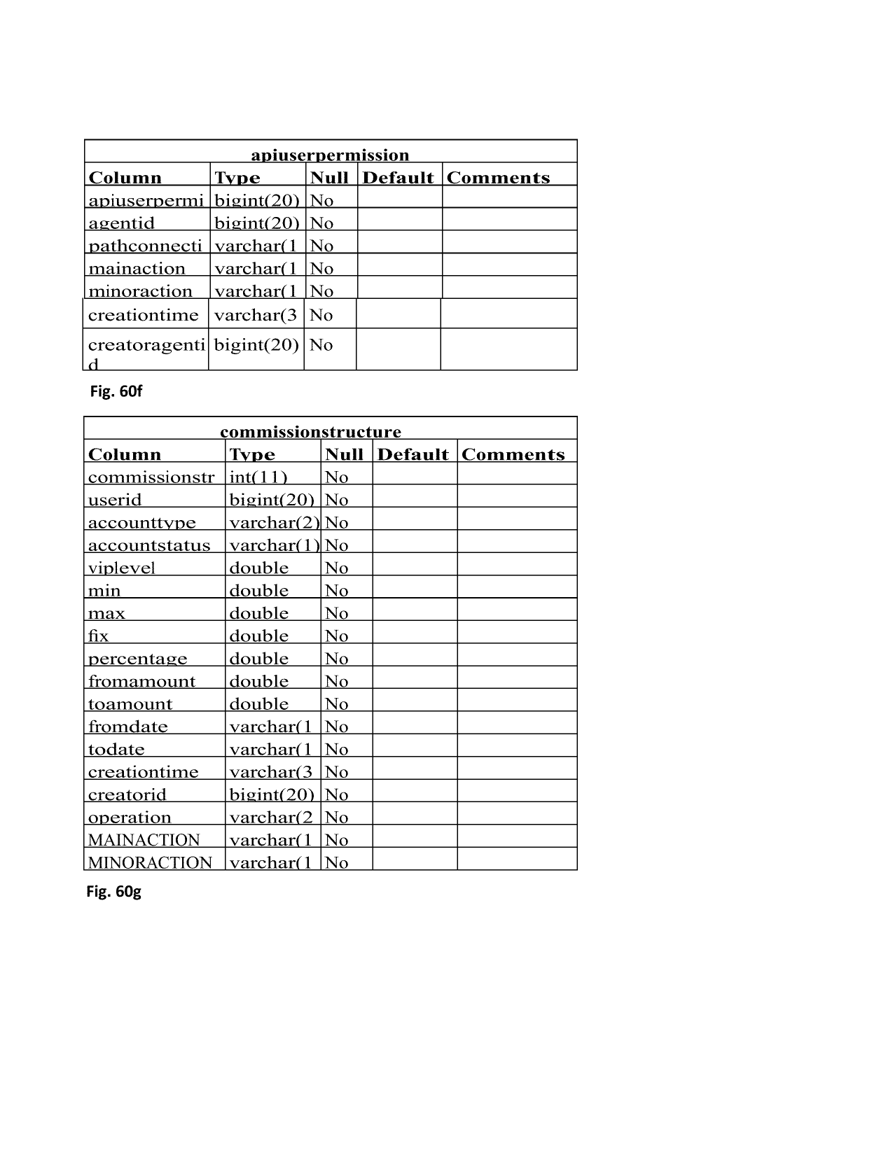

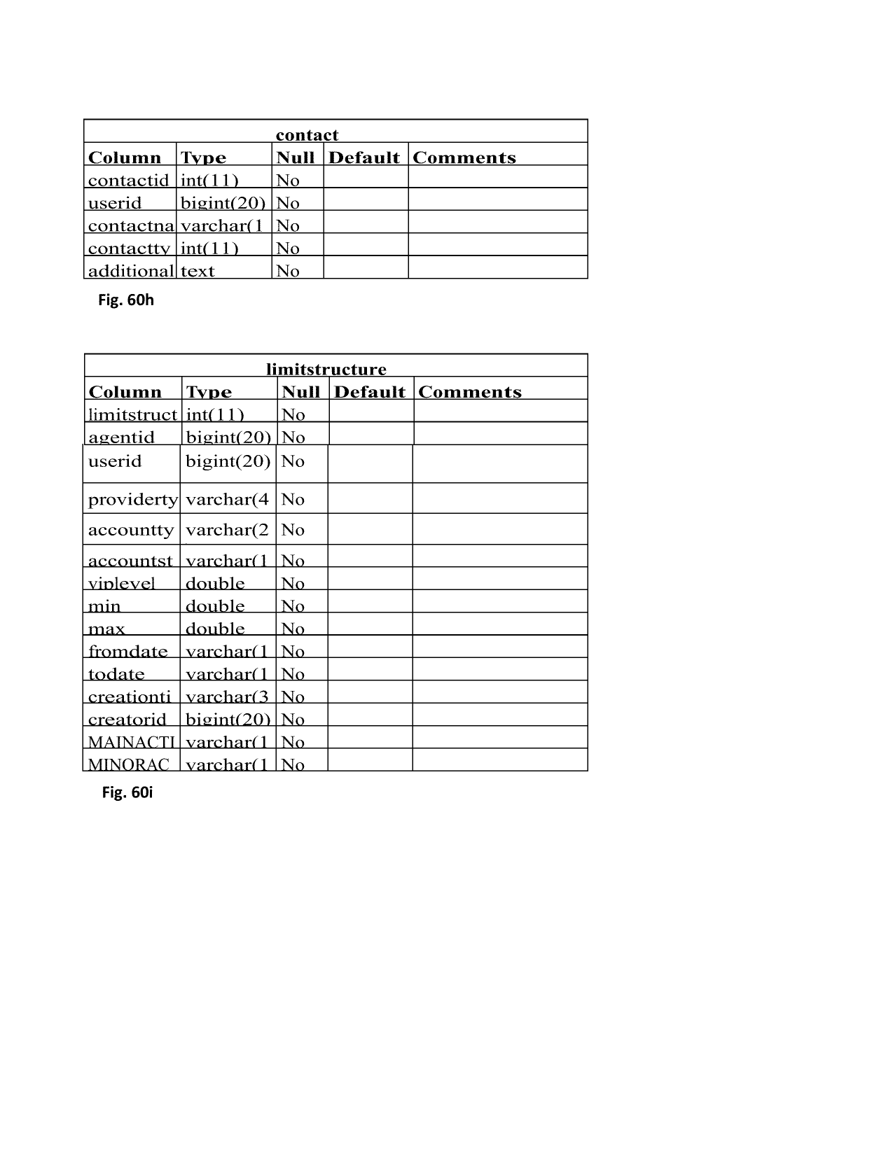

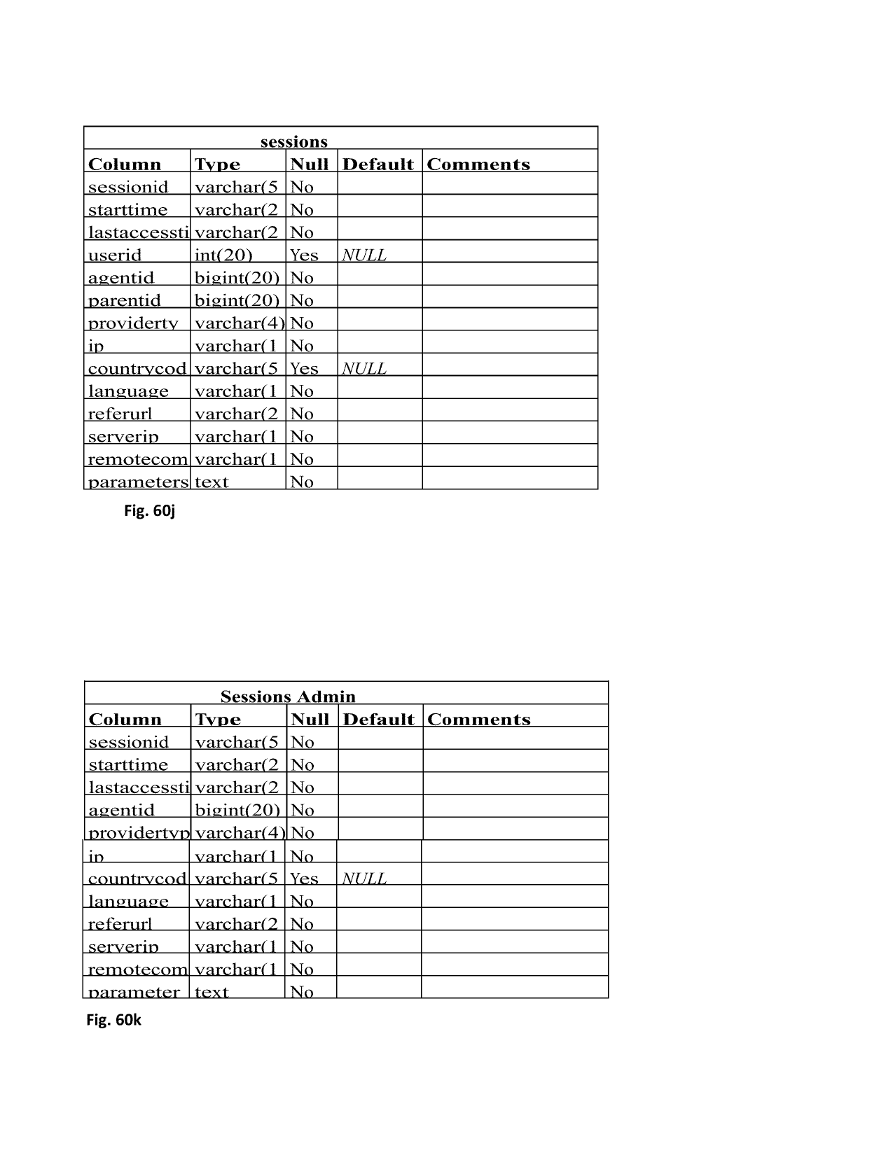

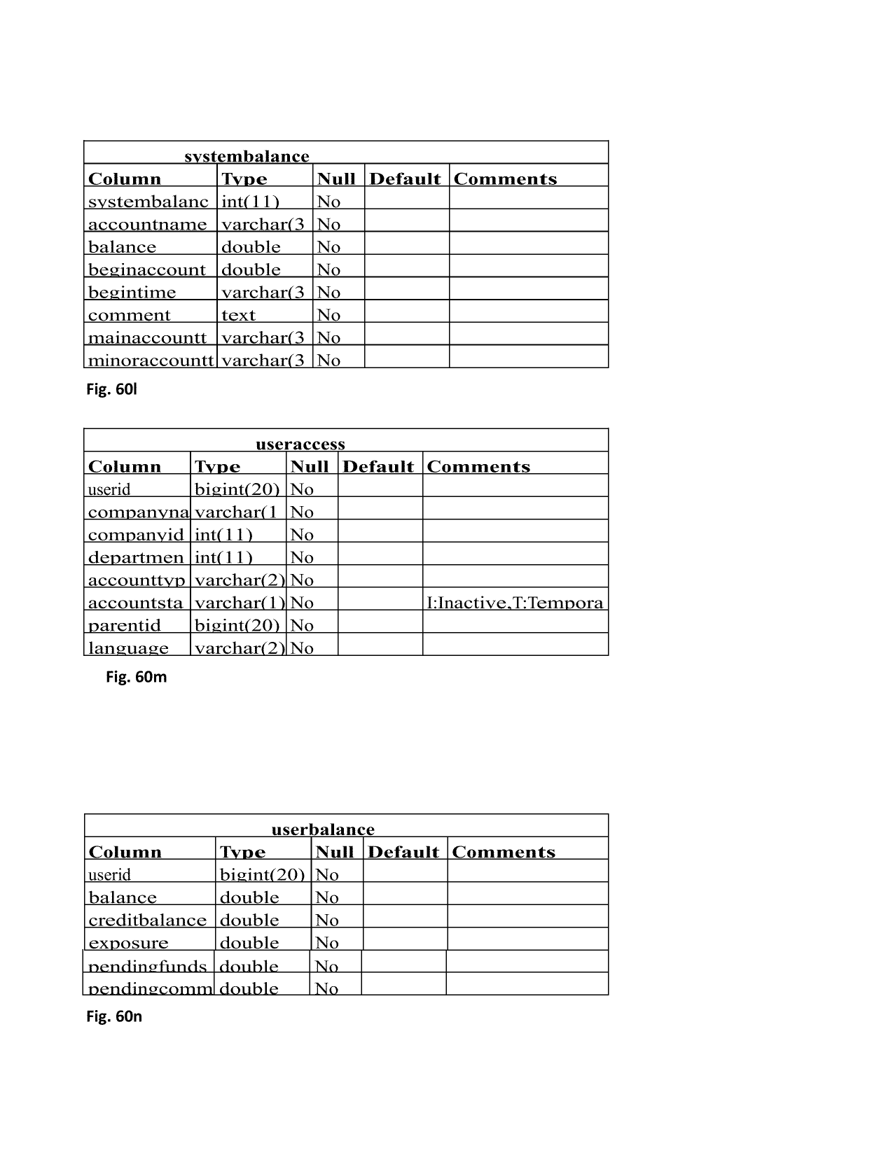

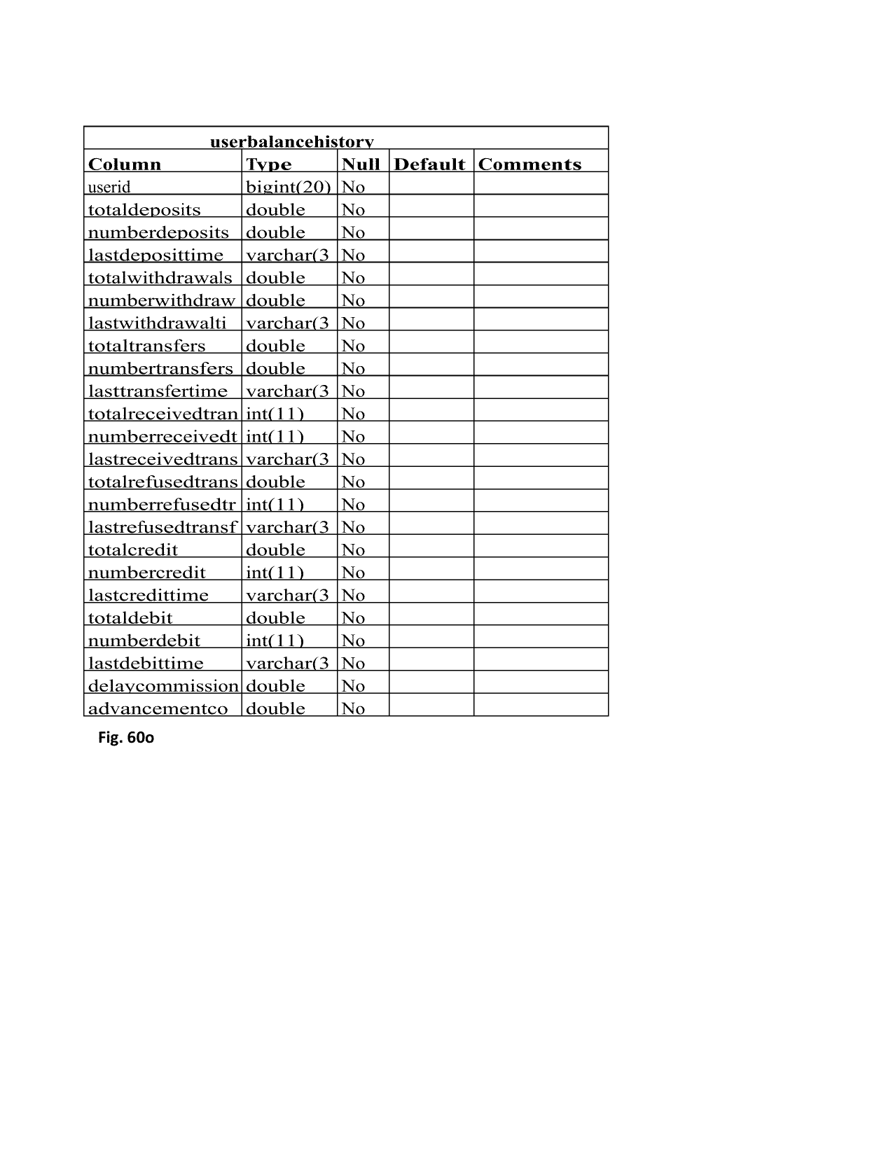

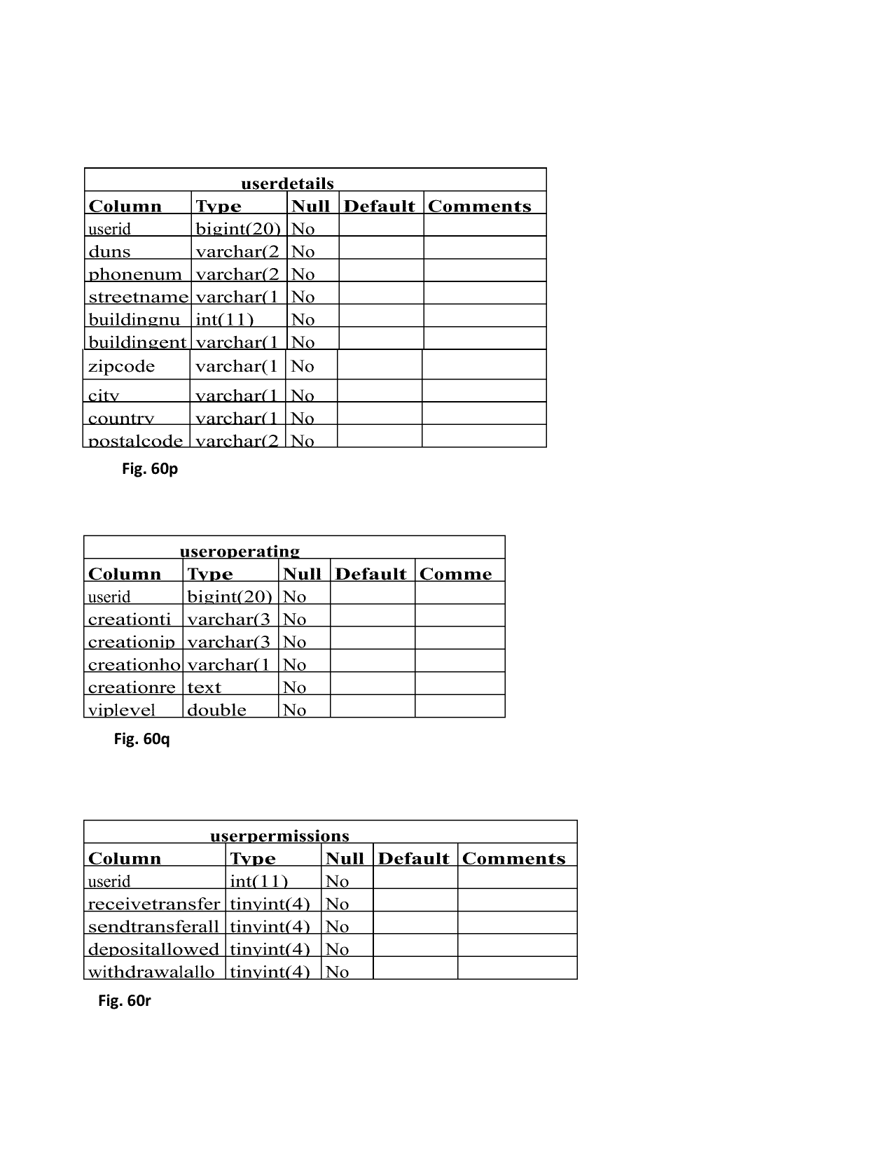

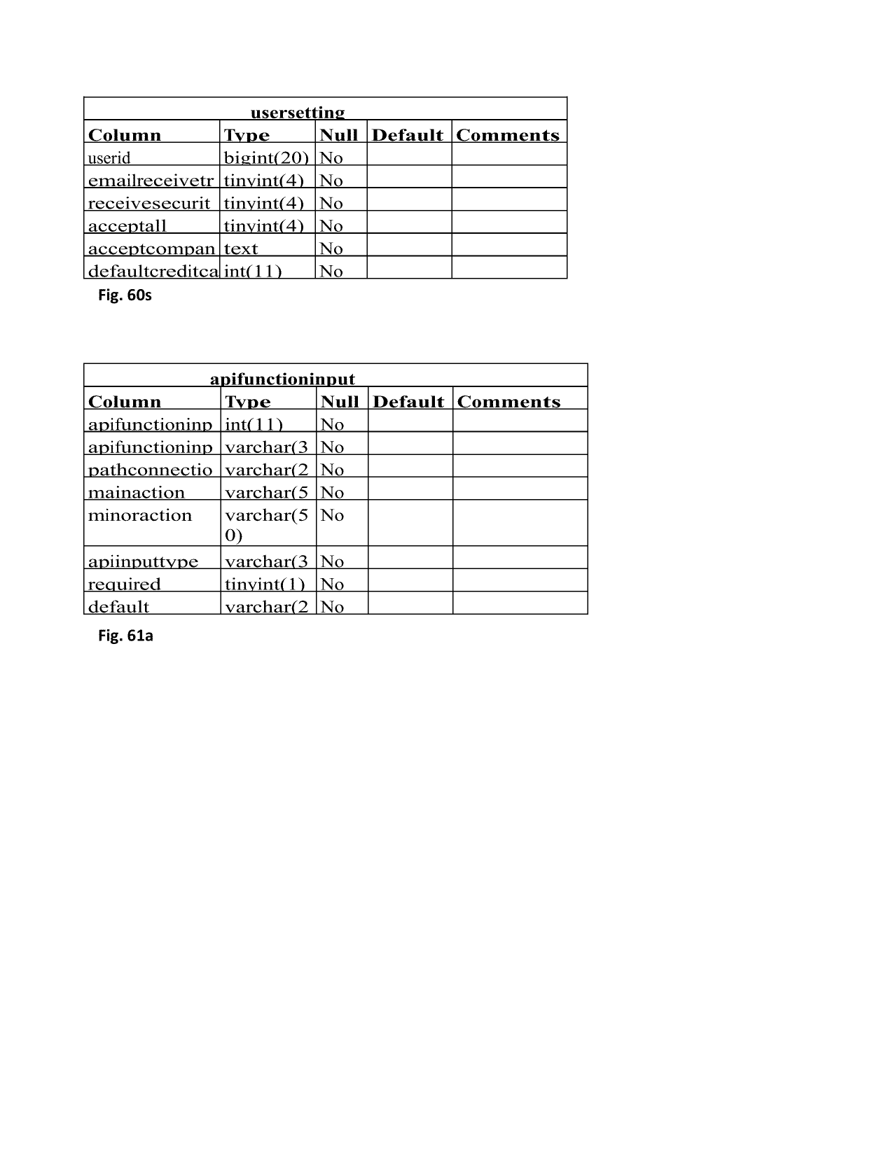

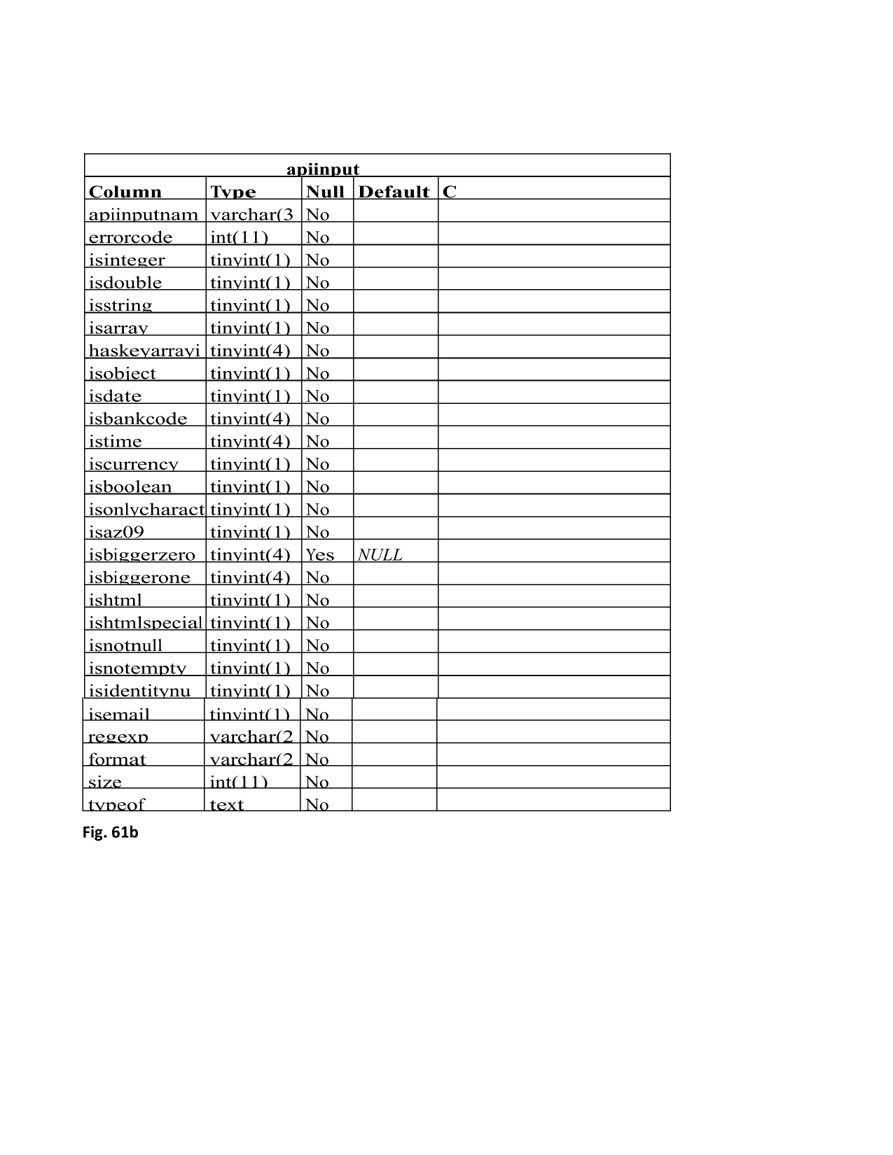

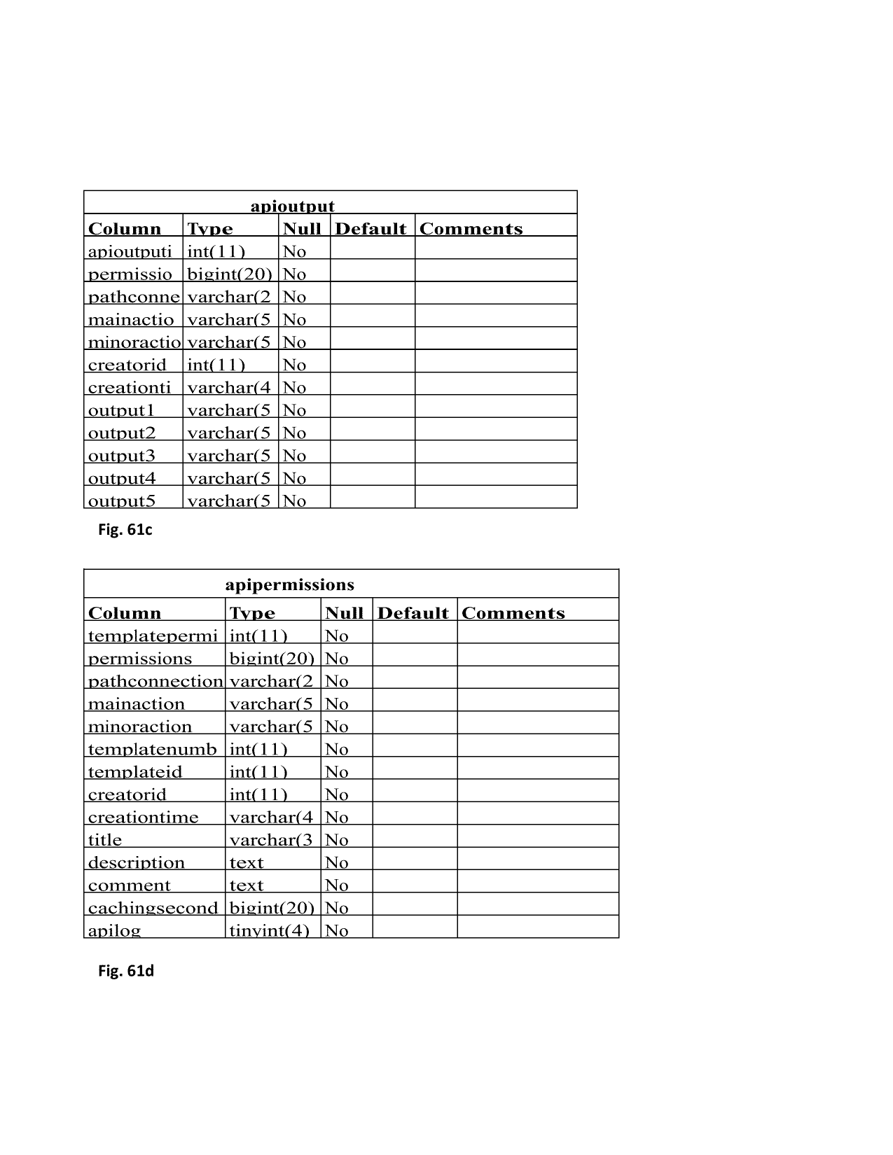

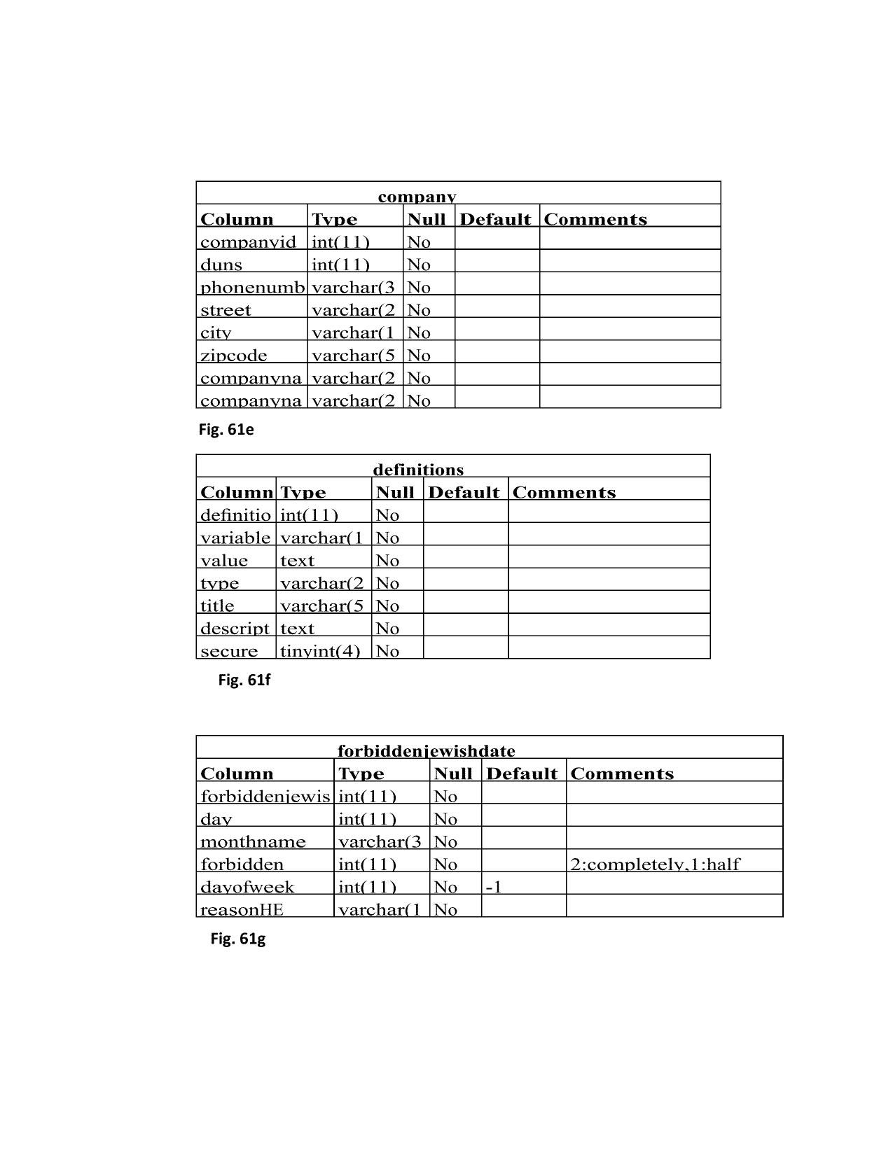

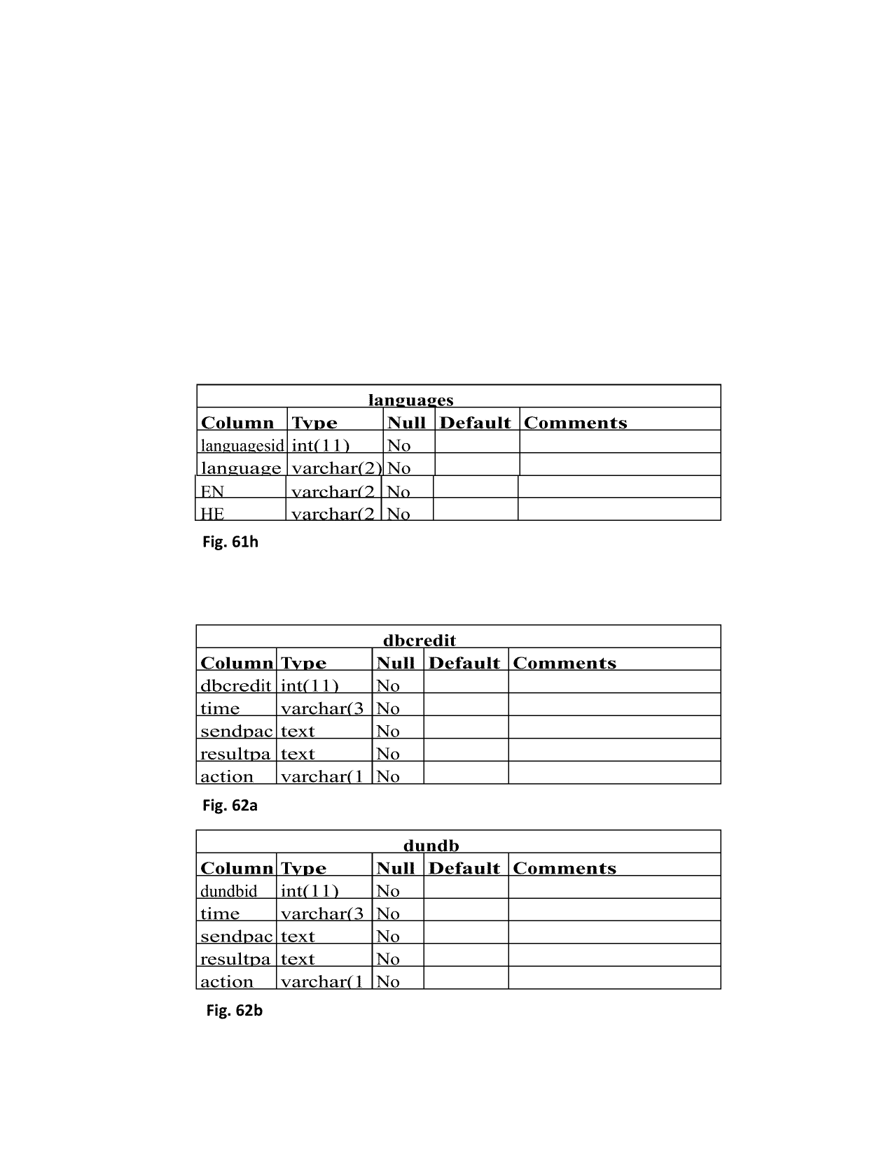

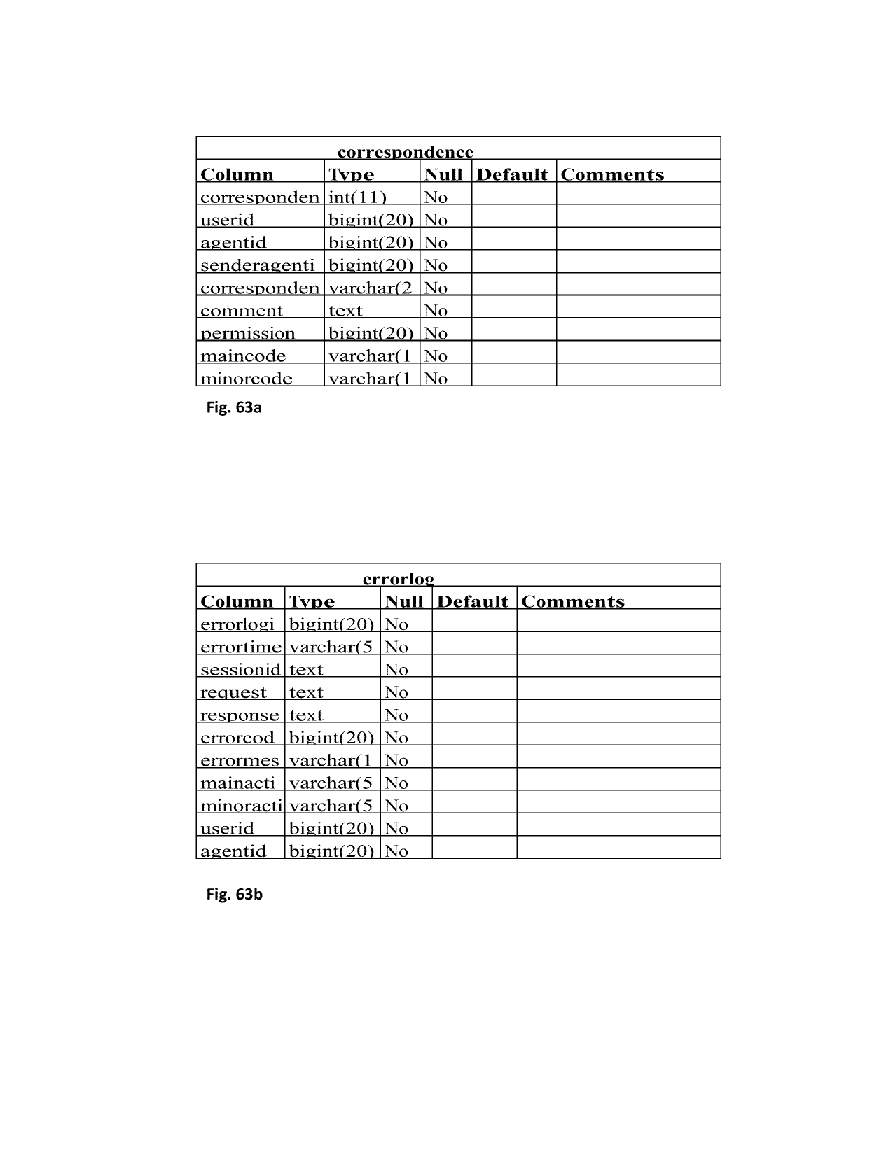

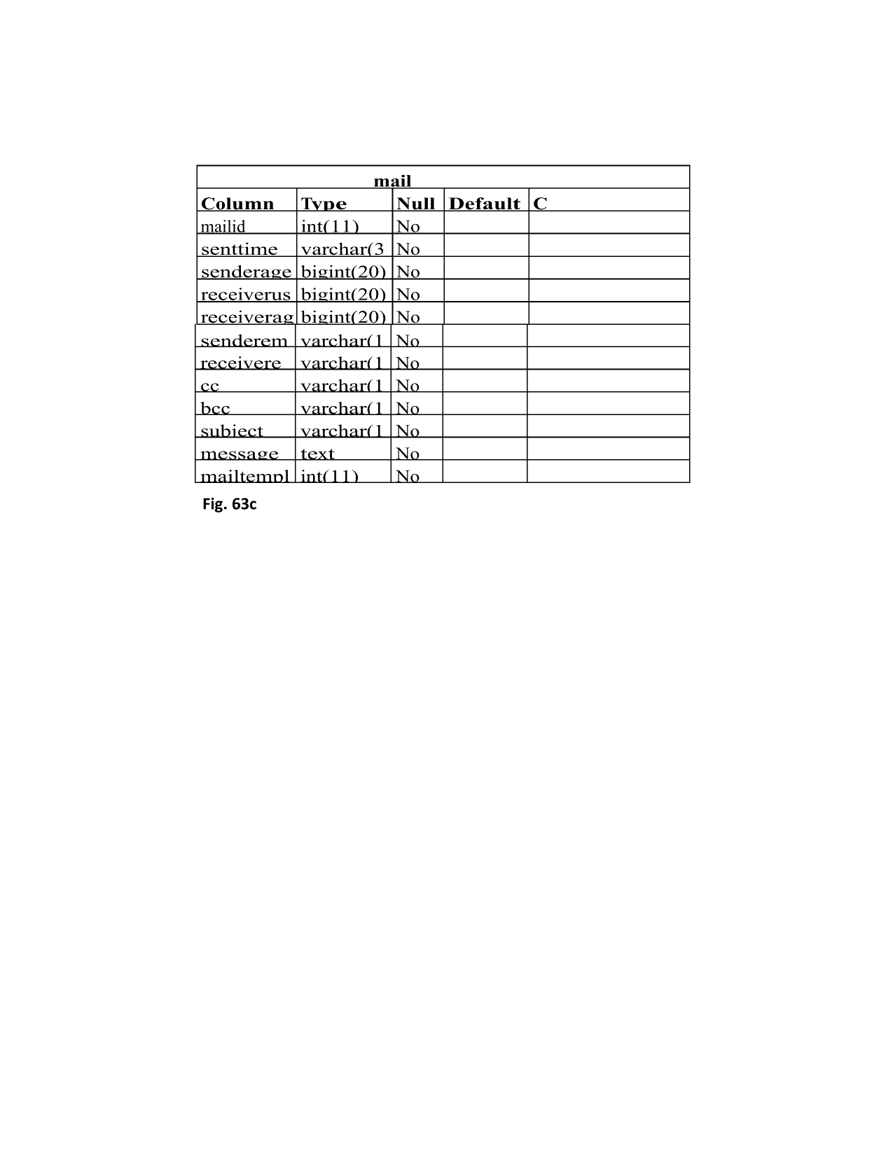

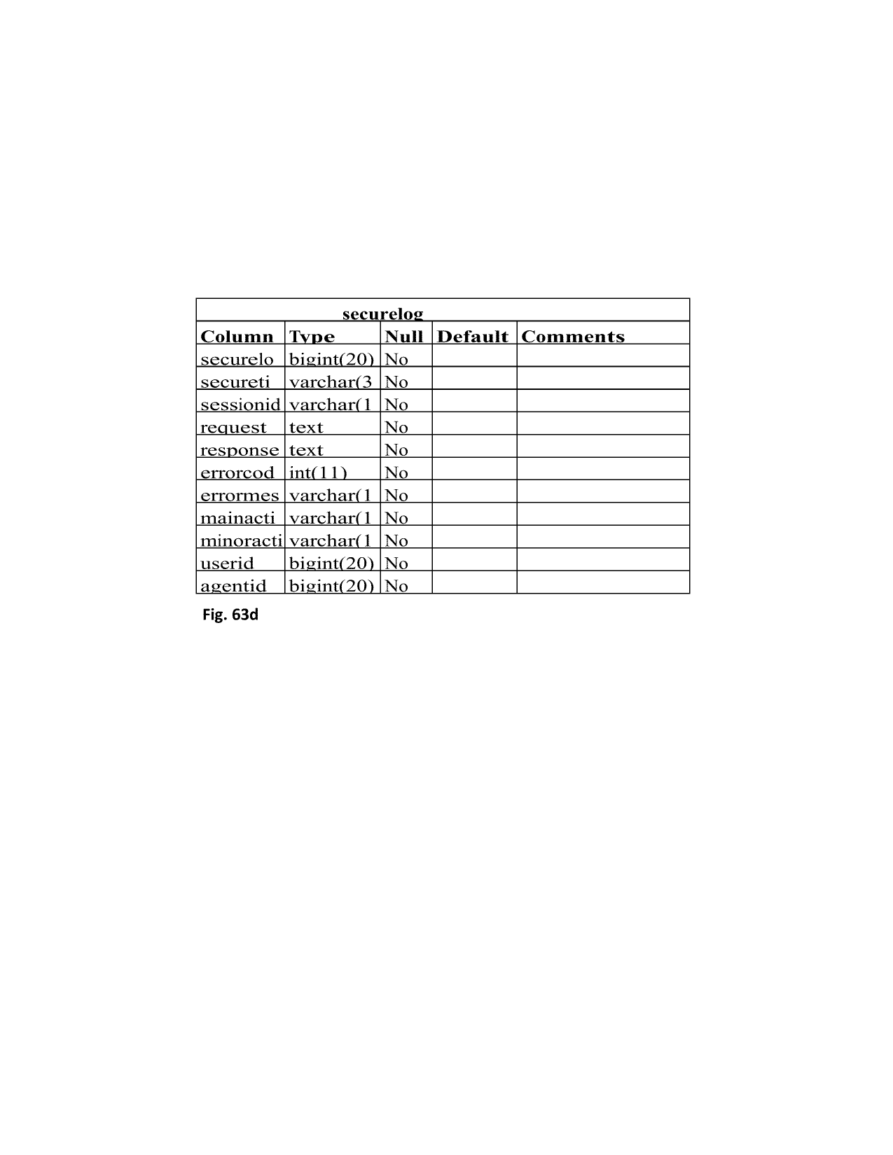

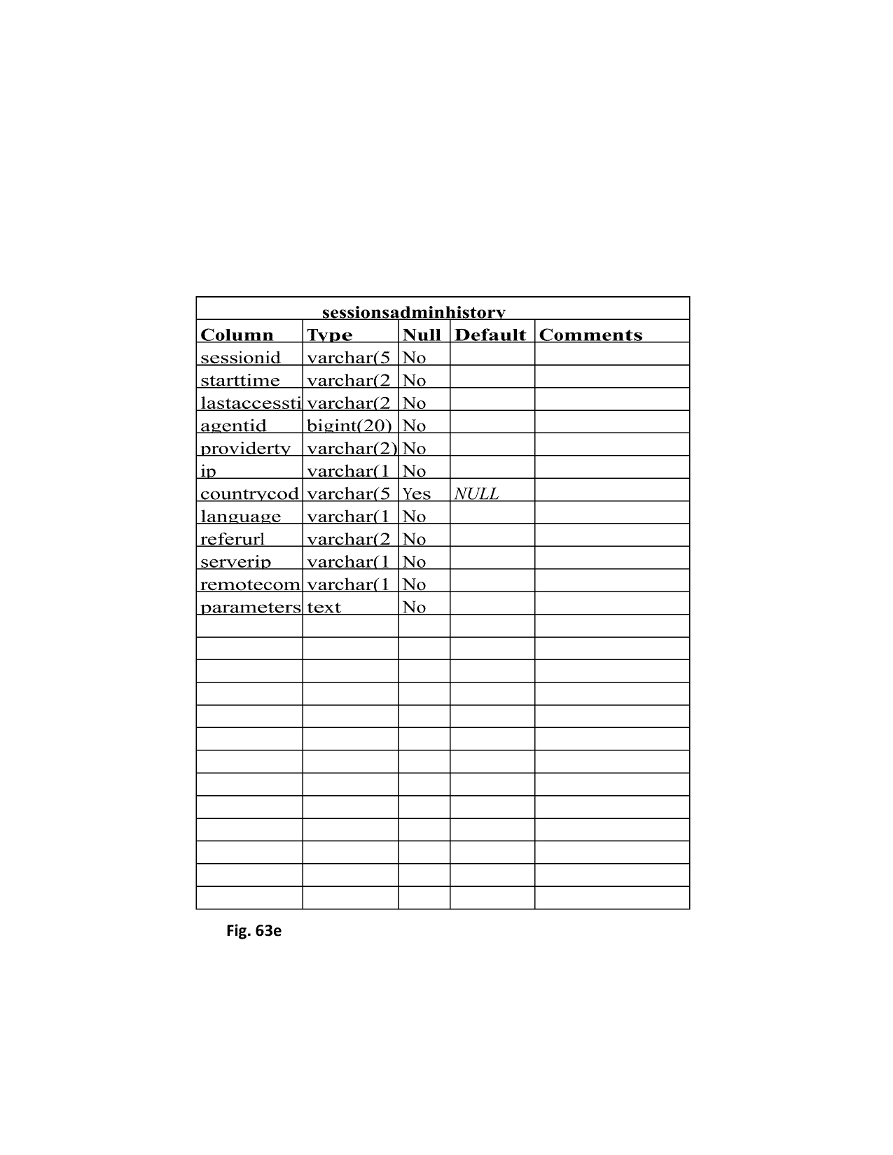

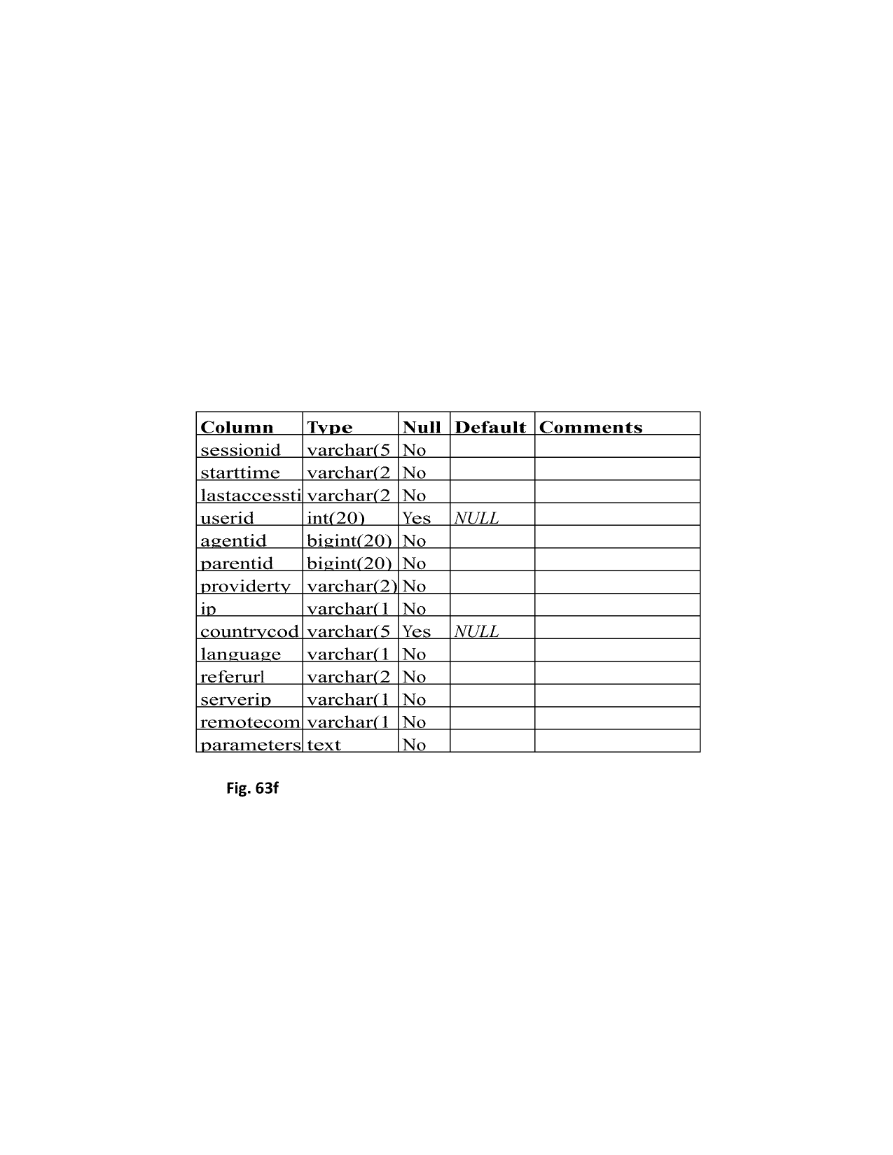

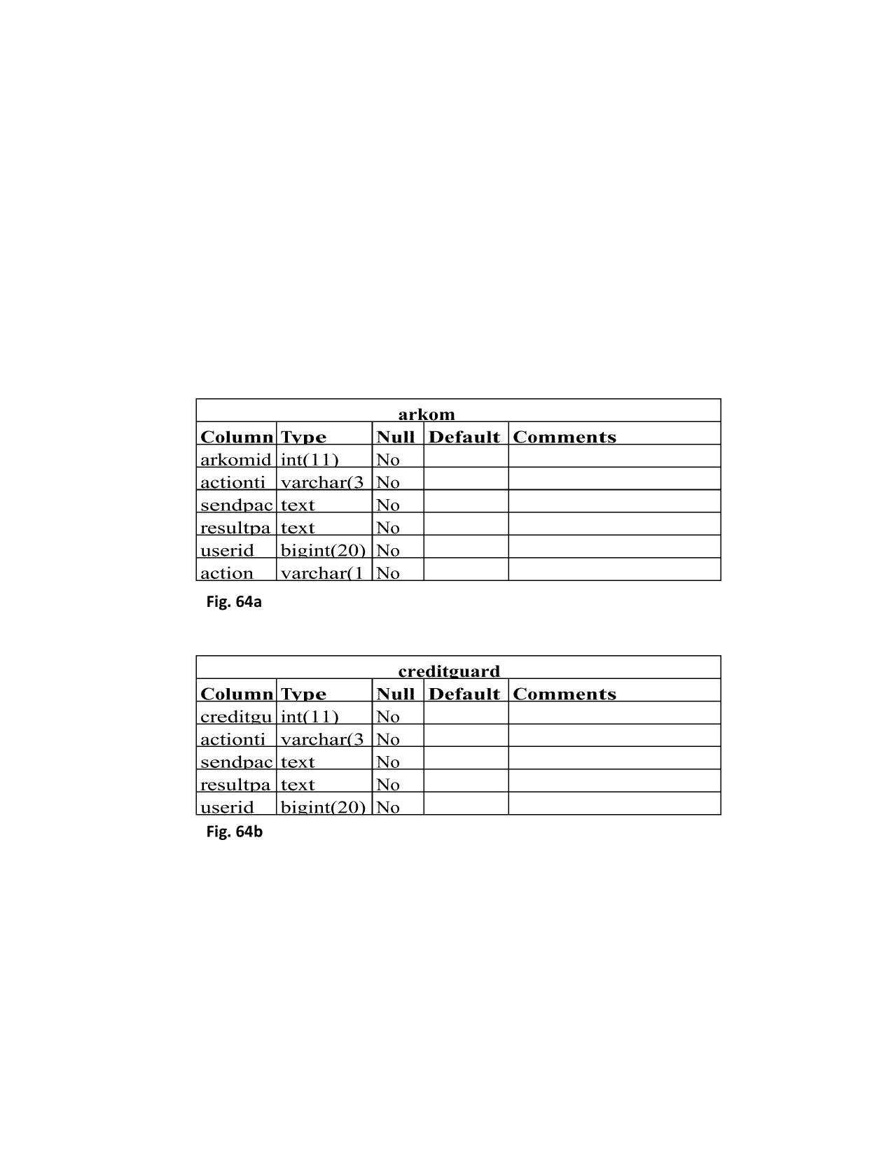

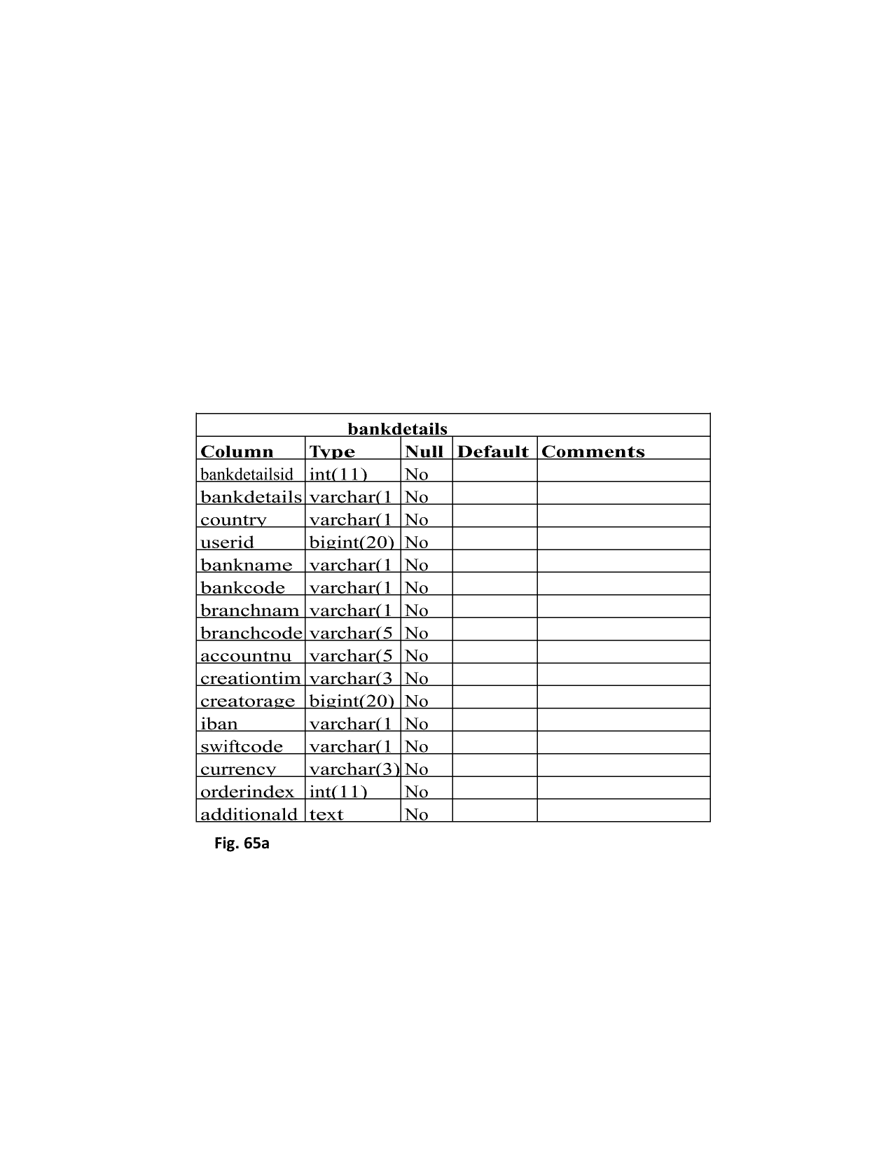

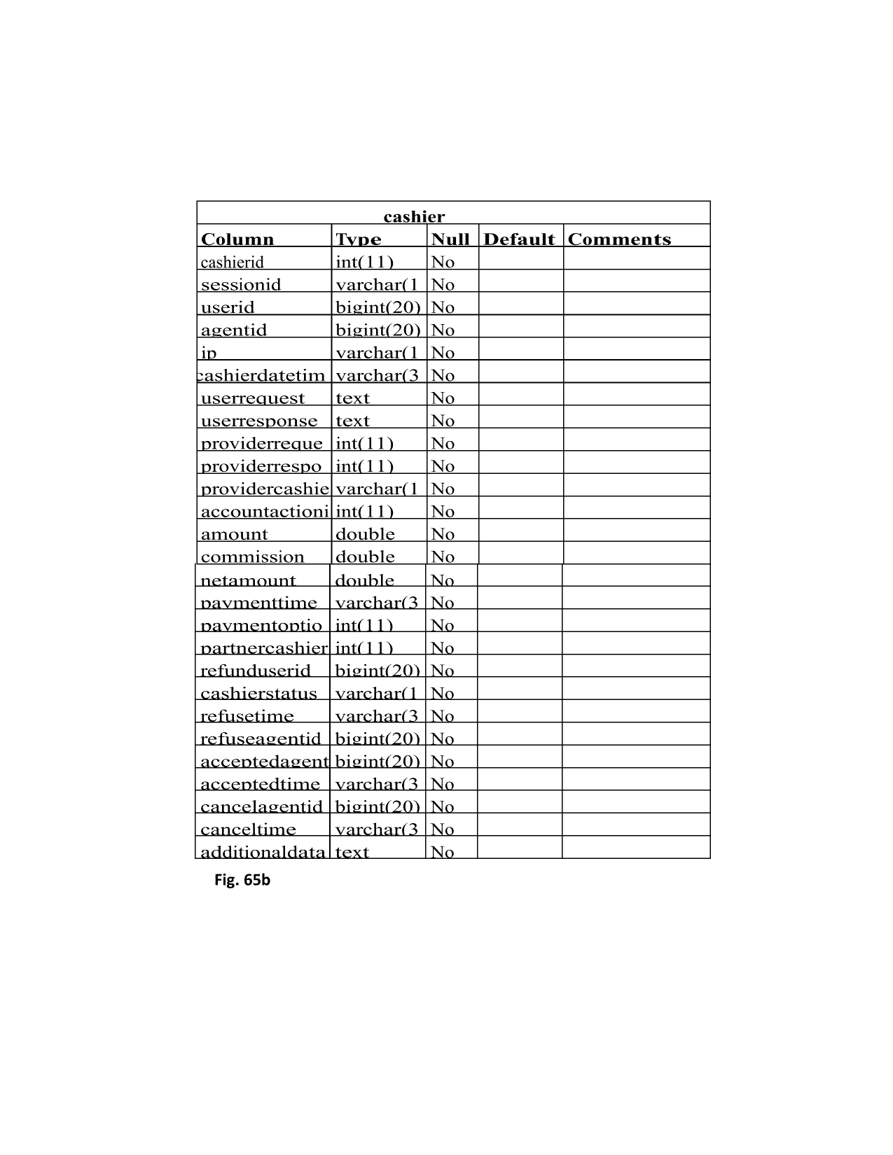

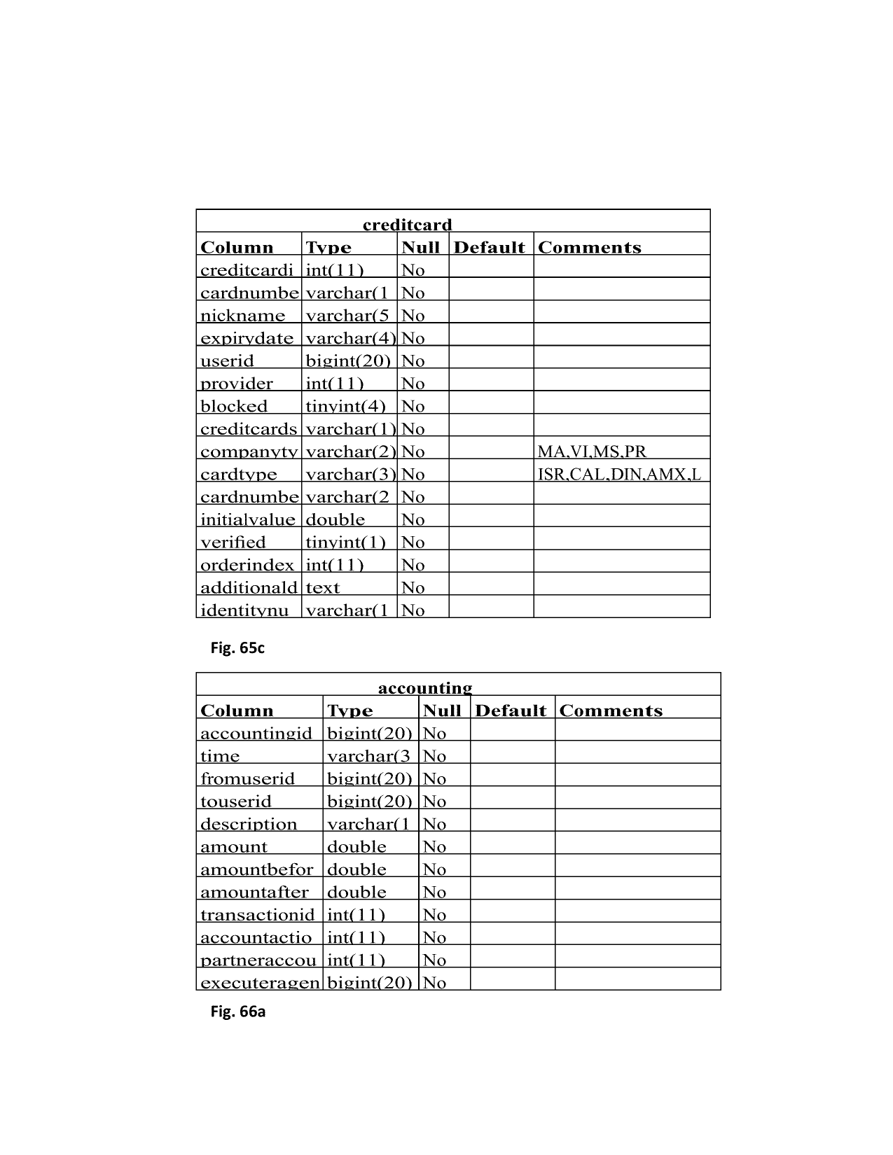

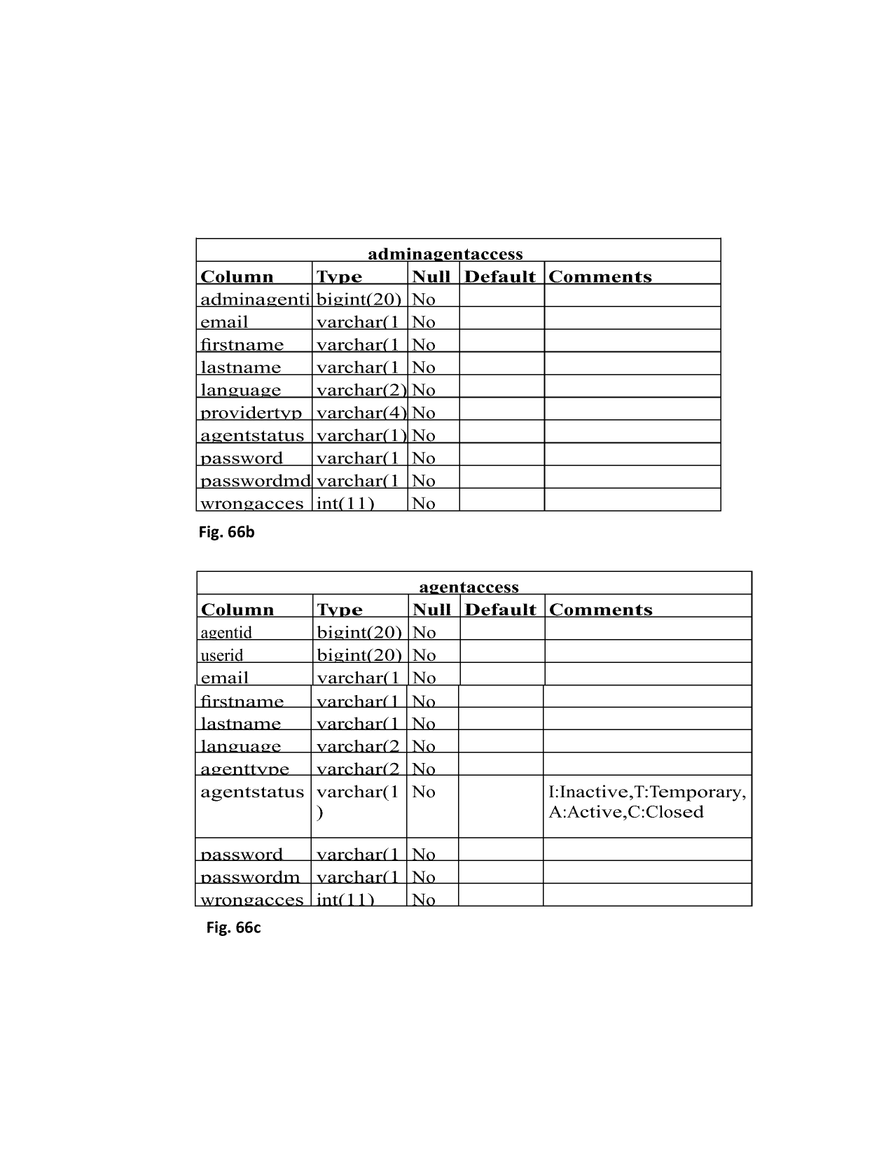

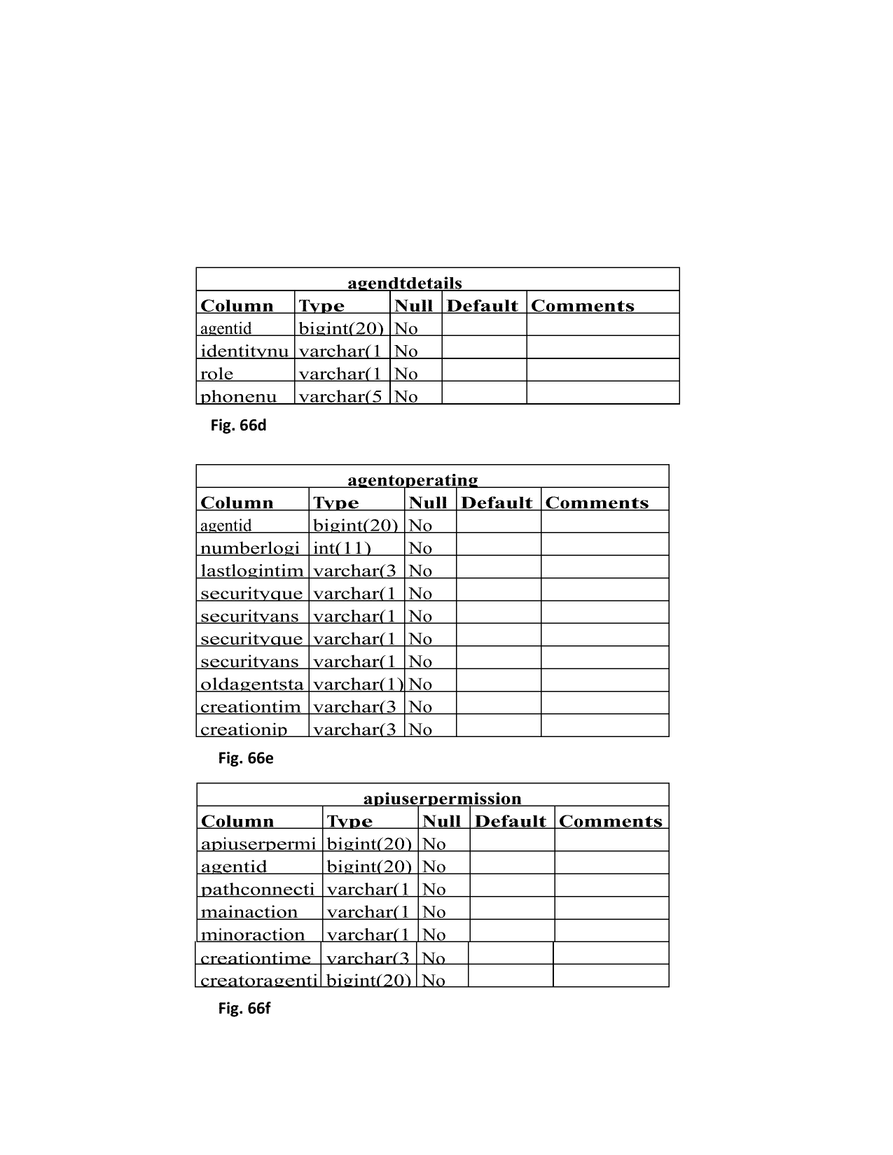

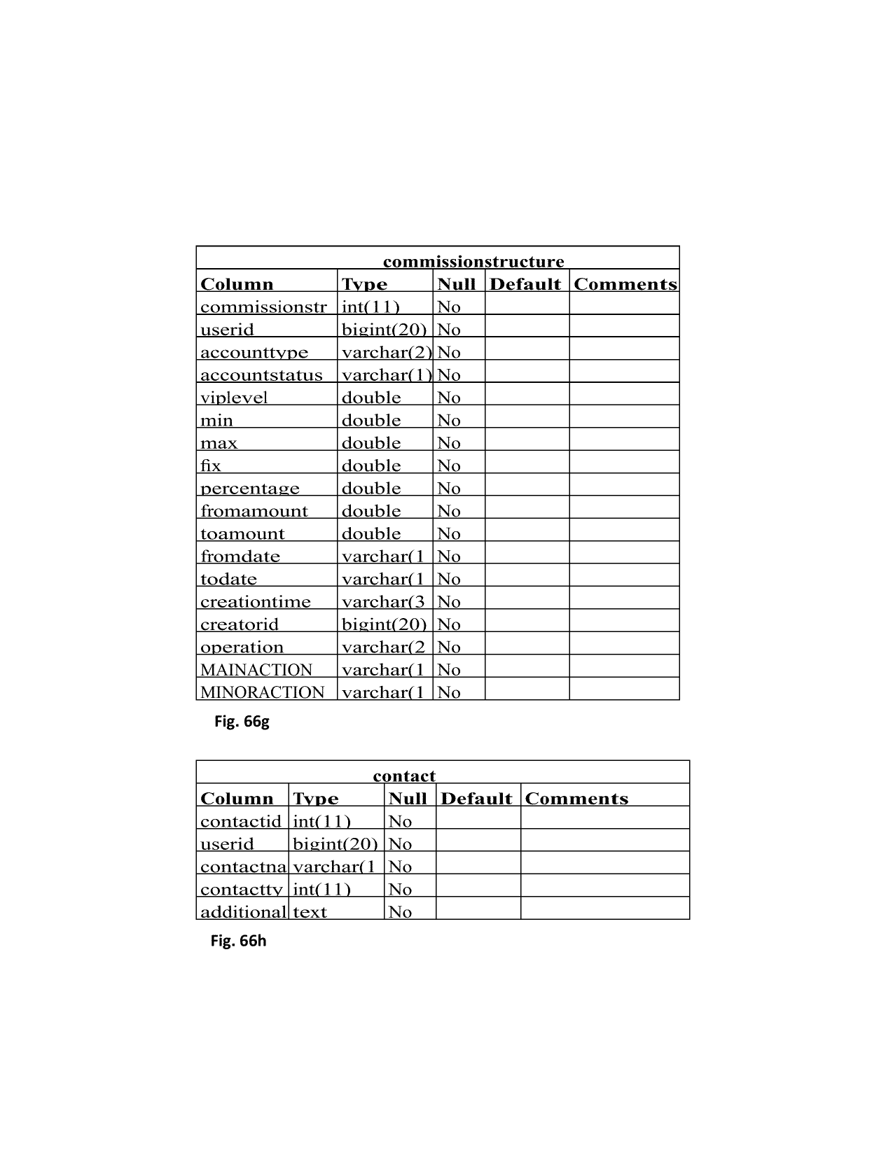

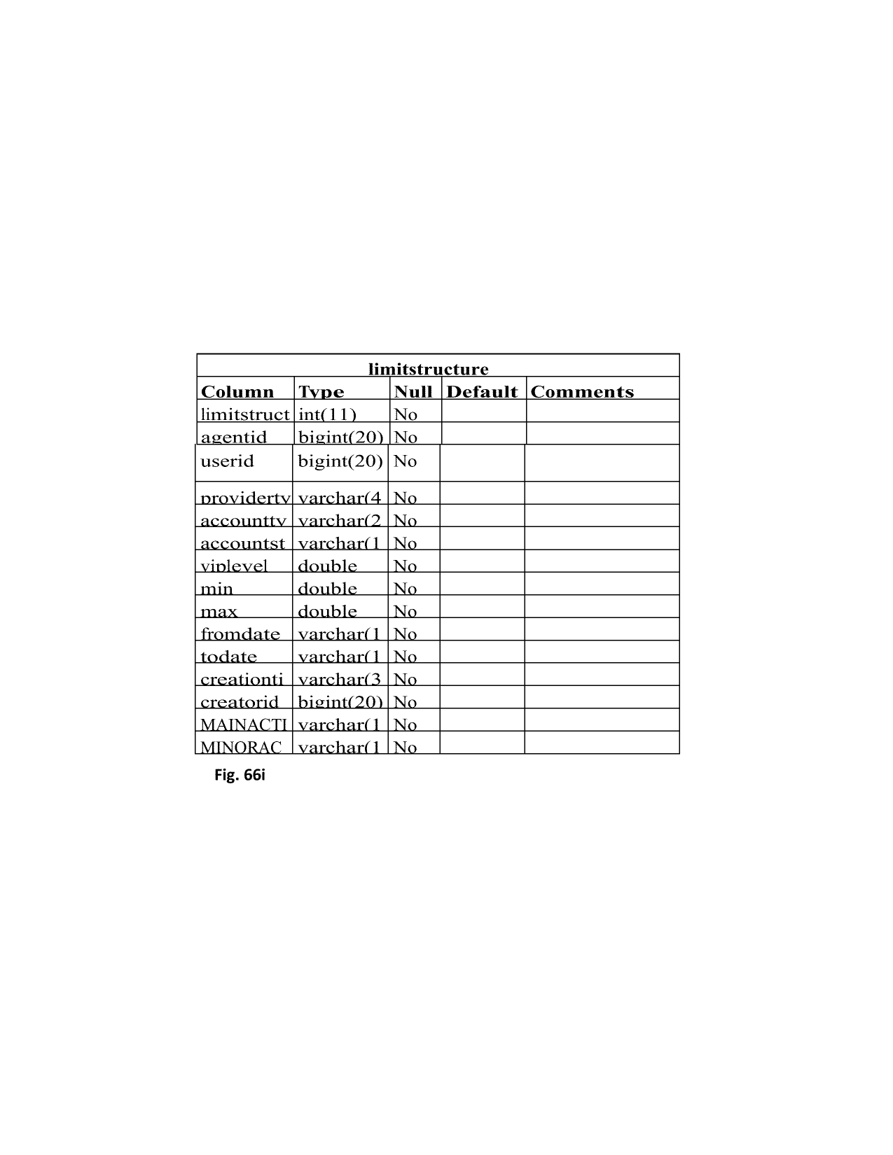

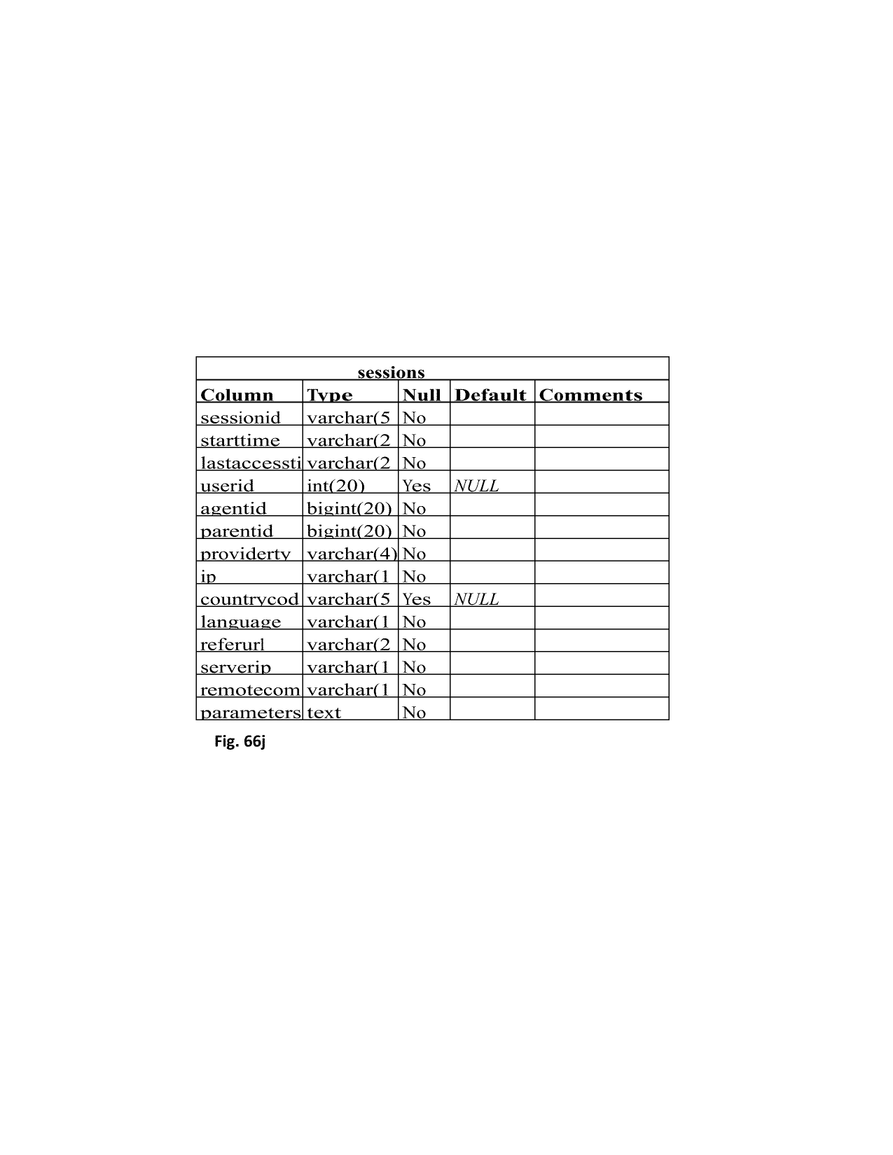

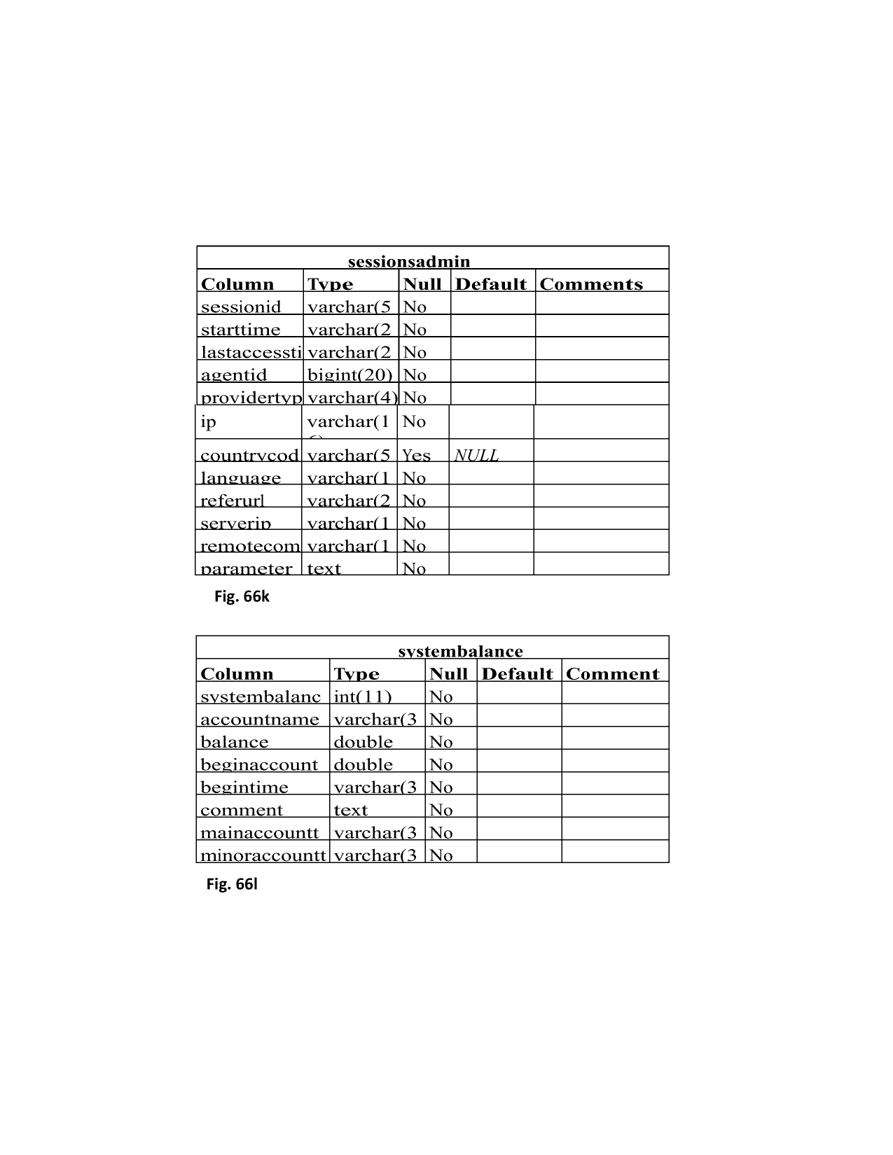

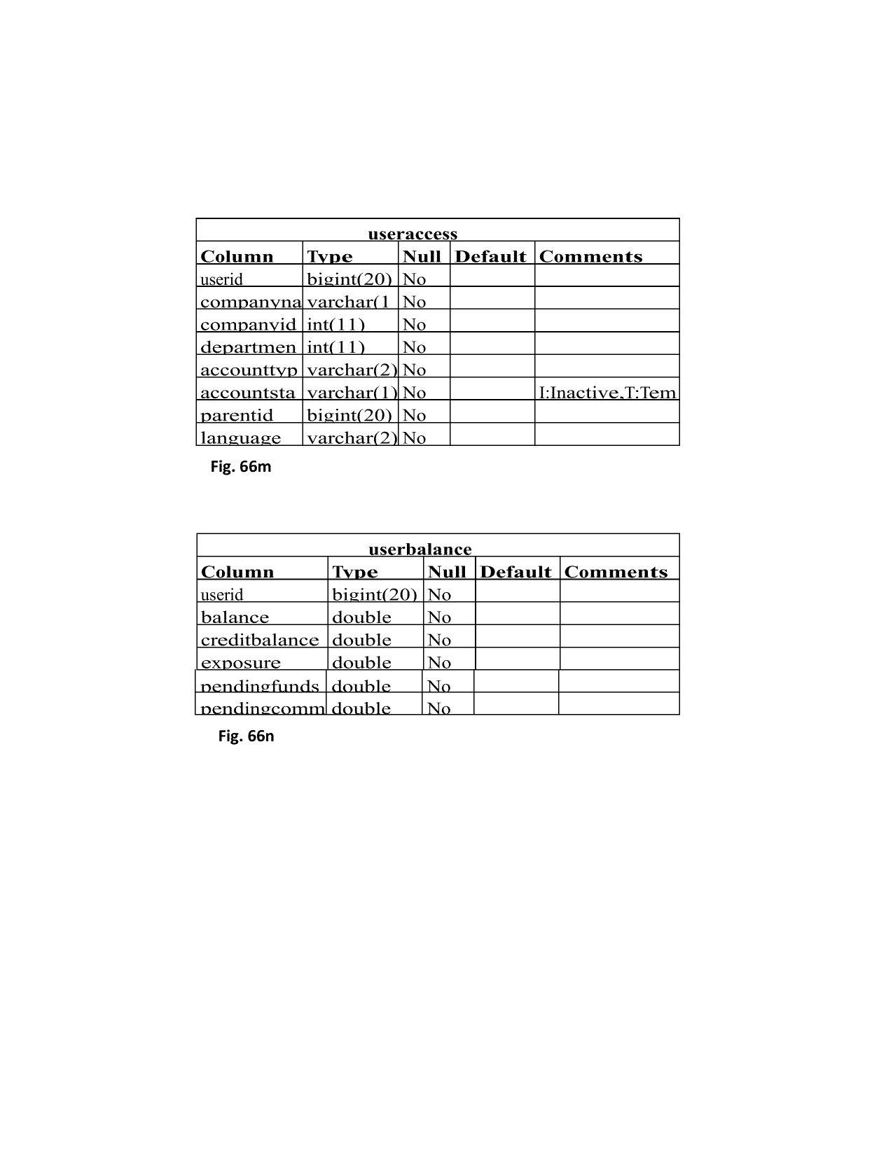

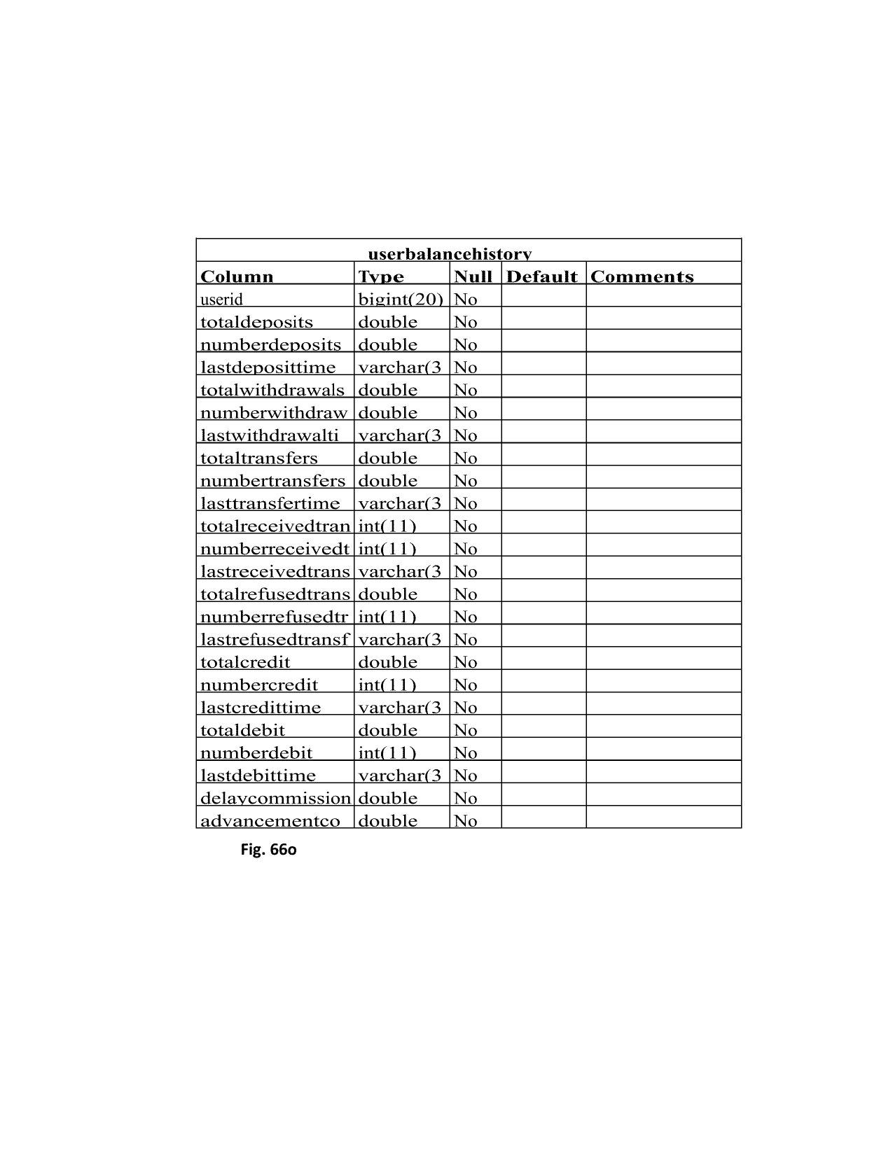

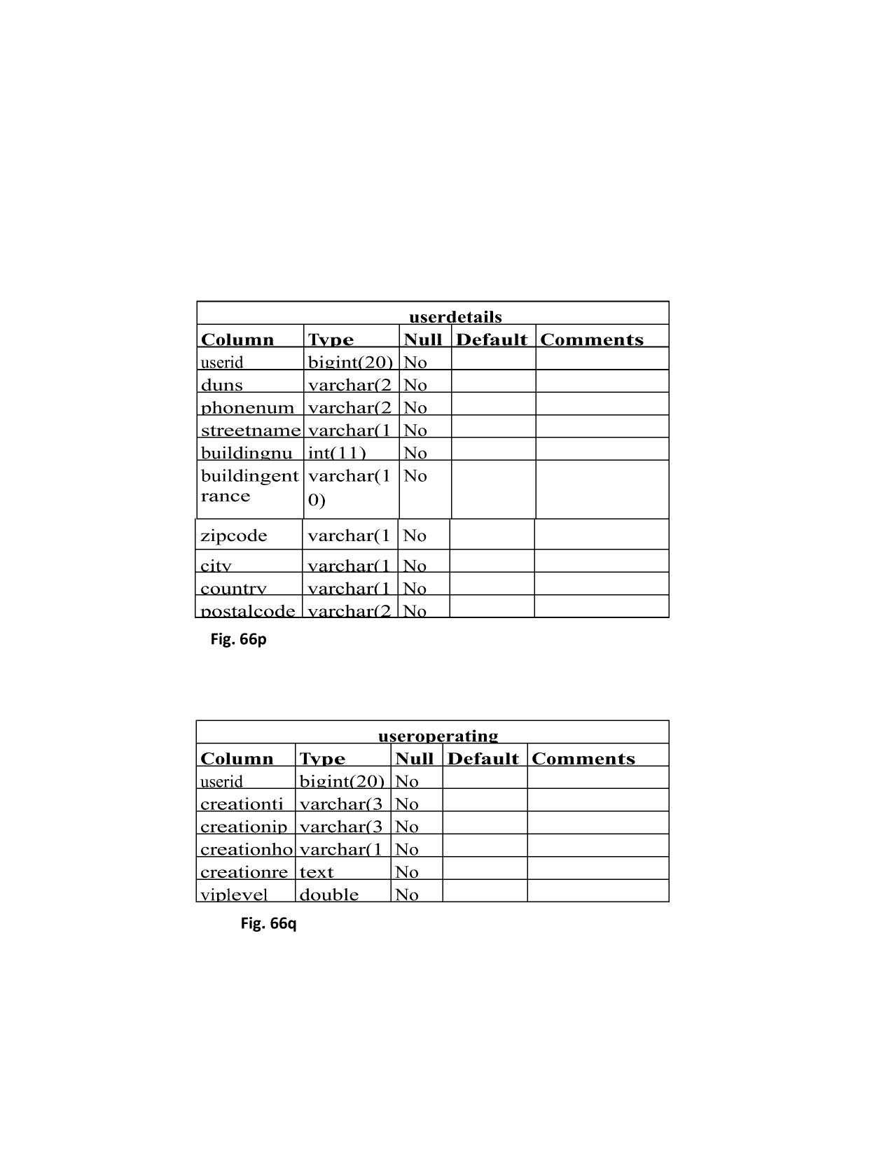

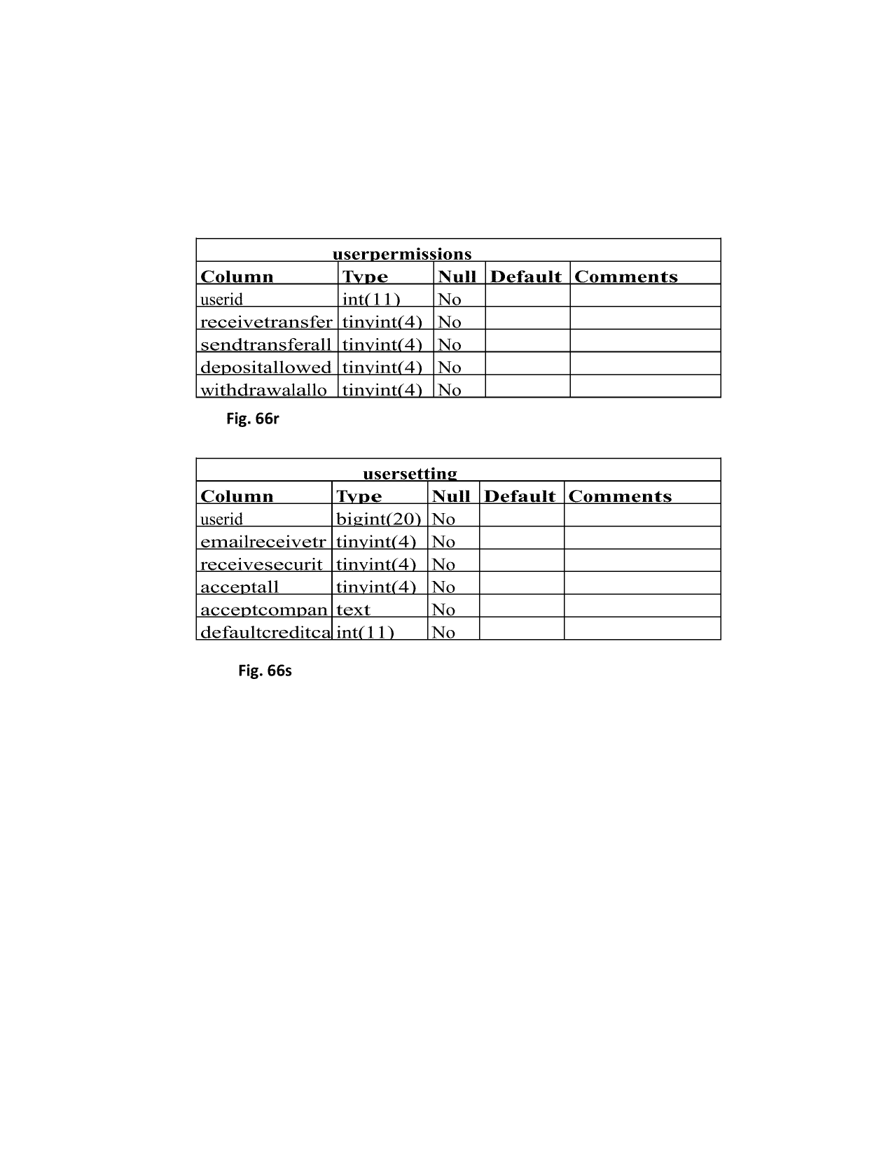

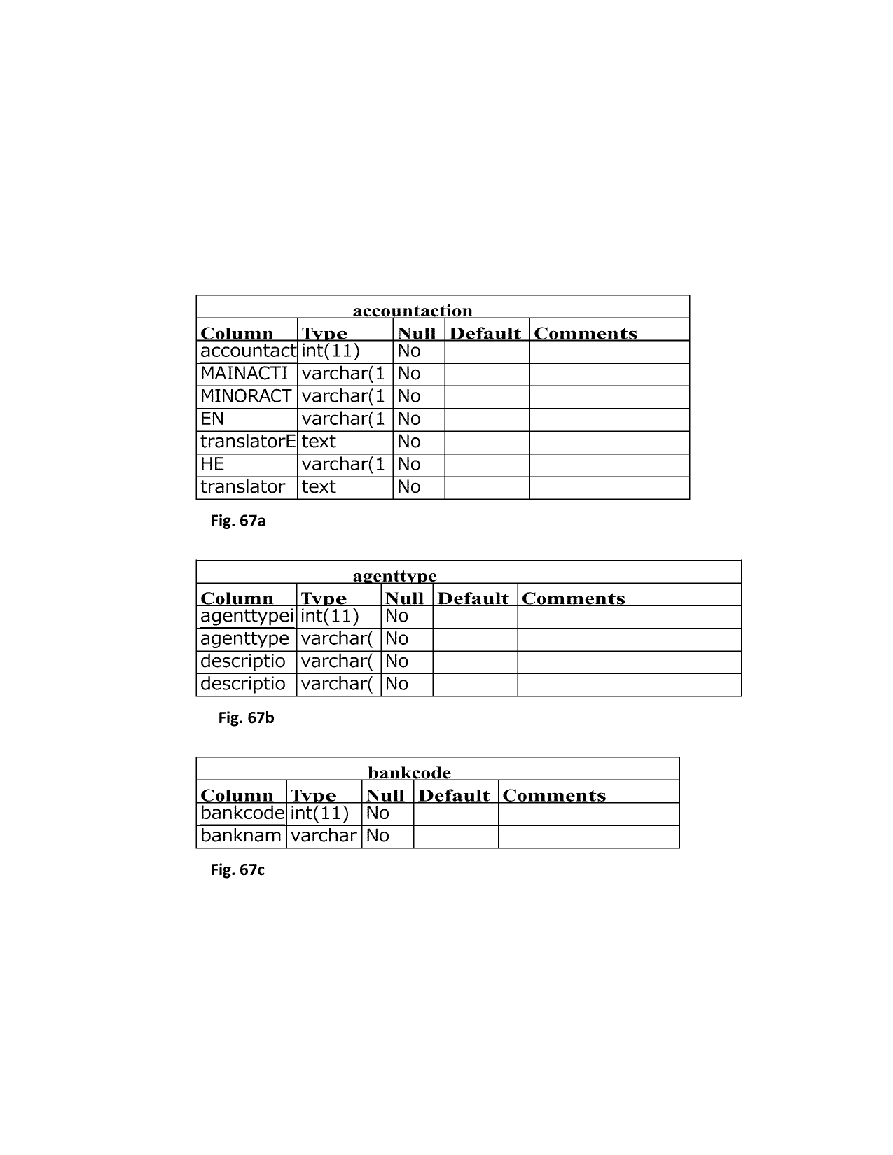

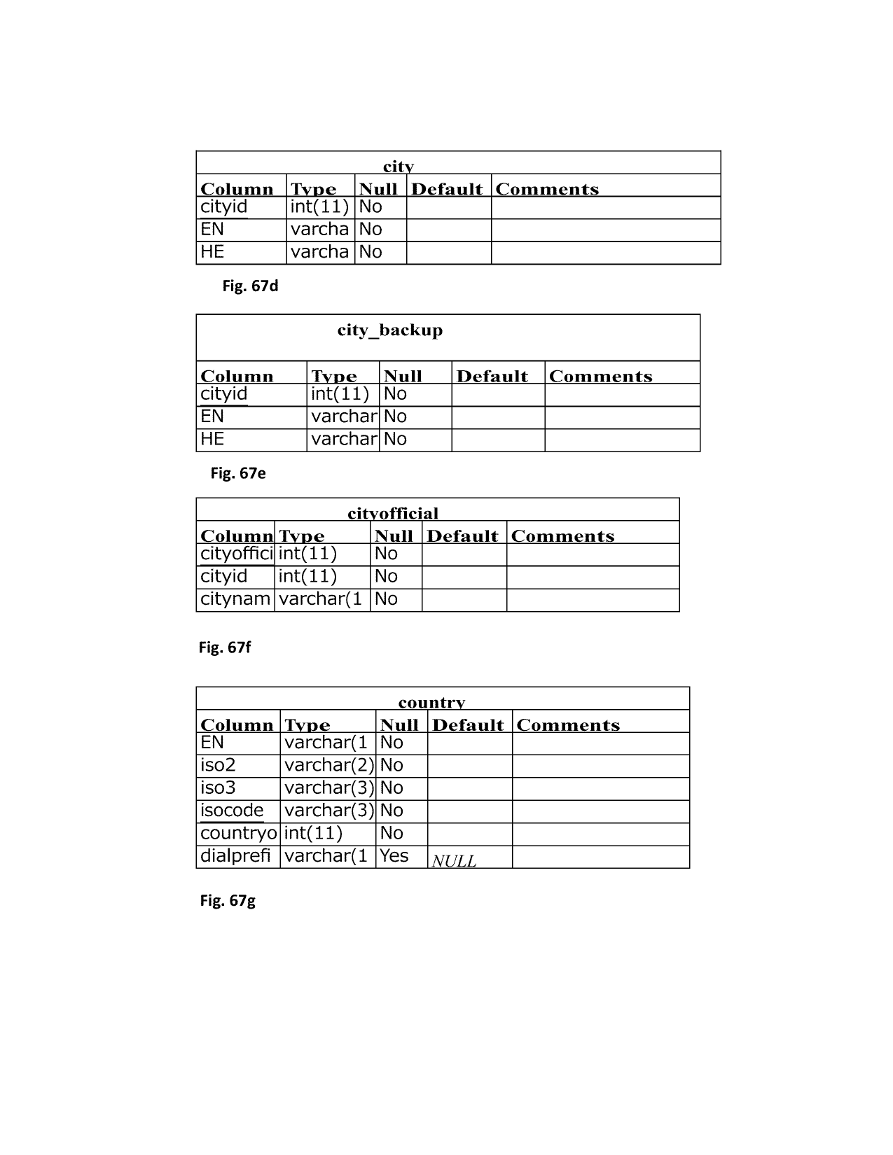

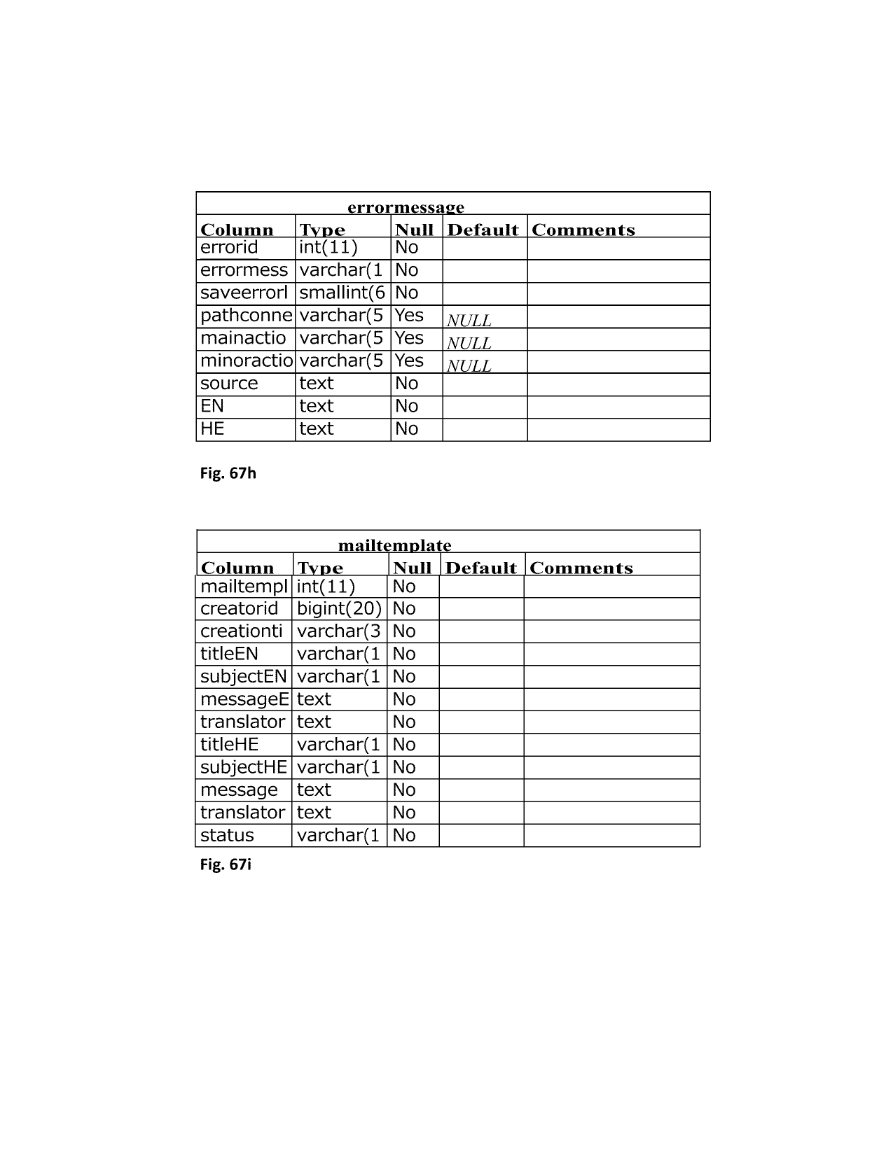

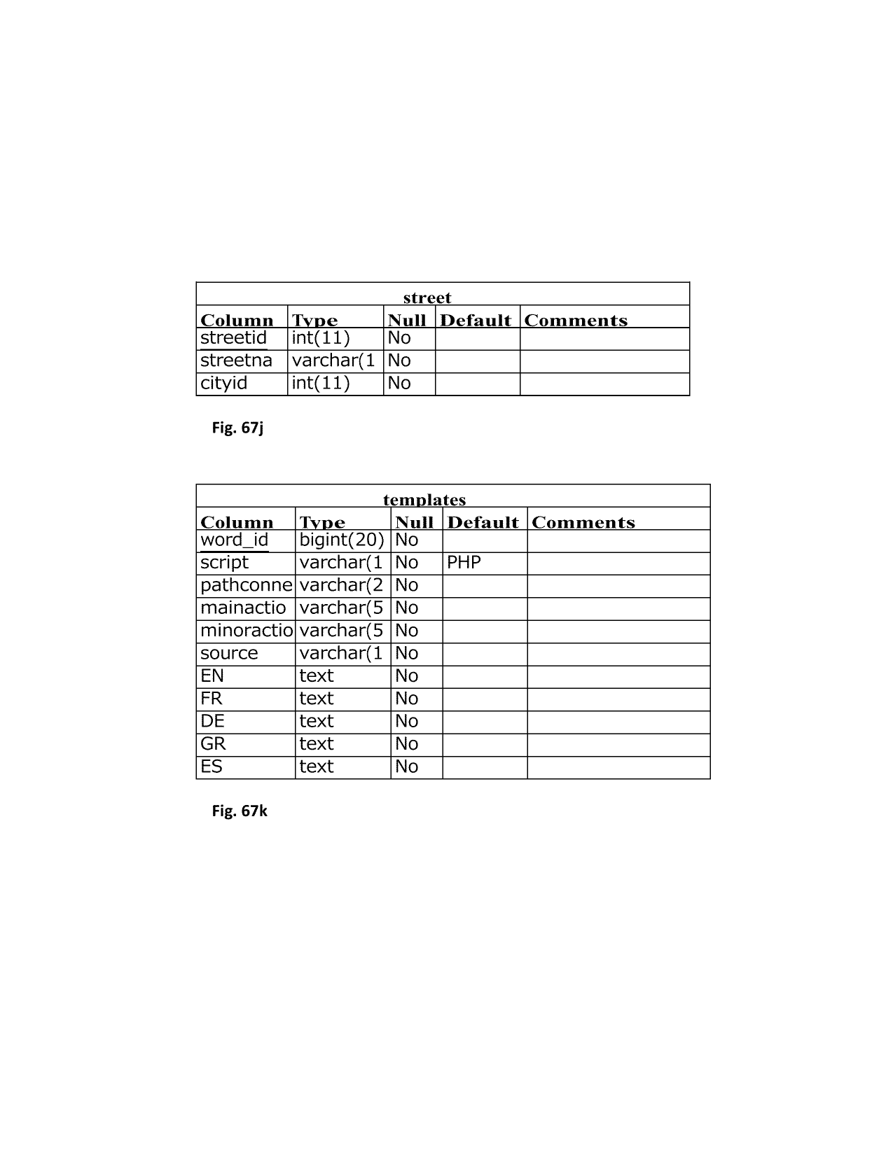

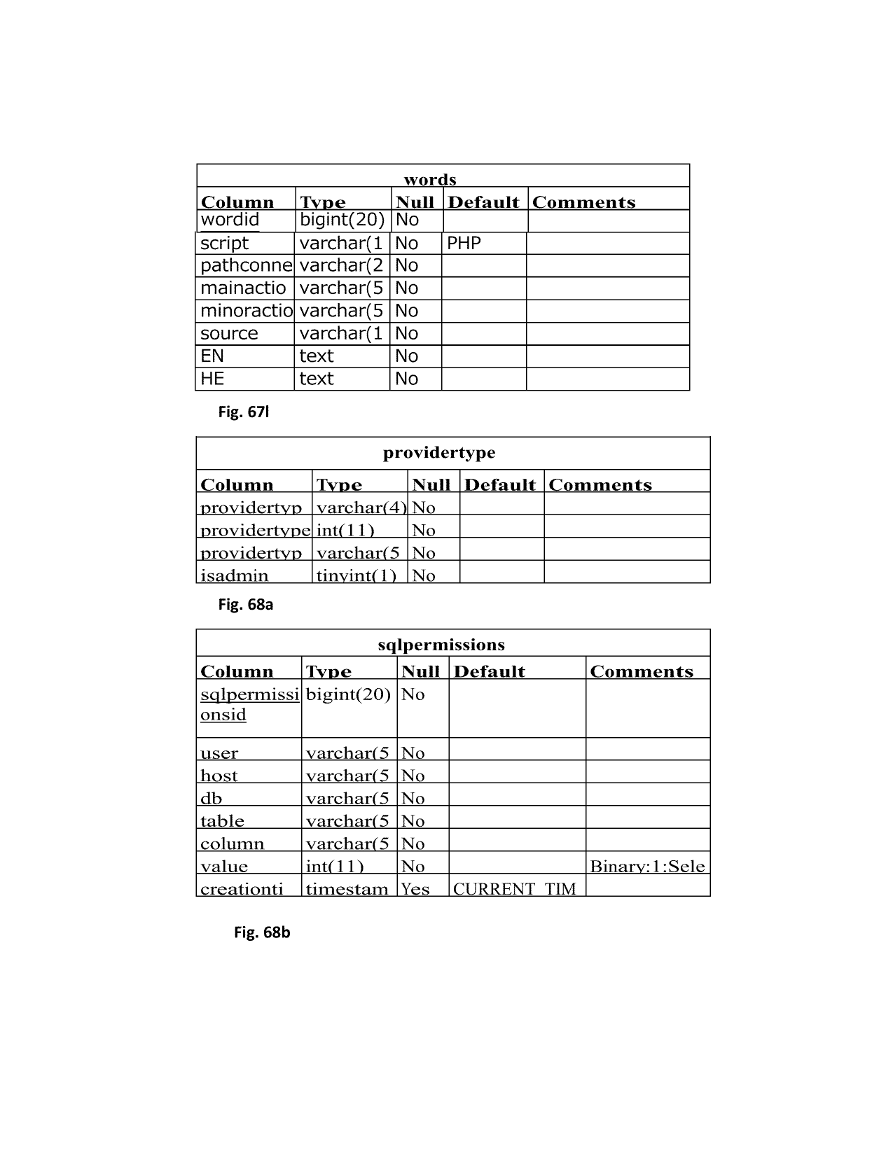

The method of FIG. 1a is applicable for management of a wide variety of resources such as but not limited to any of the following: printers or other equipment resources such as construction equipment resources; fleets, e.g. of vehicles performing deliveries or conveying passengers; computer-managed credit, manufacturing facilities. The method of FIG. 1a is particularly suited to applications in which all managed resources are interchangeable such that any instance of a resource may fulfill the role of any other instance. However, mutatis mutandis, it is also suitable to applications in which only some managed resource instances can substitute for others, typically according to predefined rules. FIG. 1b is a simplified functional block diagram of a computerized system for effecting payments which may utilize the computerized method of FIG. 1a. An example implementation for login to the system, including an interface facilitating parameter definition, is described with reference to FIGS. 2-13 describing a suitable computerized “wizard” 10. An example computerized “dashboard” 20 is then described with reference to FIGS. 14a-14b. Computerized transactions which may be performed by a transactions processing unit 40 in the system of FIG. 1b are next described with reference to FIGS. 15-37. Computerized tools 60 which may be provided in the system of FIG. 1b are next described with reference to FIGS. 38-49. It is appreciated that optionally, queries and reports may be generated and handled by suitable query processing and report processing units 30 and 50 respectively. Computerized databases, e.g. storing some or all of the data in some or all of the tables described in FIGS. 55a-68b, and general functionality, e.g. as described with reference to FIGS. 50a-50b, are provided in module 70. The functionalities of any or all of the units in FIG. 1b may be distributed in any suitable manner between one or more clients and one or more servers, e.g. such that “engine” functionalities reside in the server/s and “outfit” functionalities determining user experience reside in the client/s. Databases e.g. of module 70 may reside in the client/s and/or in the server/s and/or at location/s remote from both. Data base, Server side, client side may all be hosted in a hosting farm such as that provided by Internet service providers like Bezeqint. End users typically access the system remotely, e.g. via Internet.

The terms “payer” and “Card holder” are used herein generally synonymously. The term “recipient”, “beneficiary” and “second client” are used herein generally synonymously and may refer to a receiving computerized entity receiving payments. The terms “Clearing company” and “processing company” are used generally synonymously to refer to such computerized corporate entities as Creditguard and Arkom. “Masav” is used merely herein as an example of a computerized Clearing House. “Sheva” is used merely herein as an example of a computerized bank service provider. “Client” is, unless clear otherwise by context, intended to include to either payer or beneficiary. The system login process for new users may include several steps, such as but not limited to some or all of:
Signing up to the service
Execution of login
First login screen
Details wizard
   Signing up to the service: Before using the system, new users may be required to sign up. Signing up may comprise some or all of the following steps, suitably ordered e.g. as shown:
Completing the Signing up form
Receiving a validation email and password
Finishing the signing up

FIGS. 2a-2b, taken together, form a table presenting example functional instructions pertaining to a computerized Sign up form which may be displayed to a user during sign-up.

FIGS. 2a-2b, taken together, form a table presenting example functional instructions pertaining to a computerized Sign up form which may be displayed to a user during sign-up. FIG. 3 is a table presenting example functional instructions pertaining to a signing up process which was successful.

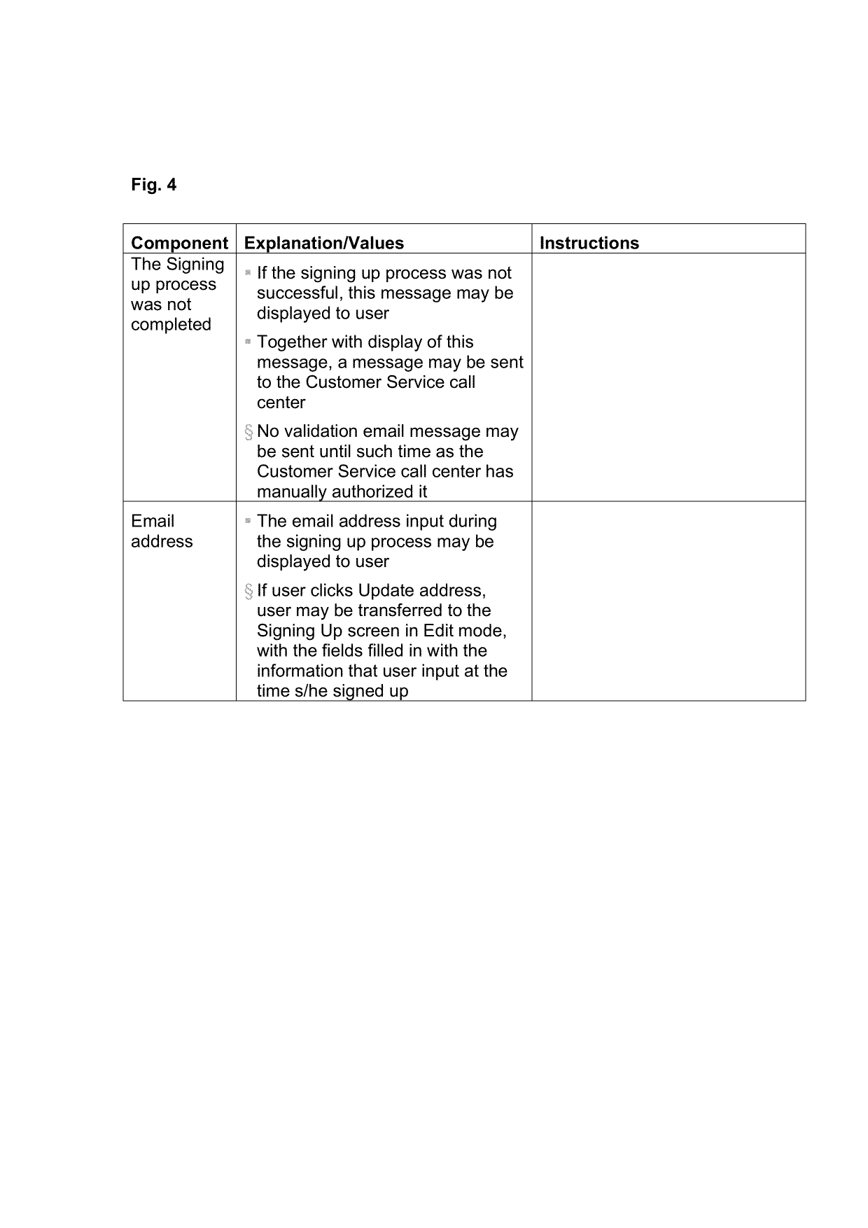

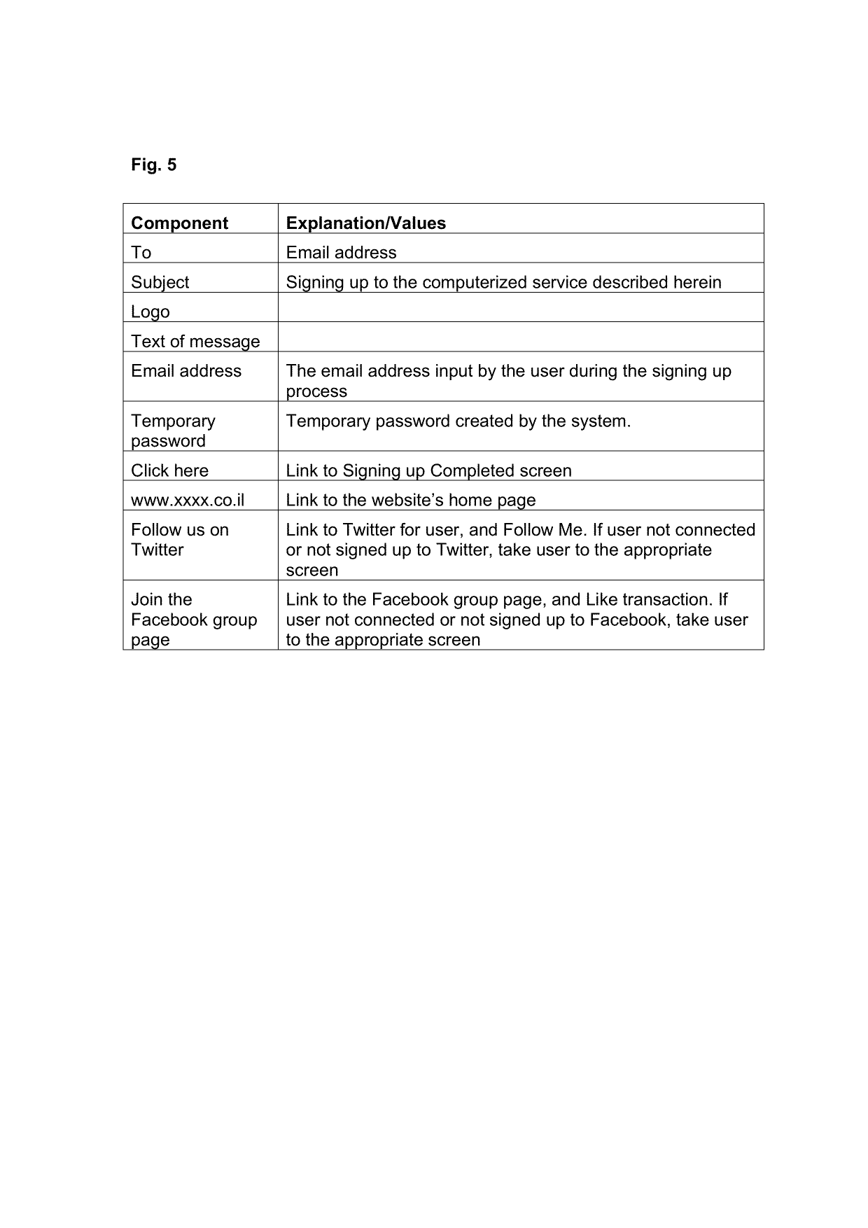

FIG. 4 is a table presenting example functional instructions pertaining to a signing up process which has failed. FIG. 5 is a table presenting example functional instructions pertaining to a validation email message which may be sent to a user.

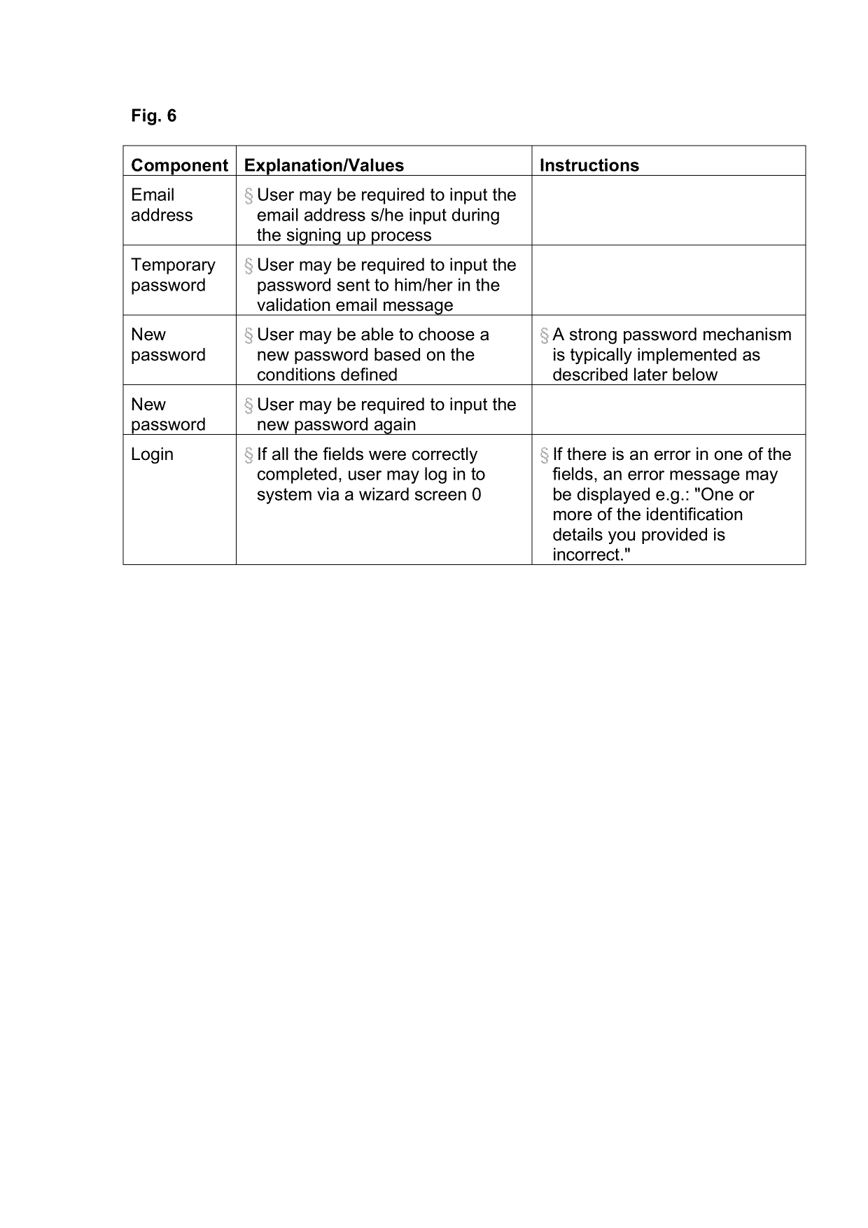

FIG. 6 is a table presenting example functional instructions pertaining to completion of the signing up process, according to certain embodiments.

A wizard may now enter operation which may provide any or all of the following functionalities: After completing the signing up process on the website and logging into to the system for the first time only, a wizard may be displayed to a user to help him/her define the parameters for using the system.

The signing up process to the system e.g. according to users' type may include some or all of the following functionalities:
User signs up to system as Type 1 user.
After selecting purpose for using the system, user may become a more advanced user, and may have the option of becoming an even more advanced user:
   Receiving payments from customers—user may become Type 2; however the forms may enable user to become Type 3 (after sending them in and being approved); and/or
   Receiving payments from customers and making outgoing payments to suppliers—user may become Type 4; however the forms may enable user to become Type 5 (after sending them in and being approved)

To advance to Type 6, a user may be required to meet with a human representative. The wizard typically presents suitable screens such as some or all of the following four screens:
Main screen—describes the advantages of the system and constitutes an introduction to the wizard
Wizard screen 1—includes general details for using the website
Wizard screen 2—includes the forms and components which may be required for using the system
Finish screen—wizard summary and commencement of system usage

The Main screen is now described in detail. The main screen may have some or all of the following three modes:
Beneficiary signs up following invitation to receive an incoming payment
Payer user who signs up following invitation to make an outgoing payment
Any other user

The contents of the page and the information displayed vary e.g. according to the type of user signed up, for example some or all of the following:
Beneficiary who signs up following invitation to receive an incoming payment may be presented with information about pending outgoing payments
Payer user who signs up following an invitation to make an outgoing payment may be presented with information about pending incoming payments
Any other user—general information

The Beneficiary typically signs up following invitation to receive an incoming payment. A Payer user typically signs up following receipt of a computerized invitation to make an outgoing payment.

The Wizard screen 1 may include a variety of details which may be required from a user such as but not limited to some or all of the following:
Company details
Definition of users and authorizations
   The purpose for using the system
   The users of the system
   Functionaries in the system
Defining of means of payment

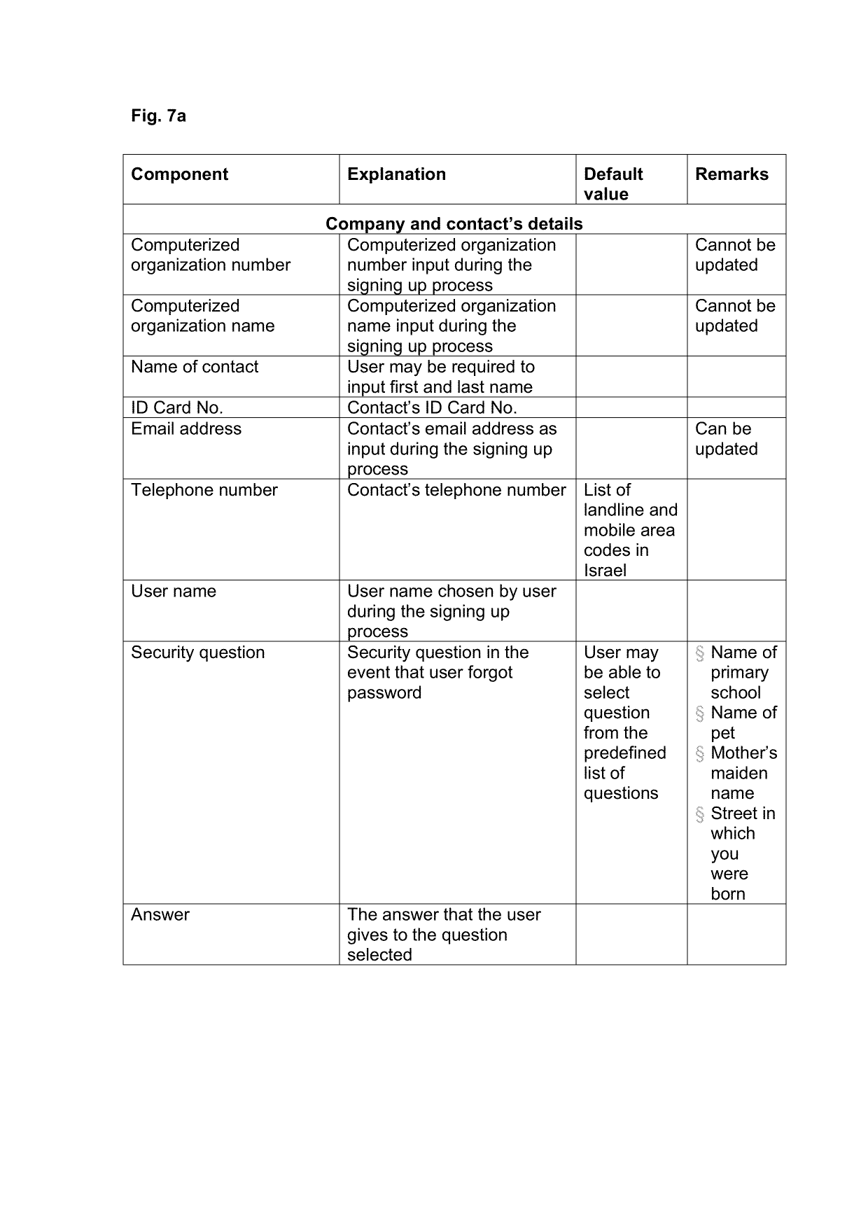

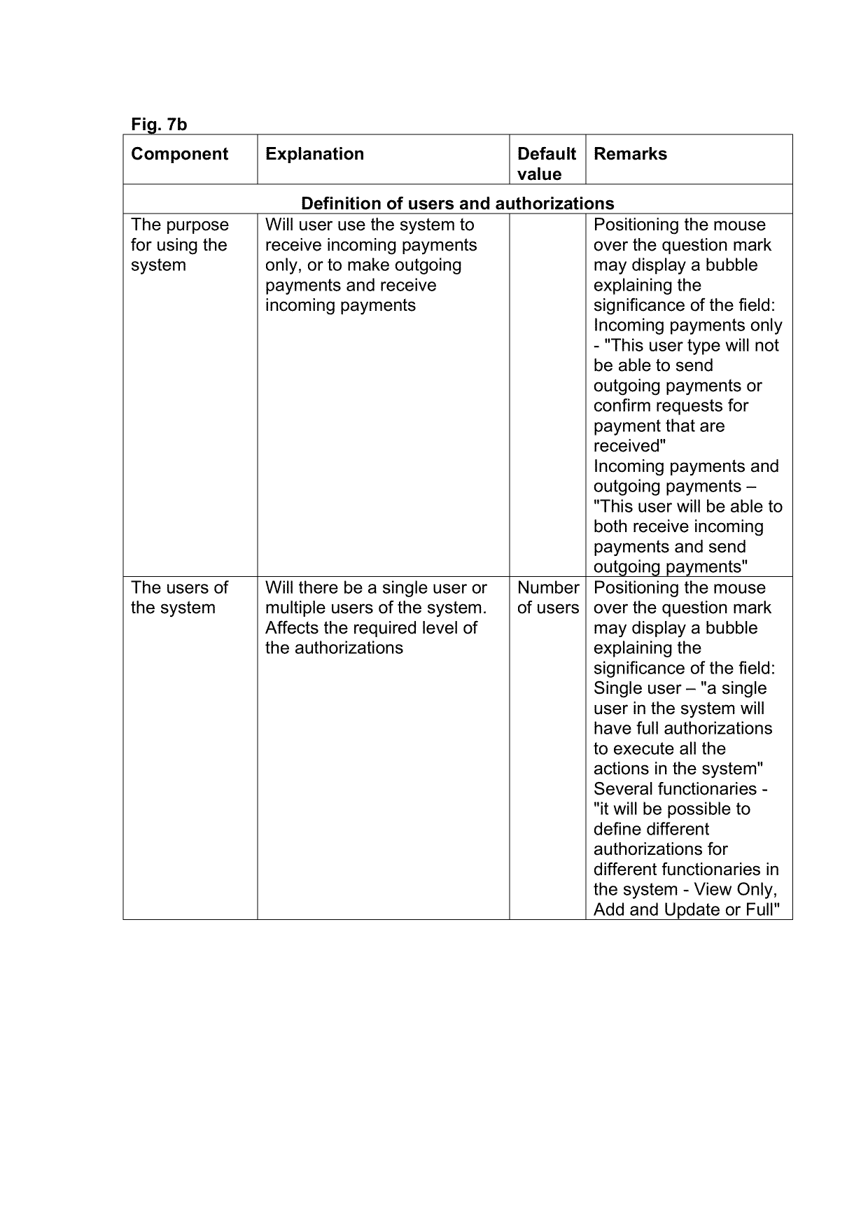

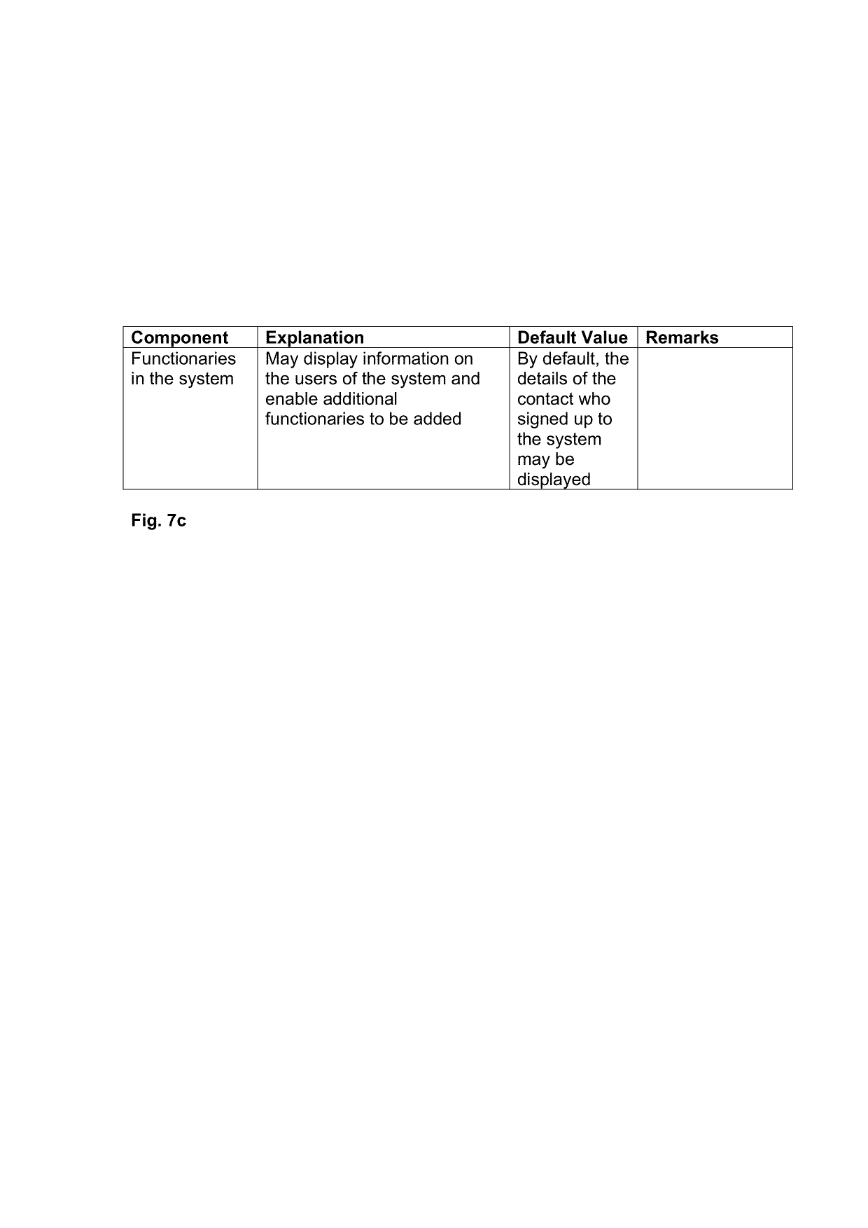

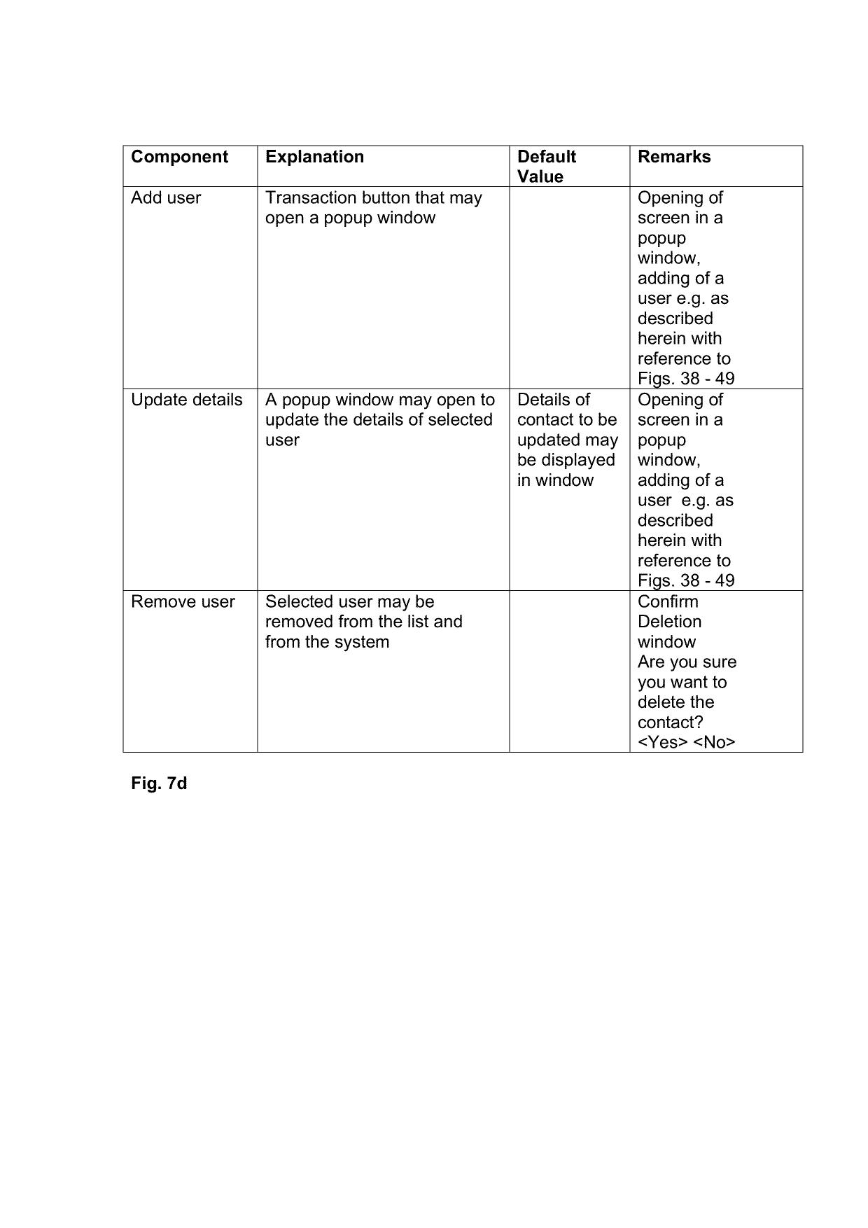

FIG. 7a is a table presenting example functional instructions pertaining to particulars of a user organization and of an individual user within that organization.

FIGS. 7b-7c, taken together, form a table presenting example functional instructions pertaining to user definitions and authorizations.

FIG. 7d is a table presenting example functional instructions pertaining to defining computerized payment means.

A second Wizard screen may be presented which presents conditions for a user organization such as a computerized organization joining, e.g. some or all of:
Forms which may be required
Use of additional security devices
Help and support

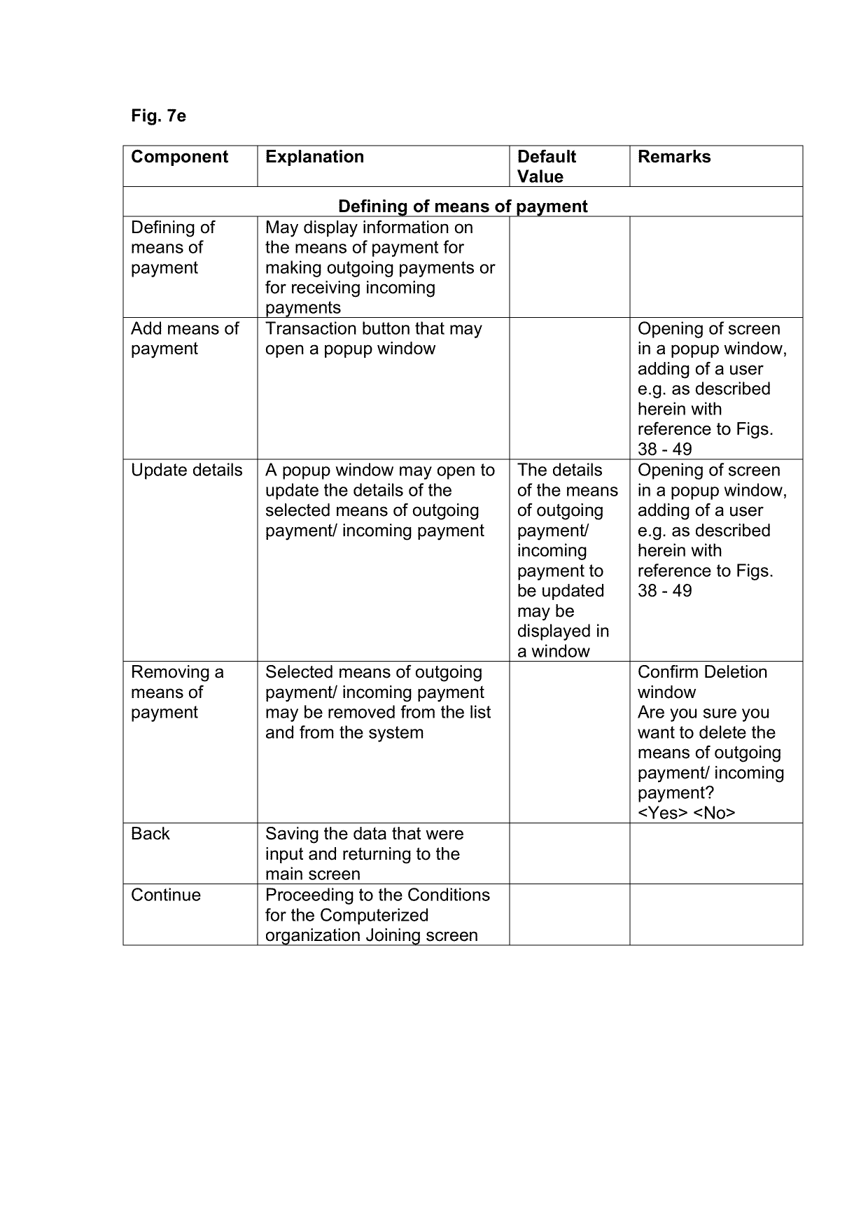

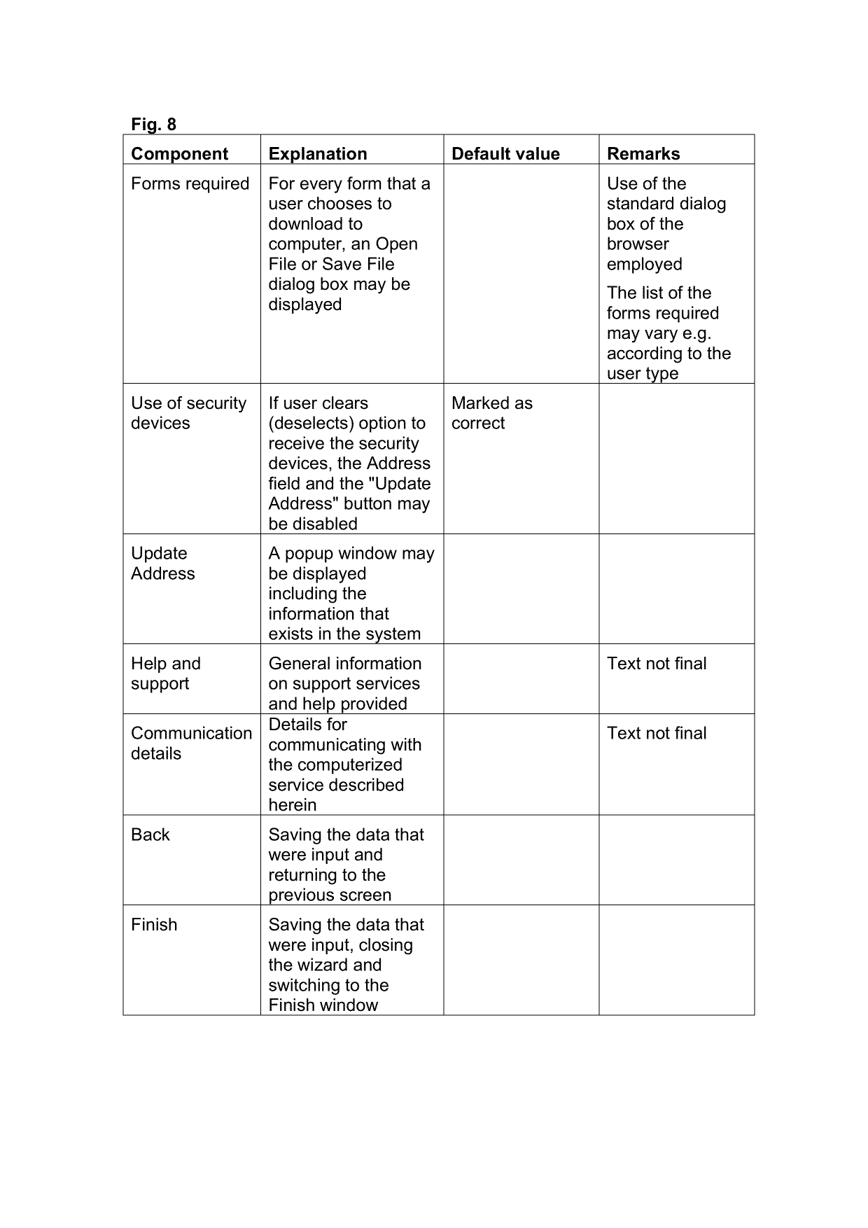

Details for communicating with an entity operating the system of the present invention, are described for example in the Functional instructions in the table of FIG. 8.

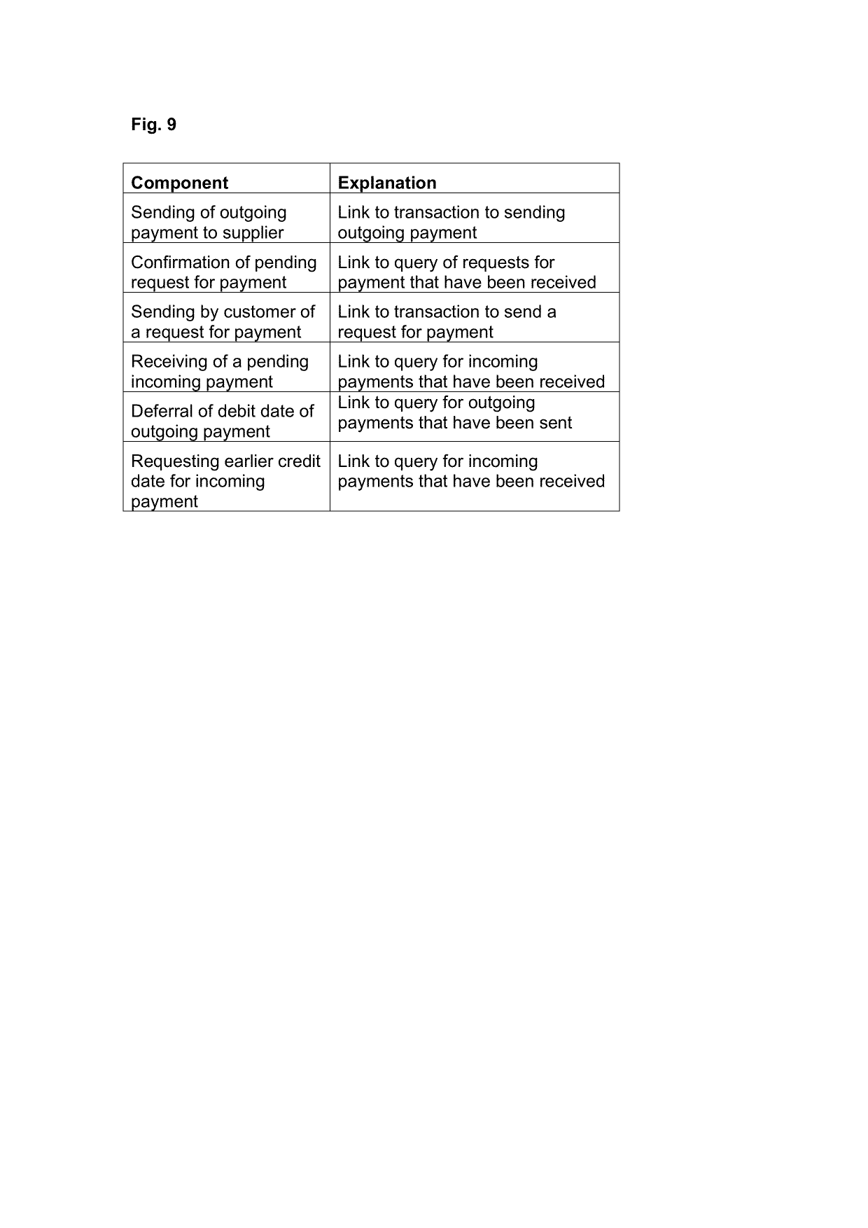

A Finish window may be presented to the user, e.g. as described in the Functional instructions in the table of FIG. 9.

Login to system from the marketing website on a current basis may include several screens and options.

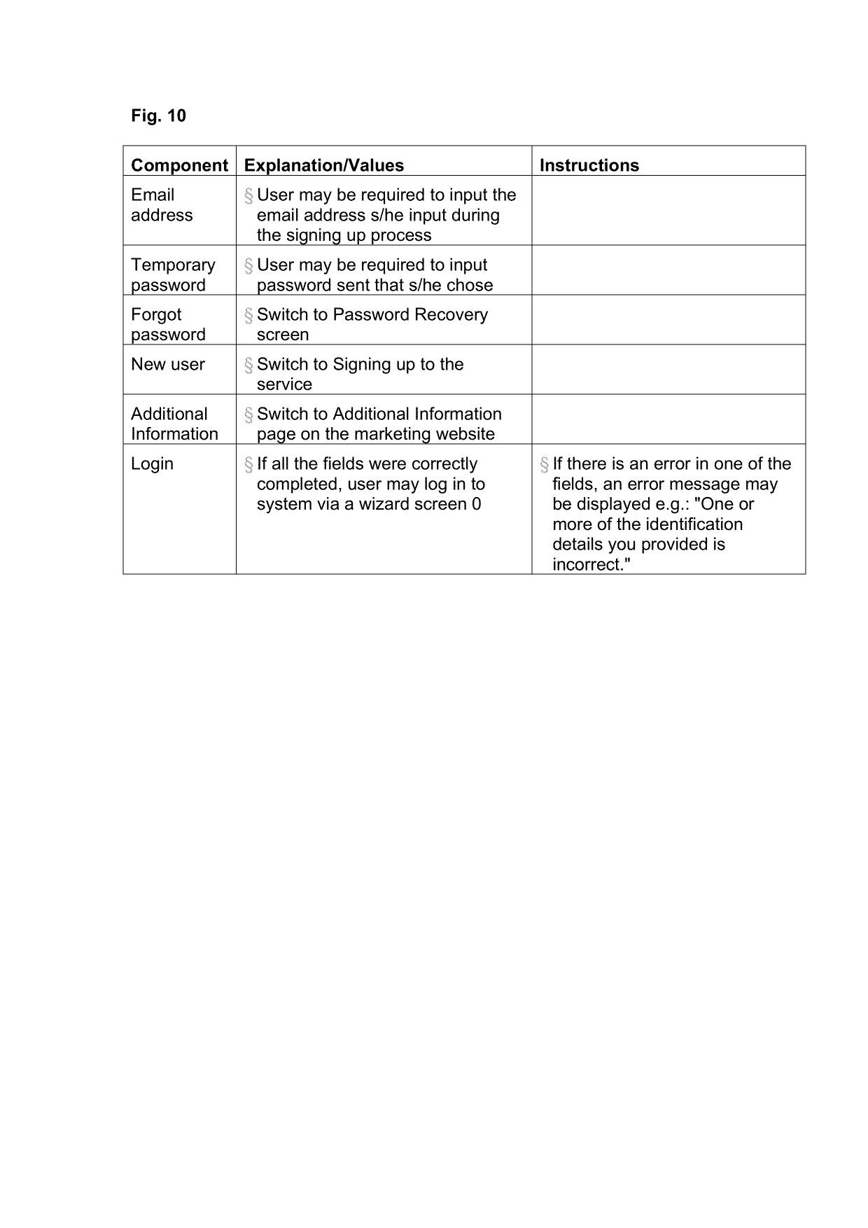

Selecting the option to login to system from the marketing website may take the user to a suitable Login screen, e.g. as described in the Functional instructions in the table of FIG. 10.

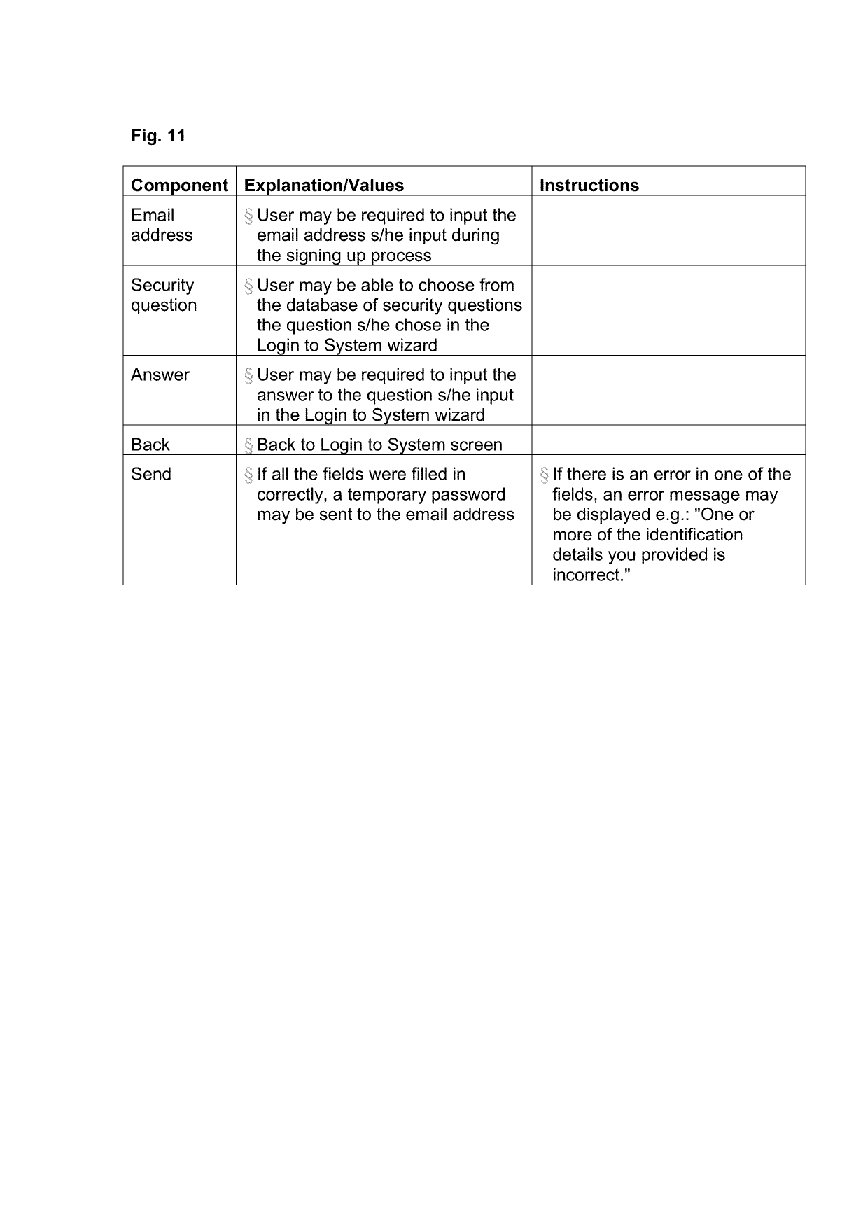

FIG. 11 is a table presenting example functional instructions pertaining to the issue of forgotten passwords.

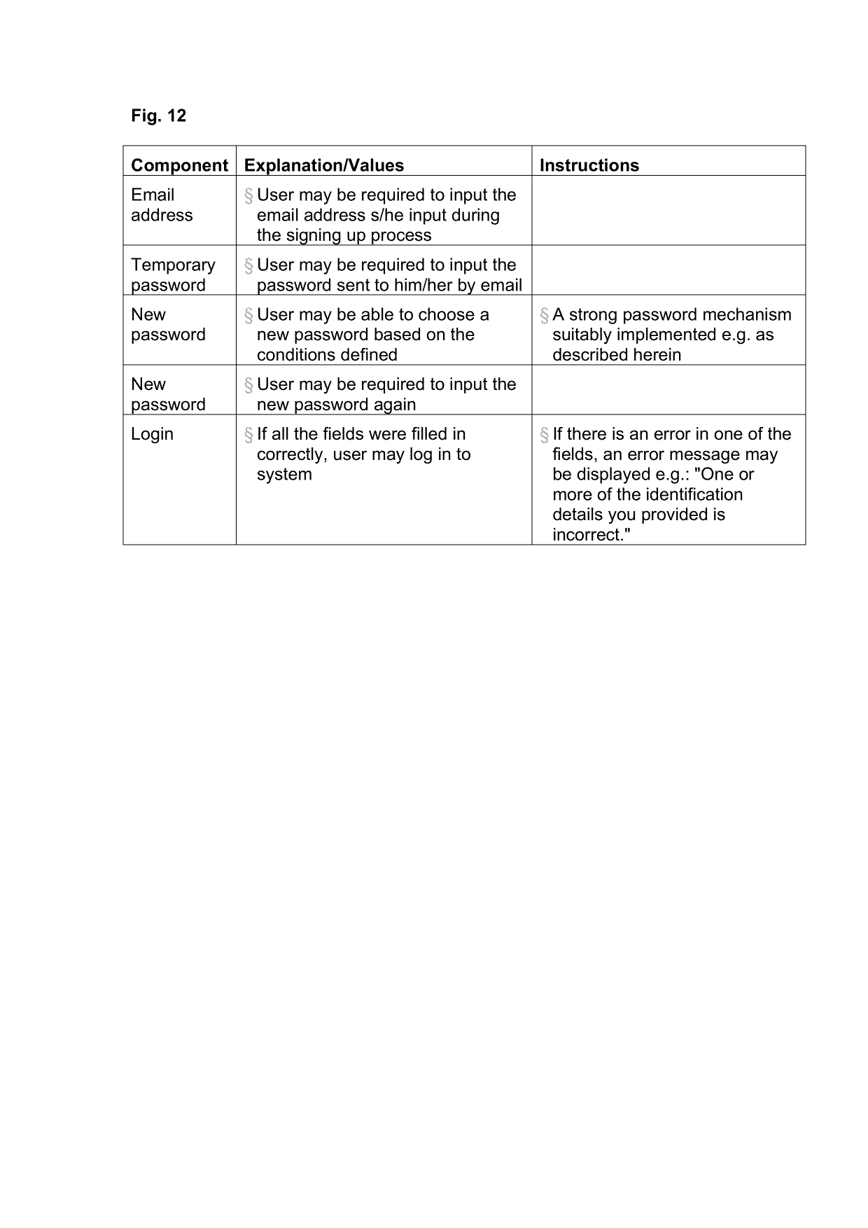

FIG. 12 is a table presenting example functional instructions pertaining to the issue of password replacement.

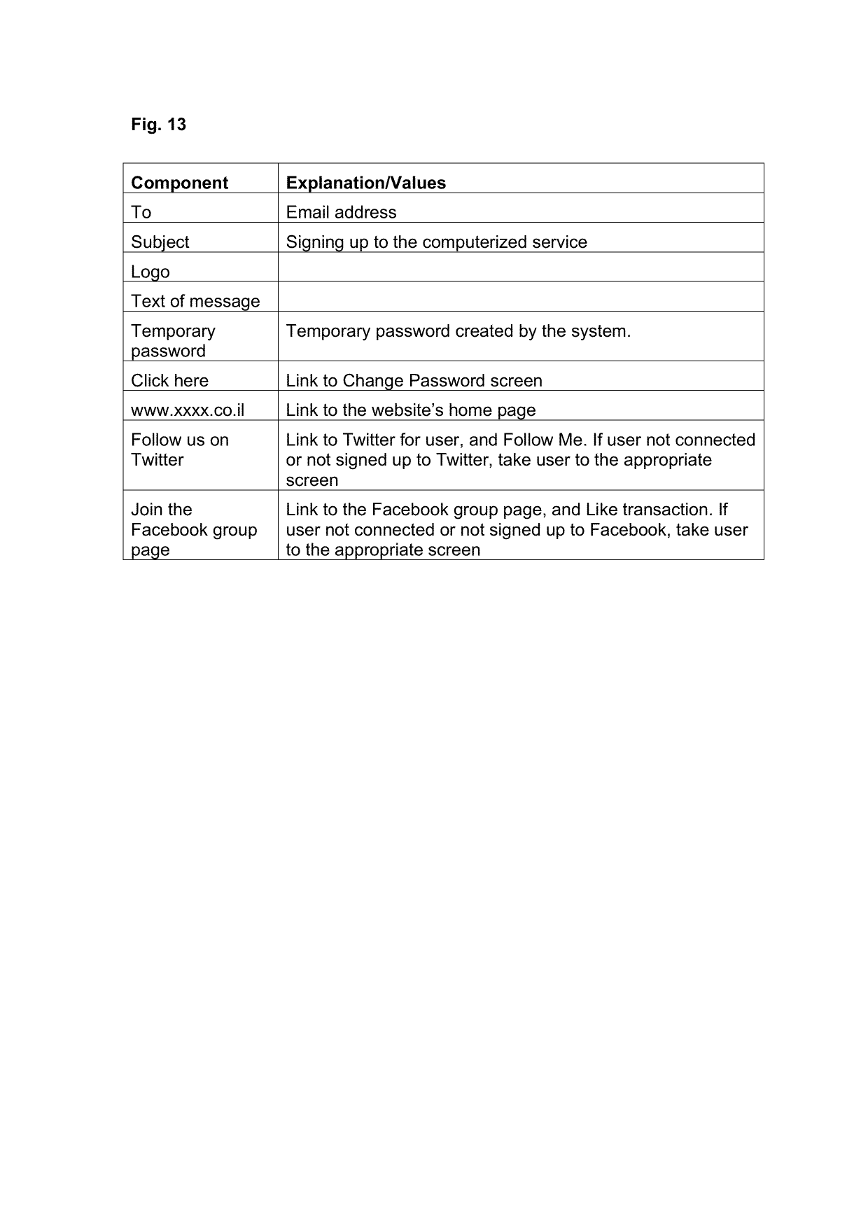

A Password recovery email message may be sent to the user, e.g. as described in the Functional instructions in the table of FIG. 13.

Preferred computerized methods for Validation of computerized organization name and handling of exceptions are now described in detail.

The signing up process may require validation of computerized organization name and may have one or more of the following characteristics:
The computerized organization's, e.g. corporation's, details may be validated in a suitable database e.g. Dun & Bradstreet, typically by a web service in real time
If the computerized organization number is not found in the database, the following message may be displayed to user: “The computerized organization number was not found. Check the number that you entered”
If user entered erroneous number twice, a message may be displayed to the user at the end of the process, and exception handling performed e.g. as described below in detail
Every new user may be subjected to a credit check performed by a qualified entity e.g. Dun & Bradstreet. If, say, the computerized organization does not have a single controlling shareholder (check with D & B (e.g.) if this computerized organization type is indicated), a check may be run on the computerized organization; a computerized organization whose score is higher than a specified parameter may pass smoothly; however, if the computerized organization score is lower than a specified parameter, an alert may be issued to the back office to run an in-depth check and authorize the account. In the case of a computerized organization that has a single controlling shareholder and in the case of a licensed dealer, the check may be run with D & B (e.g.) at the level of the individual based on the shareholder's ID Card no. All the checks may be run in an automated manner in real time via a web service.
   Exception handling may be provided and may include any or all of the following functionalities:
A user who feeds in a computerized organization number or name not found in the Dun & Bradstreet (e.g.) database may still be able to proceed with the signing up process.
An alert may be sent simultaneously to the management system
The system administrator may receive the alert and may be required to conduct the validation manually vis a viz the Dun & Bradstreet (e.g.) database
If the information is found manually, the user may be able to use system
If the information is not found manually, the system administrator may approach the contact who was input during the signing up processes.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an transaction, a product, a service or any other information described herein that impacts, in a positive manner, a problem or objectives described herein; and (b) outputting the solution.

The contents of a permanent application framework which may be displayed throughout all the queries and the information presented in the system is now described. The contents may include some or all of the following:
Logo
Personal appeal to the user—“Hello <User Name>, your last log in to the system: <Date> at <Time>”
Message indicator—indicates the number of messages not read by the user. A click on the link takes the user to the “Messages and Alerts” query
Top navigation—the list of topics in the system. Selecting a specific tab changes the navigation bar on the right and also changes the appearance of the selected tab.
Exit—Selecting the Exit option displays a pop-up window—“Are you sure that you want to exit from the system?”<Yes> <No>
The bottom bar—includes links to the website pages which may open in a new window. It is appreciated that the illustrated embodiment is not intended to be limiting and in particular, there may of course be other indicators for security and collaborations

An entry screen may be displayed for signed up users. The contents of the screen may vary e.g. according to the type of user and the user authorizations and may for example include some or all of the following elements:

### Incoming Payments:

List of the most recent incoming payments received and confirmed by beneficiary.
The list may display a maximum of the five (say) most recent incoming payments.
If there are no incoming payments, the table title may be displayed in addition to the text “No incoming payments for display. You can send a request for payment to customers”, plus the button “Send request for payment”.
If there are more than five incoming payments in the system, a link to “Additional incoming payments” may be displayed, which may point to the query “Incoming payments received”.
Moving the mouse over the Additional Information icon may display a window including the details for the means of the incoming payment (tool tip behavior).
The table may be sorted according to credit date—from the nearest date to the most distant date.
Next to incoming payments for which earlier payment has not been requested, an “Earlier” transaction button may be displayed. Clicking it may display additional information about an incoming payments query, in which a request can be made for an earlier credit date.

### Outgoing Payments:

The most recent list of outgoing payments sent and that have been confirmed for receiving by beneficiary
The list may display a maximum of the five most recent outgoing payments.
If there are no outgoing payments, the table title may be displayed in addition to the text “No payments for display. You can send an outgoing payment to customers”, plus the button “Send outgoing payment”.
If there are more than five outgoing payments in the system, a link to “Additional outgoing payments” may be displayed, which may point to the query “Outgoing payments sent”.
Moving the mouse over the Additional Information icon may display a window with the details of the means of the outgoing payment (tool tip behavior).
The table may be sorted according to debit date—from the nearest date to the most distant date.
Alongside outgoing payments whose debit date has not been deferred, the “Defer” transaction button may be displayed. Clicking it may display additional information on the outgoing payments sent query, in which the debit date can be deferred.

### Pending Requests:

This query may display all the requests awaiting handling in the system, e.g. according to authorizations.
The list may display a maximum of the five most recent requests awaiting handling.
If there are no pending requests, the table title may be displayed in addition to the text “No pending requests for display”.
If there are more than five pending requests in the system, a link to “Additional requests” may be displayed, which may point to the “Pending requests” query.
The list may be sorted by request date—from the nearest date to the most distant date.
Examples of request types, some or all of which may be provided, are listed in the table of FIG. 14a.

### Account Summary:

This area may display a summary of the user's activity for the current month.
Total outgoing payments for the current month—link to the Send Outgoing Payment transaction
Total incoming payments for the current month—link to the Send Request for Payment transaction
Balance—incoming payments less outgoing payments for the current month—link to an additional transaction (loan)
Credit line—link to credit line management tool
Customer type—link to account management tool

The system tree, e.g. as described in FIG. 14b, may be identical for all user types. A user who is not authorized to execute a transaction or to view certain information may receive an appropriate alert:
User type limit (for example: Basic User type who tries to access a Send Outgoing Payment transaction)
   This transaction is typically not available to a Basic User type.
   In order to execute a “Send Outgoing Payment”, you are requested to upgrade your User type.
   To update a User Type, click here or click the Tools menu.
Authorization limit (for example: a View Only user who tries to access a Send Outgoing Payment transaction).
   This transaction is typically not available to users defined as View Only.
   In order to execute a “Send Outgoing Payment”, you are requested to upgrade your authorizations.
   To upgrade your level of authorization, click here or click the Tools menu.
Usage Purpose limit (for example: Incoming Payment Only that tries to access a Send Outgoing Payment transaction).
   This transaction is typically not available for the Usage Purpose defined in the system: Incoming Payment Only.
   In order to execute a “Send Outgoing Payment”, you are requested to update the Usage Purpose in the system.
   To update the Usage Purpose, click here or click the Tools menu.

Various actions exist pertaining to an outgoing payment/incoming payment in the system, e.g. some or all of those set out in the table of FIG. 15. These are now described in detail.

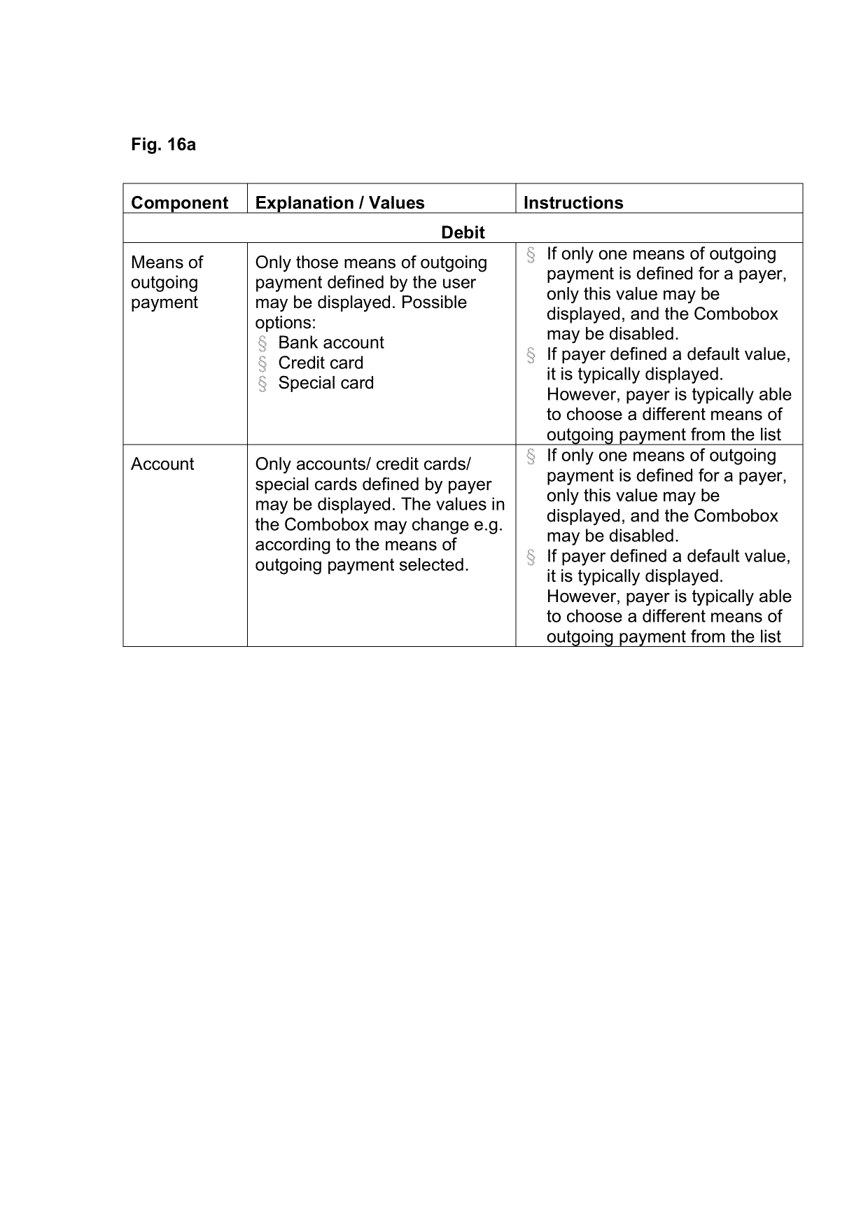

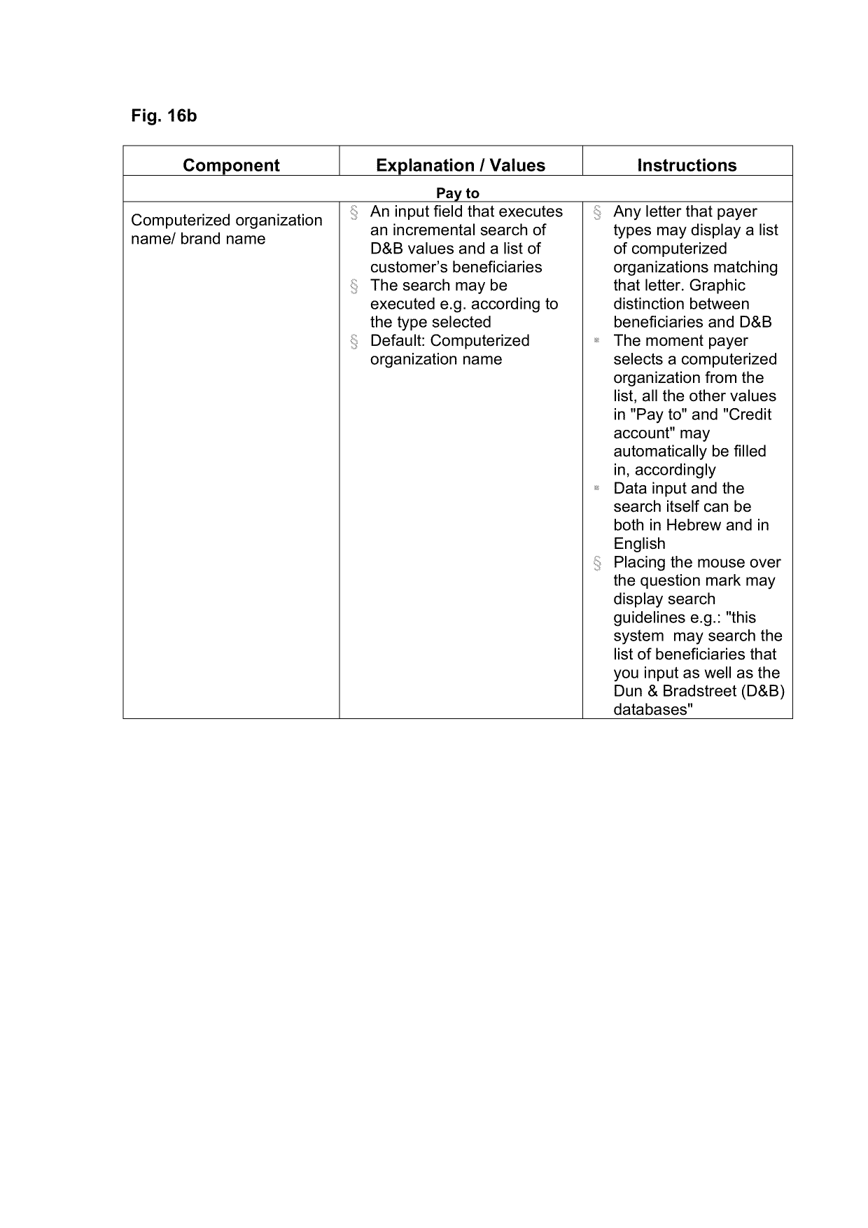

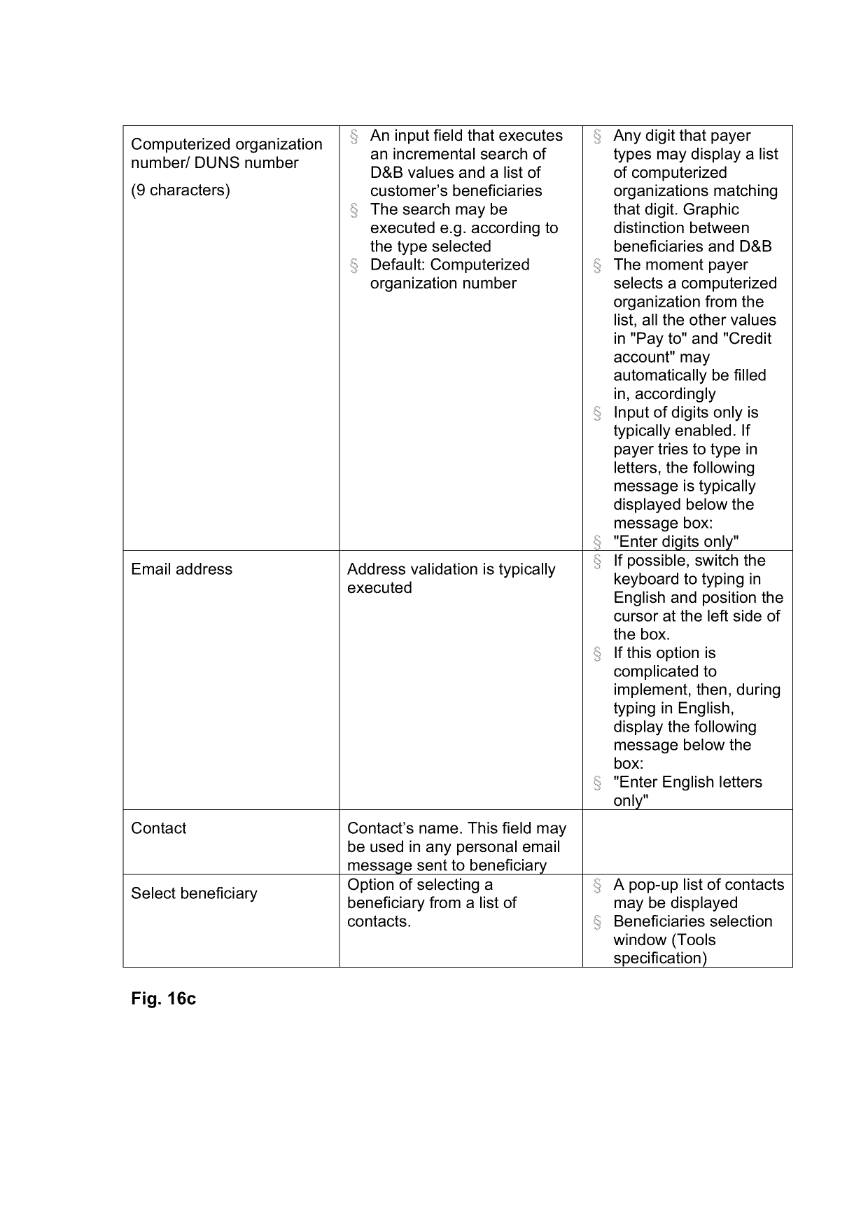

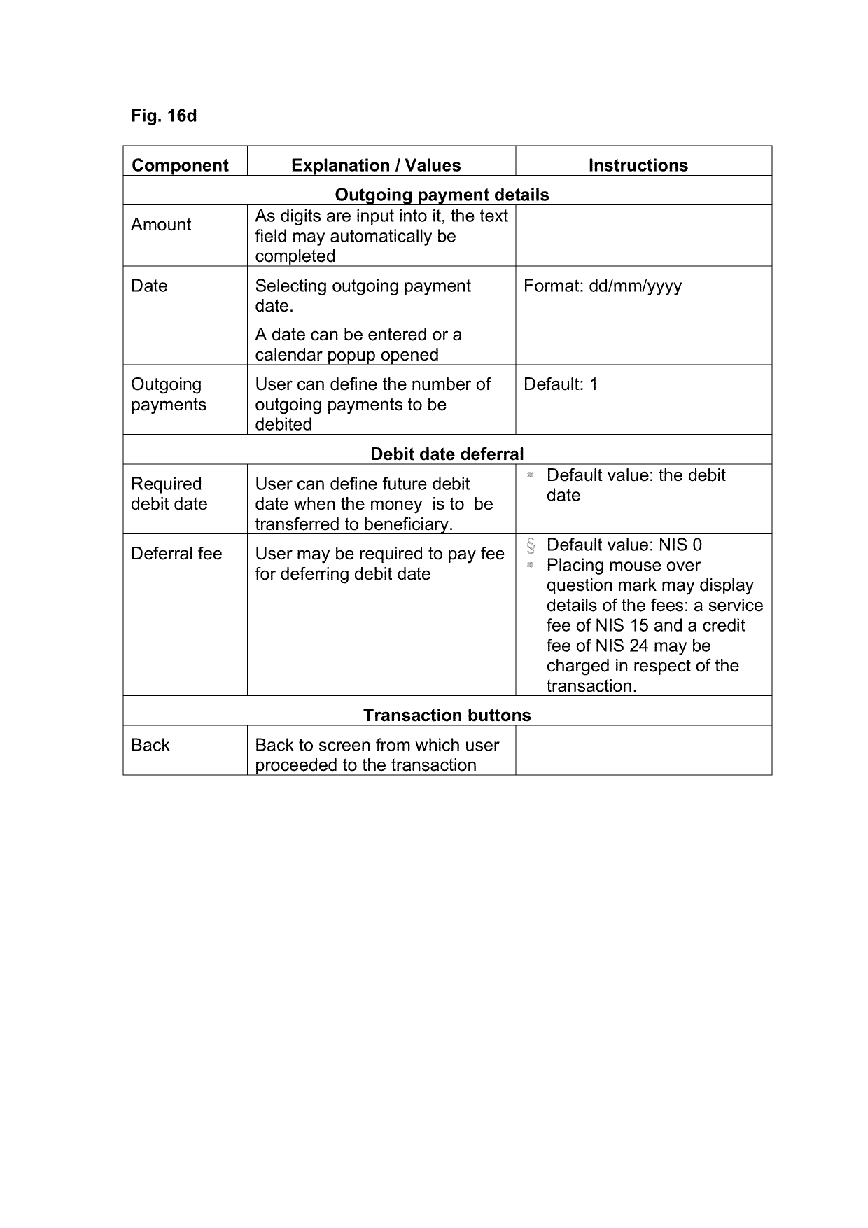

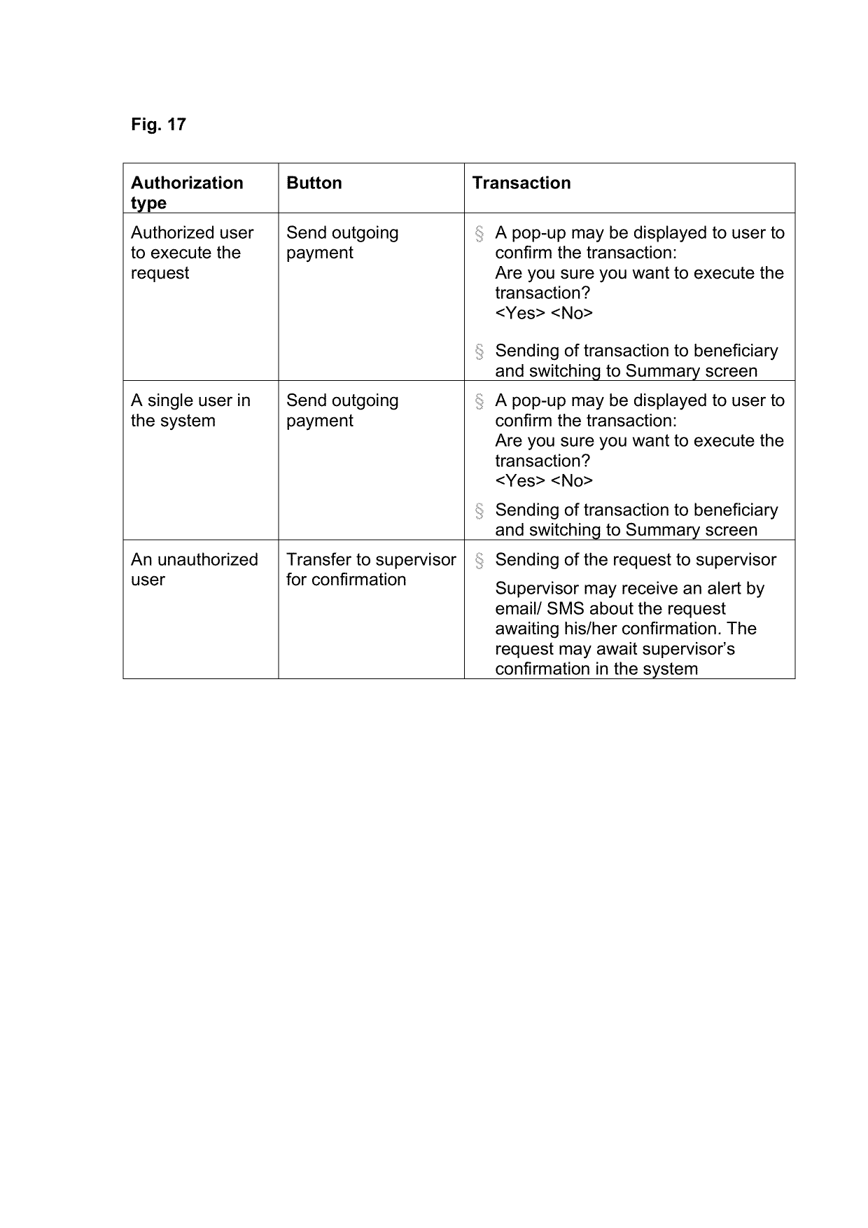

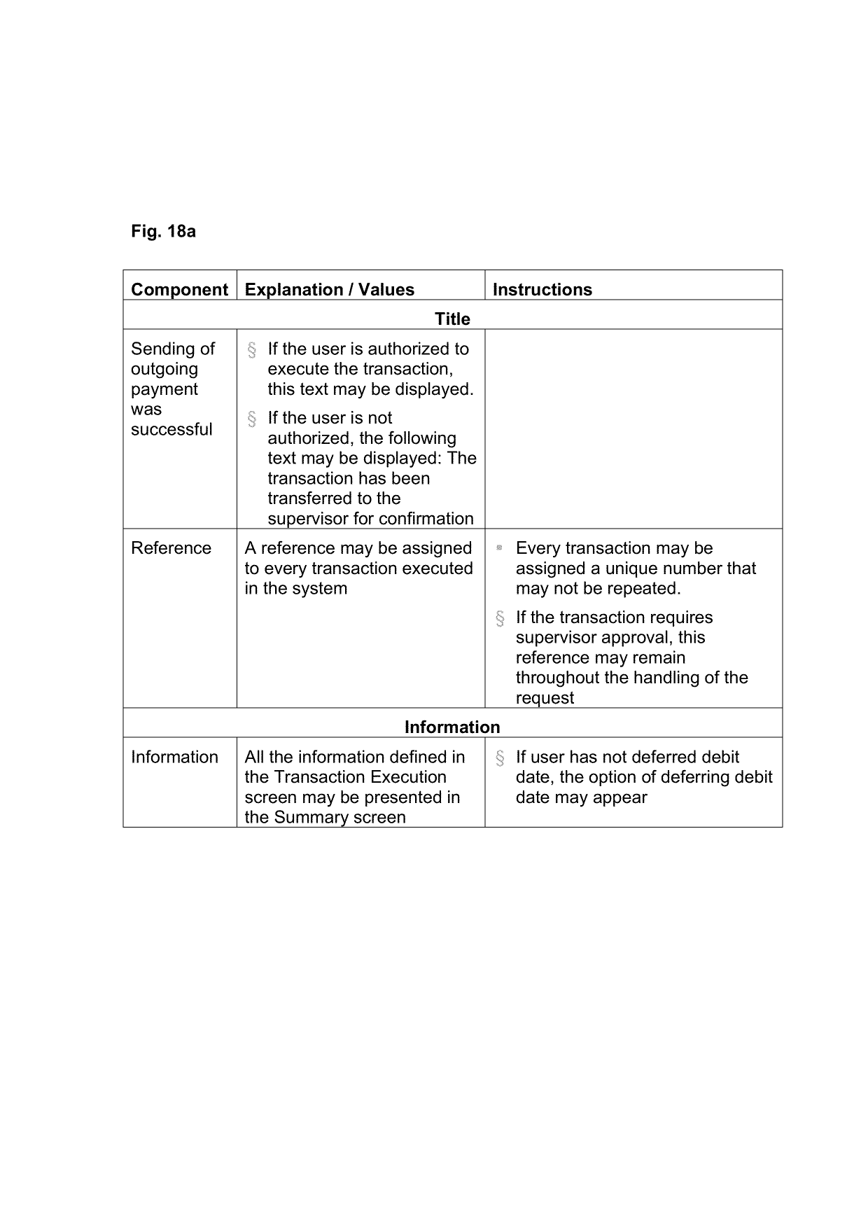

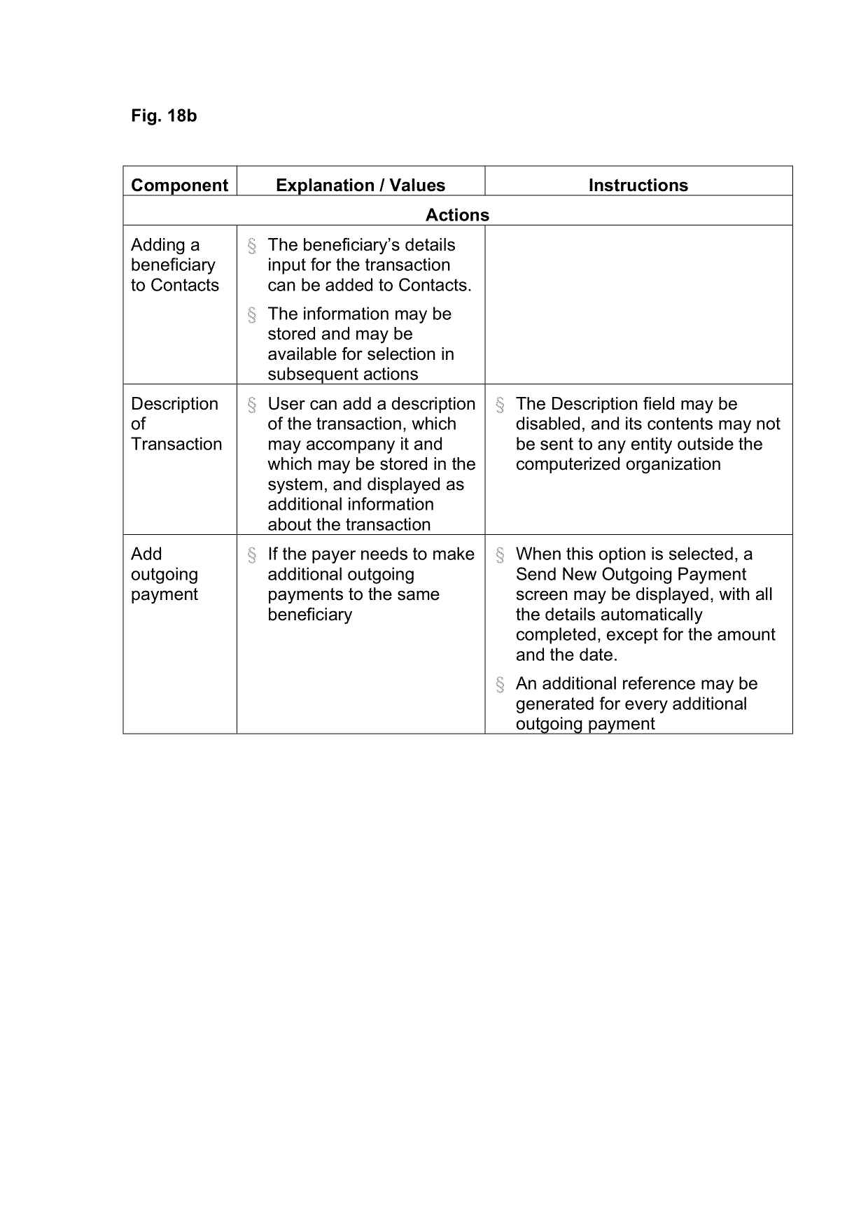

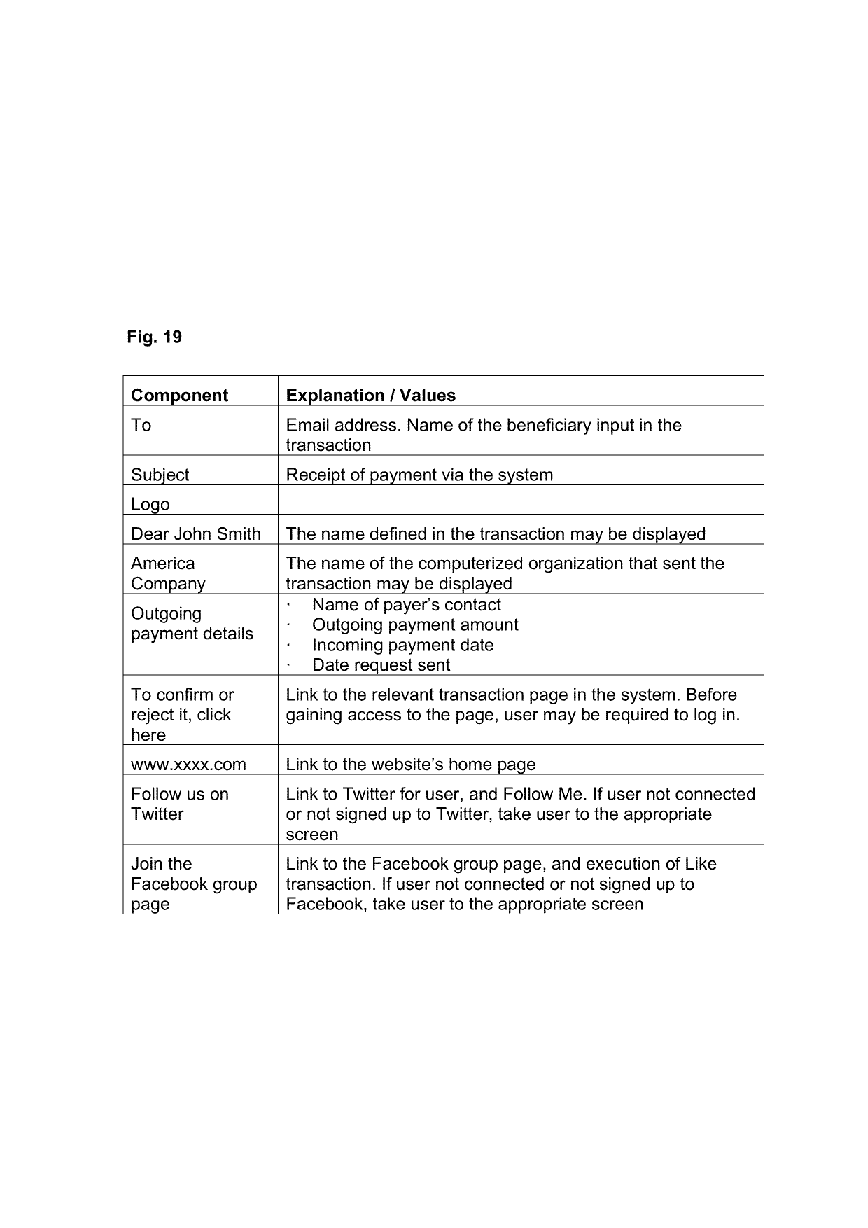

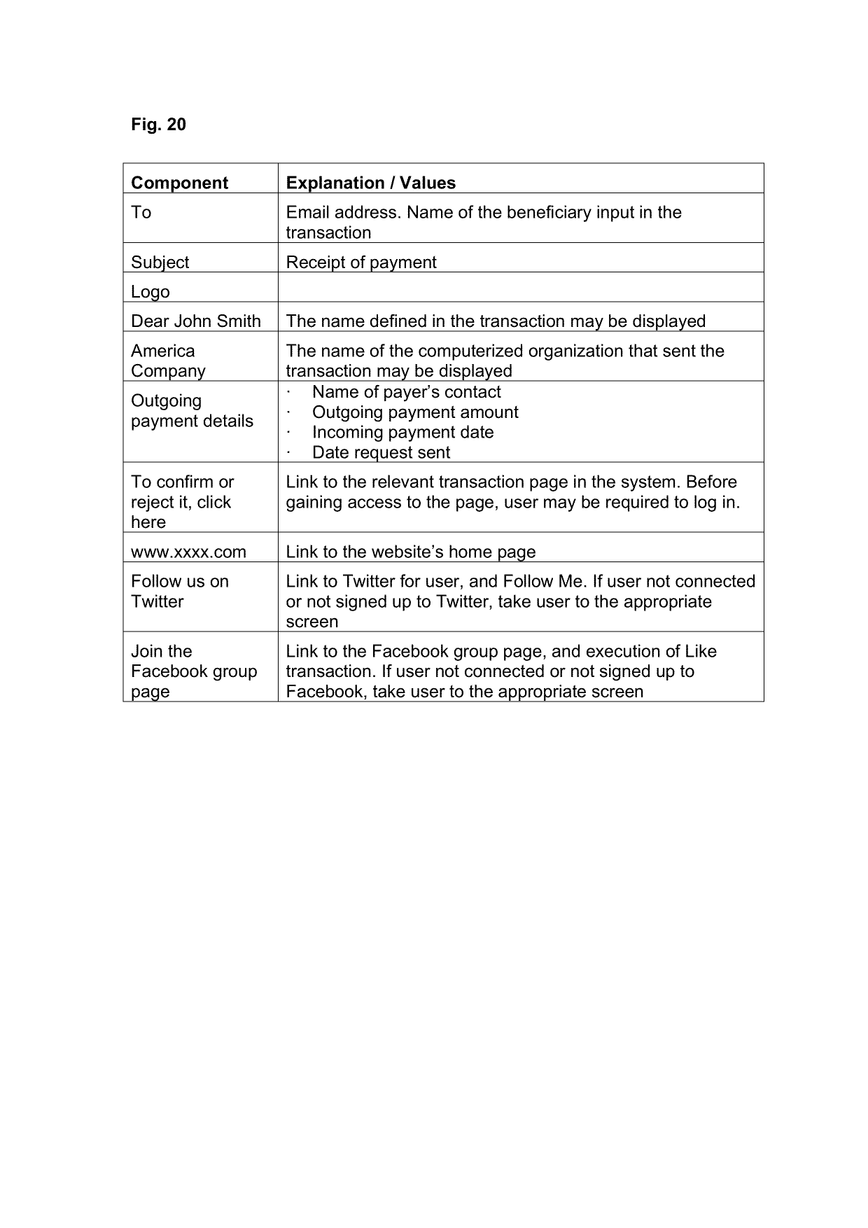

a. Sending an Outgoing Payment:
The process for sending an outgoing payment may comprise the following screens:
Transaction Details Definition
Transaction Details Summary
   In addition, a beneficiary may be sent an email notification of the execution of the outgoing payment. There may be two versions of the email message:
A user who is signed up to the system of the present invention
A user who is not signed up to the system of the present invention
   Up to a limit, e.g. three, email messages may be sent to the beneficiary in respect of the transaction:
Email message at the time of execution of the transaction
Email reminder after X days—if beneficiary has not signed up to the system of the present invention
Email reminder after Y days—if beneficiary did not sign up to the system of the present invention after the first reminder
   A suitable Transaction Details Definition screen may be provided.
Functional instructions are set out in the table of FIG. 16a.
Transaction execution authorizations are typically defined in the system and are typically supported, e.g. as shown in the table of FIG. 17.
   A suitable Transaction Details Summary screen may be displayed.
If no deferral was defined in the Transaction Details screen a suitable notification may be provided. Functional instructions in this connection may be as set out in the tables of FIGS. 18a-18b.
   A suitable Email message to a signed up user may be sent.
      Functional instructions in this connection may be as set out in the table of FIG. 19.
      A suitable Email message may be sent to a user who is not signed up.
      Functional instructions in this connection may be as set out in the table of FIG. 20.
      b. Receiving of Incoming Payment

The process of receiving an incoming payment may comprise the following screens:
Confirmation/rejection/requesting earlier payment of an incoming payment
Transaction Details Summary
   In addition, an email message may be sent to payer at the end of the transaction. There may be two versions of the email message:
Email message confirming receiving of payment
Email message rejecting receiving of payment

A suitable Receiving of Incoming Payment screen may be displayed.

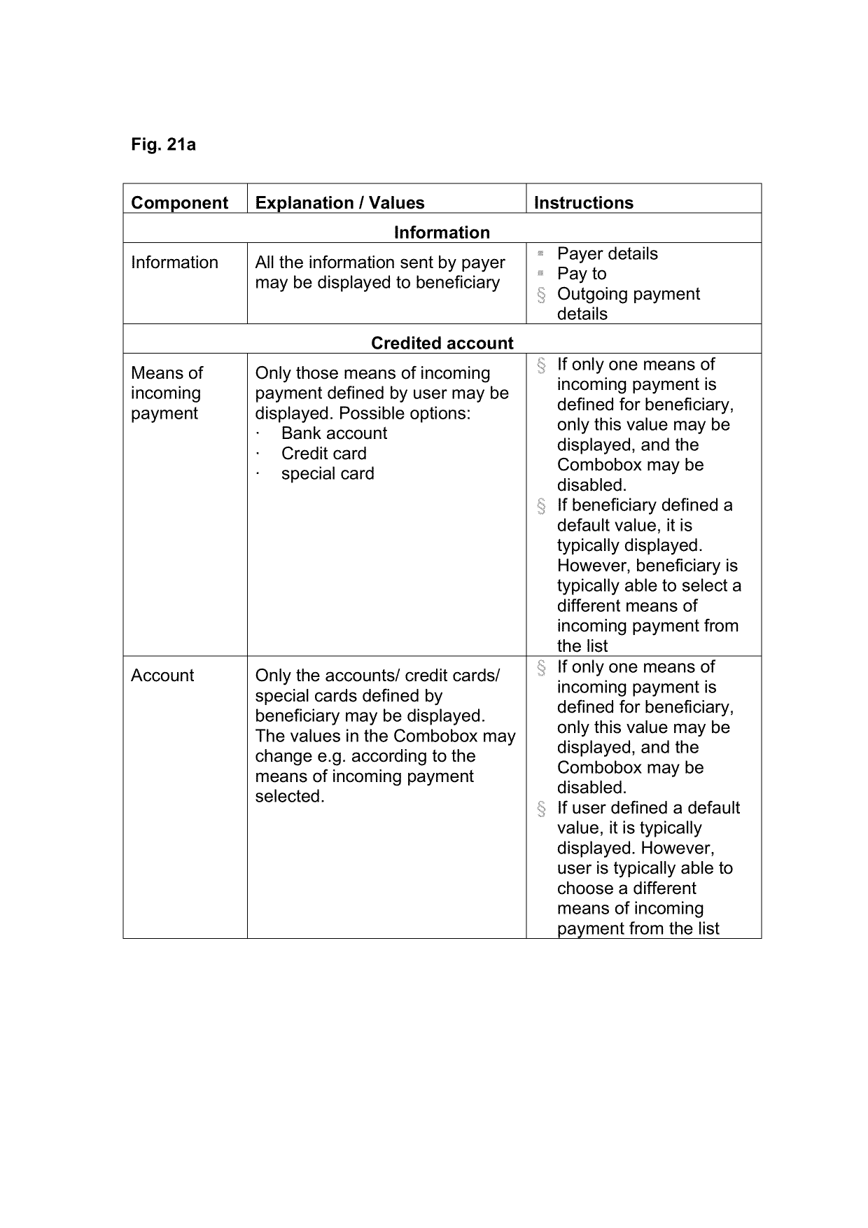

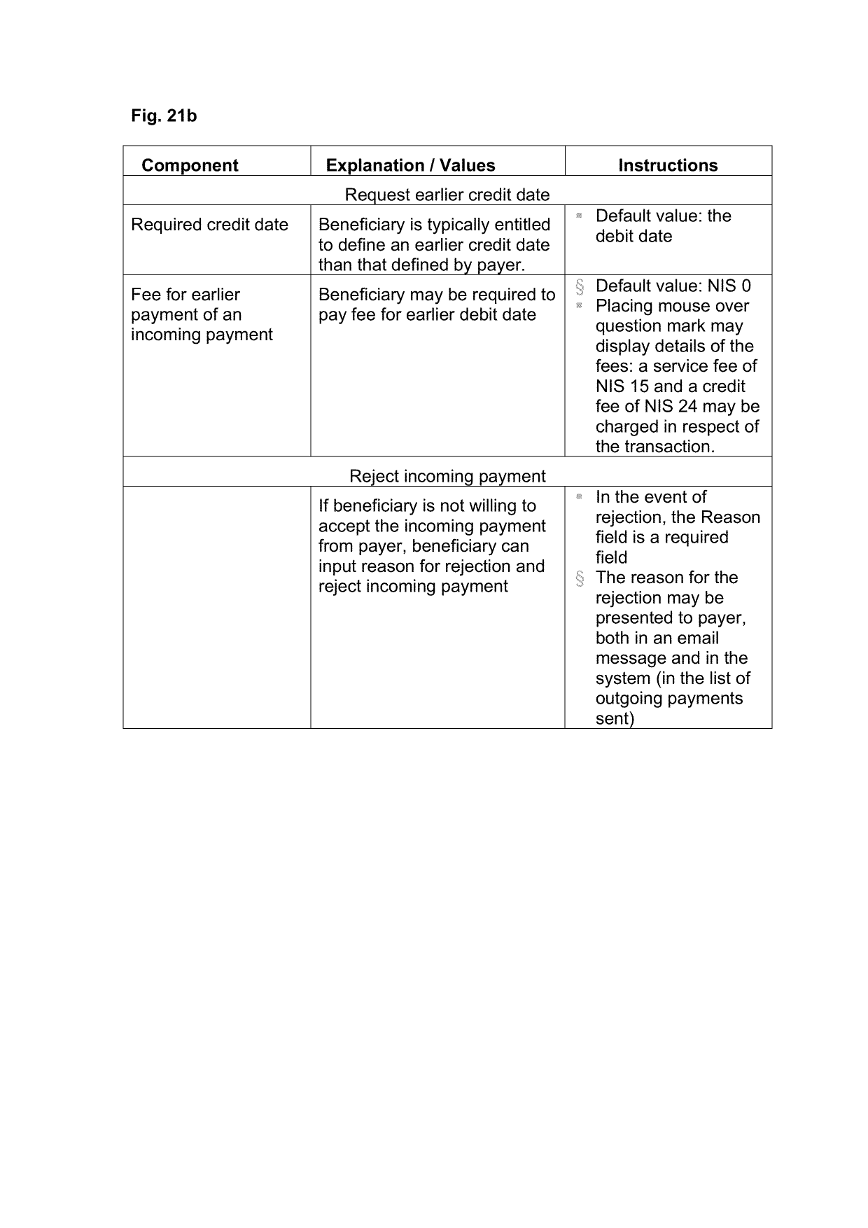

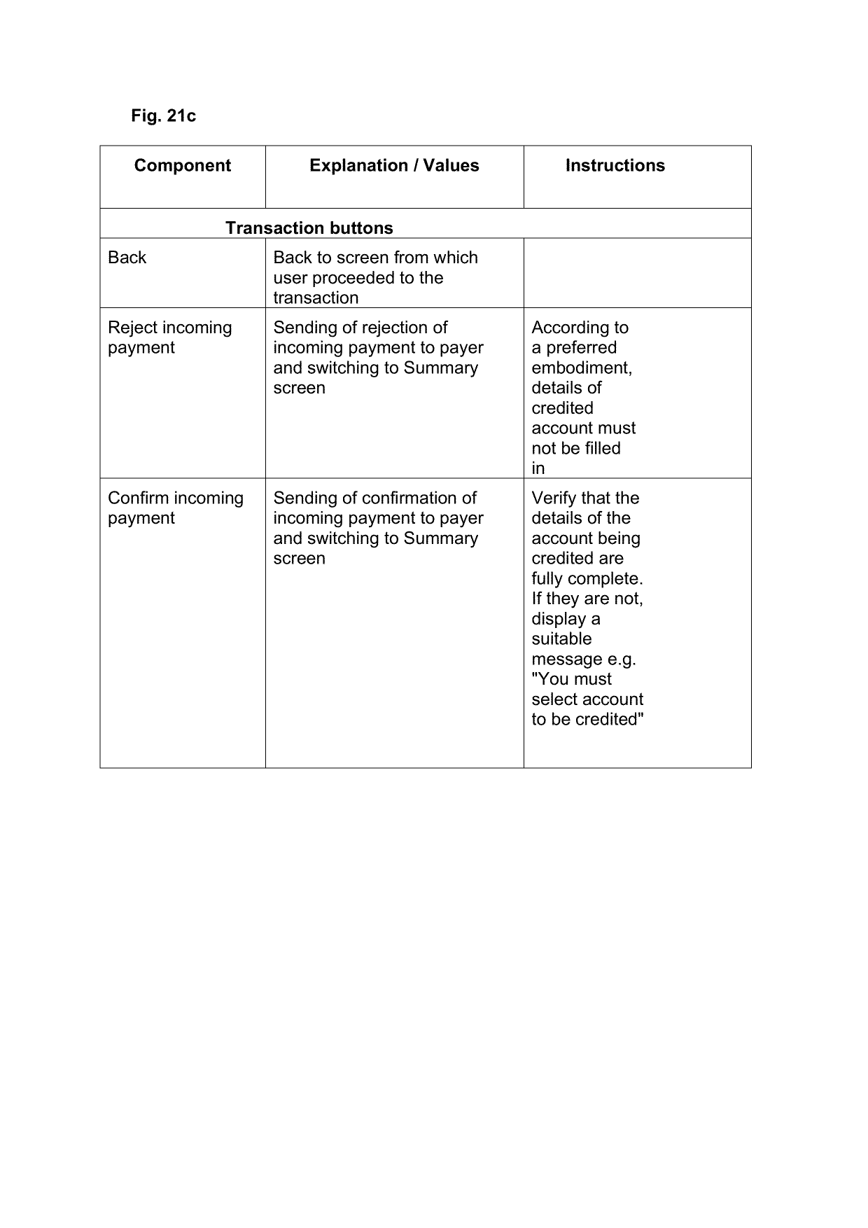

Functional instructions in this connection may be as set out in the tables of FIGS. 21a-21c.

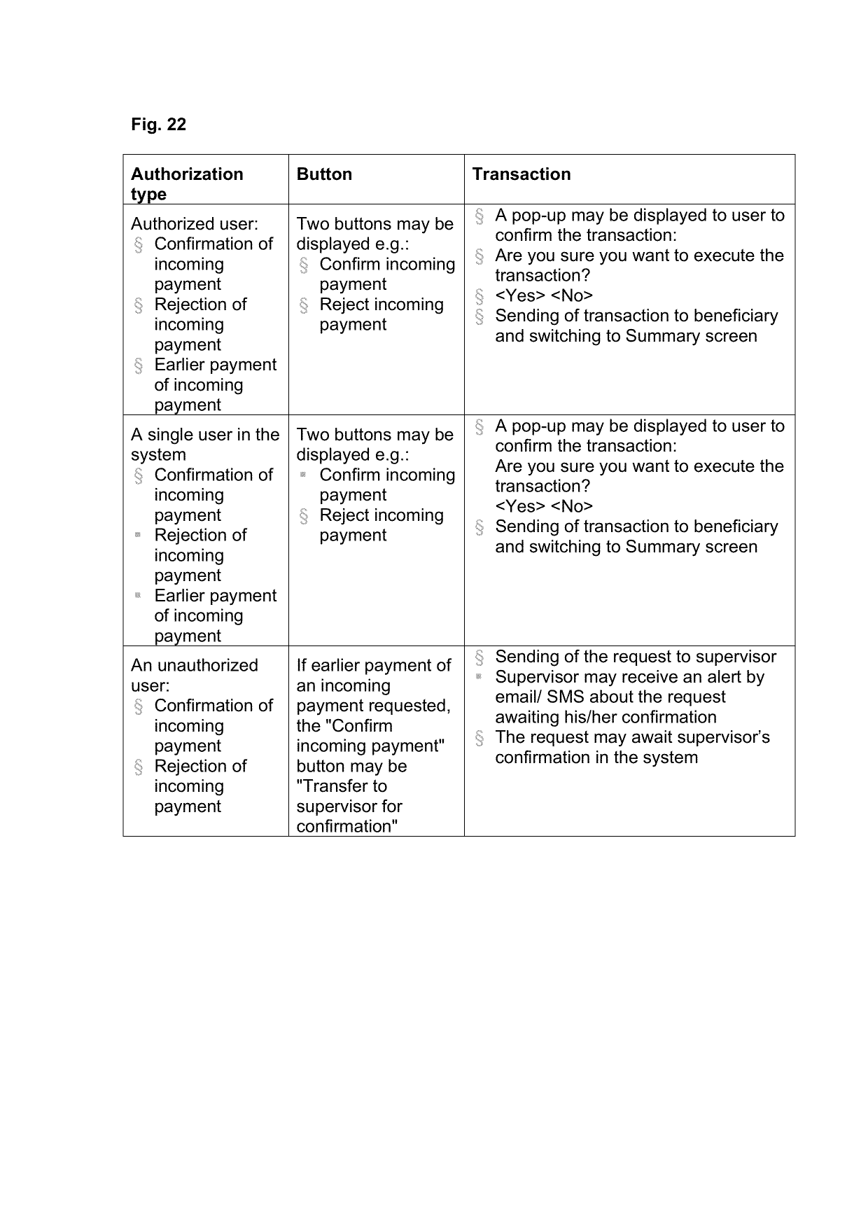

Transaction execution authorizations may be defined in the system and are typically supported e.g. as set out in the table of FIG. 22.

A suitable screen for Confirmation of Receiving of Incoming Payment may be displayed.

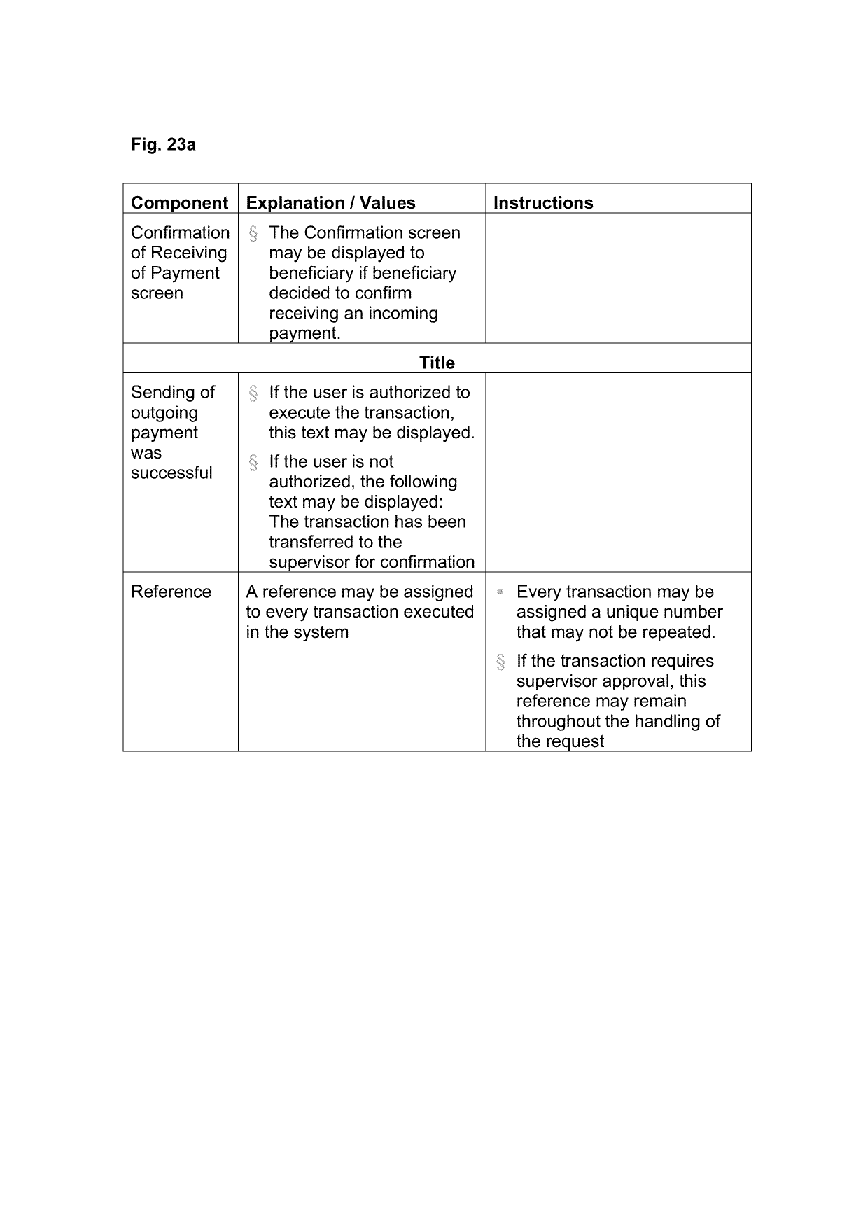

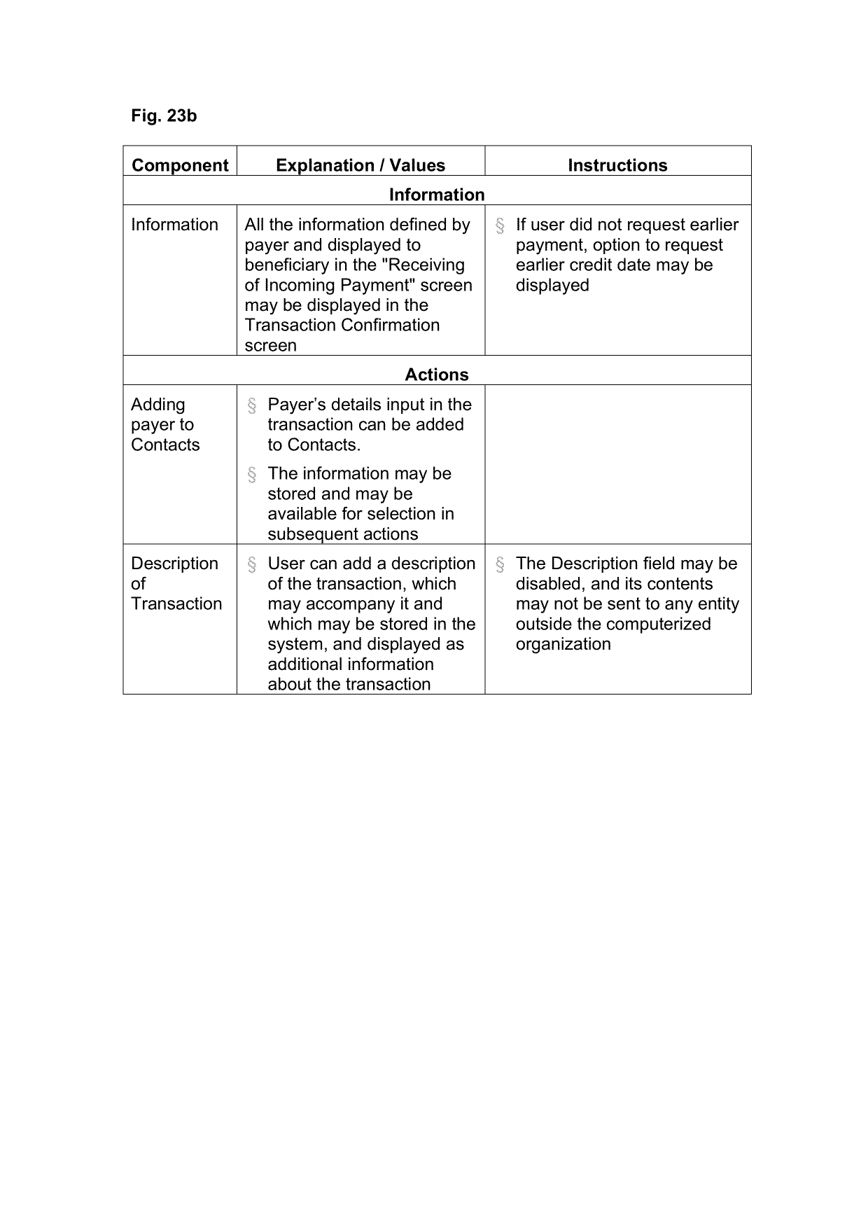

If an earlier credit date was not requested in the transaction screen, suitable notification may be provided. Functional instructions in this connection may be as set out in the tables of FIGS. 23a-23b.
A suitable Rejecting Receiving of Payment screen may be displayed.

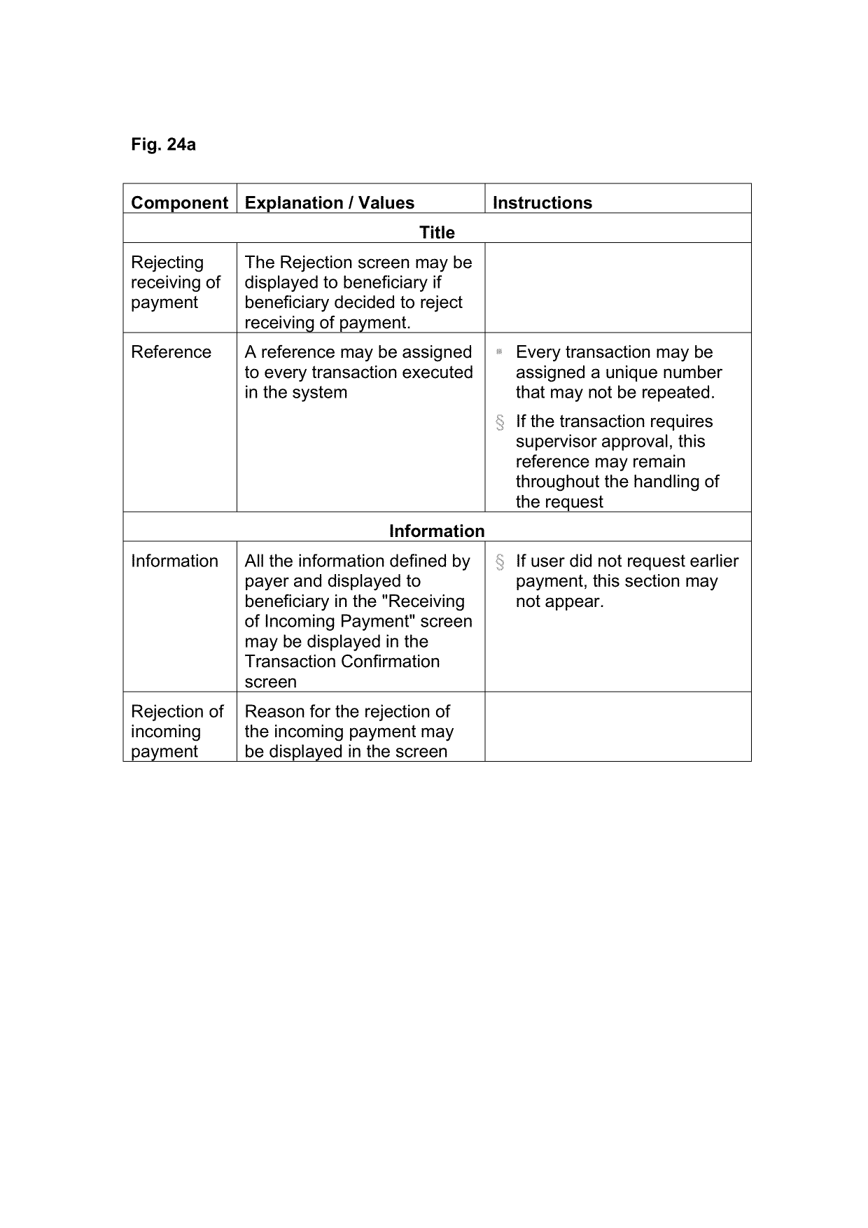

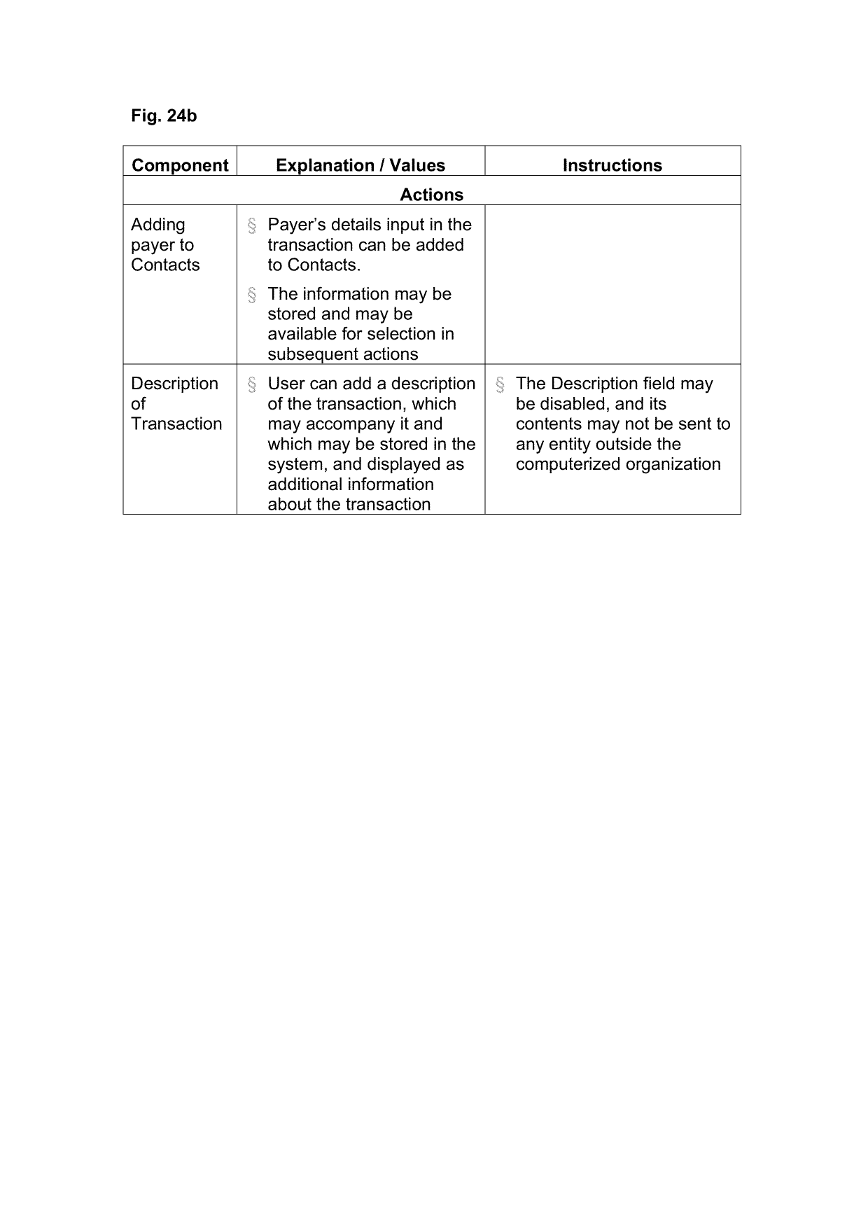

Functional instructions in this connection may be as set out in the tables of FIGS. 24a-24b.

A suitable Email message to payer confirming receiving of incoming payment may be sent.

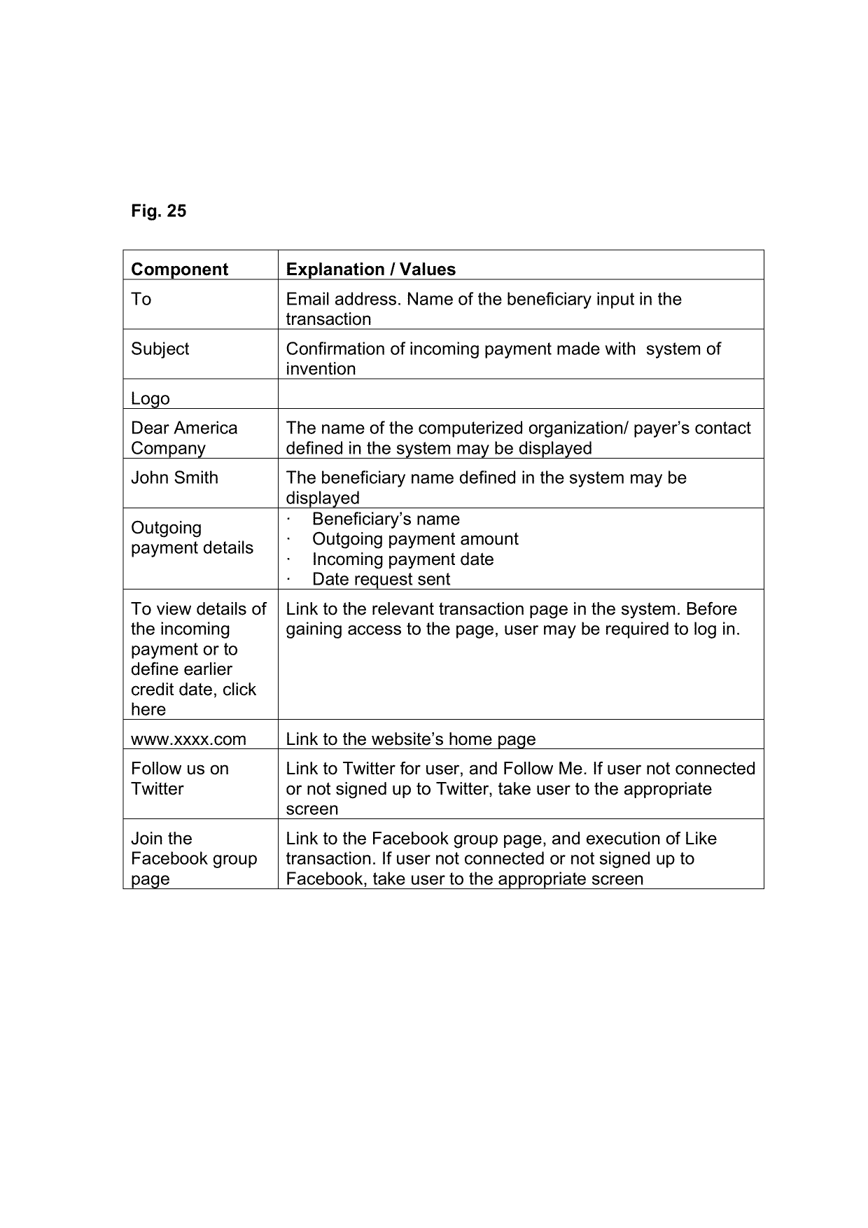

Functional instructions in this connection may be as set out in the table of FIG. 25.

A suitable Email message to payer rejecting receiving of incoming payment may be sent.

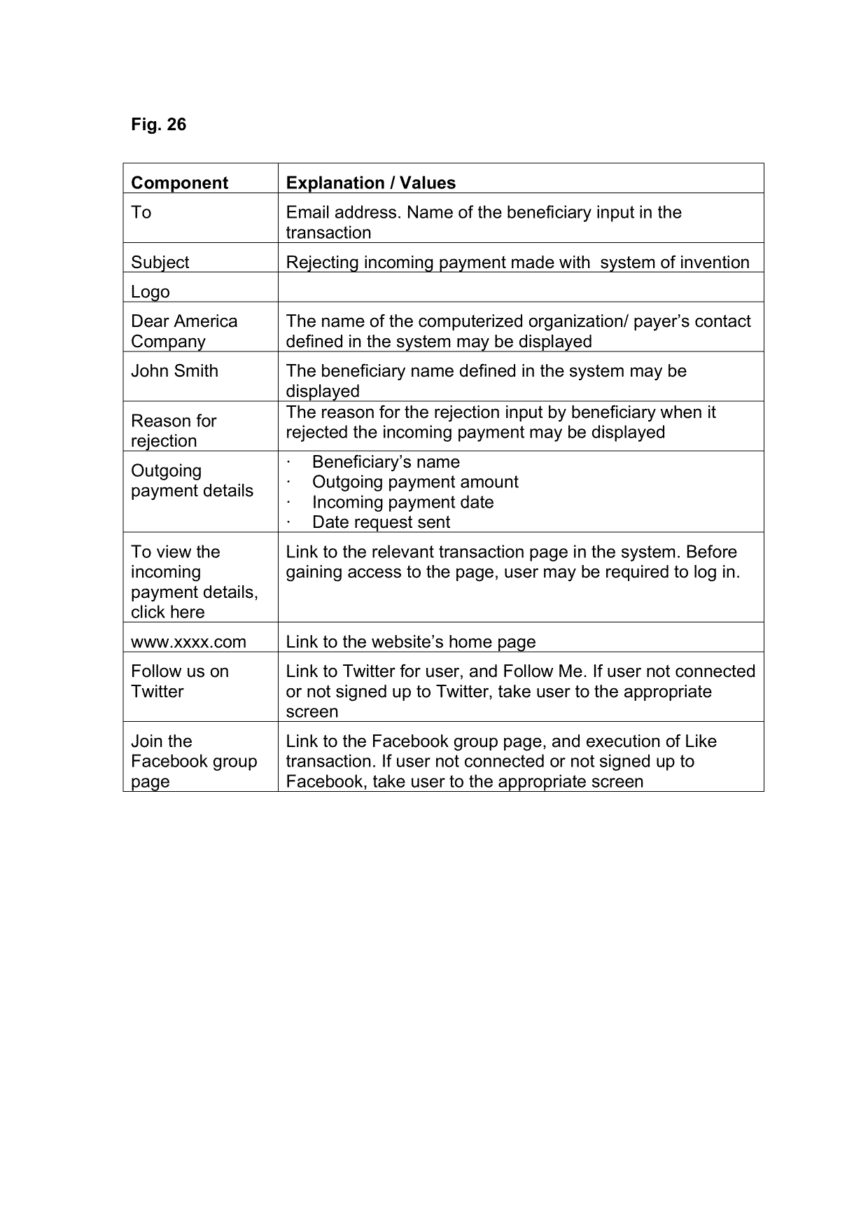

Functional instructions in this connection may be as set out in the table of FIG. 26.

c. Sending a Request for Payment

The process for sending a request for payment may comprise the following screens:
Transaction Details Definition
Transaction Details Summary

In addition, an email message may be sent to payer to notify it about the request for payment. There may be two versions of the email message:
A user who is signed up to the system of the present invention
A user who is not signed up to the system of the present invention

Up to three (say) email messages may be sent to the payer in respect of the transaction:
Email message at the time of execution of the transaction
Email reminder after X days—if payer has not signed up to the system of the present invention
Email reminder after Y days—if payer did not sign up to The system of the present invention, after the first reminder

A suitable Transaction Details Definition screen may be displayed.

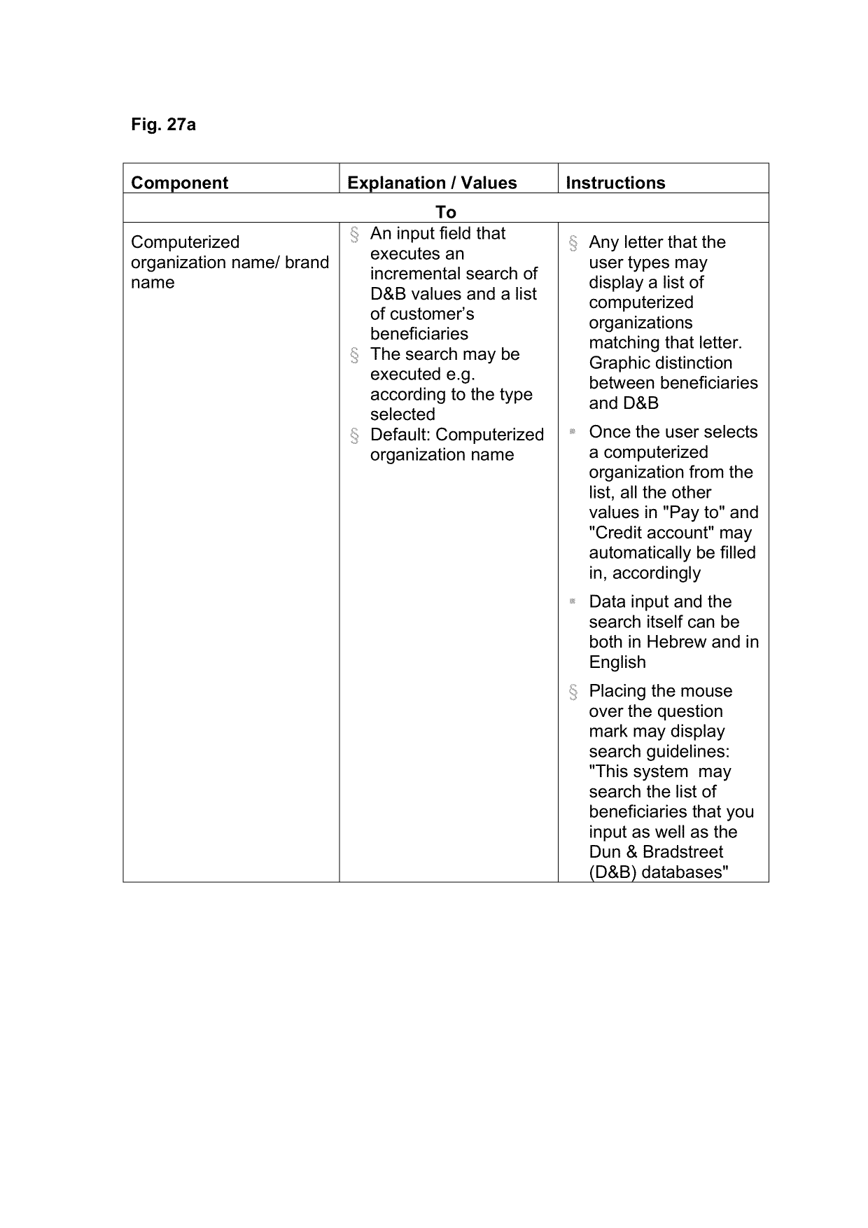

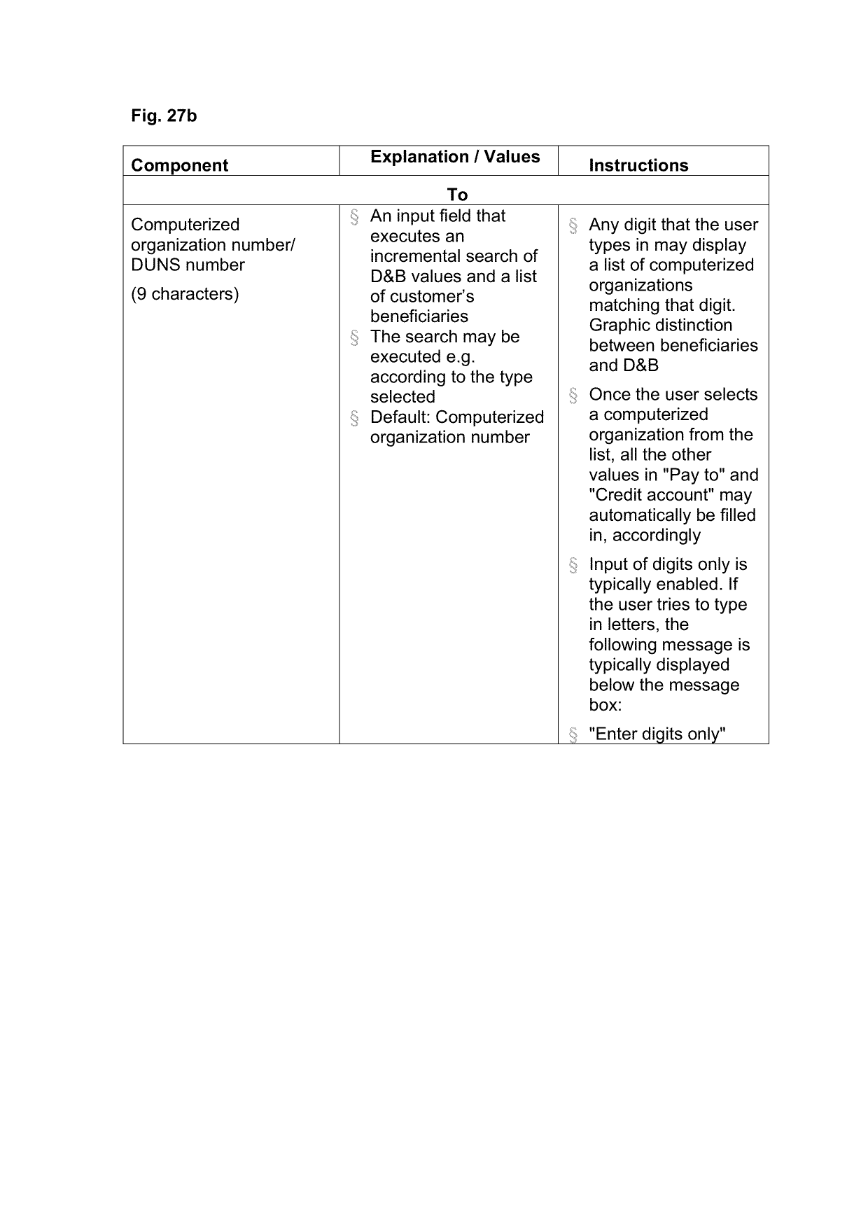

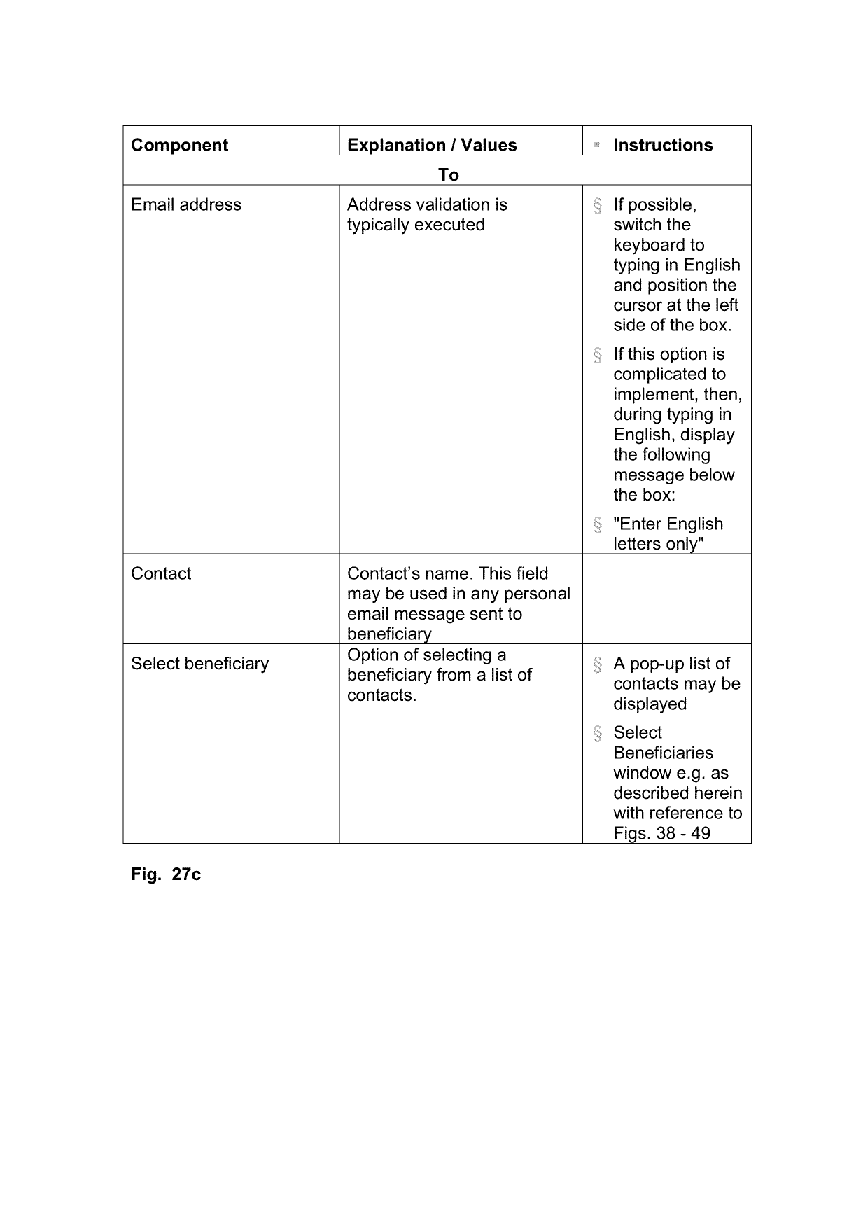

Functional instructions in this connection may be as set out in the tables of FIGS. 27a-27b.

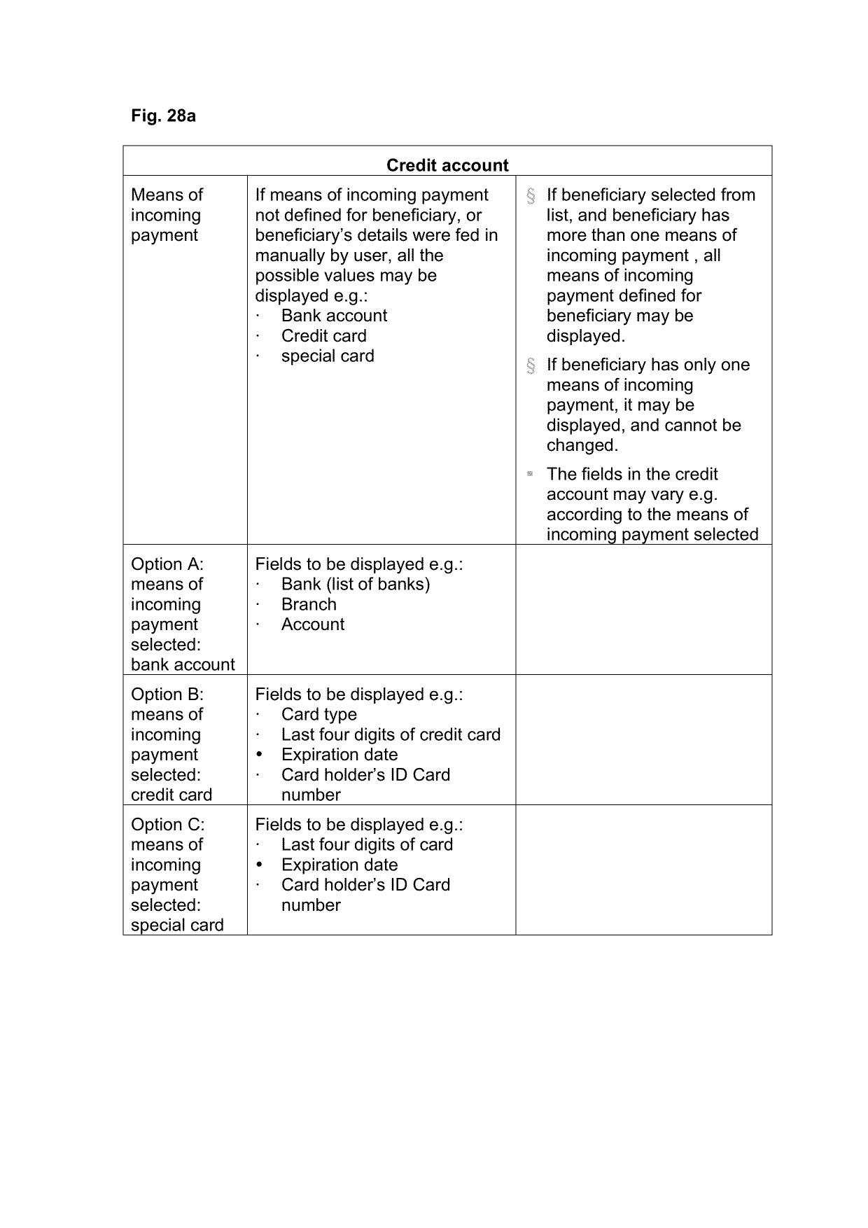

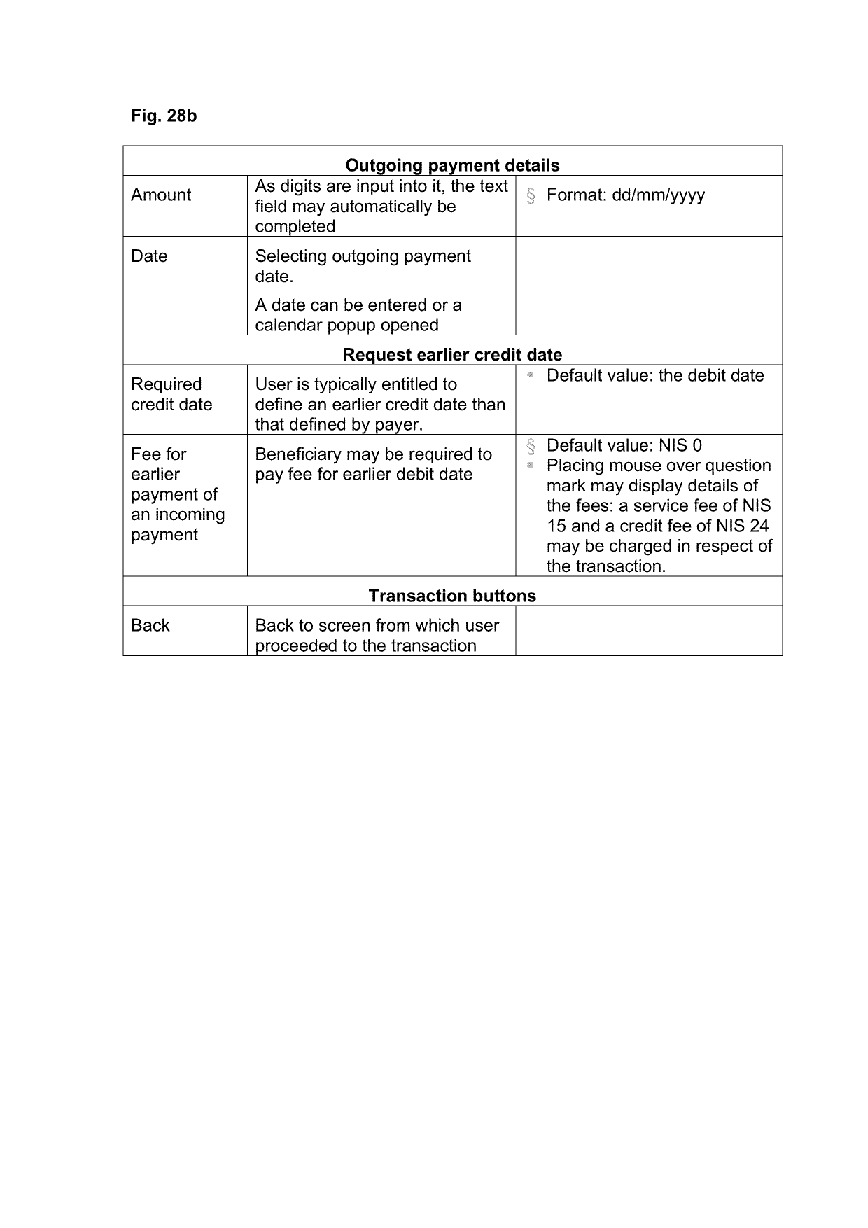

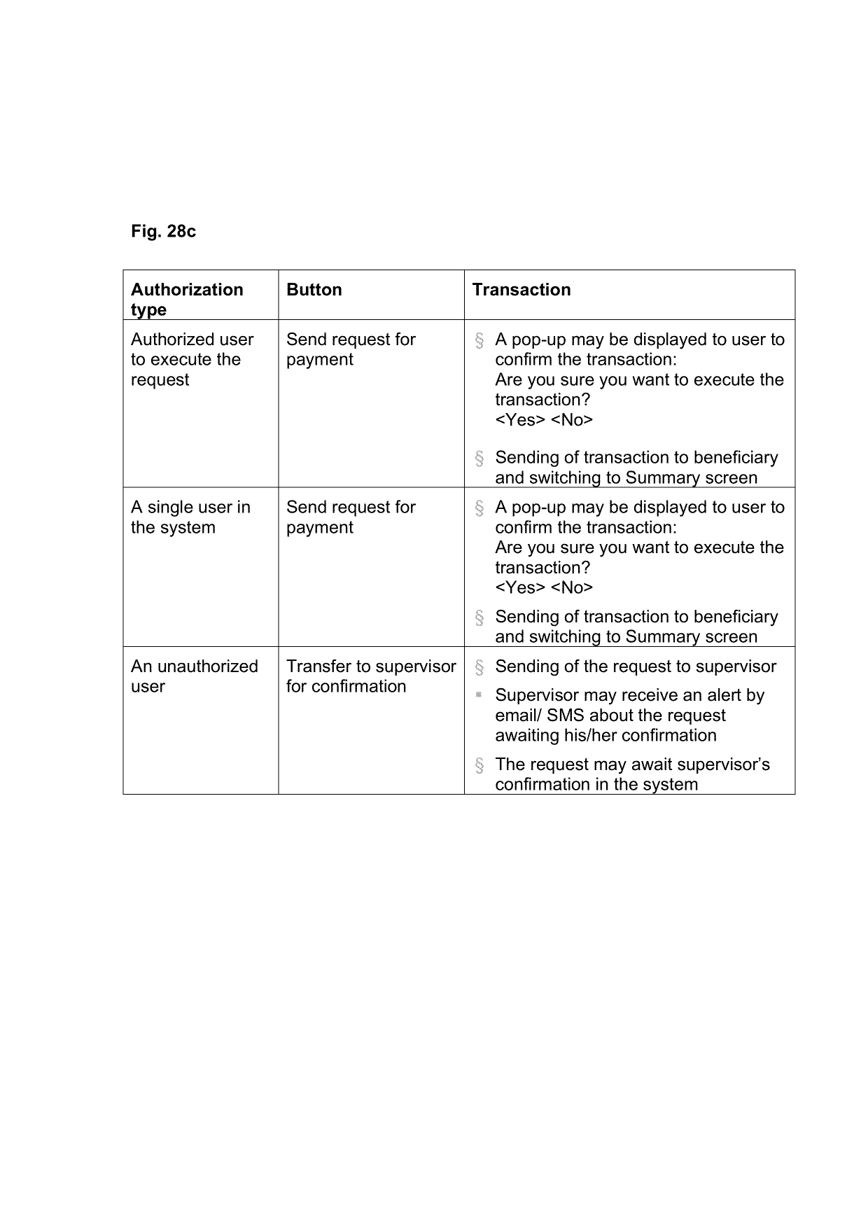

Transaction execution authorizations may be defined in the system and are typically supported, e.g. as set out in FIG. 28c.
A suitable Transaction Details Summary screen may be displayed.

If an earlier credit date was not requested in the transaction screen, a suitable notification may be provided.

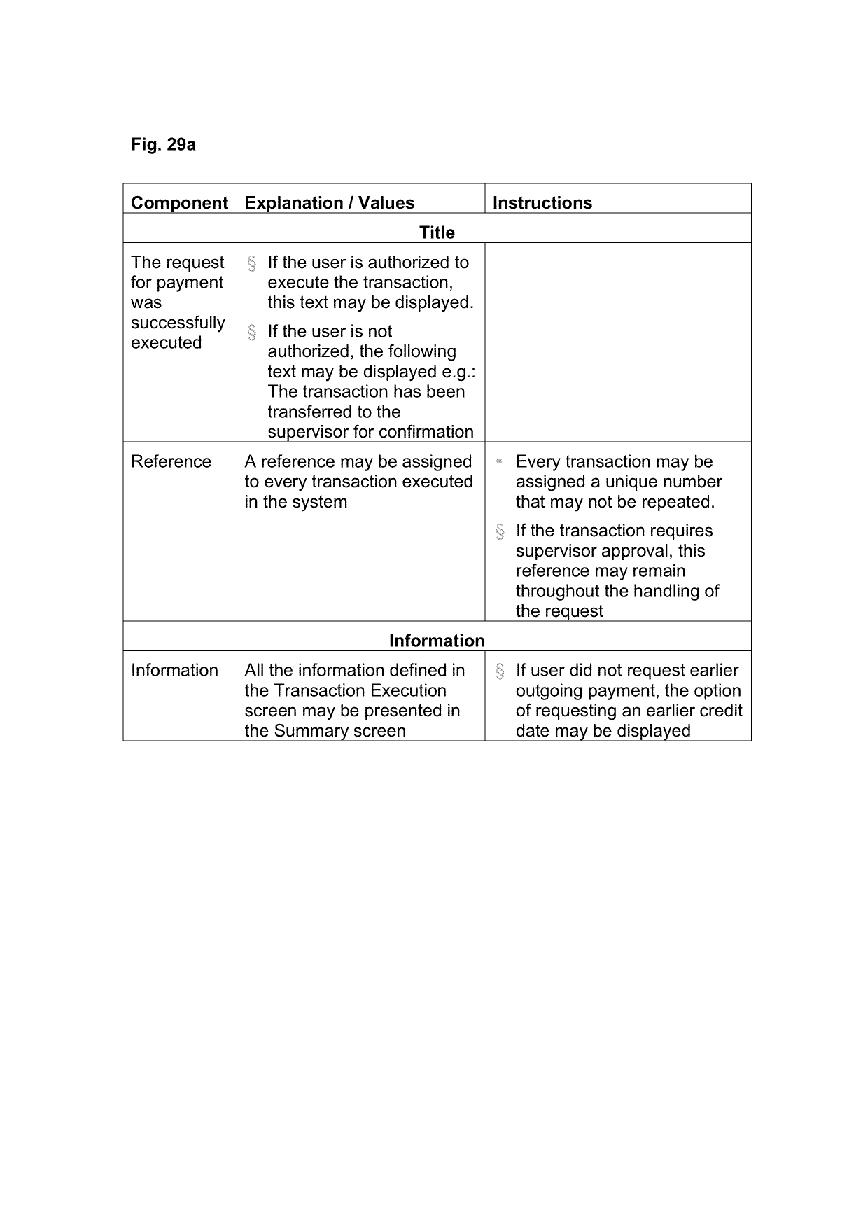

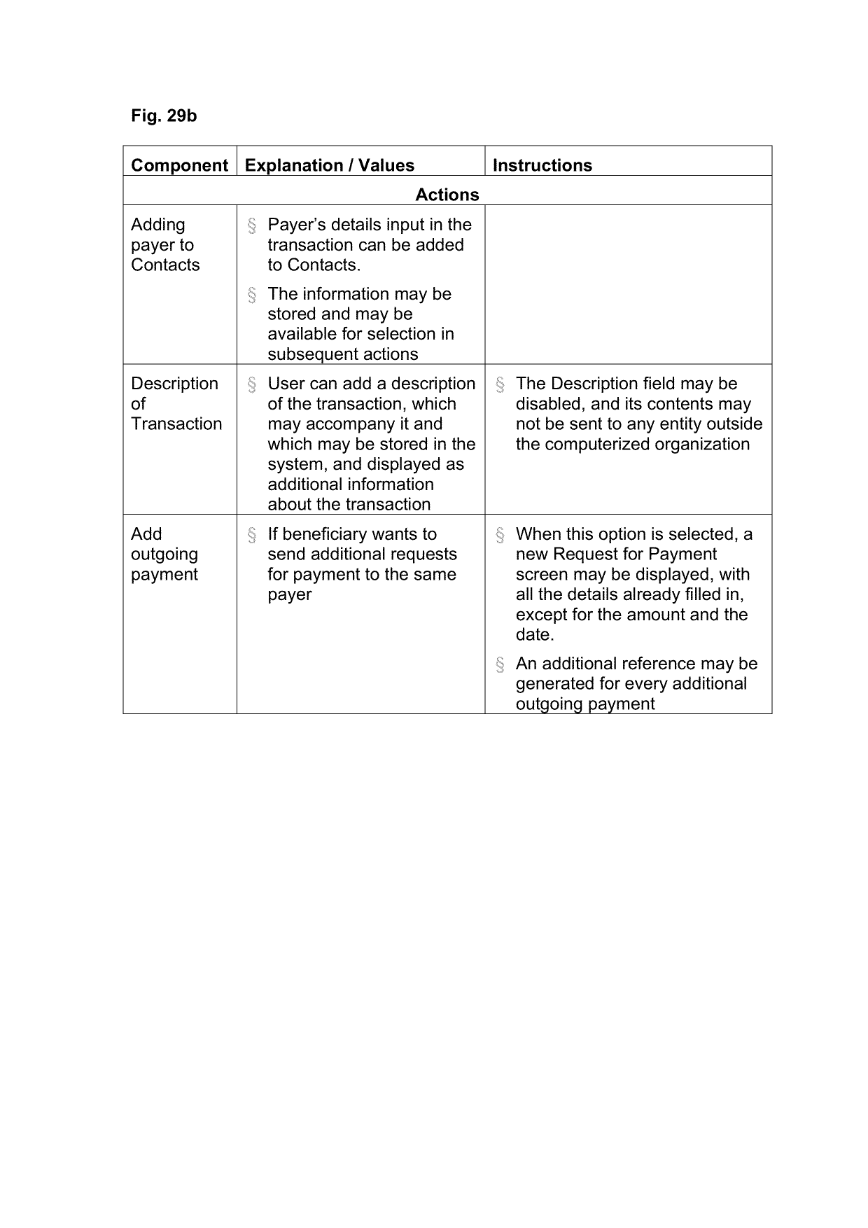

Functional instructions in this connection may be as set out in the table of FIGS. 29a-29b.

A suitable Email message to a signed up user may be sent.

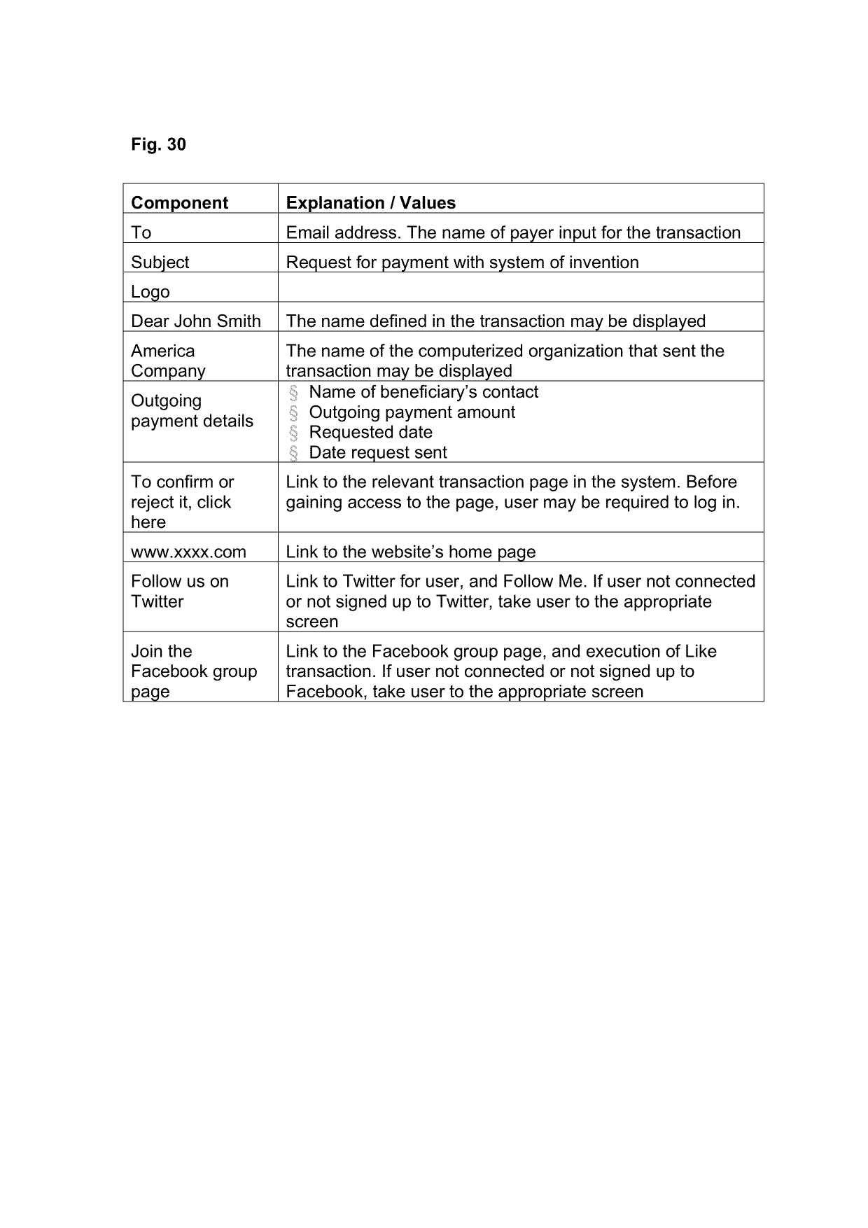

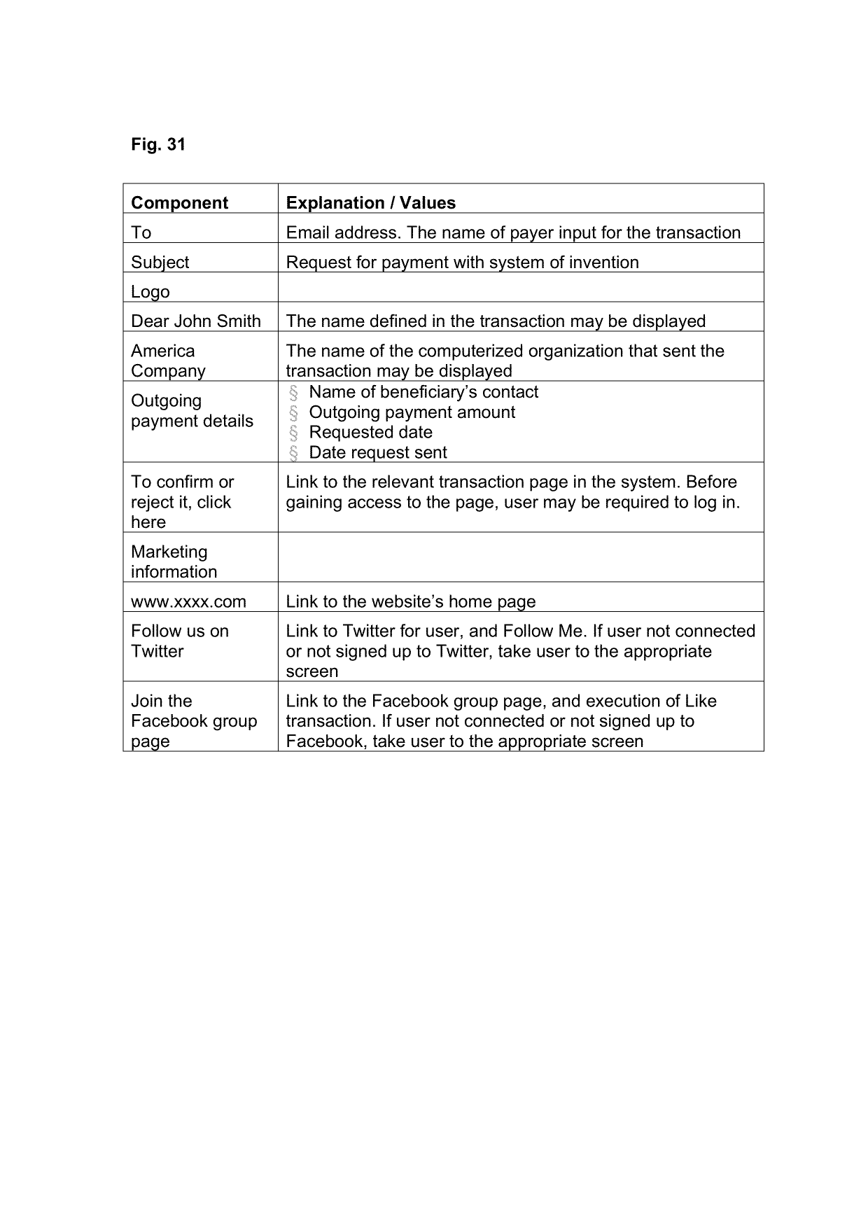

Functional instructions in this connection may be as set out in the table of FIG. 30.
A suitable Email message to a user who is not signed up may be sent.

Functional instructions in this connection may be as set out in the table of FIG. 31.

d. Receiving a Request for Payment

The process of receiving a request for payment may comprise the following screens:
Confirmation/rejection/deferral of the payment date of the incoming payment
Transaction Details Summary

In addition, an email notification may be sent to beneficiary at the end of the transaction. There may be two versions of the email message:
Confirmation of outgoing payment execution email
Rejection of outgoing payment execution email
   A suitable Receiving a Request for Payment screen may be displayed.

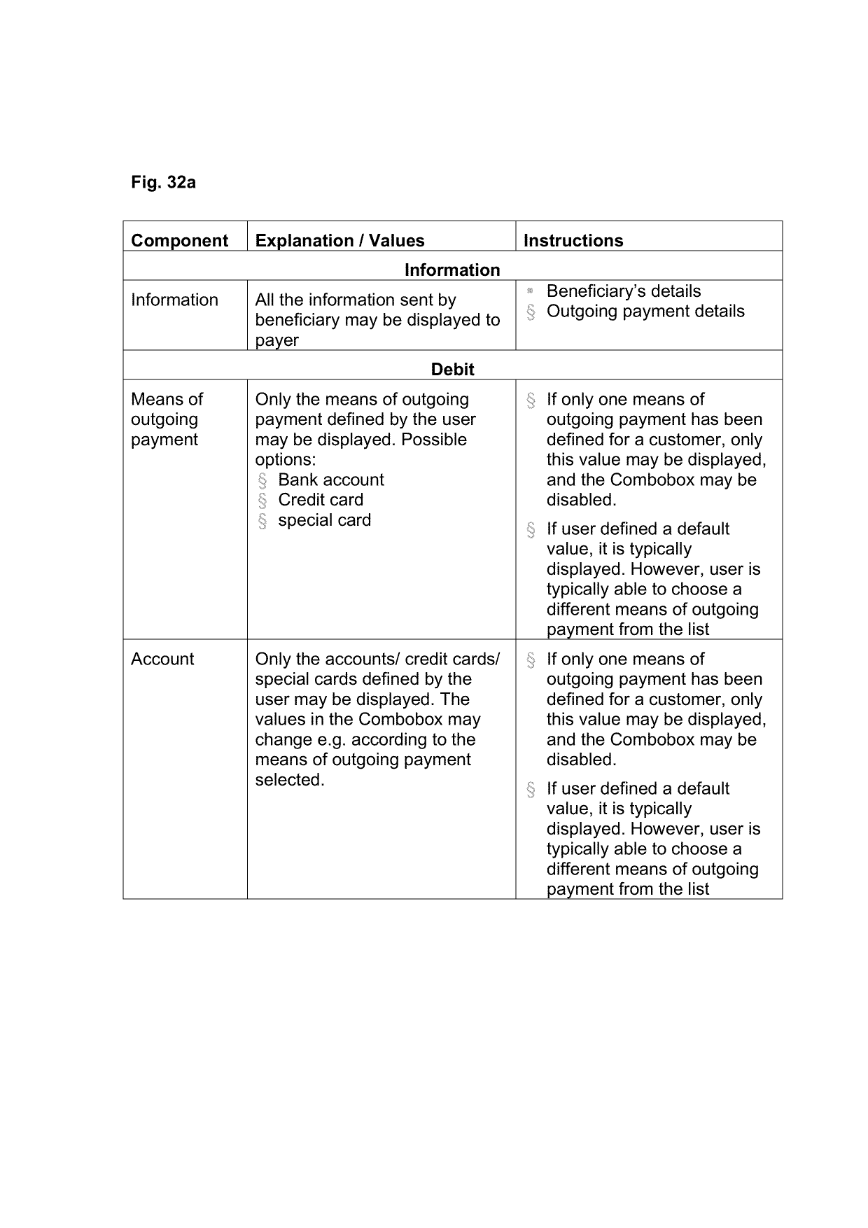

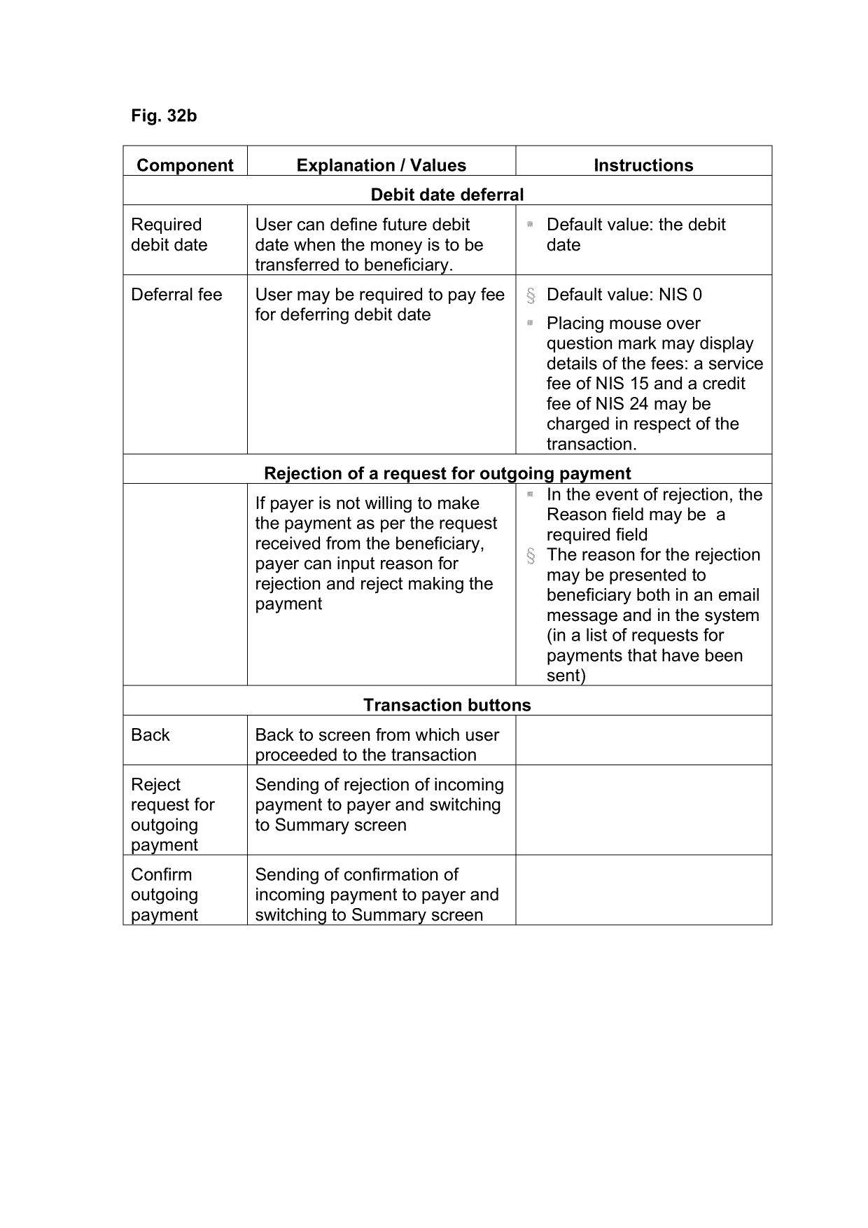

Functional instructions in this connection may be as set out in the tables of FIGS. 32a-32b.

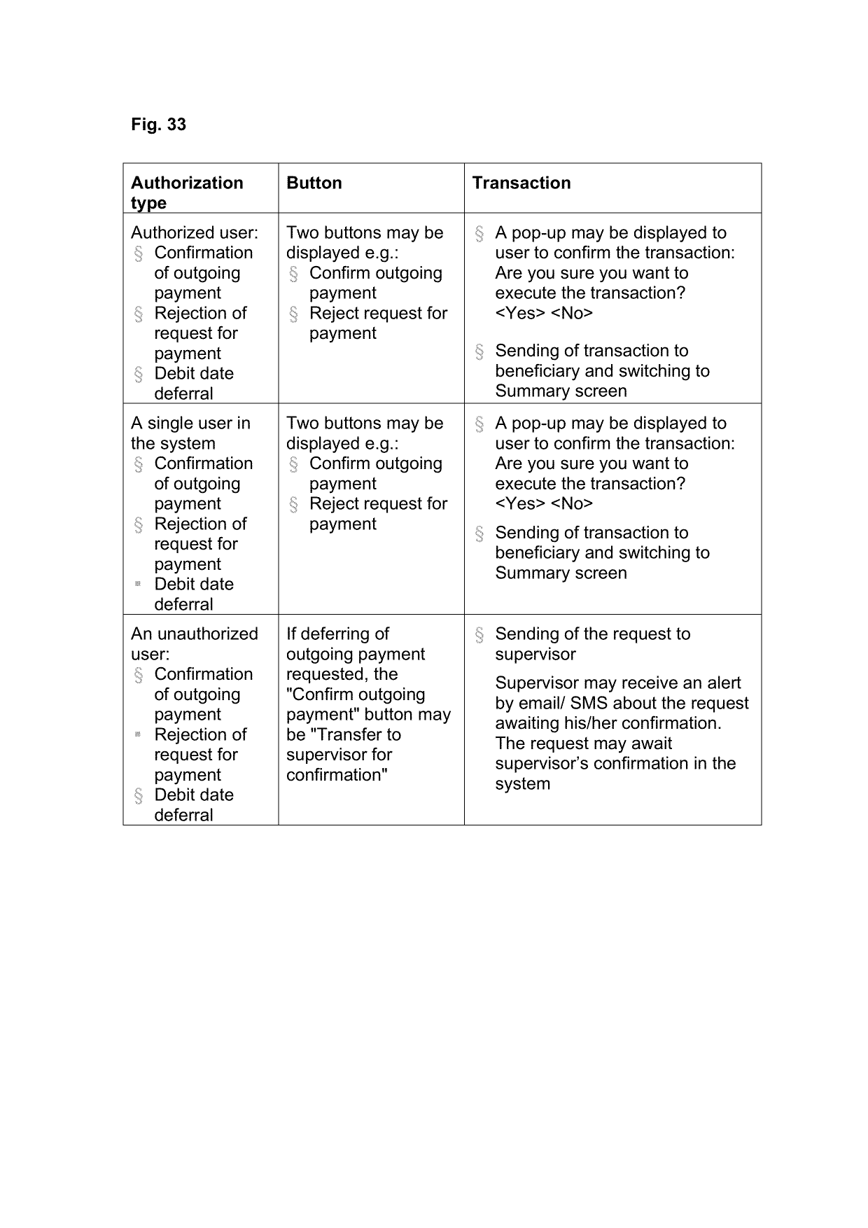

Transaction execution authorizations may be defined in the system and are typically supported e.g. as described in the table of FIG. 33.
A suitable Confirmation of Request for Payment screen may be displayed.

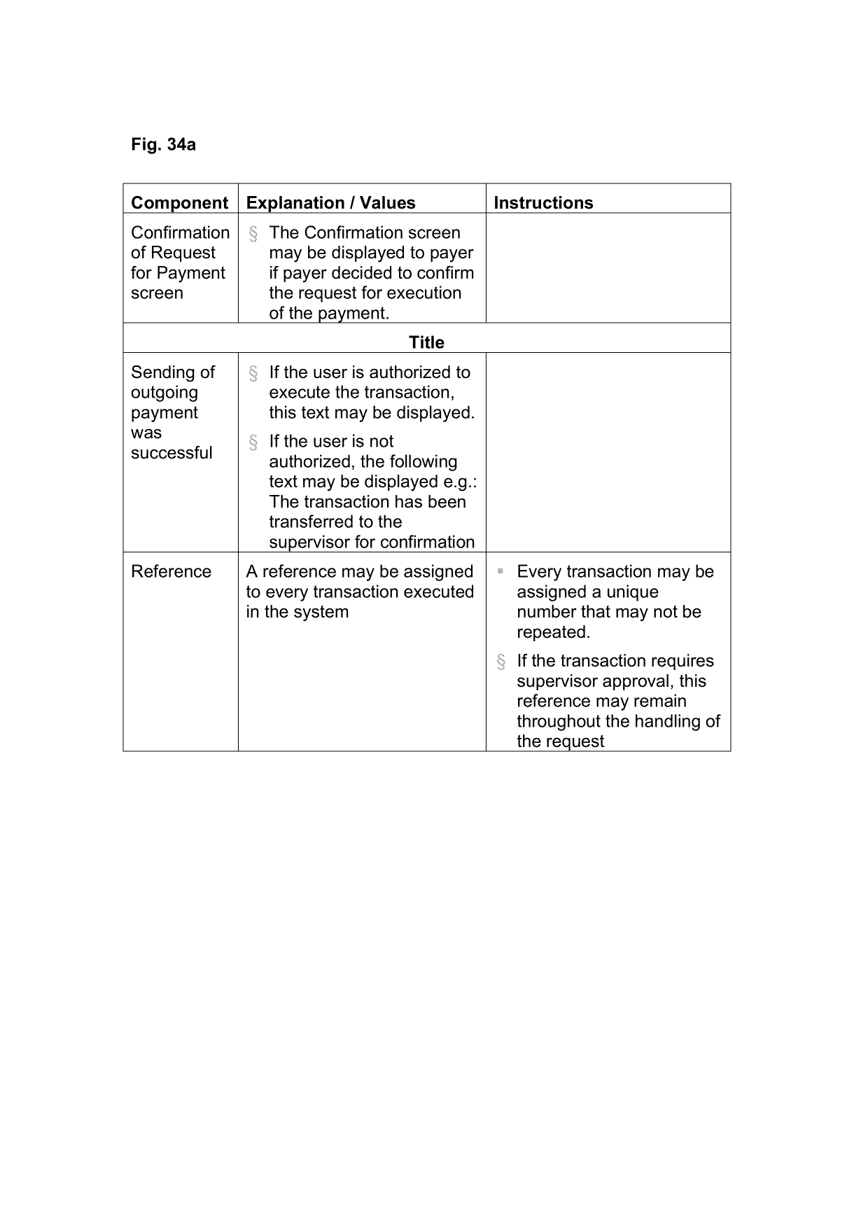

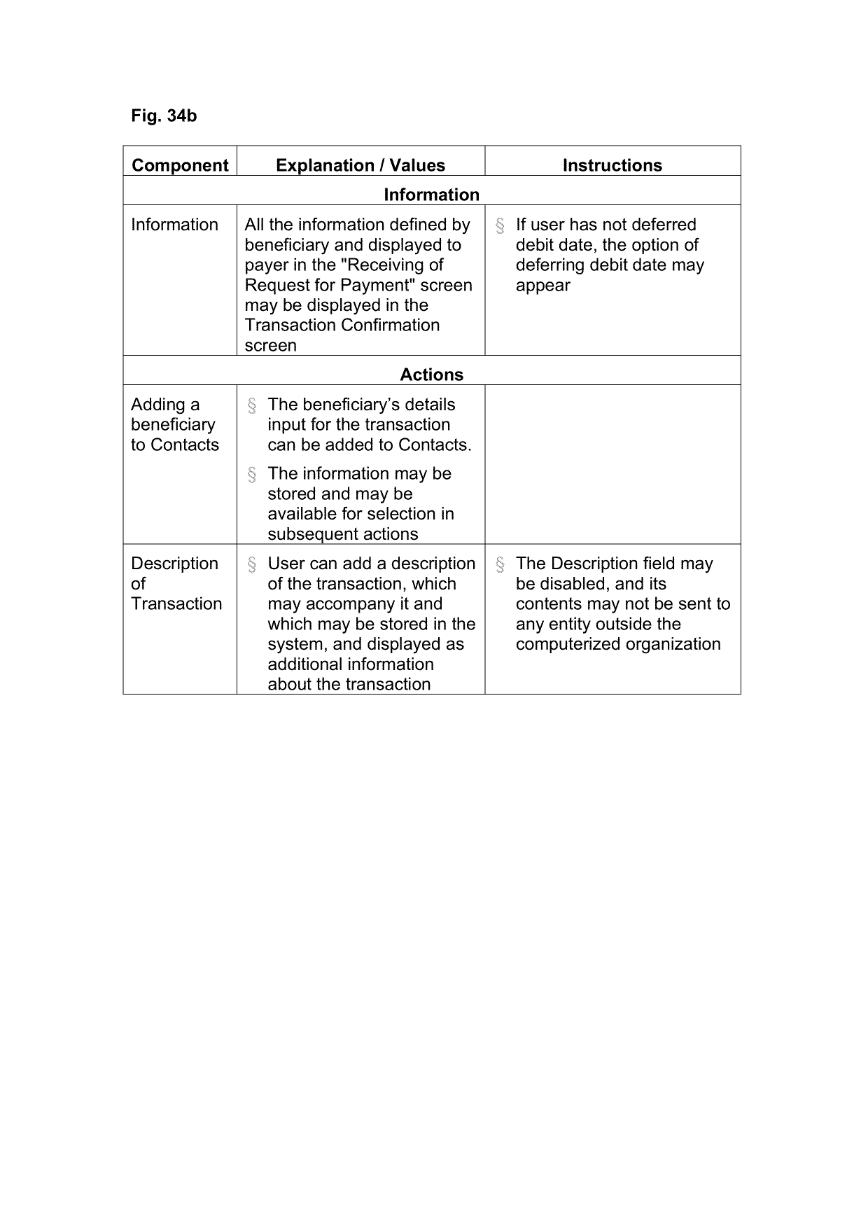

If no deferral was defined in the Transaction Details screen, a suitable notification of a proposed deferral and its terms, is typically sent to the user. Functional instructions in this connection may be as set out in the tables of FIGS. 34a-34b.
A suitable Rejection of Request for Payment screen may be displayed.

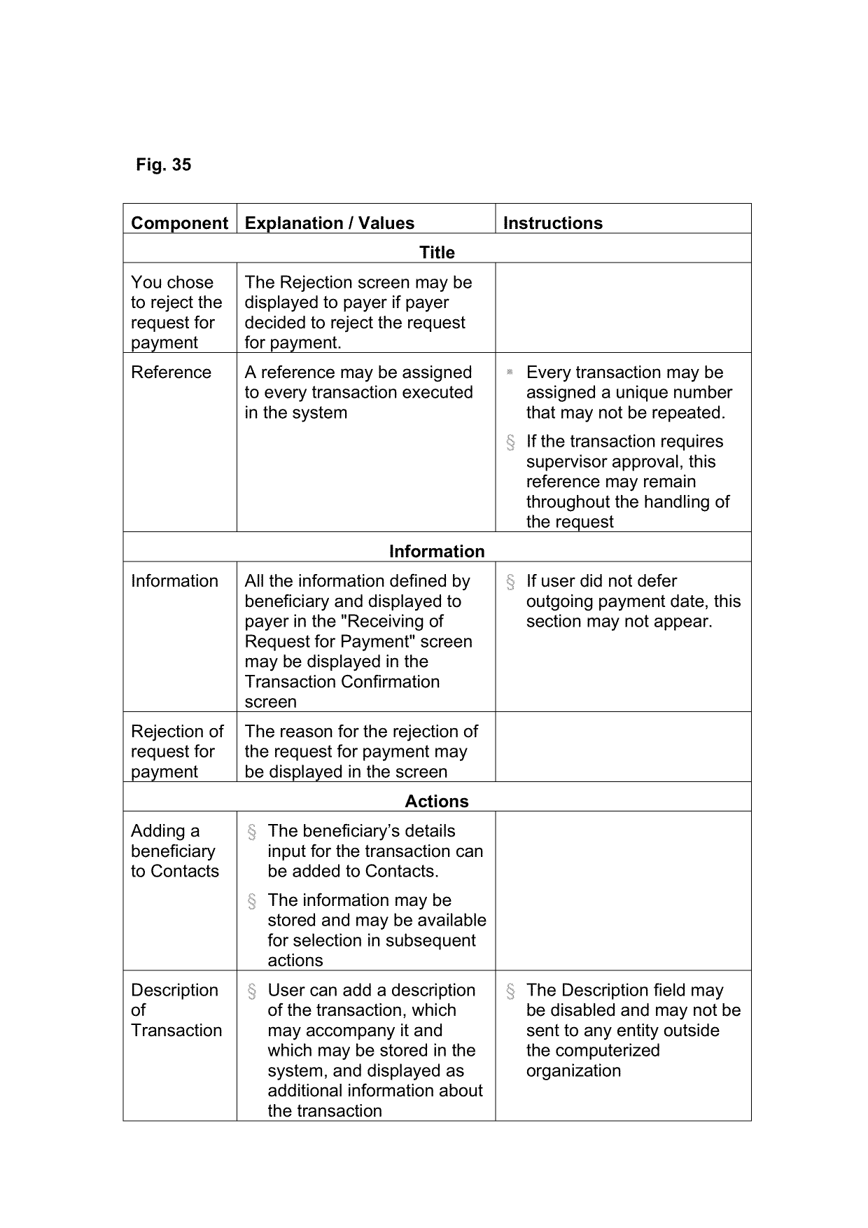

Functional instructions in this connection may be as set out in the table of FIG. 35.

A suitable Email notifying beneficiary of confirmation of request for payment may be sent.

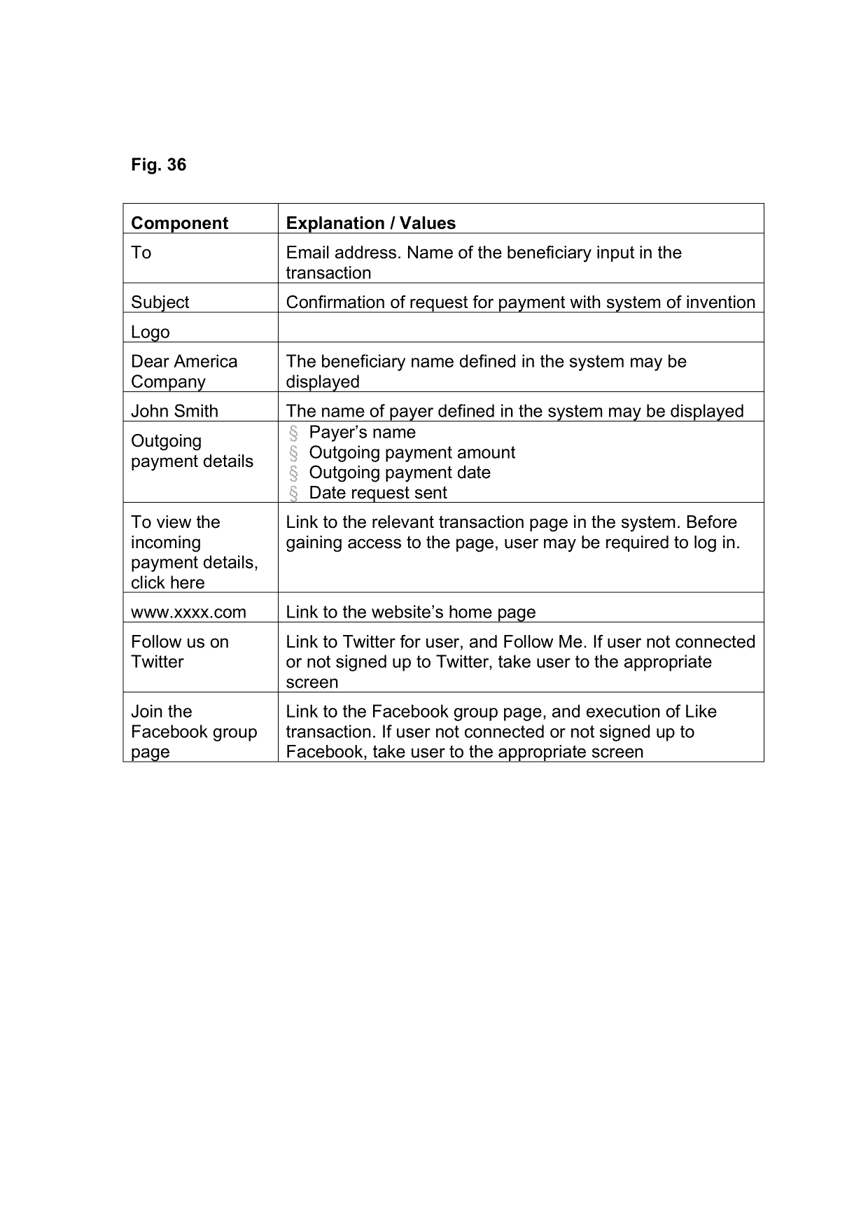

Functional instructions in this connection may be as set out in the table of FIG. 36.

A suitable Email message notifying beneficiary of rejection of request for payment may be sent.

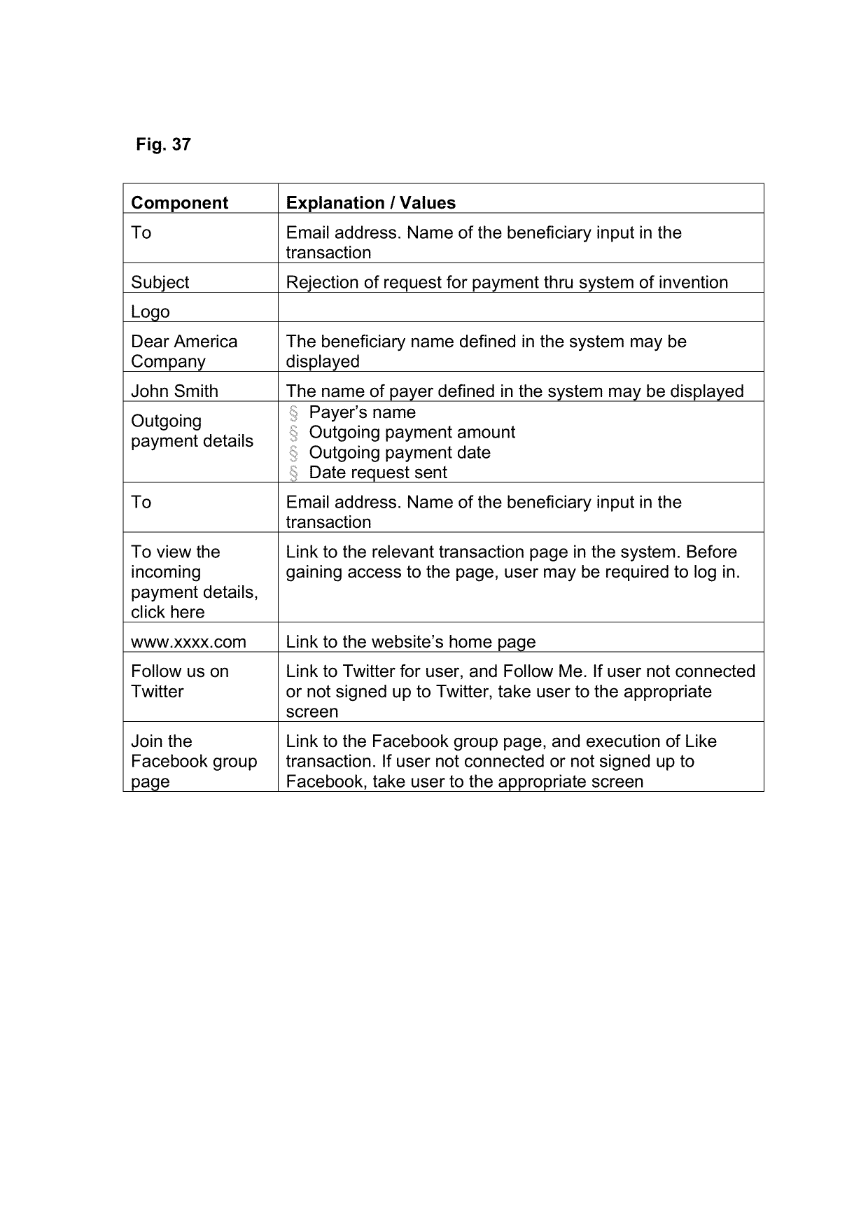

Functional instructions in this connection may be as set out in the table of FIG. 37.

A Debit/Credit display may be provided in the Transaction screens, e.g. as follows:

Debit account: There may be several options on the screen to choose from when selecting the means of payment (debit), such as but not limited to some or all of:
Bank account
Credit card without using a magnetic card reader
Credit card using a magnetic card reader
a credit card optionally issued by the system of the present invention, without using a magnetic card reader
a credit card optionally issued by the system of the present invention, using a magnetic card reader

The system may attempt to detect automatically whether a magnetic card reader is installed on the computer from which the payment is being made.
If a magnetic card reader is detected, the “Use of Magnetic Card Reader” check box may be selected
If a magnetic card reader is not detected, the “Use of Magnetic Card Reader” check box may be clear
User may be able to decide and manually change the Use of Magnetic Card Reader setting.

If the “Use of Magnetic Card Reader” check box is selected, the “Send Outgoing Payment” button may be disabled and the text “Swipe card through Magnetic Card Reader and press Send Outgoing Payment” may be displayed until the card is swiped through the magnetic card reader.

Credited account: There may be various options on the screen to choose from when selecting the means of incoming payment (credit), such as but not limited to some or all of:
Bank account
Credit card
a credit card optionally issued by the system of the present invention,

Document Changes May Include:
Transaction input screens (Send Payment/Sending Request for Payment)—ability to select input e.g. according to computerized organization name/brand name
Transaction input screens (Send Payment/Sending Request for Payment)—ability to select input e.g. according to computerized organization number/DUNS number
Transaction confirmation screens (Send Payment/Sending Request for Payment)—display e.g. according to selected parameter: computerized organization name/brand name and computerized organization number/DUNS number

The system of the present invention may include computerized management tools and utilities for the use of the different users, such as but not limited to some or all of:
Management of users
Contacts management
Management of means of outgoing payment and incoming payment
Account management
Password and definitions
Forms and security devices
Glossary
Q&A
Calculators
Services price list
Management of alerts (Stage B)
Management of credit lines (Stage B)

Suitable computerized management tools and utilities are now described in detail.

A tool for management of users may enable opening of new users in the system, definition of user type, and definition of authorizations for the different users of the system. Management of users includes several screens, such as but not limited to some or all of:
List of users
Add New User window
Update Details of Existing User window
Email notification for a new user

Process for opening a new user may include various elements, such as but not limited to some or all of:
Input of user details
Sending of email message to new user
Choosing a user name
Receiving a validation message by email
Completing the signing up and logging in to the system

A List of users may be provided.

Functional instructions in this connection may be as set out in the table of FIGS. 38a-38c.

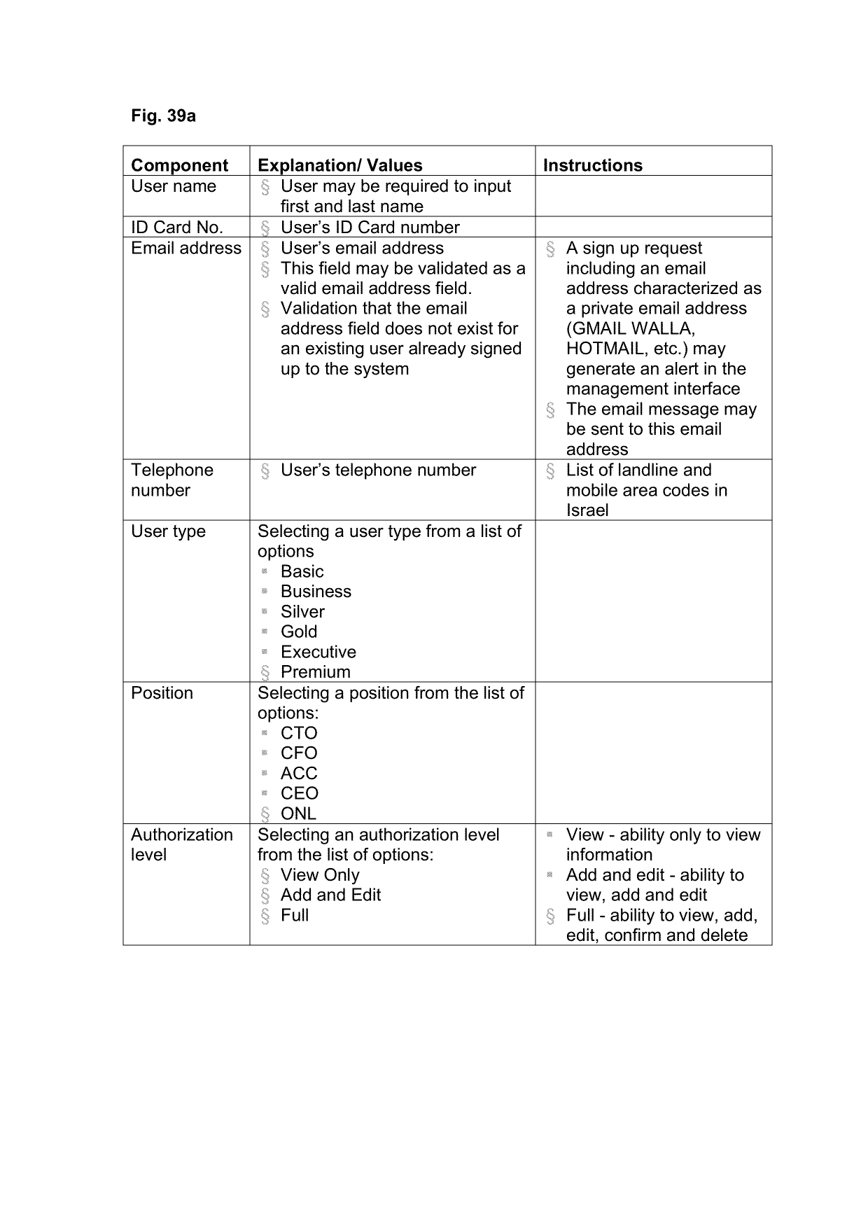

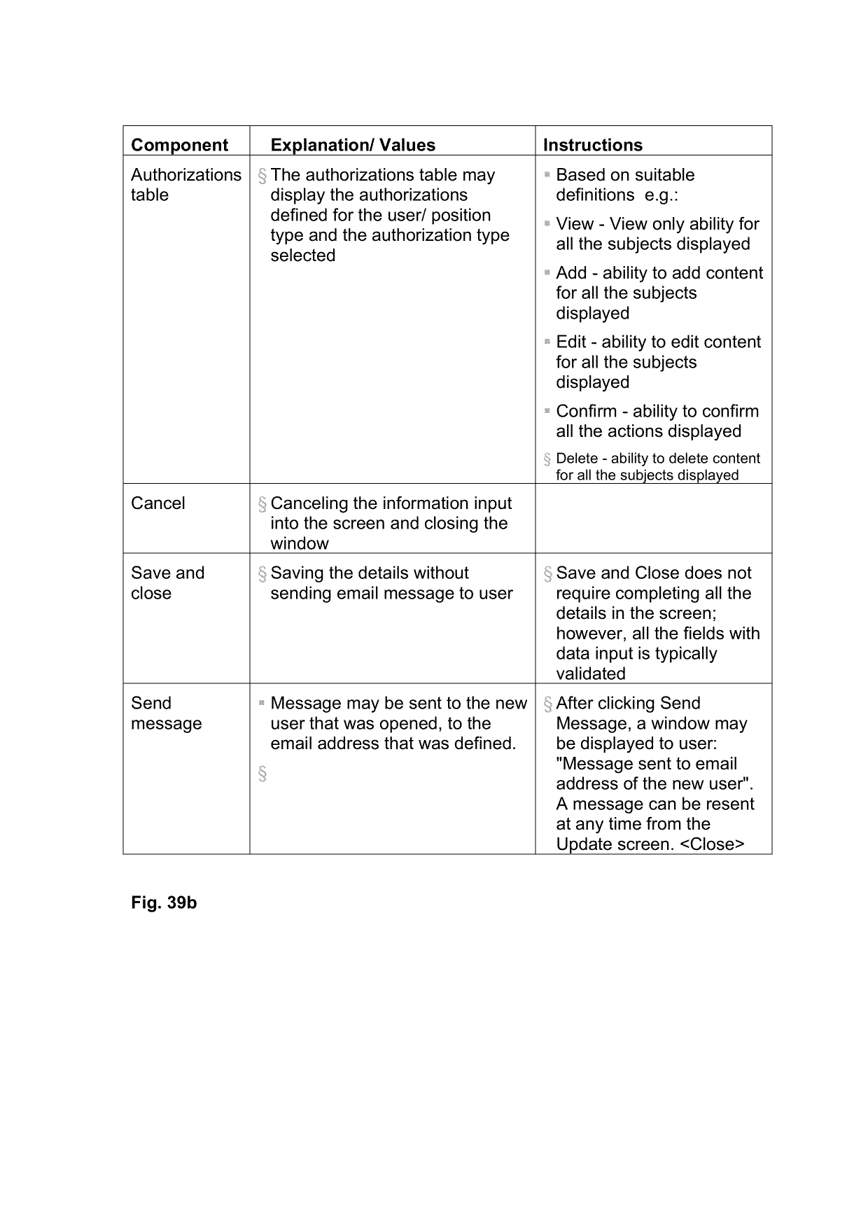

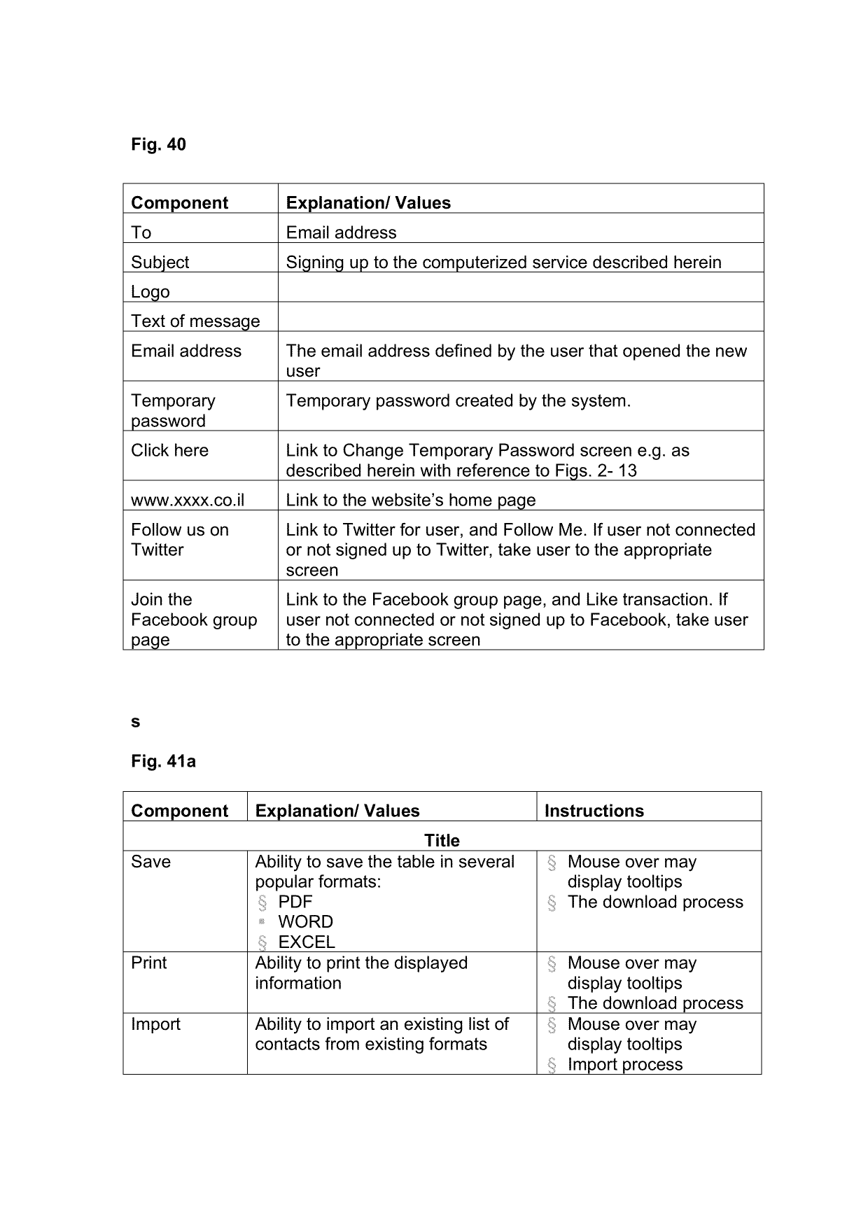

A functionality may be provided for Opening a new user. Functional instructions in this connection may be as set out in the table of FIGS. 39a and 39b, taken together.

A suitable Email message to new user may be sent. Functional instructions in this connection may be as set out in the table of FIG. 40.

A Contact management tool may enable opening of new contacts in the system, defining of contact type and additional information about each contact. Contact management may comprise the following screens:
List of contacts
Add New Contact window
Update Details of Existing Contact window

A List of contacts may be provided.

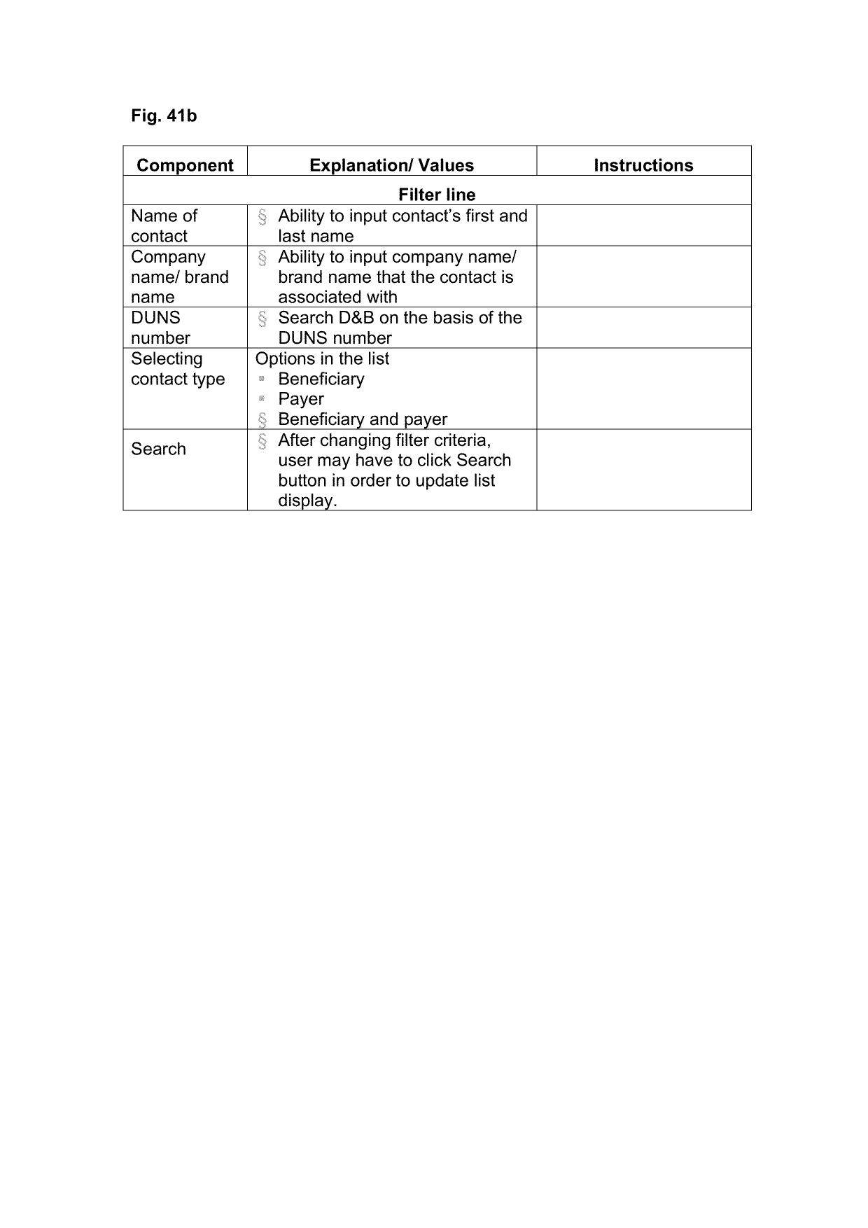

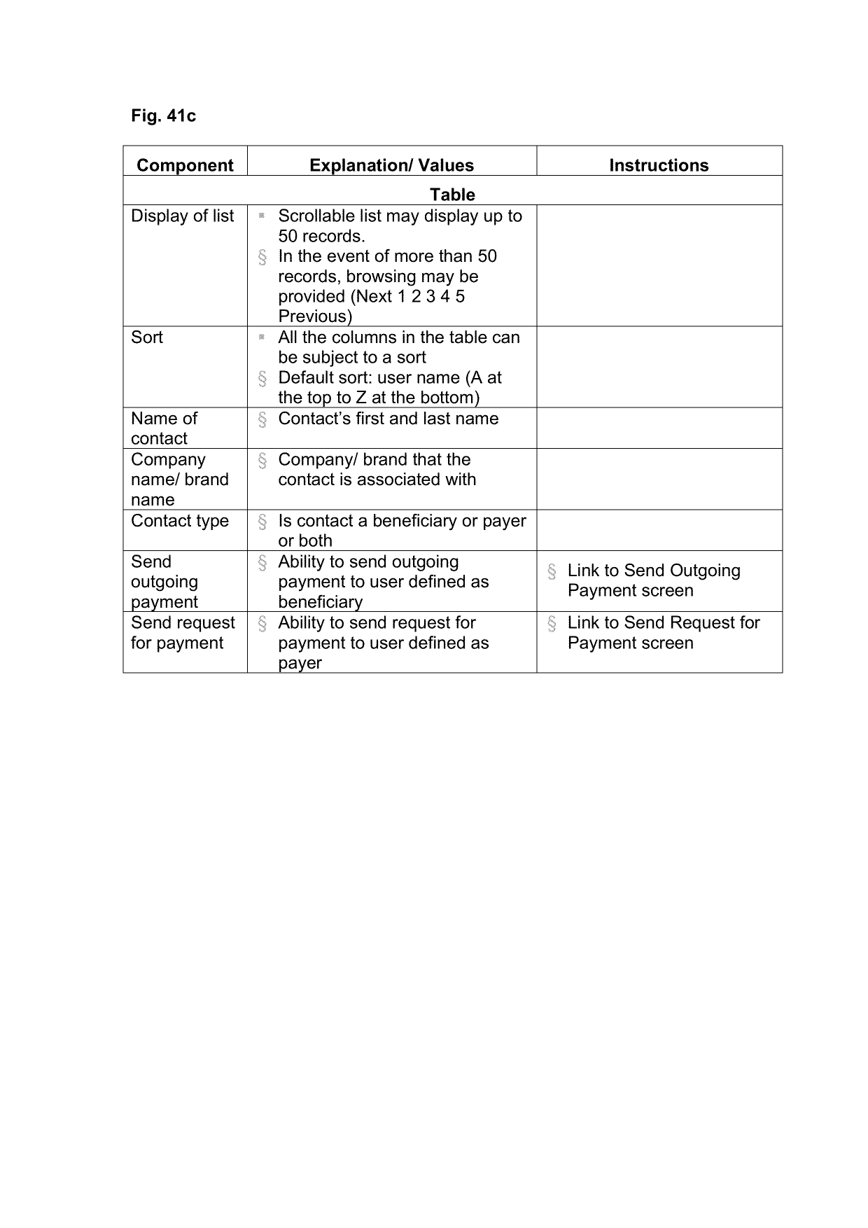

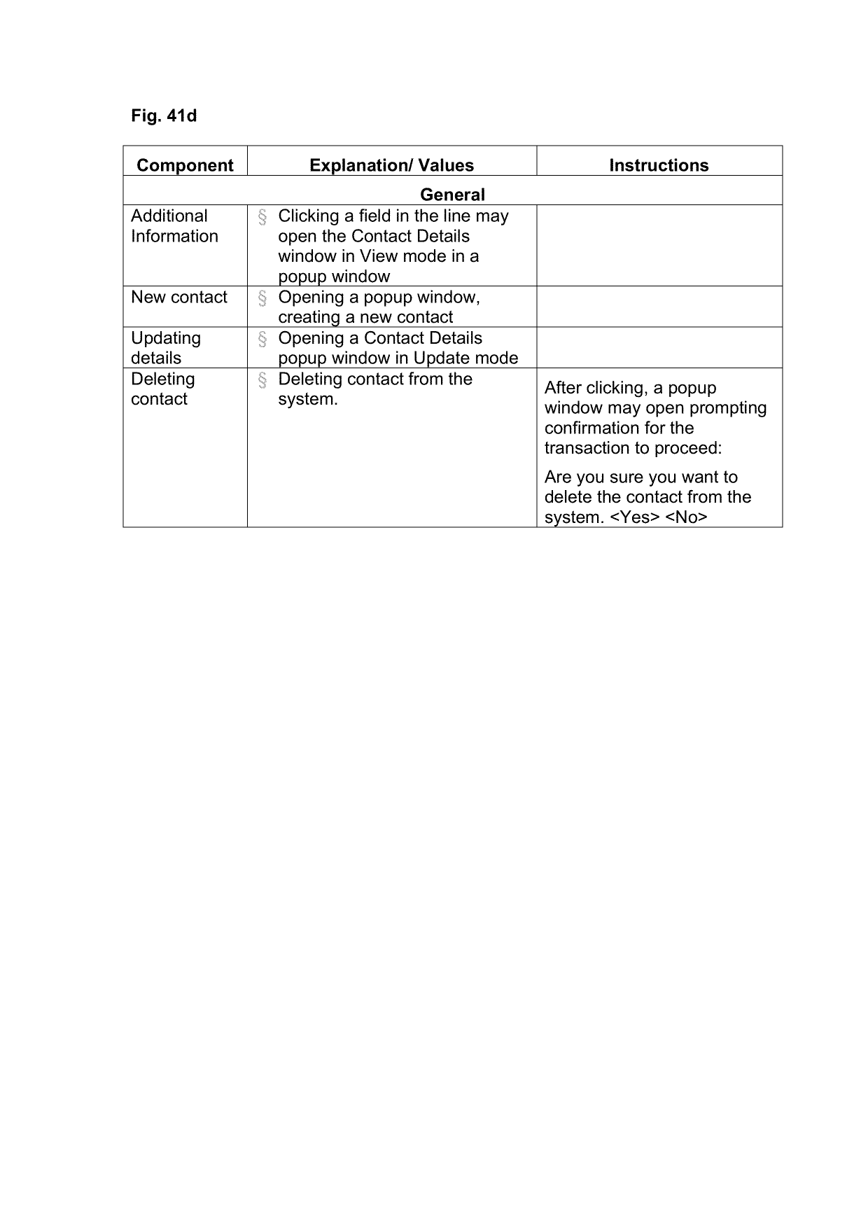

Functional instructions in this connection may be as set out in the table of FIG. 41a.

A functionality for opening a new contact may be provided.

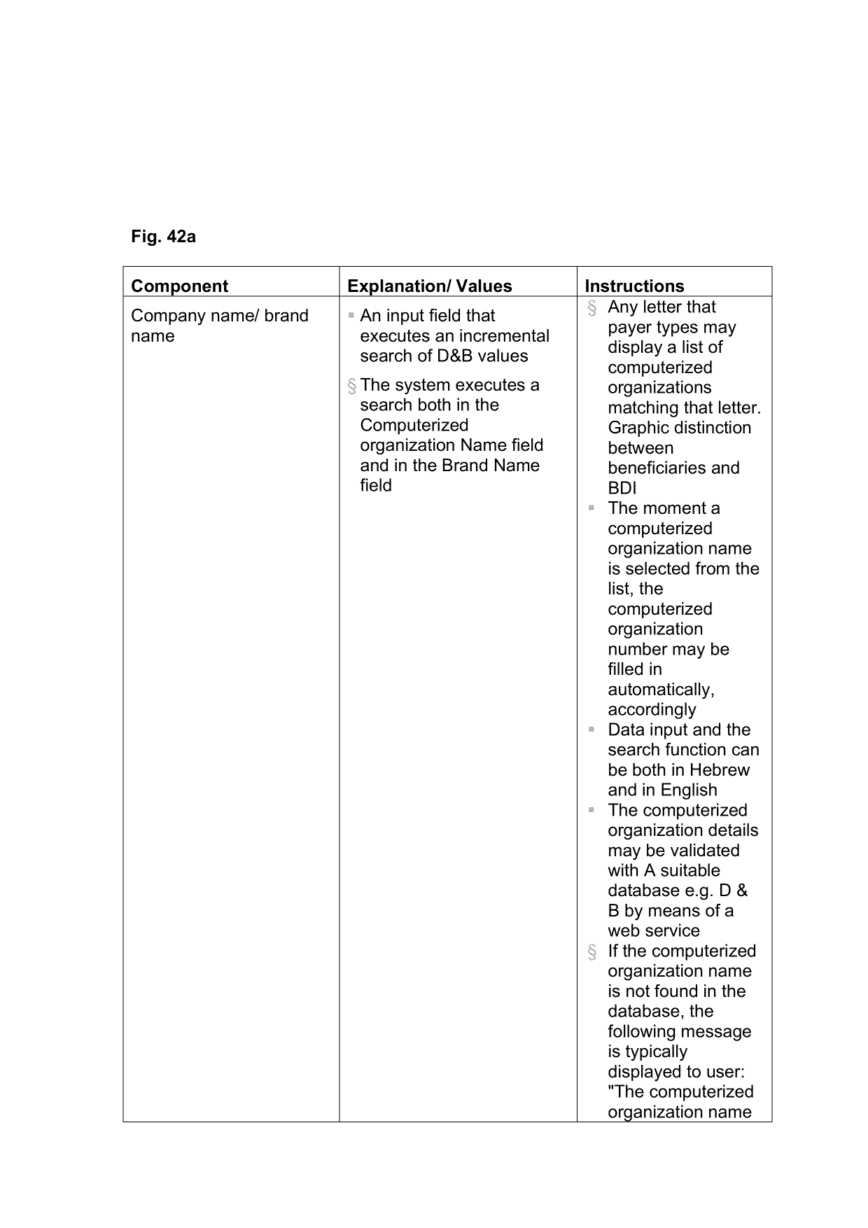

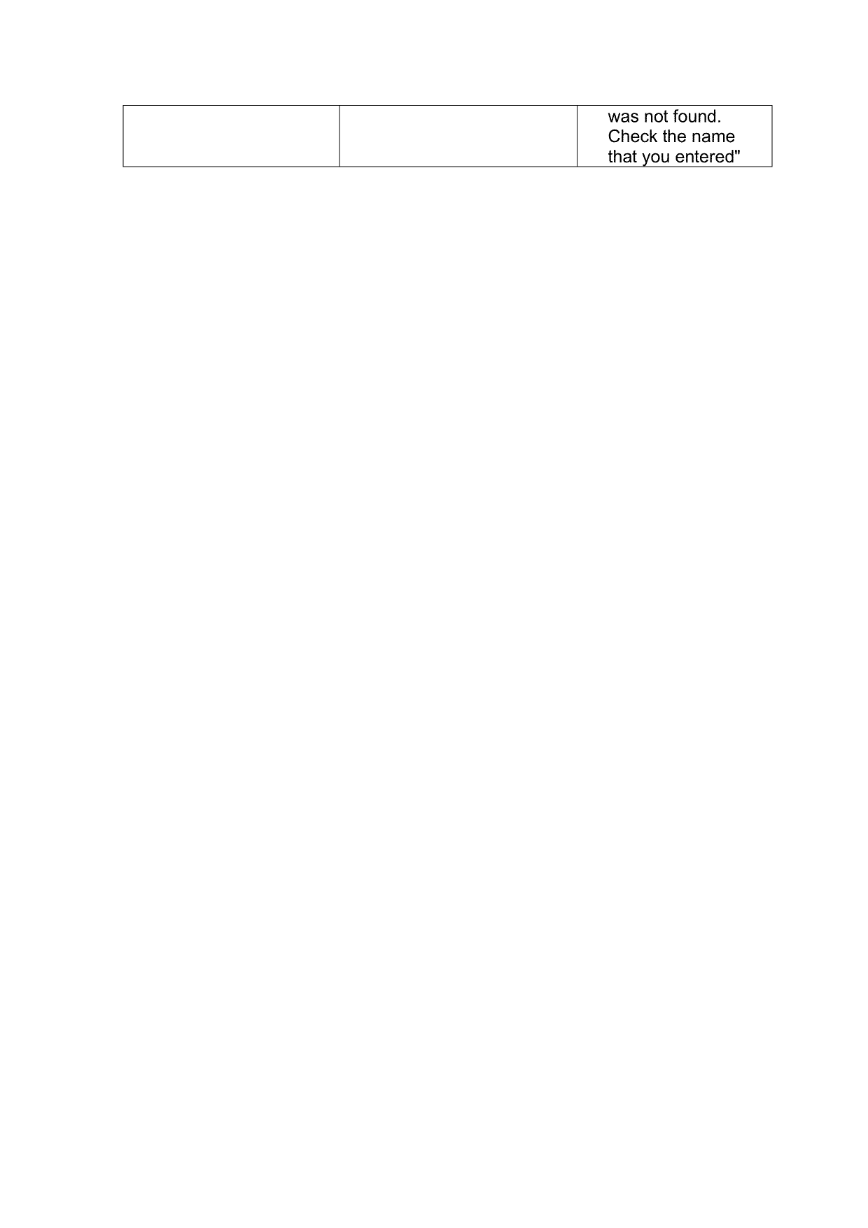

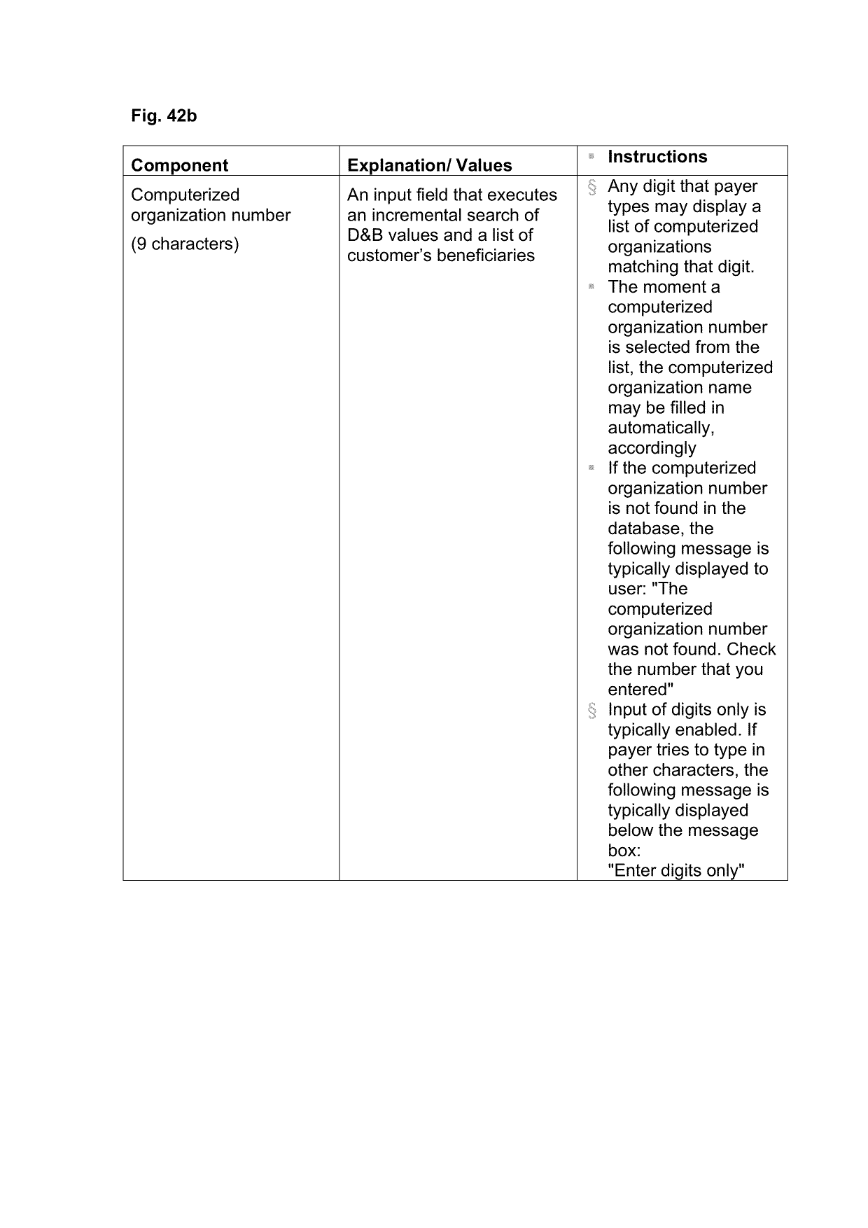

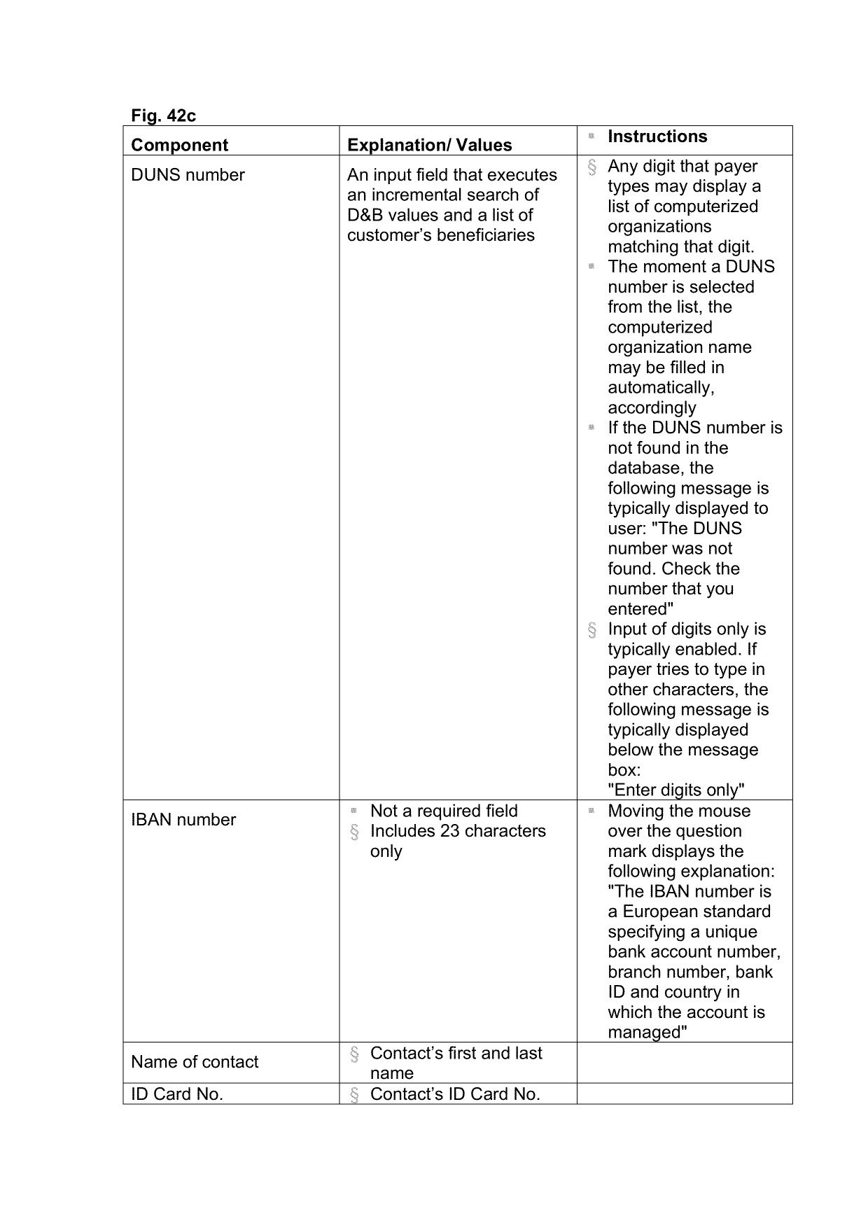

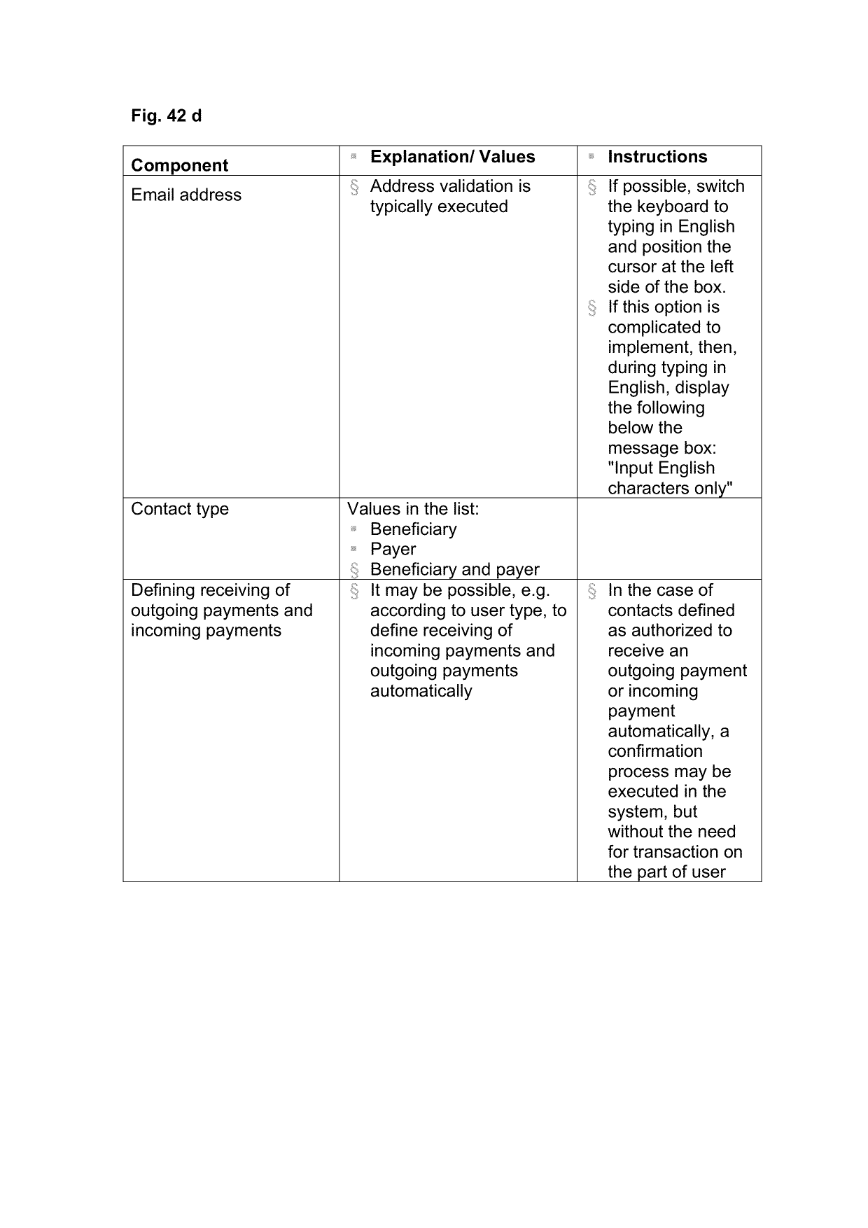

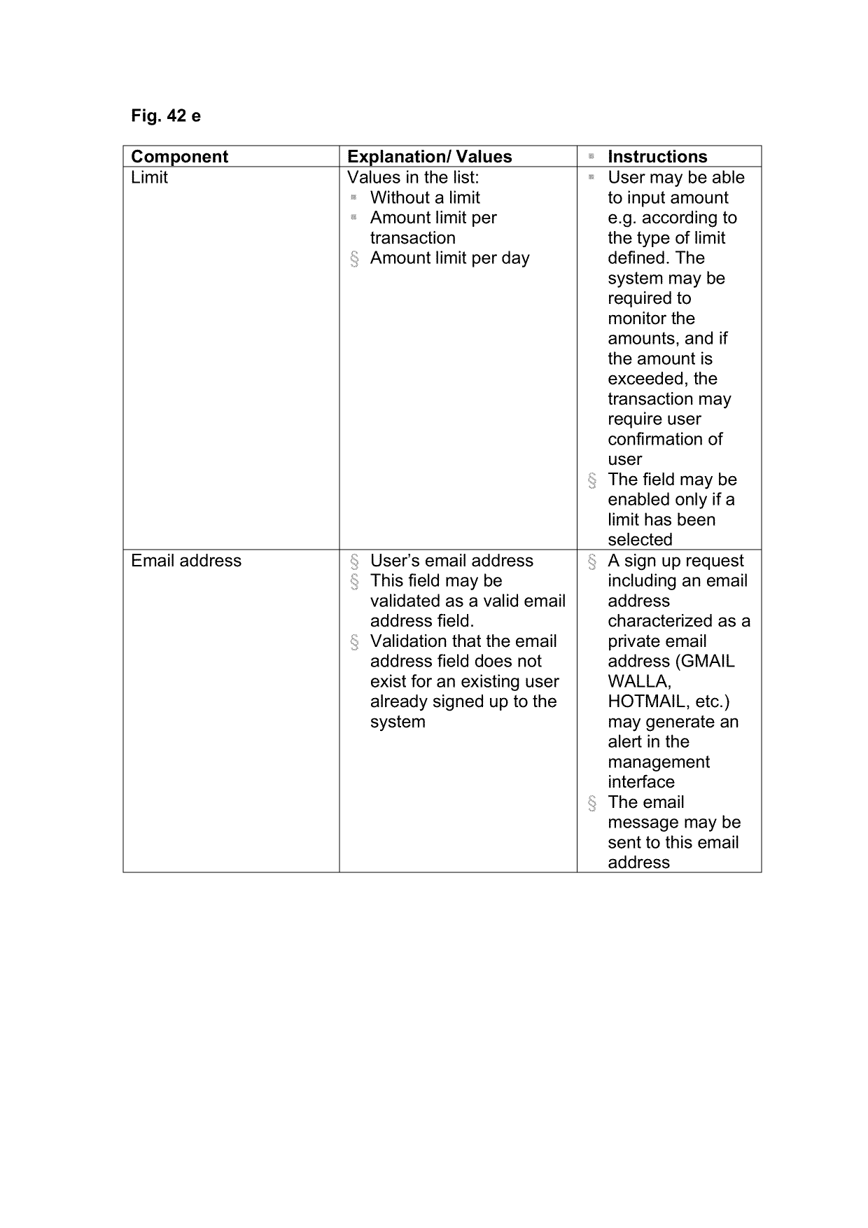

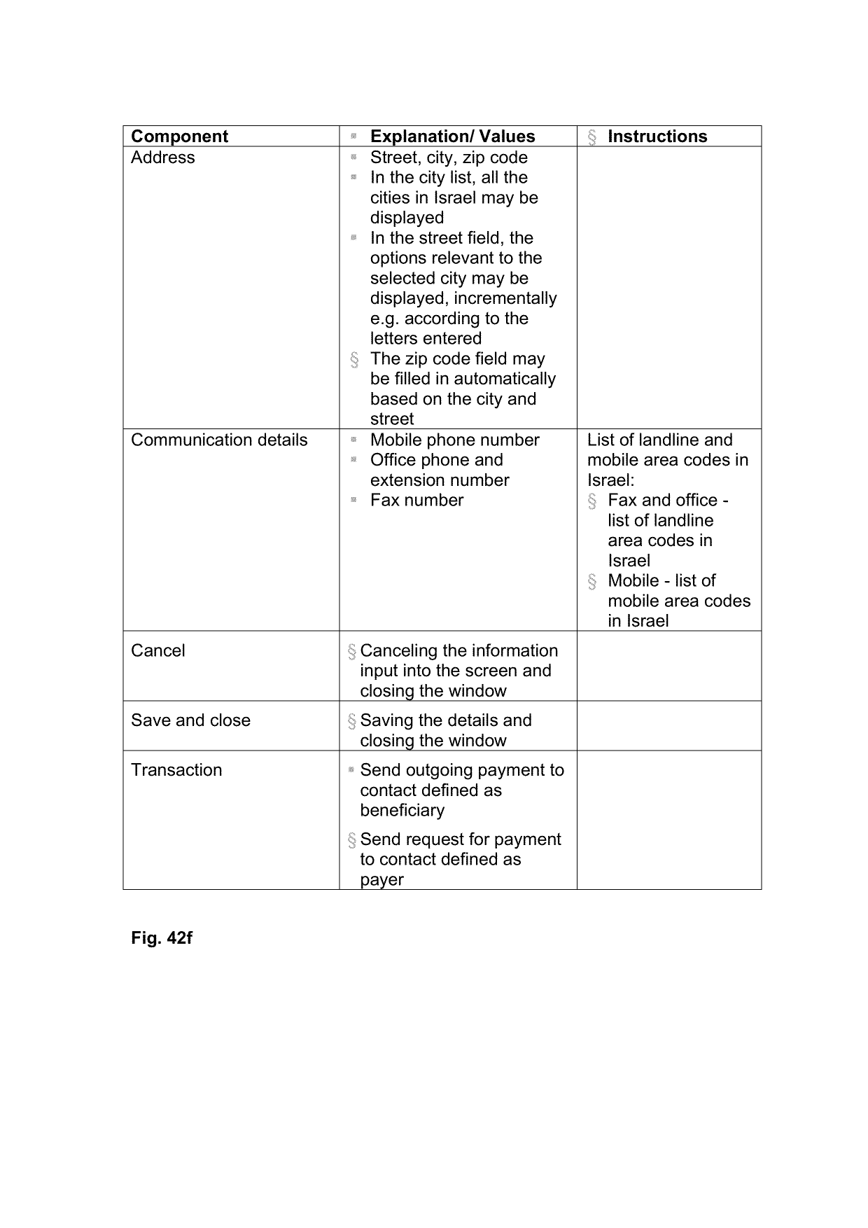

Functional instructions in this connection may be as set out in the tables of FIGS. 42a-42f.

A functionality for selecting beneficiary/payer may be provided; typically, during a Send outgoing payment transaction or Receive incoming payment transaction, user can select beneficiary or payer from the list of contacts. Typically, when:

Selecting payer: Only contacts defined as payers may be displayed

Selecting beneficiary: Only contacts defined as beneficiaries may be displayed.

The appropriate selection window may open e.g. according to the transaction, from which user may be able to select the desired beneficiary/payer. The window may display a list of the contacts meeting the search criteria in a scrollable list (no browsing). A partial search of a contact name or company/brand may display a list of all the contacts meeting the criteria.

A tool for managing means of outgoing payment and incoming payment may enable defining of means of incoming payment and means of outgoing payment for use in the system and defining of the default means.

Management of means of outgoing payment and incoming payment may comprise the following screens:
List of means of outgoing payment and incoming payment
Window for adding means of outgoing payment and incoming payment
Window for updating means of outgoing payment and incoming payment
In the outgoing payments menu—a list of means of outgoing payment (e.g. credit card, bank account) may be displayed only, including an option to Add/Update/Delete means of outgoing payment
In the incoming payments menu—a list of means of incoming payment may be displayed only, including an option to Add/Update/Delete means of incoming payment

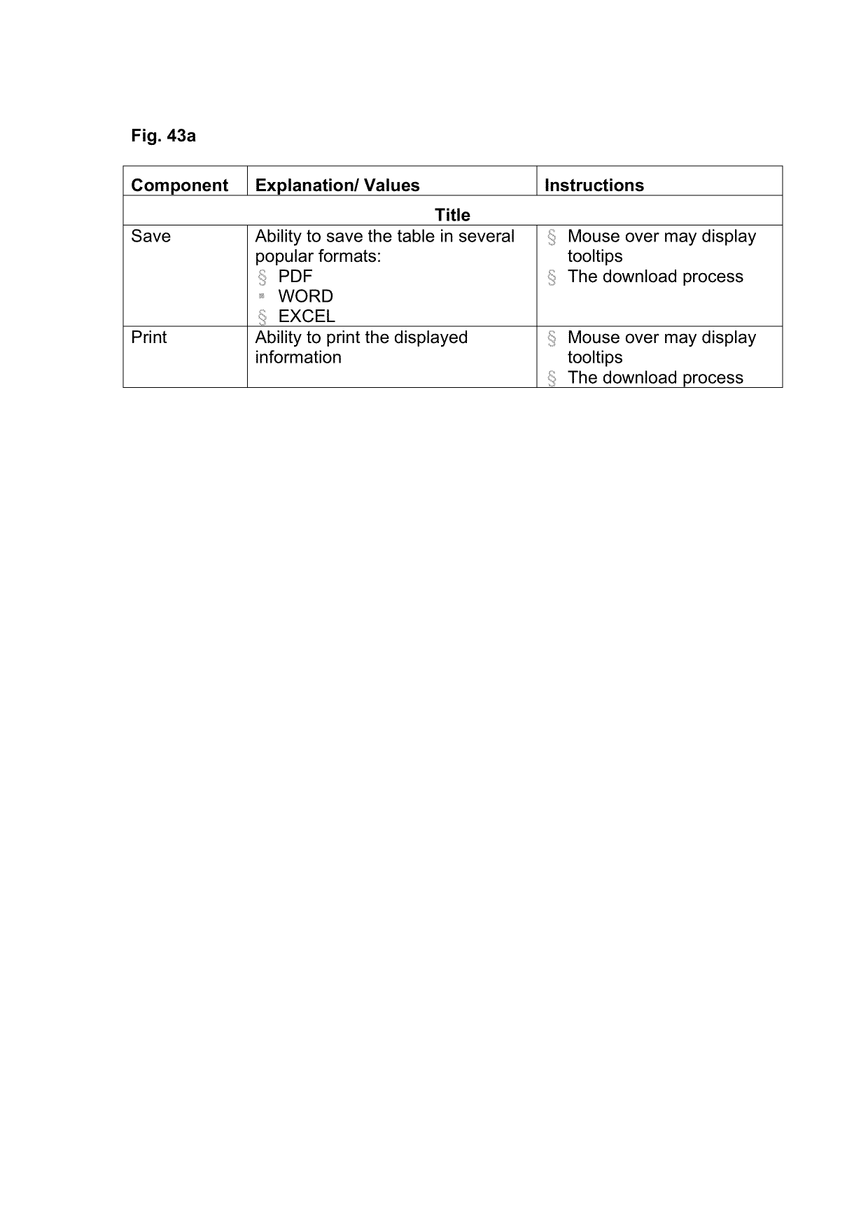

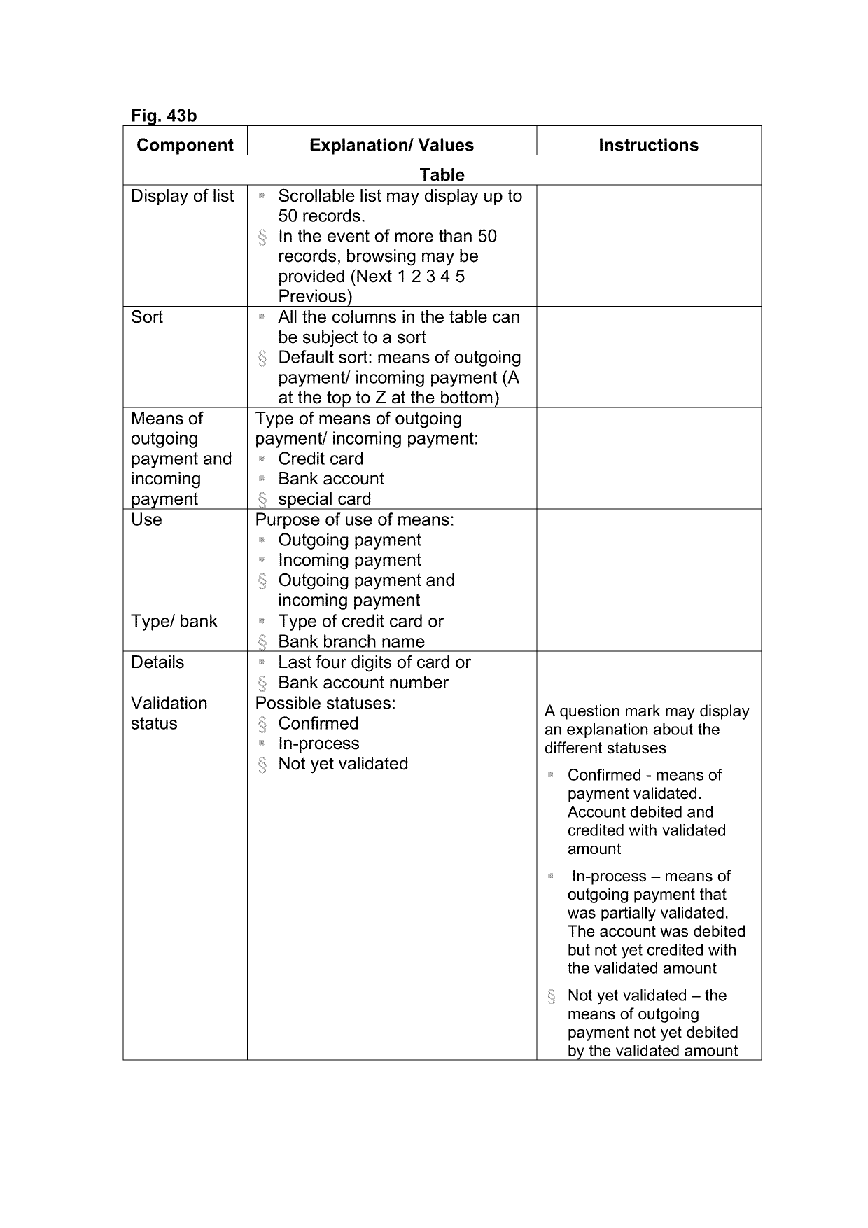

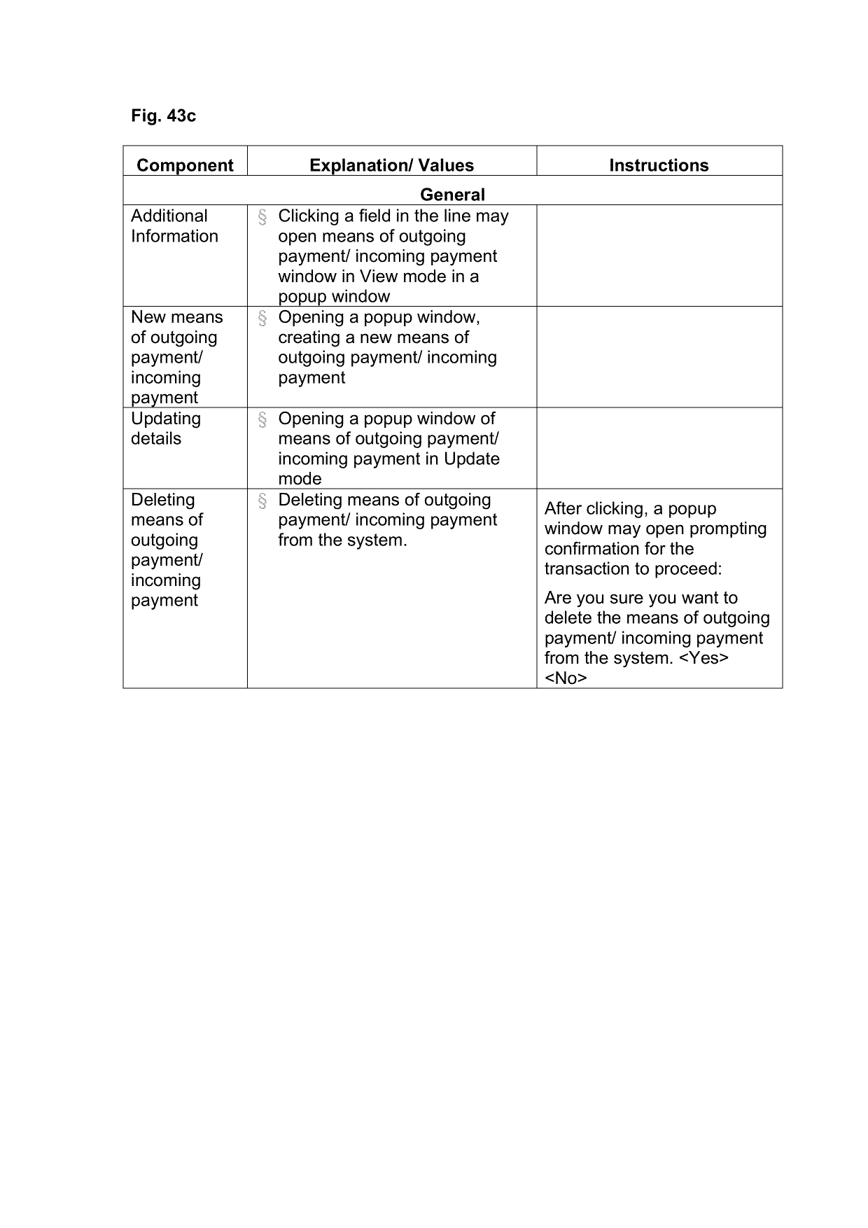

List of means of outgoing payment and incoming payment may be provided. Functional instructions in this connection may be as set out in the tables of FIGS. 43a-43b.

A functionality may be provided for opening a new means of outgoing payment/incoming payment.

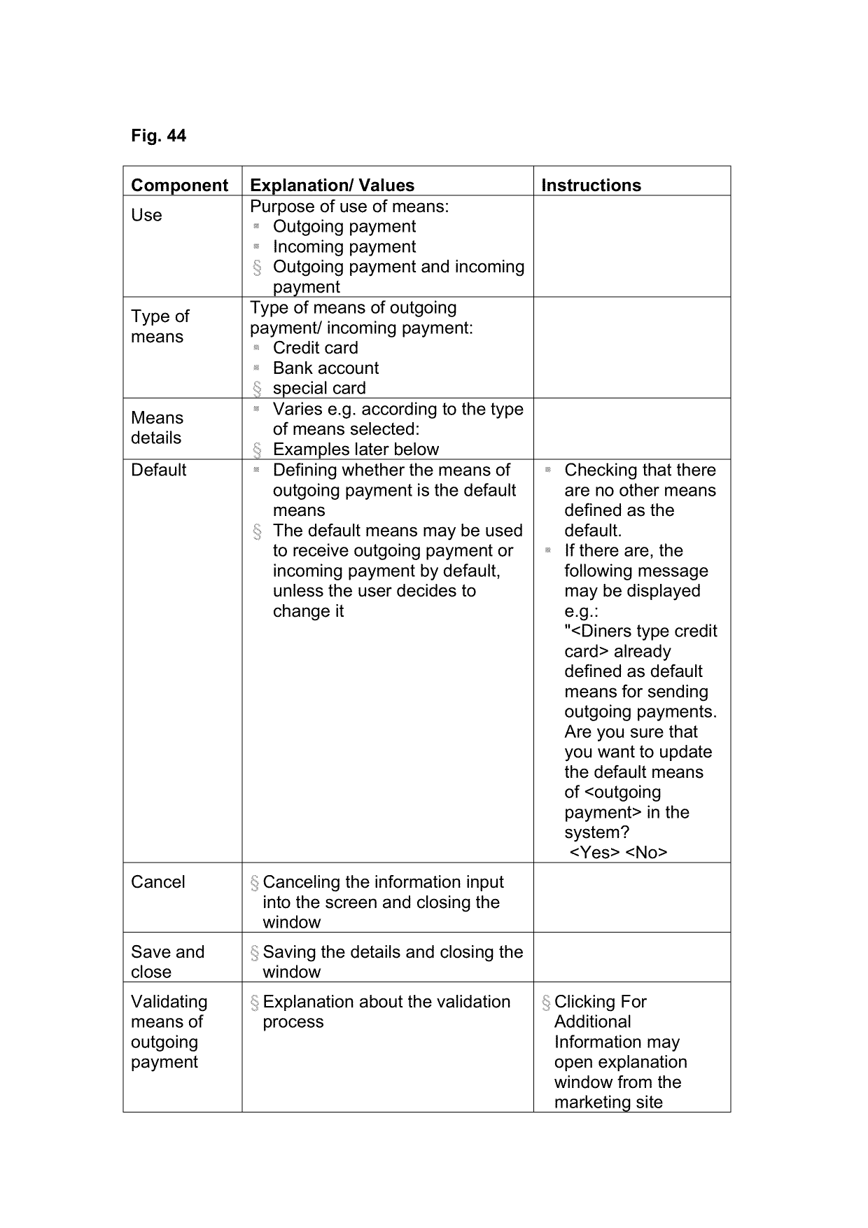

Functional instructions in this connection may be as set out in the table of FIG. 44.

Particulars of means of outgoing payment/incoming payment may be displayed.

For example, in every screen in which the “i” symbol for additional information on the means of outgoing payment/incoming payment is displayed, an Additional Information pane may be displayed.

The pane may be displayed when the mouse moves over it, and may close automatically when the mouse is no longer over the field.

The information may vary e.g. according to the type of means of outgoing payment/incoming payment.

Various Modes for inputting the details of means of outgoing payment/incoming payment may be provided, e.g. Credit cards.
The system may display a defined structure for digits e.g. according to the type of card selected

An account management tool may enable user to view the type of account s/he has been assigned and the actions available to him/her. In addition, it may also be able to update the account type. Account management includes several screens such as but not limited to some or all of:
List of account types
Account type details
Upgrading account type

A List of account types may be provided.

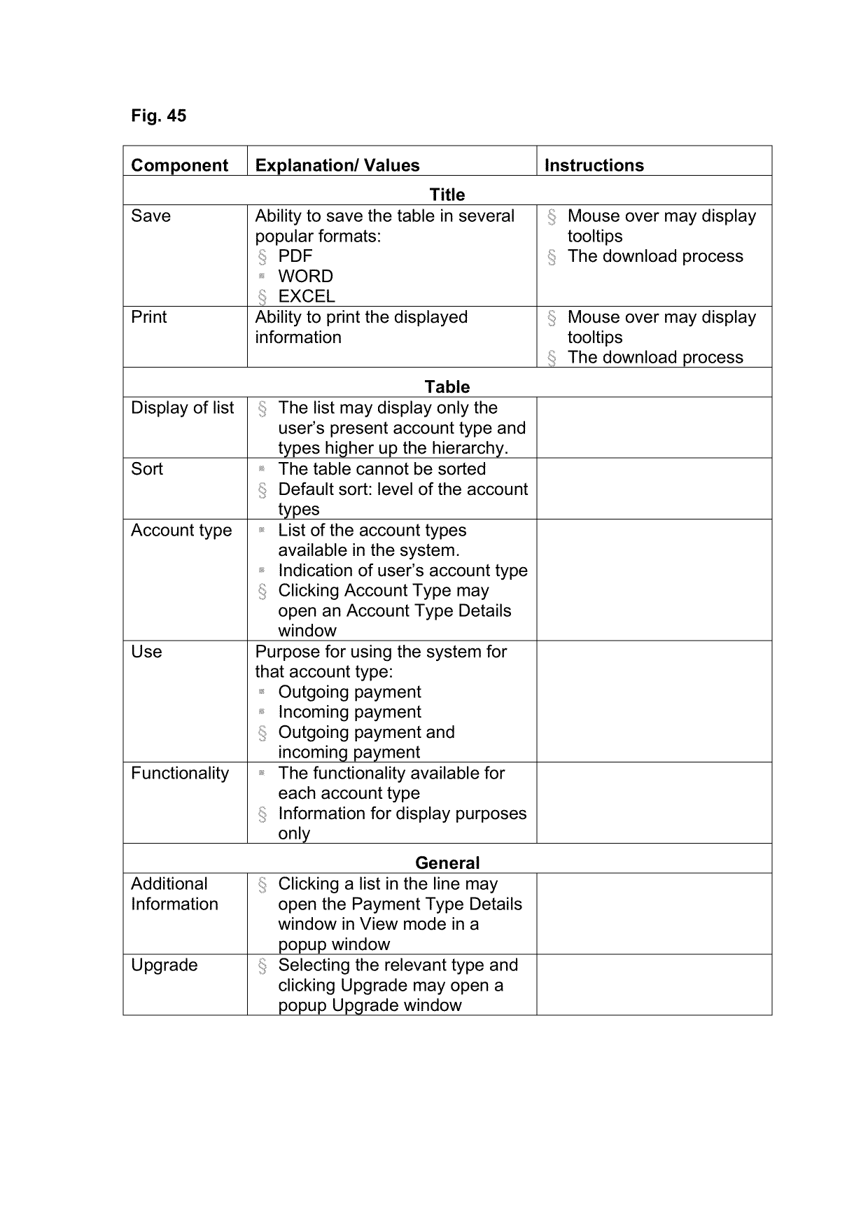

Functional instructions in this connection may be as set out in the table of FIG. 45.

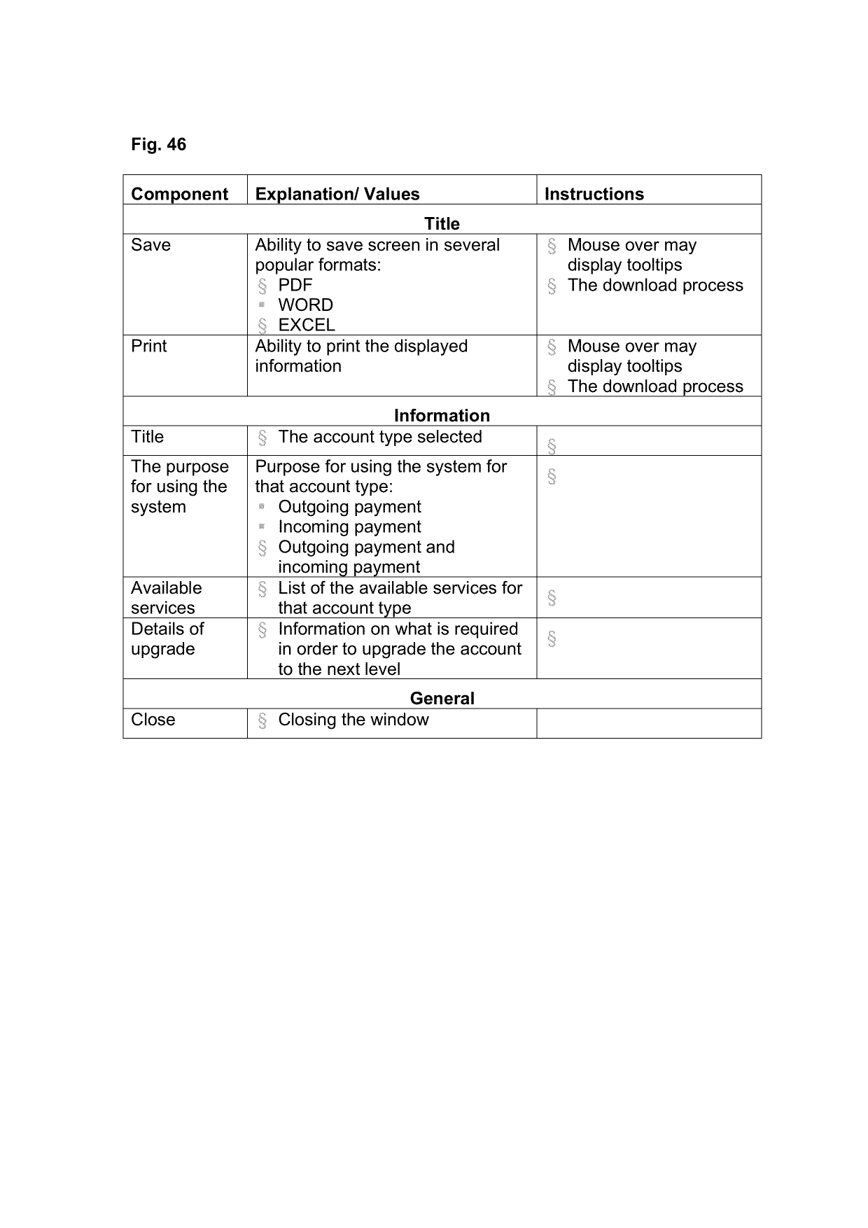

Account type details may be provided. Functional instructions in this connection may be as set out in the table of FIG. 46.

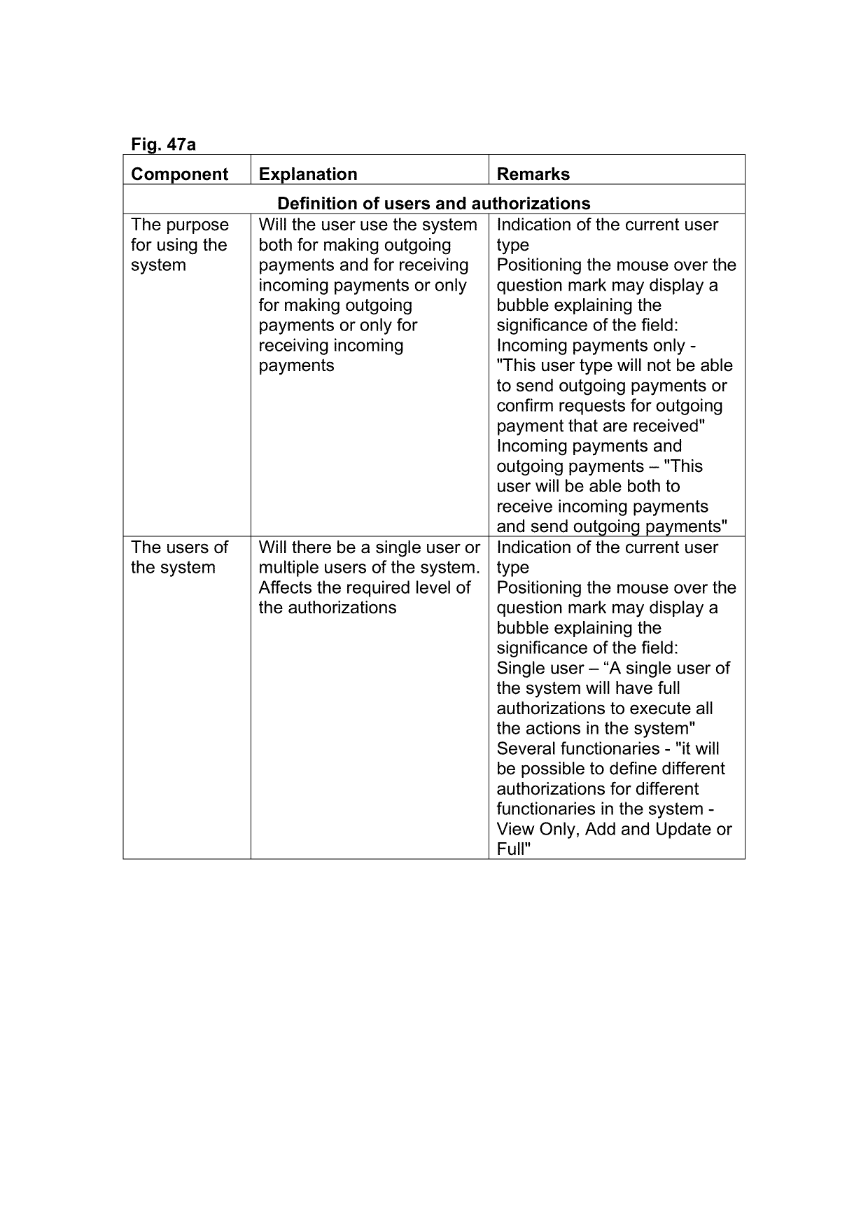

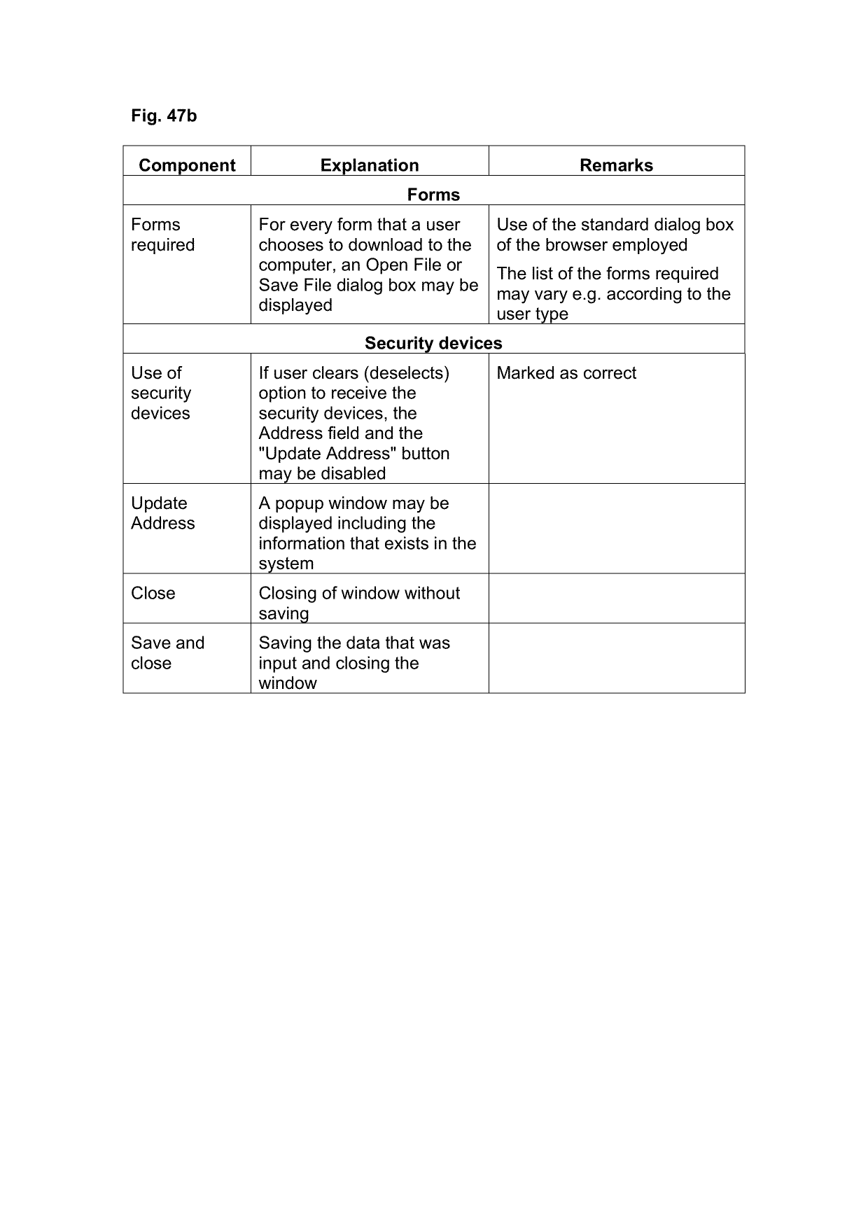

An Account upgrade may be provided. Functional instructions in this connection may be as set out in the table of FIGS. 47a-47b.

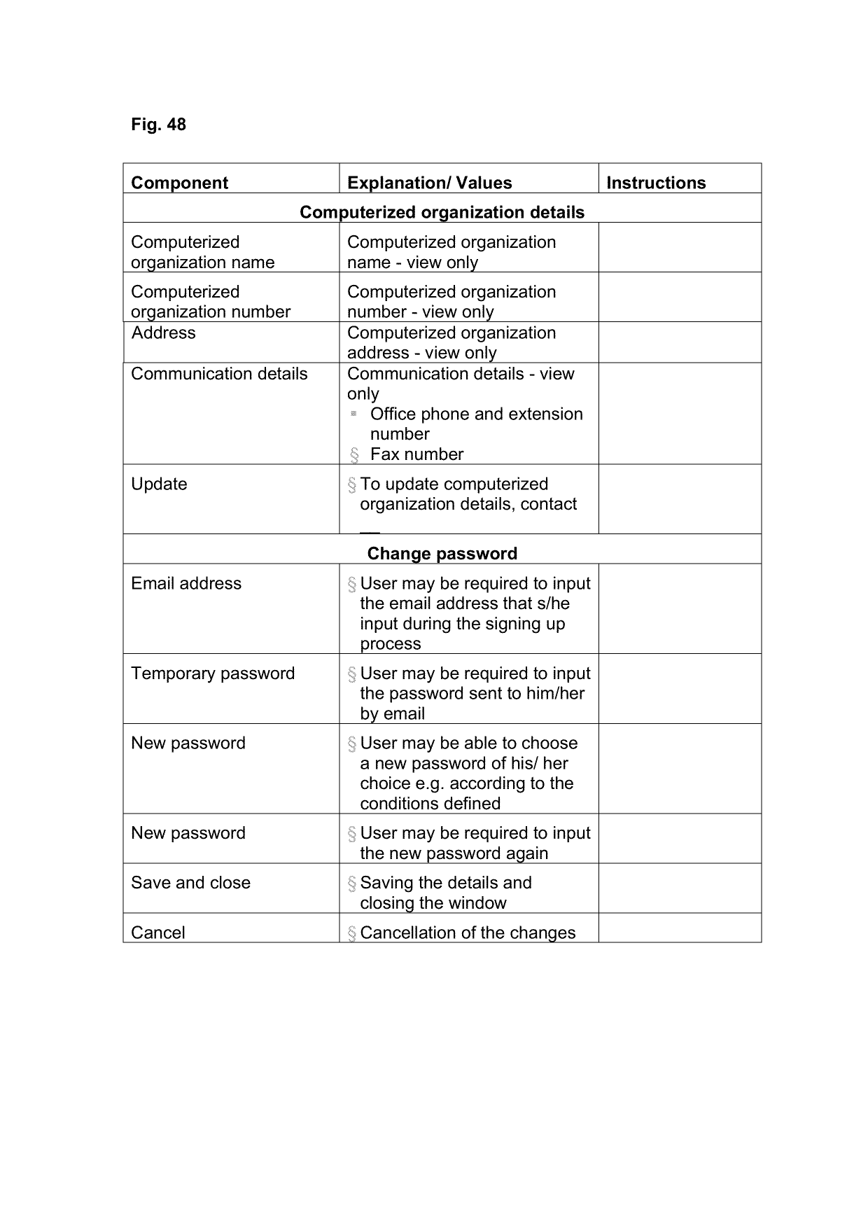

A Password and definitions may be provided to enable user to view the details of the computerized organization and to update the password that the user uses to log in to the system. Functional instructions in this connection may be as set out in the table of FIG. 48.

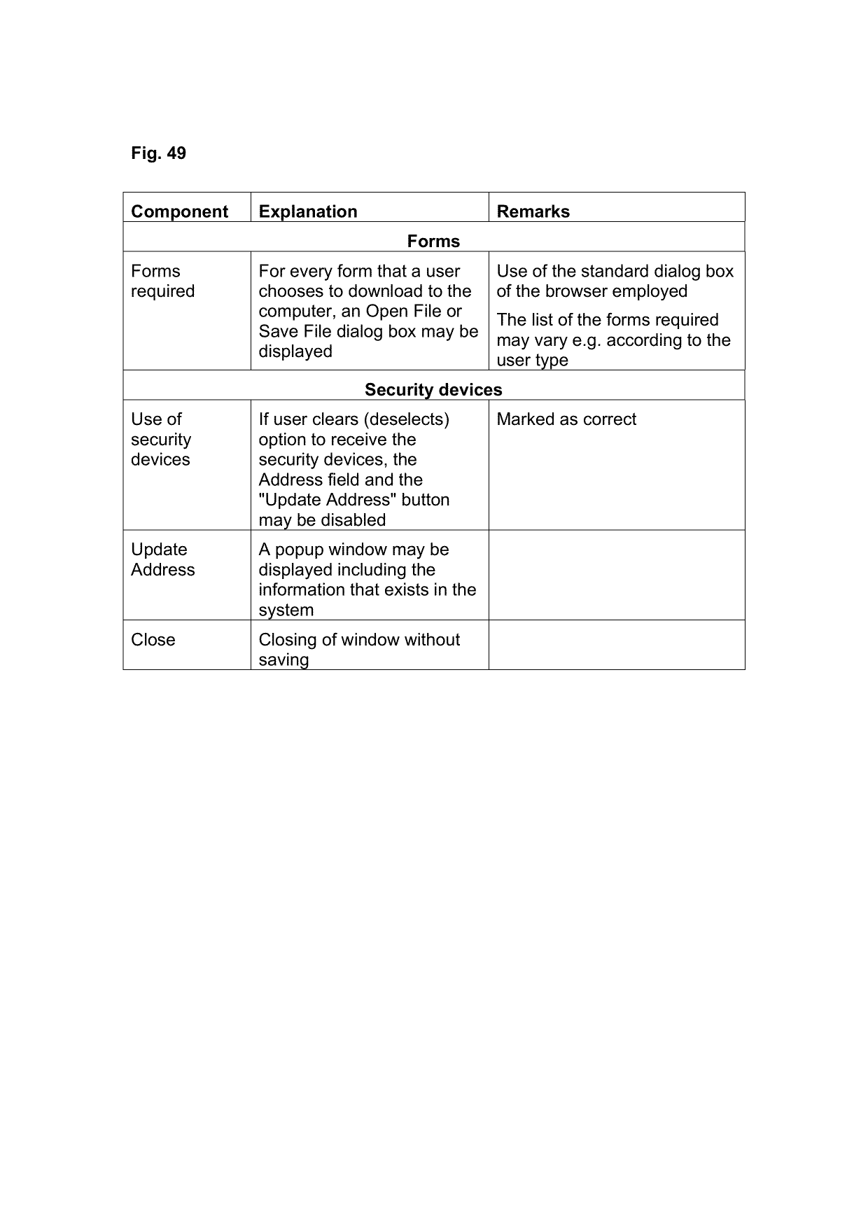

A Forms and security devices tool may be provided to enable a user to view forms which may be required to upgrade account, and to order security devices. Functional instructions in this connection may be as set out in the table of FIG. 49.

The general functionality of module 70 in FIG. 1b is now described with reference to FIGS. 50a-50b.

When entering a Send Outgoing Payment/Confirm Received Request for Payment transaction, the system may automatically identify a connected magnetic card reader. If a magnetic card reader is connected, the option “Credit card using a magnetic card reader” is typically displayed to the user.

Anywhere the user is requested to enter his/her ID Card number (during signing up/adding of a contact), the correctness of the ID Card number and control digit is typically validated. An explanation and example can be found at the following http link: halemo.net/info/idcard/index.html.
Beneficiary's means of incoming payment in every transaction may be used to debit fees for that transaction.
Payer's means of outgoing payment in every transaction may be used to debit that transaction.
General tooltips may for example include:
   Print button—click to print
   Save Tables button—click to save in (Word/Excel/PDF) format
   Save Forms button—click to save in (Word/Excel/PDF) format
   Import button—click to load an external file

Debiting fees may be computed based on the following two parameters: Service fee—fixed fee in respect of the transaction.

Credit fee—fee in respect of credit granted to payer/beneficiary (on the basis of a formula).
The fees may be debited from the means of outgoing payment/incoming payment defined for the transaction (cannot be canceled).
The fees may be debited on the date of execution of the transaction, not on the date defined for the debit/credit.

Cancellation of transactions due to absence of user response may be supported.

In respect of Sending of Outgoing Payment and Sending of Request for Payment transactions, email message may be sent to the designated agent.
Sending of Outgoing Payment—email notification may be sent to beneficiary.
Sending of Request for Payment—an email notification may be sent to payer.

Suitable contents and examples of the email notification are characterized herein e.g. with reference to FIGS. 15-37. In the event that user does not respond after a suitable number of reminders have been sent:
The transaction may be canceled.
The transaction may be presented in queries with a Canceled status.
An alert may be sent to the management system.
An email notification of cancellation of the transaction may be dispatched to the sending agent.
A message/alert about the cancellation of the transaction may be displayed in the system.

The system may send alerts to various users in respect of different transactions in the system e.g. as set out in the tables of FIGS. 50a-50b.

A message may be sent to a signed up/non signed up beneficiary about receiving of an incoming payment from payer.

A message may be sent to a payer about confirmation/rejection of receiving of incoming payment.

A message may be sent to a signed up/non signed up payer about receiving of a request for payment from beneficiary.

A message may be sent to a beneficiary about confirmation/rejection of request for payment.

A message may be sent to an authorizing agent about outgoing payment awaiting agent's confirmation in the system.

A message may be sent to an authorizing agent about confirmation/rejection of an incoming payment awaiting agent's confirmation.

A message may be sent to a authorizing agent about a request for payment that has been sent and that is awaiting agent's confirmation in the system.

A message may be sent to an authorizing agent about confirmation/rejection of a request for payment awaiting agent's confirmation.

A message may be sent to an authorizing agent about debit date deferral awaiting agent's confirmation.

A message may be sent to an authorizing agent about request for earlier credit date awaiting agent's confirmation.

Management system alerts may be provided. The management system may track and monitor all the transactions executed in the system. The information may be logged for company, user and date.

Some of the transactions executed in the system may be displayed and available in the management system, such as but not limited to some or all of:
Signing up
Login—Forgot password
Sending of forms
Upgrade requests
Sending of an outgoing payment
Receiving of outgoing payment—confirmation/rejection
Sending of a request for payment
Receiving of a request for payment—confirmation/rejection
Deferring debit date
Credit date deferral

The system administrator may receive an alert in respect of particular actions, such as but not limited to some or all of:
Input of a computerized organization not identified by D&B (e.g.)
More than three login attempts using an erroneous user name/password
Beneficiary's details not identified by D&B (e.g.)
Transaction amount higher than a specified amount that shall be defined
Number of transactions exceeds the parameter for that agent in the time frame that shall be defined
Rejection exceeding a parameter by an agent to the request of another agent
Rejection by more than X beneficiaries in a specified time frame
Receiving of forms to upgrade account
Non-use of a magnetic card reader installed at user
Excessive use of management of users

Low rating at D&B (e.g.)

Specific actions in the system may require system administrator confirmation and may not be executed without the clerk's confirmation, such as but not limited to some or all of:
Transaction amount higher than a specified amount that shall be defined
IBAN transfers
Account upgrade

During execution of the transaction, a user may receive a message that the transaction has been transferred to the system administrator for confirmation.

Invite a Friend (IAF) functionality: The system may enable a user to send invitations friends/colleagues to use the service. An Invitation screen and Email message to an invitee may provided.

Contents May Include:
Input of friend's address and details for sending invitation
Sending email message to invitee
Collecting data, such as but not limited to some or all of:
   Number of friends that user has invited
   Number of friends who responded in the affirmative to the invitation
   Number of friends who did not open the email message
   Number of friends who did open the email message
   Number of friends who did open the email message and clicked the Additional Information link

Additional Instructions
Reminder in case of lack of response—an invitee who did not sign up is typically sent another email message five days later.
Open invitations cannot be sent to the same friend again from the same user.

Any suitable Save/Print/Import mechanisms may be provided. For example, the system may enable a large part of the information in the system to be printed or saved.

If printing or saving is required, an appropriate button may be displayed.

Printing Instructions May Include:
Printing may display only the information selected for printing (without the system framework)
Printing may be economical and may include the minimum possible colors
Printing may include only the information that the user needs displayed

The system may enable saving/exporting of the information to various formats such as but not limited to some or all of:
PDF
WORD
EXCEL (CSV)
User can select the desired format to save in, and the displayed information may be adapted to the selected format
Tabular information may be saved in each of the above formats
The form format may be saved in PDF or WORD format only

Importing information: User may be able to import a contact list to the system of the present invention typically from formats such as but not limited to some or all of:
Hashayshevet
OUTLOOK
EXCEL
Gmail

A user may be able to select desired format for import.

Future transactions: The system of the present invention typically enables users to send future payments and future payment requests via credit card and via bank account. In case of a credit card, the future payment is guaranteed, due to using and maintaining the J5 feature until the actual payment date. In case of a bank account, the future payment is typically guaranteed due to suitable payment features provided by the bank.

One or both of the following future actions are typically provided:
Payment—The payer sends money to the beneficiary at a future date.
Payment request—The beneficiary requests to receive money from the payer at a future date.

In order to send a future payment, the payer typically is prompted to complete some or all of the following steps:
The payer registers or logins to The system of the present invention
The payer defines his payment method (redirect to clearing or standing order at his bank)
The payer chooses beneficiary, payment method, amount and payment (value) date

In order to send a future payment request, the beneficiary typically is prompted to complete some or all of the following steps:
The beneficiary registers or logins to the system of the present invention
The beneficiary chooses the payer, payment method, amount and payment date

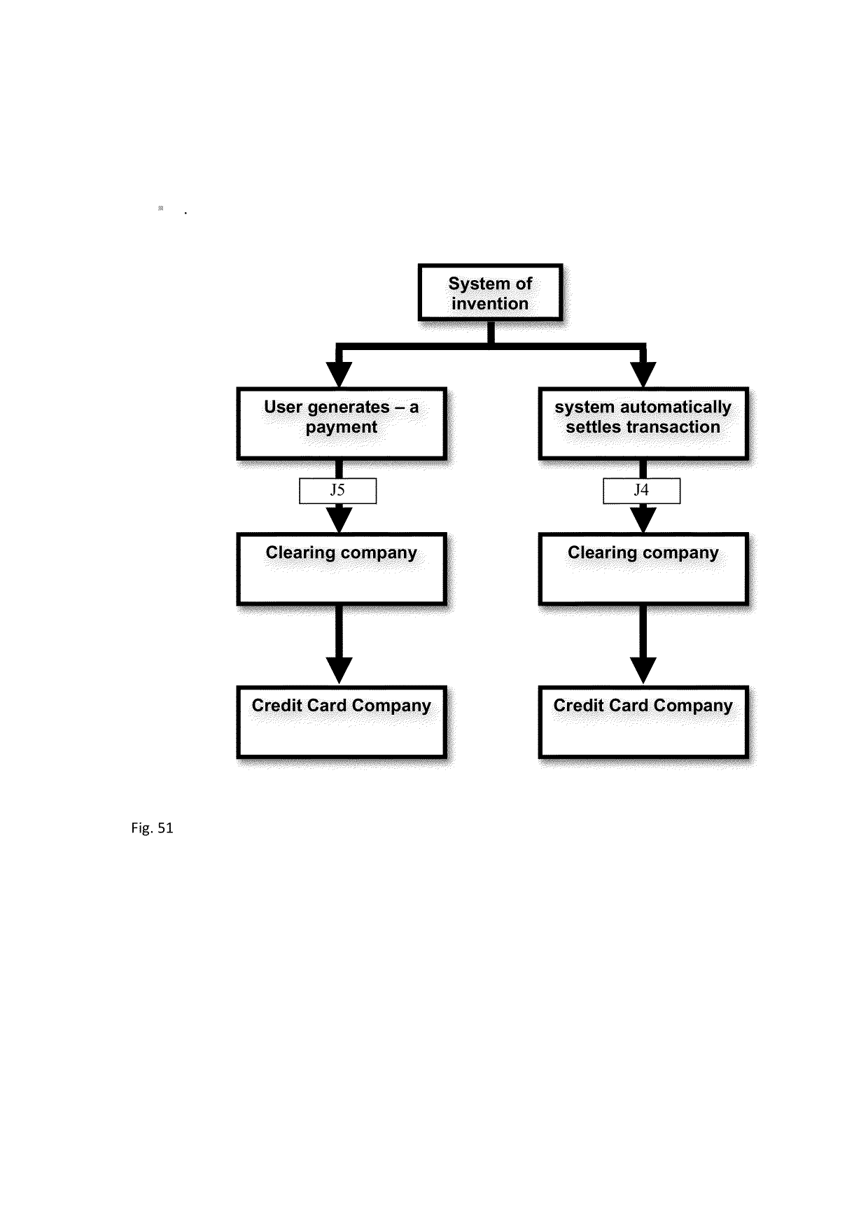

When a future payment is being sent, typically, as shown in FIG. 51, some or all of the following computerized operations occur, suitably ordered e.g. as shown:
The system of the present invention typically sends a J5 request through the clearing company to the credit card company.
The credit card company deducts the requested amount from the payer credit line.
If the beneficiary accepted the payment before the payment date, the system of the present invention may send a J4 (J0) transaction through the clearing company to the credit card company to settle the transaction.
The payer credit line is released.

A “cashier” table including some or all of the following columns is typically maintained:

| | |
|---|---|
| cashiered | netamount |
| sessionid | paymenttime |
| userid | paymentoptionid |
| agented | partnercashierid |
| ip | netamount |
| cashierdatetime | paymenttime |
| userrequest | refunduserid |
| userresponse | refusetime |
| providerrequestid | refuseagentid |
| providerresponseid | acceptedagentid |
| providercashierstatus | acceptedtime |
| accountactionid | cancelagentid |
| amount | canceltime |
| commission | additionaldata |

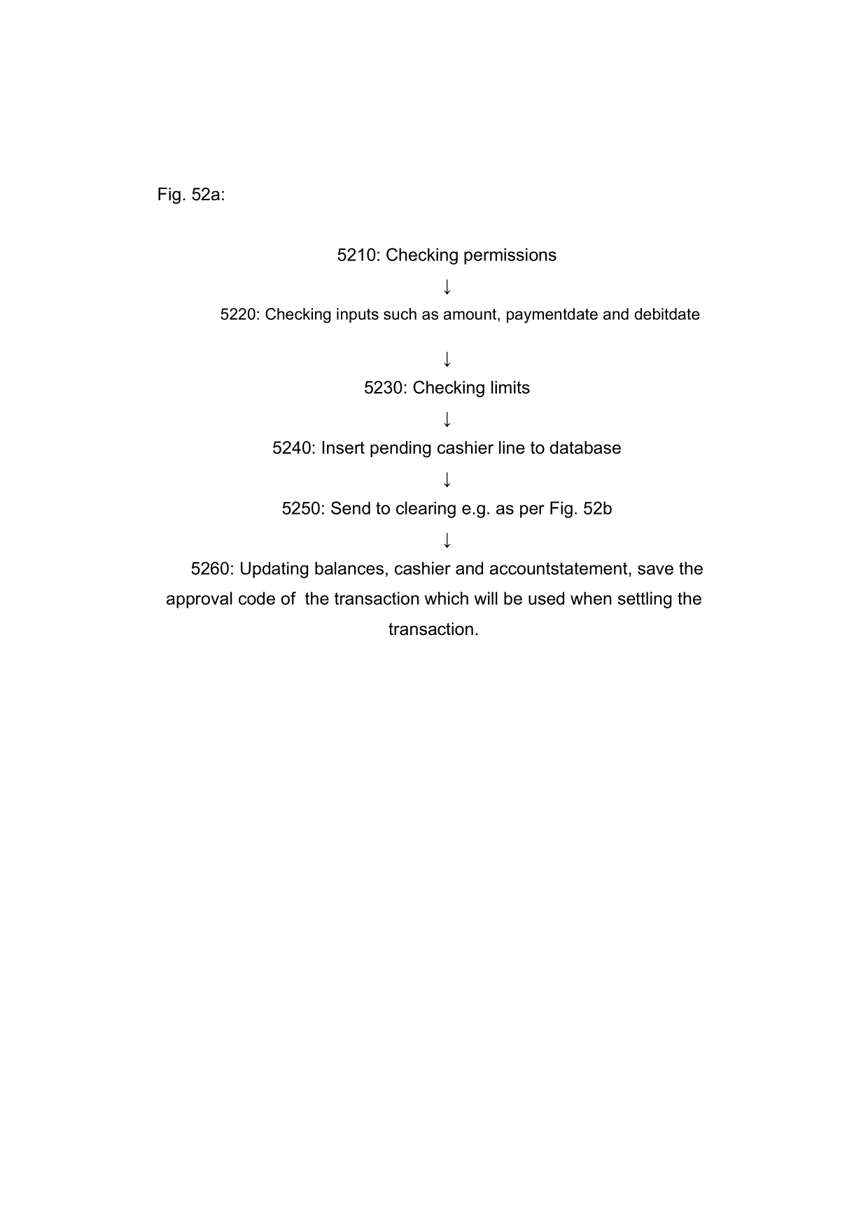

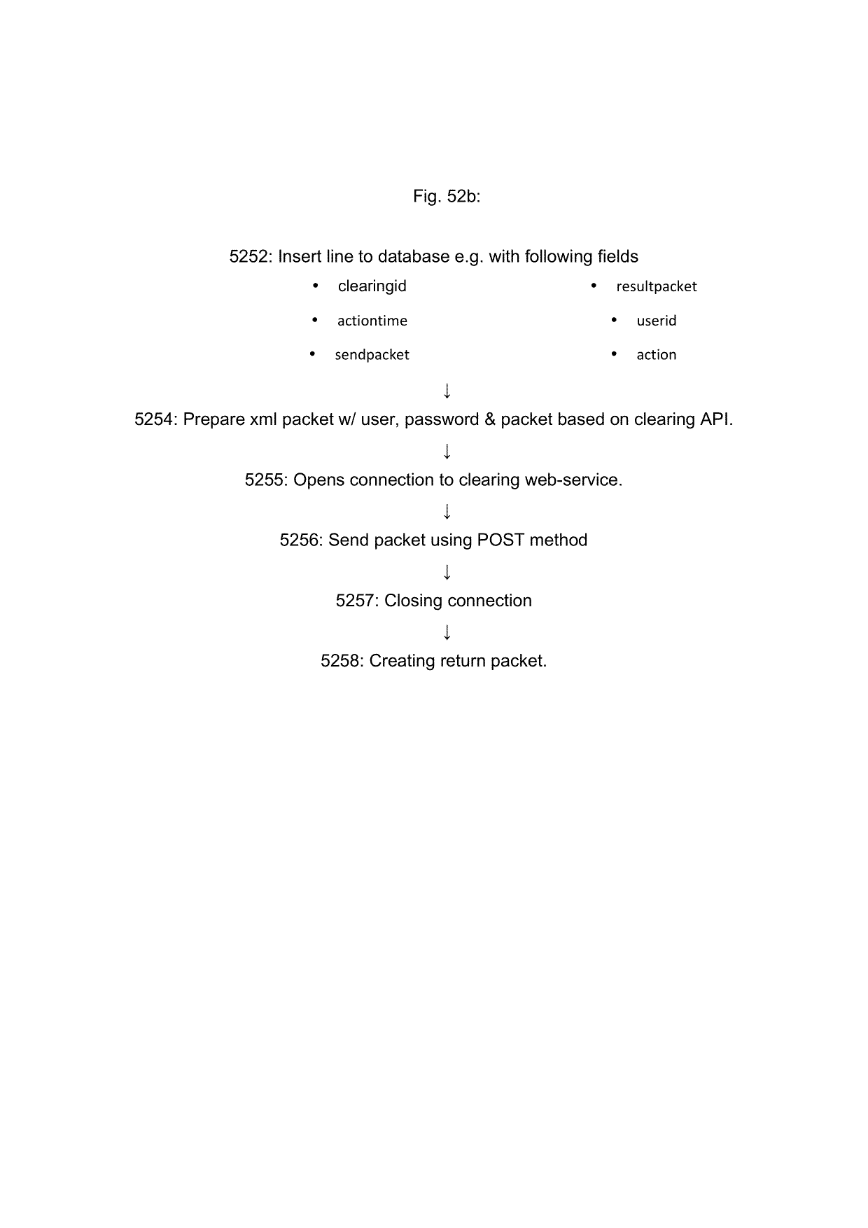

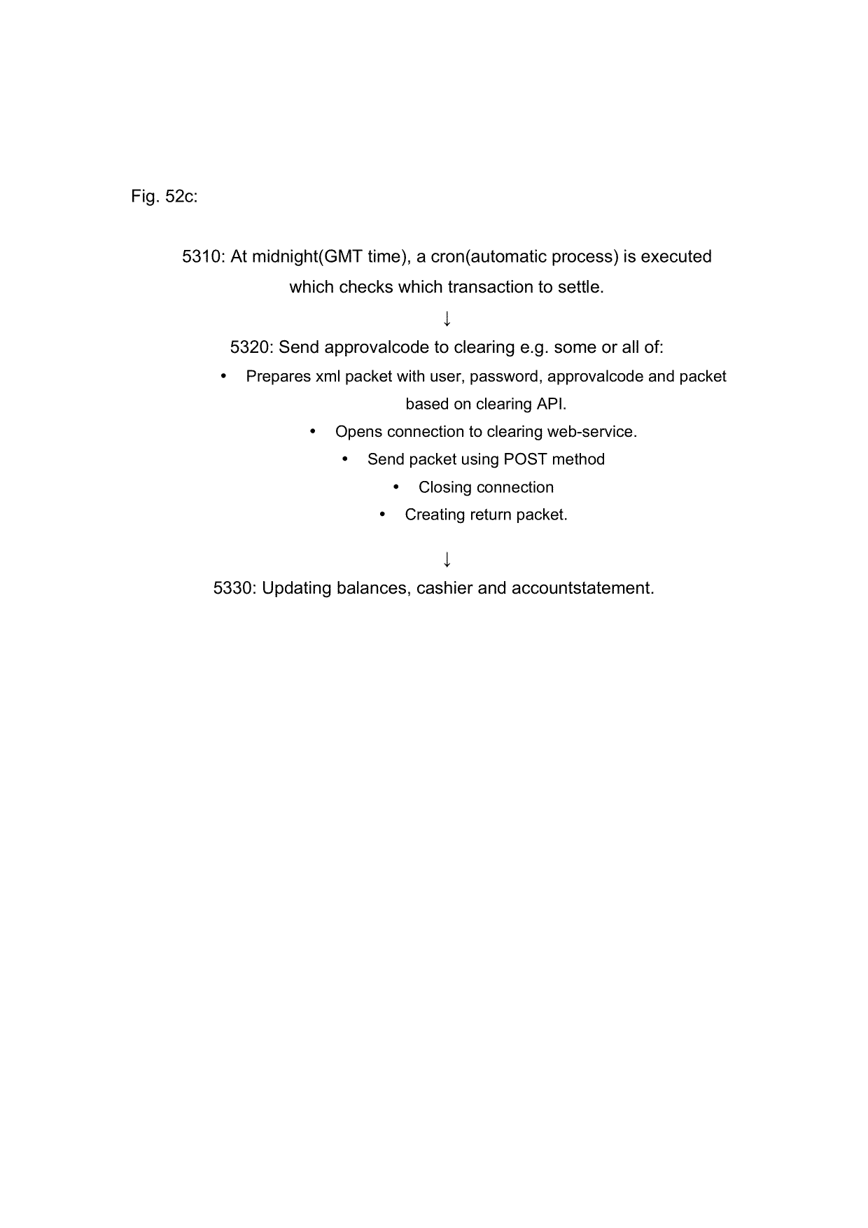

The process of future payments typically includes the following two actions:
Sending a J5 to ensure that receive the money e.g. as described in FIGS. 52a-52b
Settling the transaction at the given date, e.g. as described in FIG. 52c.

Sending J5 typically includes some or all of the following steps or tasks shown in FIG. 52a, suitably ordered e.g. as shown:
a. Checking permissions e.g. whether some or all of the following:
   Agent is allowed to perform this action
   User is allowed to deposit and to transfer
   Password provided is correct
   Agent is active
   Account is active
b. Checking inputs such as some or all of: amount, paymentdate and debitdate
c. Checking limits, typically per agent, e.g. some or all of: account, agenttype, accounttype, accountstatus. Checks may include:
   Amount exceeds limits (is too small or too big)
   Amount exceeds limits (is too small or too big) in case the card is not verified.
d. Insert pending cashier line to database
e. Send to clearing e.g. by performing some or all of the steps or tasks as shown in FIG. 52b, suitably ordered e.g. as shown.
f. Updating balances, cashier and accountstatement, save the approvalcode of the transaction which may be used when settling the transaction. This step may be based on parameters such as but not limited to some or all of: different transfer- and debittime, automatic accept from the beneficiary side and new or old beneficiary.

The “send to clearing” step of FIG. 52b may include some or all of the following steps or tasks, suitably ordered e.g. as shown:
a. Insert line to database e.g. with some or all of the following fields

| | |
|---|---|
| clearingid | resultpacket |
| actiontime | userid |
| sendpacket | action |

b. Prepare xml packet with user, password and packet based on clearing API.
   c. Open connection to clearing web-service.
   d. Send packet using POST method
   e. Closing connection
   f. Creating return packet.

Settling a transaction typically includes some or all of the following steps or tasks shown in FIG. 52c, suitably ordered e.g. as shown:
a. At (say) midnight (GMT time), a cron (automatic process) is executed which checks which transaction to settle.
b. Send approvalcode to clearing e.g. by performing some or all of the following steps or tasks, suitably ordered e.g. as follows:
   Prepares xml packet with user, password, approvalcode and packet based on clearing API.
   Opens connection to clearing web-service.
   Send packet using POST method
   Closing connection
   Creating return packet.
c. Updating balances, cashier and accountstatement.

Separation of transactions: Conventionally, payments are effected from a payer to a beneficiary. However, according to certain embodiments, any payment transaction processed through the system of the present invention typically is processed as 2 stand alone transactions:
Send Payment—the payer sends money to the system of the present invention; and
Receive Payment—the beneficiary receives money from the system of the present invention

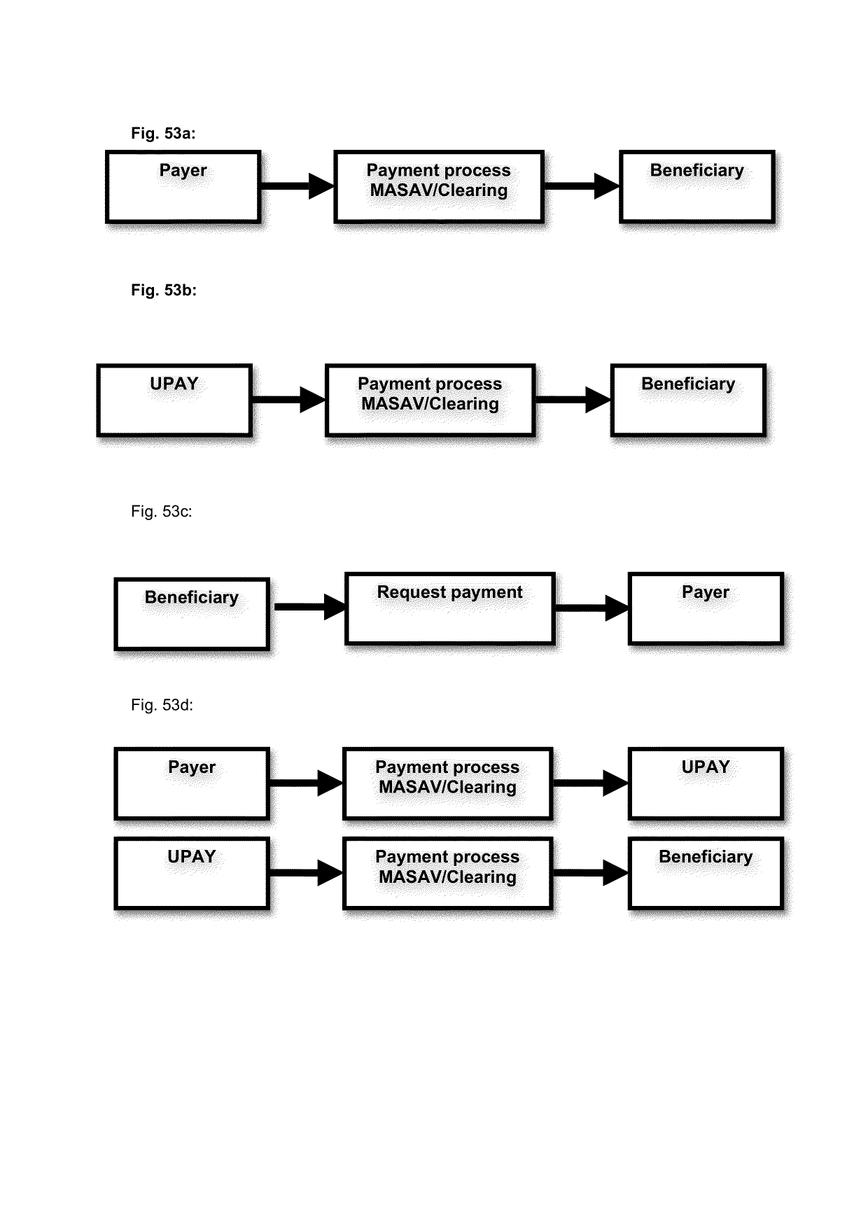

Conventionally, a payment transaction is a fixed transaction between 2 entities (payer and beneficiary) using a predefined payment method at a predefined payment date, e.g. as follows:
A payer defines an amount, the payment date, the payment method to debit and the beneficiary payment method to credit (must be the same method—credit card to credit card or bank account to bank account).
The beneficiary receives the amount at the same payment method type (credit card to credit card or bank account to bank account) to the payment method that the payer defined and the payment date defined by the payer e.g. as shown in FIG. 53a.
   Send payment: The system of the present invention typically separates the payment and enables full flexibility to each stand alone transactions e.g. as shown in FIG. 53b.
   Send Payment—The payer may define some or all of the following:
The beneficiary
The amount
The payment method to debit the payment
The payment date to debit his payment method (without affecting the beneficiary)
The payment date to credit the beneficiary

The system of the present invention typically receives the payment and:
Verifies transaction amount and value date with the processing companies
Creates 2 stand alone transactions:
   Send payment
   Receive payment
Saves each stand alone transaction typically with a transaction code (Token) received from the processing companies until payment date
   Receive Payment transaction—The beneficiary defines the following:
Accept or decline the payment
The payment method to credit the payment, which may be a different method than the one used by the payer
The payment date to credit his payment method without affecting the payer
   Send Payment transaction—The Payer can define the following:
The value date to debit his payment method (without affecting the beneficiary)

The system of the present invention typically sends payment Request (requests a payment). Typically, the system of the present invention typically separates the payment request and enables full flexibility to each stand alone transaction e.g. as shown in FIGS. 53c-53d.

Send Payment Request—The beneficiary can define some or all of the following:
The Payer
The amount
The payment method to credit the payment
The requested payment date to credit his account
The requested credit date to credit his payment method (without affecting the payer)
   The system of the present invention typically receives the payment request and:
Verifies transaction amount and payment date with the processing companies
Creates 2 stand alone transactions:
   Send payment
   Receive payment
Saves each stand alone transaction (with a transaction code received from the processing companies) until payment date
   Receive Payment Request transaction—The payer can define some or all of the following:
Accept or decline the payment request
The payment method to debit the payment (can be different method type than defined by the beneficiary)
The payment date to debit his payment method (without affecting the beneficiary)
   Send Payment Request transaction—The beneficiary can define the value date to credit his payment method (without affecting the payer)
   The process may be similar to conventional payment.
   Postpone Debit Value Date: In a send payment action, the payer defines the payment date to credit the beneficiary, but he can postpone the debit date at any time. Any change in the debit value date, doesn't change the beneficiary credit date.

### Precede Credit Value Date

In a received payment action, the initial credit payment date was defined by the payer, but the beneficiary can precede the actual credit date. Any change in the credit value date, does not change the payer debit date.

The deal structure may be implemented by performing some or all of the following steps, suitably ordered e.g. as shown:
Deal broadcast: the party who initiates the deal (can be either the payer or the beneficiary) transmit it to the system of the present invention
Deal reception: The system of the present invention's platform is receiving the transaction
Deal processing:
Deal validation: the transaction is being validated with the credit card company
Deal split: the transaction is being split into two separate transactions in the data base
Storage: the deal is being stored in the data base until the payment date
Adjustments: Each transaction can be modified by each party (postponed or preceded)
Execution: final execution of both transactions at the relevant date.

When a payer pays by credit card and the beneficiary receives this on his bank account, there may be three different actions:
i. Deposit to Payer's internal (in the system of the present invention) account by Creditcard (or Bank account)
ii. Transfer to internal (in the system of the present invention) Beneficiary
iii. Withdraw from internal (in the system of the present invention) account to Bank account (or Creditcard)

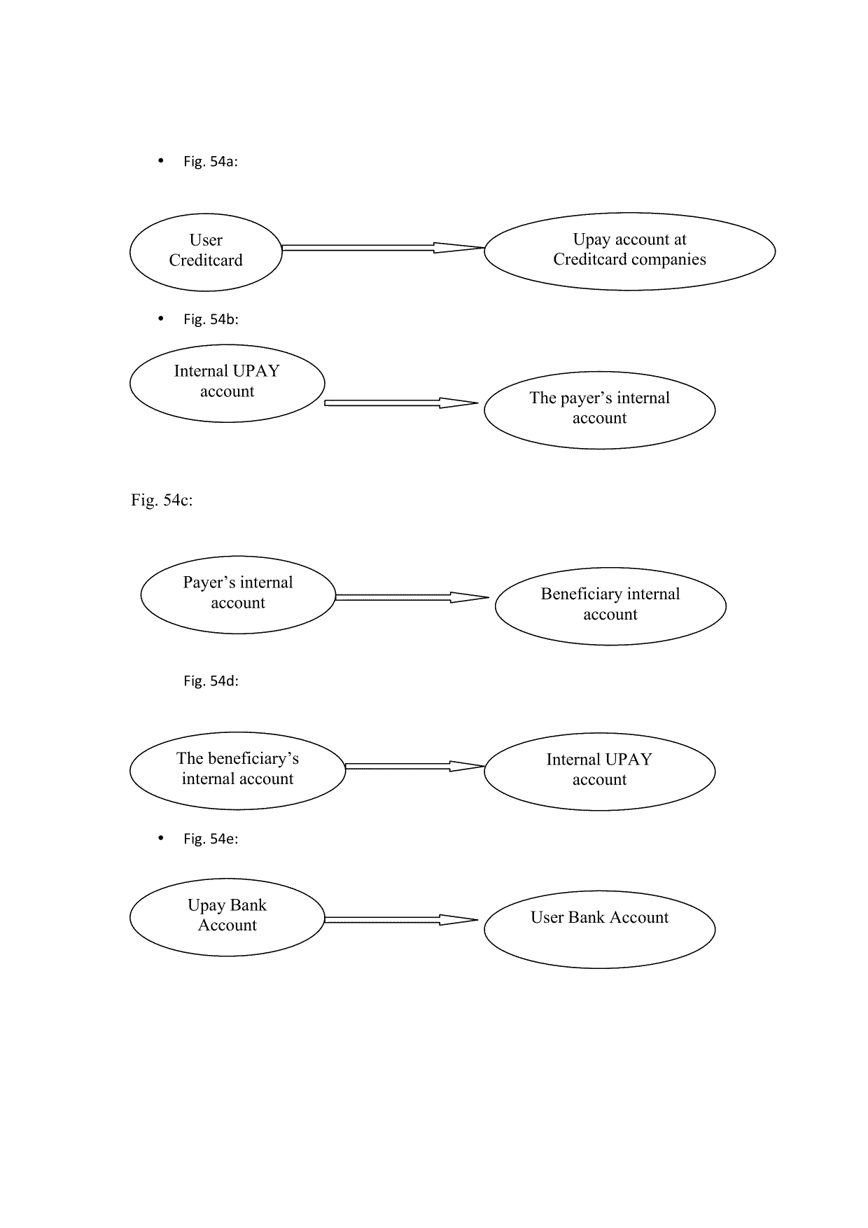

Turning to the deposit, from the credit card to the account, the system of the present invention typically holds at the credit card companies through clearing, e.g. as shown in FIG. 54a. As a result, the system of the present invention typically credits the payer's internal account e.g. as shown in FIG. 54b.

Turning to the transfer, the payer transfers from his internal account to the beneficiary account, e.g. as shown in FIG. 54c. There might be cases where this is not direct because the beneficiary did not agree to receive money. In such cases, the money is transferred to a temporary account and later when the beneficiary accepts, he may receive the money.

As for Withdrawal, the beneficiary withdraws from his internal account to the system of the present invention's internal account, e.g. as shown in FIG. 54c. As a result, the system of the present invention typically credits the beneficiary's bank account through a suitable external clearing system such as but not limited to Masav, e.g. as shown in FIG. 54e.

There may be three dates in the process which may be termed the debit-date, the transfer date and the credit date. Consequently, the payer and the beneficiary can either postpone or precede the deposit date or withdrawal date. The transfer date, also termed herein basic date, is the official agreed date between the two parties. When all different dates are equal, the process behaves as described above. When dates are different, the system of the present invention typically gives credit to deposit later and to withdrawal earlier. Technically, this may be accomplished by closing a transaction at the credit card company and getting remittance earlier.

FIGS. 55a-68b are tables which, when stored in computer memory, are useful in accordance with certain embodiments of the present invention; some or all of the tables may, in part or in their entirety, be stored in the computerized database/s 70 of FIG. 1b. It is appreciated that the names of the parameters are selected to be generally self-explanatory to an ordinarily skilled man of the art.

The scope of the present invention typically is not limited to structures and functions specifically described herein and is also intended to include devices which have the capacity to yield a structure, or perform a function, described herein, such that even though users of the device may not use the capacity, they may be, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

1. A computerized method for managing injection of resources into a flow of multiple resource utilization events, the method comprising:
receiving computerized data including a flow of base resource utilization events each including a digital representation of a basic date on which at least one externally managed resource is to be supplied by a resource supplier to a resource utilizer;
deriving first and second resource utilization events from each base resource utilization event and storing said first and second resource utilization events as two unrelated computer database records including:
a first computer database record storing a digital representation of the first resource utilization event, according to which the externally managed resource is to be supplied by a first resource supplier by a first date wherein said first date is a parameter whose initial value is said basic date; and
a second computer database record storing a digital representation of the second resource utilization event, according to which the externally managed resource is to be supplied to an individual resource utilizer by a second date wherein said second date is a parameter whose initial value is said basic date;
providing a computerized internal resource management subsystem for managing internal resources, including authorization of injection of internal resources into resource utilization events without exceeding available amounts of the internal resources and recording said injections so authorized; and
changing at least an individual date from among said first and second dates, in at least one of said computer database records, so as to define a temporal gap between said individual date and said basic date and recording at least one resource injection authorized by said internal resource management subsystem to bridge said temporal gap.

2. A computerized method according to claim 1 wherein said resources comprise equipment resources.

3. A computerized method according to claim 2 wherein said equipment resources comprise printing equipment.

4. A computerized method according to claim 1 wherein said resources comprise a fleet of vehicles performing deliveries.

5. A computerized method according to claim 1 wherein said resources comprise computer-managed credit, wherein said basic date comprises a debit date, said resource supplier comprises a payer computerized system and said resource utilizer comprises a beneficiary computerized system.

6. A computerized method according to claim 1 wherein said resources comprise manufacturing facilities.

7. A computerized method according to claim 2 wherein said equipment resources comprise construction equipment.

8. A computerized method according to claim 1 wherein said computer database record for which said individual date is changed includes a first record, and wherein said changing includes selecting as the individual date, a date later than said first date.

9. A computerized method according to claim 1 wherein said computer database record for which said individual date is changed includes a second record, and wherein said changing includes selecting as the individual date, a date earlier than said second date.

10. A computerized method according to claim 1 wherein said internally managed and externally managed resources are interchangeable.

11. A computerized method according to claim 8 wherein said changing occurs responsive to a computerized request entered by the first resource supplier.

12. A computerized method according to claim 9 wherein said changing occurs responsive to a computerized request entered by the individual resource utilizer.

13. A computerized method according to claim 1 and also comprising allowing resource suppliers to view information regarding first resource utilization events in which the resource suppliers supply the externally managed resource but not allowing resource suppliers to view information regarding second resource utilization events in which the resource suppliers supply the externally managed resource.

14. A computerized method according to claim 1 and also comprising allowing resource utilizers to view information regarding second resource utilization events in which the resource utilizers are supplied with the externally managed resource but not allowing resource utilizers to view information regarding first resource utilization events in which the resource utilizers are supplied with the externally managed resource.

15. A computerized method according to claim 5 wherein future payments are sent and received via credit cards, using future payment computerized protocol options provided by external clearing companies.

16. A computerized method according to claim 5 and also comprising a bank account computerized interface operative to send and receive a future transaction using a bank account, including interfacing with at least one external computerized electronic financial system using an API (Application program interface) predefined by the external electronic system.

17. A computerized method according to claim 16 wherein said external computerized electronic financial system comprises an Automatic Clearing House.

18. A computerized method according to claim 5 wherein full PCI compatibility is maintained. by redirecting clients to a processor system with full PCI compliance.

19. A computerized method according to claim 1 wherein computerized Delivery Guarantee is provided.

20. A computerized method according to claim 1 wherein an AJAX web application is used on a client side, to send data to, and to receive data from, a server, asynchronously and in the background.

21. A computerized method according to claim 1 wherein separation of data and interface is achieved by use of model-view-controller (MVC) software architecture.

22. A computerized method according to claim 1 and also comprising generating and utilizing at least one text file representing data stored in at least one database serving the method, to expedite client-server access while retaining flexibility of the data provided by the database.

23. A computerized system for managing injection of resources into a flow of multiple resource utilization events, the system comprising:
a resource utilization events receiver operative for receiving computerized data including a flow of base resource utilization events each including a digital representation of a basic date on which at least one externally managed resource is to be supplied by a resource supplier to a resource utilizer;
a resource utilization event splitter deriving first and second resource utilization events from each base resource utilization event and storing said first and second resource utilization events as two unrelated computer database records including:
a first computer database record storing a digital representation of the first resource utilization event, according to which the externally managed resource is to be supplied by a first resource supplier by a first date wherein said first date is a parameter whose initial value is said basic date; and
a second computer database record storing a digital representation of the second resource utilization event, according to which the externally managed resource is to be supplied to an individual resource utilizer by a second date wherein said second date is a parameter whose initial value is said basic date;
a computerized internal resource management subsystem for managing internal resources, including authorization of injection of internal resources into resource utilization events without exceeding available amounts of the internal resources and recording said injections so authorized; and
a resource injection manager operative for changing at least an individual date from among said first and second dates, in at least one of said computer database records, so to define a temporal gap between said individual date and said basic date and recording at least one resource injection authorized by said internal resource management subsystem to bridge said temporal gap.

24. A computer program product, comprising a computer usable medium having a computer readable program code embodied therein, said computer readable program code adapted to be executed to implement a method for managing injection of resources into a flow of multiple resource utilization events, the method comprising:
receiving computerized data including a flow of base resource utilization events each including a digital representation of a basic date on which at least one externally managed resource is to be supplied by a resource supplier to a resource utilizer;
deriving first and second resource utilization events from each base resource utilization event and storing said first and second resource utilization events as two unrelated computer database records including:
a first computer database record storing a digital representation of the first resource utilization event, according to which the externally managed resource is to be supplied by a first resource supplier by a first date wherein said first date is a parameter whose initial value is said basic date; and
a second computer database record storing a digital representation of the second resource utilization event, according to which the externally managed resource is to be supplied to an individual resource utilizer by a second date wherein said second date is a parameter whose initial value is said basic date;
providing a computerized internal resource management subsystem for managing internal resources, including authorization of injection of internal resources into resource utilization events without exceeding available amounts of the internal resources and recording said injections so authorized; and
changing at least an individual date from among said first and second dates, in at least one of said computer database records, so to define a temporal gap between said individual date and said basic date and recording at least one resource injection authorized by said internal resource management subsystem to bridge said temporal gap.
